(19) United States
(12) Patent Application Publication
(10) Pub. No.: US 2024/0201337 A1
(43) Pub. Date: Jun. 20, 2024

(54) COHERENT PULSED LIDAR SYSTEM

(71) Applicant: Luminar, LLC, Orlando, FL (US)

(72) Inventors: Philip W. Smith, Melbourne, FL (US); David H. Minasi, Lauderdale by the Sea, FL (US); Joseph G. LaChapelle, Philomath, OR (US); Roger S. Cannon, Oviedo, FL (US); Robert D. Still, Colorado Springs, CO (US); Elias Soto, Melbourne, FL (US); Zachary Ronald Dylan Thomas Bush, Orlando, FL (US)

(21) Appl. No.: 18/517,378

(22) Filed: Nov. 22, 2023

Related U.S. Application Data
(63) Continuation-in-part of application No. 16/794,500, filed on Feb. 19, 2020, now Pat. No. 11,940,565.
(60) Provisional application No. 62/889,192, filed on Aug. 20, 2019.
(60) Provisional application No. 62/902,479, filed on Sep. 19, 2019.
(60) Provisional application No. 63/427,474, filed on Nov. 23, 2022.
(60) Provisional application No. 63/450,513, filed on Mar. 7, 2023.

(51) Int. Cl. G01S 7/481; G01S 7/4861; G01S 7/497

(52) U.S. Cl. CPC G01S 7/4814; G01S 7/4861; G01S 7/497

(57) ABSTRACT

In one embodiment, a lidar system includes a light source configured to emit local-oscillator (LO) light and pulses of light, the emitted pulses of light including a first emitted pulse of light, where an optical frequency of the first emitted pulse of light is offset from an optical frequency of the LO light by a first frequency offset. The lidar system further includes a receiver configured to detect the LO light and a first received pulse of light, the first received pulse of light including light from the first emitted pulse of light scattered by a target located a distance from the lidar system. The receiver includes a detector, where: the LO light and the first received pulse of light are coherently mixed together at the detector, and the detector is configured to produce a photocurrent signal corresponding to the coherent mixing.

### CROSS-REFERENCE TO RELATED APPLICATIONS

This application is a continuation-in-part of U.S. patent application Ser. No. 16/794,500, filed 19 Feb. 2020, which claims the benefit, under 35 U.S.C. § 119(c), of U.S. Provisional Application No. 62/889,192, filed 20 Aug. 2019, and U.S. Provisional Application No. 62/902,479, filed 19 Sep. 2019, the entireties of which are incorporated by reference herein. Additionally, this application claims the benefit, under 35 U.S.C. § 119(c), of U.S. Provisional Application No. 63/427,474, filed 23 Nov. 2022, and U.S. Provisional Application No. 63/450,513, filed 7 Mar. 2023, the entireties of which are incorporated by reference herein.

### TECHNICAL FIELD

This disclosure generally relates to lidar systems.

### BACKGROUND

Light detection and ranging (lidar) is a technology that can be used to measure distances to remote targets. Typically, a lidar system includes a light source and an optical receiver. The light source can include, for example, a laser which emits light having a particular operating wavelength. The operating wavelength of a lidar system may lie, for example, in the infrared, visible, or ultraviolet portions of the electromagnetic spectrum. The light source emits light toward a target which scatters the light, and some of the scattered light is received back at the receiver. The system determines the distance to the target based on one or more characteristics associated with the received light. For example, the lidar system may determine the distance to the target based on the time of flight for a pulse of light emitted by the light source to travel to the target and back to the lidar system.

### BRIEF DESCRIPTION OF THE DRAWINGS

FIG. 1 illustrates an example light detection and ranging (lidar) system.

FIG. 2 illustrates an example scan pattern produced by a lidar system.

FIG. 3 illustrates an example lidar system with an example rotating polygon mirror.

FIG. 4 illustrates an example light-source field of view (FOV_{L}) and receiver field of view (FOV_{R}) for a lidar system.

FIG. 5 illustrates an example unidirectional scan pattern that includes multiple pixels and multiple scan lines.

FIG. 6 illustrates an example lidar system with a light source that emits pulses of light and local-oscillator (LO) light.

FIG. 7 illustrates an example light source that includes a seed laser diode and a semiconductor optical amplifier (SOA).

FIG. 8 illustrates an example light source that includes a semiconductor optical amplifier (SOA) with a tapered optical waveguide.

FIG. 9 illustrates an example light source that includes a sampled-grating distributed Bragg reflector (SG-DBR) laser.

FIG. 10 illustrates an example light source with an optical splitter that splits output light from a seed laser diode to produce seed light and local-oscillator (LO) light.

FIG. 11 illustrates an example light source with a photonic integrated circuit (PIC) that includes an optical-waveguide splitter.

FIG. 12A illustrates an example light source with a seed laser that includes a seed laser diode and a local-oscillator (LO) laser diode.

FIG. 12B illustrates an example light source that includes a direct-emitter laser diode and a local-oscillator (LO) laser diode.

FIG. 13 illustrates an example light source that includes a seed laser, a semiconductor optical amplifier (SOA), and a fiber-optic amplifier.

FIG. 14 illustrates an example fiber-optic amplifier.

FIGS. 15-18 each illustrate an example light source that includes a seed laser, a semiconductor optical amplifier (SOA), and one or more optical modulators.

FIG. 19 illustrates an example light source with a photonic integrated circuit (PIC) that includes a phase modulator.

FIG. 20 illustrates an example light source with a photonic integrated circuit (PIC) that includes a phase modulator located before an optical splitter.

FIG. 21 illustrates an example light source with a photonic integrated circuit (PIC) that includes an amplitude modulator and a phase modulator.

FIG. 22 illustrates example graphs of seed current (I₁), LO light, seed light, SOA current (I₂), and an output beam that includes emitted optical pulses.

FIGS. 23-24 each illustrate example graphs of optical power and frequency for seed light, an output beam, and LO light.

FIG. 25 illustrates example time-domain and frequency-domain graphs of LO light, seed light, and an emitted pulse of light.

FIG. 26 illustrates example graphs of seed light, an emitted optical pulse, a received optical pulse, LO light, and detector photocurrent.

FIG. 27 illustrates an example photocurrent signal and voltage signal that result from the coherent mixing of LO light and a received pulse of light.

FIG. 28 illustrates an example receiver that includes a combiner and two detectors.

FIG. 29 illustrates an example receiver that includes an integrated-optic combiner and two detectors.

FIG. 30 illustrates an example receiver that includes a 90-degree optical hybrid 428 and four detectors.

FIG. 31 illustrates an example light source and receiver integrated into a photonic integrated circuit (PIC).

FIG. 32 illustrates an example receiver that includes two polarization beam-splitters.

FIG. 33 illustrates an example receiver that includes an optical polarization element.

FIG. 34 illustrates an example lidar system with two emitted pulses of light and two received pulses of light.

FIG. 35 illustrates example graphs of optical power and frequency for seed light, an output beam, and LO light.

FIG. 36 illustrates two example photocurrent signals that result from coherent mixing of LO light with two respective received pulses of light.

FIG. 37 illustrates an example receiver that includes a detector and a detection circuit.

FIGS. 38-39 each illustrate an example receiver with a detection circuit that includes one frequency-detection channel.

FIG. 40 illustrates example graphs of signals associated with the receivers of FIGS. 38-39.

FIGS. 41-42 illustrate an example receiver with a detection circuit that includes three frequency-detection channels.

FIGS. 43-44 each illustrate an example receiver with a detection circuit that includes one frequency-detection channel.

FIG. 45 illustrates example graphs of signals associated with the receivers of FIGS. 43-44.

FIG. 46 illustrates an example receiver with a detection circuit that includes three frequency-detection channels.

FIG. 47 illustrates example frequency-domain graphs of signals associated with the receiver of FIG. 46.

FIGS. 48-49 illustrate example time-domain graphs of signals associated with the receiver of FIG. 46.

FIG. 50 illustrates the example receiver of FIG. 46 with a second received pulse of light.

FIG. 51 illustrates example frequency-domain graphs of signals associated with the receiver of FIGS. 46 and 50.

FIGS. 52-53 each illustrate an example adjustable electronic local oscillator configured to produce multiple different oscillator frequencies.

FIG. 54A illustrates example frequency-domain graphs of signals associated with an adjustable-frequency electronic local oscillator and two received pulses of light.

FIG. 54B illustrates example frequency-domain graphs of signals associated with an adjustable-frequency electronic filter and two received pulses of light.

FIG. 55 illustrates an example lidar system with four emitted pulses of light and four received pulses of light.

FIG. 56 illustrates example time-domain graphs of signals associated with the lidar system of FIG. 55.

FIG. 57 illustrates an example receiver in which each frequency-detection channel includes an in-phase channel and a quadrature channel.

FIGS. 58-59 each illustrate an example receiver with a detection circuit that includes a frequency-detection channel.

FIG. 60 illustrates example signals associated with a Doppler-shifted pulse of light that is received by a lidar system.

FIGS. 61-64 each illustrate example pass-bands of an electronic band-pass filter.

FIG. 65 illustrates example signals associated with a Doppler-shifted pulse of light that is received by a lidar system.

FIGS. 66-68 each illustrate example pass-bands of an electronic band-pass filter.

FIG. 69 illustrates an example method for determining that a received pulse of light is associated with an emitted pulse of light.

FIG. 70 illustrates an example computer system.

### DESCRIPTION OF EXAMPLE EMBODIMENTS

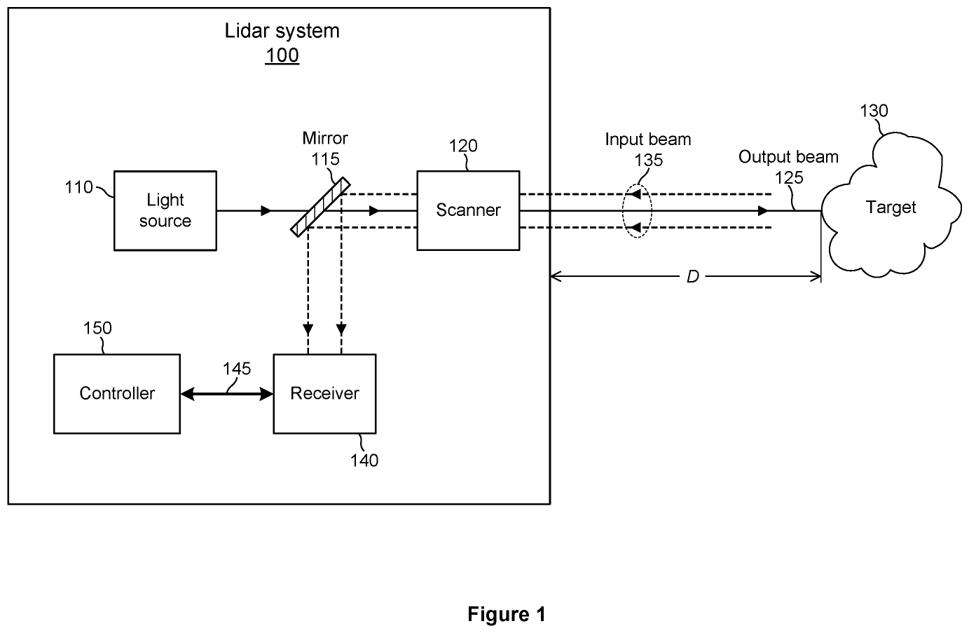

FIG. 1 illustrates an example light detection and ranging (lidar) system 100. In particular embodiments, a lidar system 100 may be referred to as a laser ranging system, a laser radar system, a LIDAR system, a lidar sensor, or a laser detection and ranging (LADAR or ladar) system. In particular embodiments, a lidar system 100 may include a light source 110, mirror 115, scanner 120, receiver 140, or controller 150 (which may be referred to as a processor). The light source 110 may include, for example, a laser which emits light having a particular operating wavelength in the infrared, visible, or ultraviolet portions of the electromagnetic spectrum. As an example, light source 110 may include a laser with one or more operating wavelengths between approximately 900 nanometers (nm) and 2000 nm. The light source 110 emits an output beam of light 125 which may be continuous wave (CW), pulsed, or modulated in any suitable manner for a given application. The output beam of light 125 is directed downrange toward a remote target 130. As an example, the remote target 130 may be located a distance D of approximately 1 m to 1 km from the lidar system 100.

Once the output beam 125 reaches the downrange target 130, the target may scatter or reflect at least a portion of light from the output beam 125, and some of the scattered or reflected light may return toward the lidar system 100. In the example of FIG. 1, the scattered or reflected light is represented by input beam 135, which passes through scanner 120 and is reflected by mirror 115 and directed to receiver 140. In particular embodiments, a relatively small fraction of the light from output beam 125 may return to the lidar system 100 as input beam 135. As an example, the ratio of input beam 135 average power, peak power, or pulse energy to output beam 125 average power, peak power, or pulse energy may be approximately 10⁻¹, 10⁻², 10⁻³, 10⁻⁴, 10⁻⁵, 10⁻⁶, 10⁻⁷, 10⁻⁸, 10⁻⁹, 10⁻¹⁰, 10⁻¹¹, or 10⁻¹². As another example, if a pulse of light of output beam 125 has a pulse energy of 1 microjoule (μJ), then the pulse energy of a corresponding pulse of input beam 135 may have a pulse energy of approximately 10 nanojoules (nJ), 1 nJ, 100 picojoules (pJ), 10 pJ, 1 pJ, 100 femtojoules (fJ), 10 fJ, 1 fJ, 100 attojoules (aJ), 10 aJ, 1 aJ, or 0.1 aJ.

In particular embodiments, output beam 125 may include or may be referred to as an optical signal, output optical signal, emitted optical signal, output light, emitted pulse of light, laser beam, light beam, optical beam, emitted beam, emitted light, or beam. In particular embodiments, input beam 135 may include or may be referred to as a received optical signal, received pulse of light, input pulse of light, input optical signal, return beam, received beam, received beam of light, return light, received light, input light, scattered light, or reflected light. As used herein, scattered light may refer to light that is scattered or reflected by a target 130. As an example, an input beam 135 may include: light from the output beam 125 that is scattered by target 130; light from the output beam 125 that is reflected by target 130; or a combination of scattered and reflected light from target 130.

In particular embodiments, receiver 140 may receive or detect photons from input beam 135 and produce one or more representative electrical signals. For example, the receiver 140 may produce an electrical output signal 145 that is representative of the input beam 135, and the electrical signal 145 may be sent to controller 150. In particular embodiments, receiver 140 or controller 150 may include a processor, a computer system, an ASIC, an FPGA, or other suitable computing circuitry. A controller 150 may be configured to analyze one or more characteristics of the electrical signal 145 from the receiver 140 to determine one or more characteristics of the target 130, such as its distance downrange from the lidar system 100. This may be done, for example, by analyzing a time of flight or a frequency or phase of a transmitted beam of light 125 or a received beam of light 135. If lidar system 100 measures a time of flight of ΔT (e.g., ΔT may represent a round-trip time of flight for an emitted pulse of light to travel from the lidar system 100 to the target 130 and back to the lidar system 100), then the distance D from the target 130 to the lidar system 100 may be expressed as D=c·ΔT/2, where c is the speed of light (approximately 3.0×10⁸ m/s). As an example, if a time of flight is measured to be ΔT=300 ns, then the distance from the target 130 to the lidar system 100 may be determined to be approximately D=45.0 m. As another example, if a time of flight is measured to be ΔT=1.33 μs, then the distance from the target 130 to the lidar system 100 may be determined to be approximately D=199.5 m. In particular embodiments, a distance D from lidar system 100 to a target 130 may be referred to as a distance, depth, or range of target 130. As used herein, the speed of light c refers to the speed of light in any suitable medium, such as for example in air, water, or vacuum. As an example, the speed of light in vacuum is approximately 2.9979×10⁸ m/s, and the speed of light in air (which has a refractive index of approximately 1.0003) is approximately 2.9970×10⁸ m/s.

In particular embodiments, light source 110 may include a pulsed or CW laser. As an example, light source 110 may be a pulsed laser configured to produce or emit pulses of light with a pulse duration or pulse width of approximately 10 picoseconds (ps) to 100 nanoseconds (ns). The pulses may have a pulse duration (Δτ) of approximately 100 ps, 200 ps, 400 ps, 1 ns, 2 ns, 5 ns, 10 ns, 20 ns, 50 ns, 100 ns, or any other suitable pulse duration. As another example, light source 110 may be a pulsed laser that produces pulses of light with a pulse duration of approximately 1-5 ns. As another example, light source 110 may be a pulsed laser that produces pulses of light at a pulse repetition frequency of approximately 80 kHz to 10 MHz or a pulse period (e.g., a time between consecutive pulses of light) of approximately 100 ns to 12.5 μs. The pulse period t may be related to the pulse repetition frequency (PRF) by the expression τ=1/PRF. For example, a pulse period of 1.33 μs corresponds to a PRF of approximately 752 kHz. In particular embodiments, light source 110 may have a substantially constant pulse repetition frequency, or light source 110 may have a variable or adjustable pulse repetition frequency. As an example, light source 110 may be a pulsed laser that produces pulses at a substantially constant pulse repetition frequency of approximately 640 kHz (e.g., 640,000 pulses per second), corresponding to a pulse period of approximately 1.56 μs. As another example, light source 110 may have a pulse repetition frequency (which may be referred to as a repetition rate) that can be varied from approximately 200 kHz to 2 MHz. As used herein, a pulse of light may be referred to as an optical pulse, a light pulse, or a pulse.

In particular embodiments, light source 110 may include a pulsed or CW laser that produces a free-space output beam 125 having any suitable average optical power. As an example, output beam 125 may have an average power of approximately 1 milliwatt (mW), 10 mW, 100 mW, 1 watt (W), 10 W, or any other suitable average power. In particular embodiments, output beam 125 may include optical pulses with any suitable pulse energy or peak optical power. As an example, output beam 125 may include pulses with a pulse energy of approximately 0.01 μJ. 0.1 μJ, 0.5 μJ, 1 μJ, 2 μJ, 10 μJ, 100 μJ, 1 mJ, or any other suitable pulse energy. As another example, output beam 125 may include pulses with a peak power of approximately 10 W, 100 W. 1 KW, 5 KW, 10 KW, or any other suitable peak power. The peak power (Pₚₑₐₖ) of a pulse of light can be related to the pulse energy (E) by the expression E=Pₚₑₐₖ·Δτ, where Δτ is the duration of the pulse, and the duration of a pulse may be defined as the full width at half maximum duration of the pulse. For example, an optical pulse with a duration of 1 ns and a pulse energy of 1 μJ has a peak power of approximately 1 kW. The average power (Pₐᵥ) of an output beam 125 can be related to the pulse repetition frequency (PRF) and pulse energy by the expression Pₐᵥ=PRF·E. For example, if the pulse repetition frequency is 500 kHz, then the average power of an output beam 125 with 1-μJ pulses is approximately 0.5 W.

In particular embodiments, light source 110 may include a laser diode, such as for example, a Fabry-Perot laser diode, a quantum well laser, a distributed Bragg reflector (DBR) laser, a distributed feedback (DFB) laser, a vertical-cavity surface-emitting laser (VCSEL), a quantum dot laser diode, a grating-coupled surface-emitting laser (GCSEL), a slab-coupled optical waveguide laser (SCOWL), a single-transverse-mode laser diode, a multi-mode broad area laser diode, a laser-diode bar, a laser-diode stack, or a tapered-stripe laser diode. As an example, light source 110 may include an aluminum-gallium-arsenide (AlGaAs) laser diode, an indium-gallium-arsenide (InGaAs) laser diode, an indium-gallium-arsenide-phosphide (InGaAsP) laser diode, or a laser diode that includes any suitable combination of aluminum (Al), indium (In), gallium (Ga), arsenic (As), phosphorous (P), or any other suitable material. In particular embodiments, light source 110 may include a pulsed or CW laser diode with a peak emission wavelength between 1200 nm and 1600 nm. As an example, light source 110 may include a current-modulated InGaAsP DFB laser diode that produces optical pulses at a wavelength of approximately 1550 nm. As another example, light source 110 may include a laser diode that emits light at a wavelength between 1500 nm and 1510 nm.

In particular embodiments, light source 110 may include a pulsed or CW laser diode followed by one or more optical-amplification stages. For example, a seed laser diode may produce a seed optical signal, and an optical amplifier may amplify the seed optical signal to produce an amplified optical signal that is emitted by the light source 110. In particular embodiments, an optical amplifier may include a fiber-optic amplifier or a semiconductor optical amplifier (SOA). For example, a pulsed laser diode may produce relatively low-power optical seed pulses which are amplified by a fiber-optic amplifier. As another example, a light source 110 may include a fiber-laser module that includes a current-modulated laser diode with an operating wavelength of approximately 1550 nm followed by a single-stage or a multi-stage erbium-doped fiber amplifier (EDFA) or erbium-ytterbium-doped fiber amplifier (EYDFA) that amplifies the seed pulses from the laser diode. As another example, light source 110 may include a continuous-wave (CW) or quasi-CW laser diode followed by an external optical modulator (e.g., an electro-optic amplitude modulator). The optical modulator may modulate the CW light from the laser diode to produce optical pulses which are sent to a fiber-optic amplifier or SOA. As another example, light source 110 may include a pulsed or CW seed laser diode followed by a semiconductor optical amplifier (SOA). The SOA may include an active optical waveguide configured to receive light from the seed laser diode and amplify the light as it propagates through the waveguide. The optical gain of the SOA may be provided by pulsed or direct-current (DC) electrical current supplied to the SOA. The SOA may be integrated on the same chip as the seed laser diode, or the SOA may be a separate device with an anti-reflection coating on its input facet or output facet. As another example, light source 110 may include a seed laser diode followed by a SOA, which in turn is followed by a fiber-optic amplifier. For example, the seed laser diode may produce relatively low-power seed pulses which are amplified by the SOA, and the fiber-optic amplifier may further amplify the optical pulses.

In particular embodiments, light source 110 may include a direct-emitter laser diode. A direct-emitter laser diode (which may be referred to as a direct emitter) may include a laser diode which produces light that is not subsequently amplified by an optical amplifier. A light source 110 that includes a direct-emitter laser diode may not include an optical amplifier, and the output light produced by a direct emitter may not be amplified after it is emitted by the laser diode. The light produced by a direct-emitter laser diode (e.g., optical pulses, CW light, or frequency-modulated light) may be emitted directly as a free-space output beam 125 without being amplified. A direct-emitter laser diode may be driven by an electrical power source that supplies current pulses to the laser diode, and each current pulse may result in the emission of an output optical pulse.

In particular embodiments, light source 110 may include a diode-pumped solid-state (DPSS) laser. A DPSS laser (which may be referred to as a solid-state laser) may refer to a laser that includes a solid-state, glass, ceramic, or crystal-based gain medium that is pumped by one or more pump laser diodes. The gain medium may include a host material that is doped with rare-earth ions (e.g., neodymium, erbium, ytterbium, or praseodymium). For example, a gain medium may include a yttrium aluminum garnet (YAG) crystal that is doped with neodymium (Nd) ions, and the gain medium may be referred to as a Nd:YAG crystal. A DPSS laser with a Nd:YAG gain medium may produce light at a wavelength between approximately 1300 nm and approximately 1400 nm, and the Nd:YAG gain medium may be pumped by one or more pump laser diodes with an operating wavelength between approximately 730 nm and approximately 900 nm. A DPSS laser may be a passively Q-switched laser that includes a saturable absorber (e.g., a vanadium-doped crystal that acts as a saturable absorber). Alternatively, a DPSS laser may be an actively Q-switched laser that includes an active Q-switch (e.g., an acousto-optic modulator or an electro-optic modulator). A passively or actively Q-switched DPSS laser may produce output optical pulses that form an output beam 125 of a lidar system 100.

In particular embodiments, an output beam of light 125 emitted by light source 110 may be unpolarized or randomly polarized, may have no specific or fixed polarization (e.g., the polarization may vary with time), or may have a particular polarization (e.g., output beam 125 may be linearly polarized, elliptically polarized, or circularly polarized). As an example, light source 110 may produce light with no specific polarization or may produce light that is linearly polarized.

In particular embodiments, lidar system 100 may include one or more optical components configured to reflect, focus, filter, shape, modify, steer, or direct light within the lidar system 100 or light produced or received by the lidar system 100 (e.g., output beam 125 or input beam 135). As an example, lidar system 100 may include one or more lenses, mirrors, optical filters (e.g., band-pass or interference filters), beam-splitters, optical splitters, polarizers, polarizing beam-splitters, wave plates (e.g., half-wave or quarter-wave plates), diffractive elements, holographic elements, isolators, couplers, detectors, beam combiners, or collimators. The optical components in a lidar system 100 may be free-space optical components, fiber-coupled optical components, or a combination of free-space and fiber-coupled optical components.

In particular embodiments, lidar system 100 may include a telescope, one or more lenses, or one or more mirrors configured to expand, focus, collimate, or steer the output beam 125 or the input beam 135 to a desired beam diameter or divergence. As an example, the lidar system 100 may include one or more lenses to focus the input beam 135 onto a photodetector of receiver 140. As another example, the lidar system 100 may include one or more flat mirrors or curved mirrors (e.g., concave, convex, or parabolic mirrors) to steer or focus the output beam 125 or the input beam 135. For example, the lidar system 100 may include an off-axis parabolic mirror to focus the input beam 135 onto a photodetector of receiver 140. As illustrated in FIG. 1, the lidar system 100 may include mirror 115 (which may be a metallic or dielectric mirror), and mirror 115 may be configured so that light beam 125 passes through the mirror 115 or passes along an edge or side of the mirror 115 and input beam 135 is reflected toward the receiver 140. As an example, mirror 115 (which may be referred to as an overlap mirror, superposition mirror, or beam-combiner mirror) may include a hole, slot, or aperture which output light beam 125 passes through. As another example, rather than passing through the mirror 115, the output beam 125 may be directed to pass alongside the mirror 115 with a gap (e.g., a gap of width approximately 0.1 mm, 0.5 mm, 1 mm, 2 mm, 5 mm, or 10 mm) between the output beam 125 and an edge of the mirror 115.

In particular embodiments, mirror 115 may provide for output beam 125 and input beam 135 to be substantially coaxial so that the two beams travel along approximately the same optical path (albeit in opposite directions). The input and output beams being substantially coaxial may refer to the beams being at least partially overlapped or sharing a common propagation axis so that input beam 135 and output beam 125 travel along substantially the same optical path (albeit in opposite directions). As an example, output beam 125 and input beam 135 may be parallel to each other to within less than 10 mrad, 5 mrad, 2 mrad, 1 mrad, 0.5 mrad, or 0.1 mrad. As output beam 125 is scanned across a field of regard, the input beam 135 may follow along with the output beam 125 so that the coaxial relationship between the two beams is maintained.

In particular embodiments, lidar system 100 may include a scanner 120 configured to scan an output beam 125 across a field of regard of the lidar system 100. As an example, scanner 120 may include one or more scan mirrors configured to pivot, rotate, oscillate, or move in an angular manner about one or more rotation axes. The output beam 125 may be reflected by a scan mirror, and as the scan mirror pivots or rotates, the reflected output beam 125 may be scanned in a corresponding angular manner. As an example, a scan mirror may be configured to periodically pivot back and forth over a 30-degree range, which results in the output beam 125 scanning back and forth across a 60-degree range (e.g., a Θ-degree rotation by a scan mirror results in a 20-degree angular scan of output beam 125).

In particular embodiments, a scan mirror (which may be referred to as a scanning mirror) may be attached to or mechanically driven by a scanner actuator or mechanism which pivots or rotates the mirror over a particular angular range (e.g., over a 5° angular range, 30° angular range, 60° angular range, 120° angular range, 360° angular range, or any other suitable angular range). A scanner actuator or mechanism configured to pivot or rotate a mirror may include a galvanometer scanner, a resonant scanner, a piezoelectric actuator, a voice coil motor, an electric motor (e.g., a DC motor, a brushless DC motor, a synchronous electric motor, or a stepper motor), a microelectromechanical systems (MEMS) device, or any other suitable actuator or mechanism. As an example, a scanner 120 may include a scan mirror attached to a galvanometer scanner configured to pivot back and forth over a 1° to 30° angular range. As another example, a scanner 120 may include a scan mirror that is attached to or is part of a MEMS device configured to scan over a 1° to 30° angular range. As another example, a scanner 120 may include a polygon mirror configured to rotate continuously in the same direction (e.g., rather than pivoting back and forth, the polygon mirror continuously rotates 360 degrees in a clockwise or counterclockwise direction). The polygon mirror may be coupled or attached to a synchronous motor configured to rotate the polygon mirror at a substantially fixed rotational frequency (e.g., a rotational frequency of approximately 1 Hz, 10 Hz, 50 Hz, 100 Hz, 500 Hz, or 1,000 Hz).

In particular embodiments, scanner 120 may be configured to scan an output beam 125 (which may include at least a portion of the light emitted by light source 110) across a field of regard of a lidar system 100. A field of regard (FOR) of a lidar system 100 may refer to an area, region, or angular range over which the lidar system 100 may be configured to scan or capture distance information. As an example, a lidar system 100 with an output beam 125 with a 30-degree scanning range may be referred to as having a 30-degree angular field of regard. As another example, a lidar system 100 with a scan mirror that rotates over a 30-degree range may produce an output beam 125 that scans across a 60-degree range (e.g., a 60-degree FOR). In particular embodiments, lidar system 100 may have a FOR of approximately 10°, 20°, 40°, 60°, 120°, 360°, or any other suitable FOR.

In particular embodiments, scanner 120 may be configured to scan the output beam 125 horizontally and vertically, and lidar system 100 may have a particular FOR along the horizontal direction and another particular FOR along the vertical direction. As an example, lidar system 100 may have a horizontal FOR of 10° to 120° and a vertical FOR of 2° to 45°. In particular embodiments, scanner 120 may include a first scan mirror and a second scan mirror, where the first scan mirror directs the output beam 125 toward the second scan mirror, and the second scan mirror directs the output beam 125 downrange from the lidar system 100. As an example, the first scan mirror may scan the output beam 125 along a first direction, and the second scan mirror may scan the output beam 125 along a second direction that is different from the first direction (e.g., the first and second directions may be approximately orthogonal to one another, or the second direction may be oriented at any suitable non-zero angle with respect to the first direction). As another example, the first scan mirror may scan the output beam 125 along a substantially horizontal direction, and the second scan mirror may scan the output beam 125 along a substantially vertical direction (or vice versa). As another example, the first and second scan mirrors may each be driven by galvanometer scanners. As another example, the first or second scan mirror may include a polygon mirror driven by an electric motor. In particular embodiments, scanner 120 may be referred to as a beam scanner, optical scanner, or laser scanner.

In particular embodiments, one or more scan mirrors may be communicatively coupled to a controller 150 which may control the scan mirror(s) so as to guide the output beam 125 in a desired direction downrange or along a desired scan pattern. In particular embodiments, a scan pattern may refer to a pattern or path along which the output beam 125 is directed. As an example, scanner 120 may include two scan mirrors configured to scan the output beam 125 across a 60° horizontal FOR and a 20° vertical FOR. The two scan mirrors may be controlled to follow a scan path that substantially covers the 60°×20° FOR. As an example, the scan path may result in a point cloud with pixels that substantially cover the 60°×20° FOR. The pixels may be approximately evenly distributed across the 60°×20° FOR. Alternatively, the pixels may have a particular nonuniform distribution (e.g., the pixels may be distributed across all or a portion of the 60°×20° FOR, and the pixels may have a higher density in one or more particular regions of the 60°×20° FOR).

In particular embodiments, a lidar system 100 may include a scanner 120 with a solid-state scanning device. A solid-state scanning device may refer to a scanner 120 that scans an output beam 125 without the use of moving parts (e.g., without the use of a mechanical scanner, such as a mirror that rotates or pivots). For example, a solid-state scanner 120 may include one or more of the following: an optical phased array scanning device; a liquid-crystal scanning device; or a liquid lens scanning device. A solid-state scanner 120 may be an electrically addressable device that scans an output beam 125 along one axis (e.g., horizontally) or along two axes (e.g., horizontally and vertically). In particular embodiments, a scanner 120 may include a solid-state scanner and a mechanical scanner. For example, a scanner 120 may include an optical phased array scanner configured to scan an output beam 125 in one direction and a galvanometer scanner that scans the output beam 125 in an approximately orthogonal direction. The optical phased array scanner may scan the output beam relatively rapidly in a horizontal direction across the field of regard (e.g., at a scan rate of 50 to 1,000 scan lines per second), and the galvanometer may pivot a mirror at a rate of 1-30 Hz to scan the output beam 125 vertically.

In particular embodiments, a lidar system 100 may include a light source 110 configured to emit pulses of light and a scanner 120 configured to scan at least a portion of the emitted pulses of light across a field of regard of the lidar system 100. One or more of the emitted pulses of light may be scattered by a target 130 located downrange from the lidar system 100, and a receiver 140 may detect at least a portion of the pulses of light scattered by the target 130. A receiver 140 may include or may be referred to as a photoreceiver, optical receiver, optical sensor, detector, photodetector, or optical detector. In particular embodiments, lidar system 100 may include a receiver 140 that receives or detects at least a portion of input beam 135 and produces an electrical signal that corresponds to input beam 135. As an example, if input beam 135 includes an optical pulse, then receiver 140 may produce an electrical current or voltage pulse that corresponds to the optical pulse detected by receiver 140. As another example, receiver 140 may include one or more avalanche photodiodes (APDs) or one or more single-photon avalanche diodes (SPADs). As another example, receiver 140 may include one or more PN photodiodes (e.g., a photodiode structure formed by a p-type semiconductor and a n-type semiconductor, where the PN acronym refers to the structure having p-doped and n-doped regions) or one or more PIN photodiodes (e.g., a photodiode structure formed by an undoped intrinsic semiconductor region located between p-type and n-type regions, where the PIN acronym refers to the structure having p-doped, intrinsic, and n-doped regions). An APD, SPAD, PN photodiode, or PIN photodiode may each be referred to as a detector, optical detector, photodetector, or photodiode. A detector may receive an input beam 135 that includes an optical pulse, and the detector may produce a pulse of electrical current that corresponds to the received optical pulse. A detector may have an active region or an avalanche-multiplication region that includes silicon, germanium, InGaAs, indium aluminum arsenide (InAlAs), InAsSb (indium arsenide antimonide), AlAsSb (aluminum arsenide antimonide), AlInAsSb (aluminum indium arsenide antimonide), or silicon germanium (SiGe). The active region may refer to an area over which a detector may receive or detect input light. An active region may have any suitable size or diameter, such as for example, a diameter of approximately 10 μm, 25 μm, 50 μm, 80 μm, 100 μm, 200 μm, 500 μm, 1 mm, 2 mm, or 5 mm.

In particular embodiments, receiver 140 may include electronic circuitry that performs signal amplification, sampling, filtering, signal conditioning, analog-to-digital conversion, time-to-digital conversion, pulse detection, threshold detection, rising-edge detection, or falling-edge detection. As an example, receiver 140 may include a transimpedance amplifier that converts a photocurrent (e.g., a pulse of current produced by an APD in response to a received optical pulse) into a voltage signal. Additionally or alternatively, the receiver 140 may include a low-noise amplifier, an input-stage amplifier, or a radio-frequency (RF) amplifier. The voltage signal may be sent to pulse-detection circuitry that produces an analog or digital output signal 145 that corresponds to one or more optical characteristics (e.g., rising edge, falling edge, amplitude, duration, or energy) of a received optical pulse. As an example, the pulse-detection circuitry may perform a time-to-digital conversion to produce a digital output signal 145. The electrical output signal 145 may be sent to controller 150 for processing or analysis (e.g., to determine a time-of-flight value corresponding to a received optical pulse).

In particular embodiments, a controller 150 (which may include or may be referred to as a processor, an FPGA, an ASIC, a computer, or a computing system) may be located within a lidar system 100 or outside of a lidar system 100. Alternatively, one or more parts of a controller 150 may be located within a lidar system 100, and one or more other parts of a controller 150 may be located outside a lidar system 100. In particular embodiments, one or more parts of a controller 150 may be located within a receiver 140 of a lidar system 100, and one or more other parts of a controller 150 may be located in other parts of the lidar system 100. For example, a receiver 140 may include an FPGA or ASIC configured to process an electrical output signal from the receiver 140, and the processed signal may be sent to a computing system located elsewhere within the lidar system 100 or outside the lidar system 100. In particular embodiments, a controller 150 may include any suitable arrangement or combination of logic circuitry, analog circuitry, or digital circuitry.

In particular embodiments, controller 150 may be electrically coupled or communicatively coupled to light source 110, scanner 120, or receiver 140. As an example, controller 150 may receive electrical trigger pulses or edges from light source 110, where each pulse or edge corresponds to the emission of an optical pulse by light source 110. As another example, controller 150 may provide instructions, a control signal, or a trigger signal to light source 110 indicating when light source 110 should produce optical pulses. Controller 150 may send an electrical trigger signal that includes electrical pulses, where each electrical pulse results in the emission of an optical pulse by light source 110. In particular embodiments, the frequency, period, duration, pulse energy, peak power, average power, or wavelength of the optical pulses produced by light source 110 may be adjusted based on instructions, a control signal, or trigger pulses provided by controller 150. In particular embodiments, controller 150 may be coupled to light source 110 and receiver 140, and the controller 150 may determine a time-of-flight value for an optical pulse based on timing information associated with a time when the pulse was emitted by light source 110 and a time when a portion of the pulse (e.g., input beam 135) was detected or received by receiver 140. In particular embodiments, controller 150 may include circuitry that performs signal amplification, sampling, filtering, signal conditioning, analog-to-digital conversion, time-to-digital conversion, pulse detection, threshold detection, rising-edge detection, or falling-edge detection.

In particular embodiments, lidar system 100 may include one or more processors (e.g., a controller 150) configured to determine a distance D from the lidar system 100 to a target 130 based at least in part on a round-trip time of flight for an emitted pulse of light to travel from the lidar system 100 to the target 130 and back to the lidar system 100. The target 130 may be at least partially contained within a field of regard of the lidar system 100 and located a distance D from the lidar system 100 that is less than or equal to an operating range (R_{OP}) of the lidar system 100. In particular embodiments, an operating range (which may be referred to as an operating distance) of a lidar system 100 may refer to a distance over which the lidar system 100 is configured to sense or identify targets 130 located within a field of regard of the lidar system 100. The operating range of lidar system 100 may be any suitable distance, such as for example, 25 m, 50 m, 100 m, 200 m, 250 m, 500 m, or 1 km. As an example, a lidar system 100 with a 200-m operating range may be configured to sense or identify various targets 130 located up to 200 m away from the lidar system 100. Additionally, the pulse period τ may be related to the pulse repetition frequency (PRF) by the expression T=1/PRF. For example, a pulse period of 1.33 μs corresponds to a PRF of approximately 752 kHz.

In particular embodiments, a lidar system 100 may be used to determine the distance to one or more downrange targets 130. By scanning the lidar system 100 across a field of regard, the system may be used to map the distance to a number of points within the field of regard. Each of these depth-mapped points may be referred to as a pixel or a voxel. A collection of pixels captured in succession (which may be referred to as a depth map, a point cloud, or a frame) may be rendered as an image or may be analyzed to identify or detect objects or to determine a shape or distance of objects within the FOR. As an example, a point cloud may cover a field of regard that extends 60° horizontally and 15° vertically, and the point cloud may include a frame of 100-2000 pixels in the horizontal direction by 4-400 pixels in the vertical direction.

In particular embodiments, lidar system 100 may be configured to repeatedly capture or generate point clouds of a field of regard at any suitable frame rate between approximately 0.1 frames per second (FPS) and approximately 1,000 FPS. As an example, lidar system 100 may generate point clouds at a frame rate of approximately 0.1 FPS, 0.5 FPS, 1 FPS, 2 FPS, 5 FPS, 10 FPS, 20 FPS, 100 FPS, 500 FPS, or 1,000 FPS. As another example, lidar system 100 may be configured to produce optical pulses at a rate of 5×10⁵ pulses/second (e.g., the system may determine 500,000 pixel distances per second) and scan a frame of 1000×50 pixels (e.g., 50,000 pixels/frame), which corresponds to a point-cloud frame rate of 10 frames per second (e.g., 10 point clouds per second). In particular embodiments, a point-cloud frame rate may be substantially fixed, or a point-cloud frame rate may be dynamically adjustable. As an example, a lidar system 100 may capture one or more point clouds at a particular frame rate (e.g., 1 Hz) and then switch to capture one or more point clouds at a different frame rate (e.g., 10 Hz). A slower frame rate (e.g., 1 Hz) may be used to capture one or more high-resolution point clouds, and a faster frame rate (e.g., 10 Hz) may be used to rapidly capture multiple lower-resolution point clouds.

In particular embodiments, a lidar system 100 may be configured to sense, identify, or determine distances to one or more targets 130 within a field of regard. As an example, a lidar system 100 may determine a distance to a target 130, where all or part of the target 130 is contained within a field of regard of the lidar system 100. All or part of a target 130 being contained within a FOR of the lidar system 100 may refer to the FOR overlapping, encompassing, or enclosing at least a portion of the target 130. In particular embodiments, target 130 may include all or part of an object that is moving or stationary relative to lidar system 100. As an example, target 130 may include all or a portion of a person, vehicle, motorcycle, truck, train, bicycle, wheelchair, pedestrian, animal, road sign, traffic light, lane marking, road-surface marking, parking space, pylon, guard rail, traffic barrier, pothole, railroad crossing, obstacle in or near a road, curb, stopped vehicle on or beside a road, utility pole, house, building, trash can, mailbox, tree, any other suitable object, or any suitable combination of all or part of two or more objects. In particular embodiments, a target may be referred to as an object.

In particular embodiments, a lidar system 100 may include a light source 110, scanner 120, and receiver 140 that are packaged together within a single housing, where a housing may refer to a box, case, or enclosure that holds or contains all or part of a lidar system 100. As an example, a lidar-system enclosure may contain a light source 110, mirror 115, scanner 120, and receiver 140 of a lidar system 100. Additionally, the lidar-system enclosure may include a controller 150. The lidar-system enclosure may also include one or more electrical connections for conveying electrical power or electrical signals to or from the enclosure. In particular embodiments, one or more components of a lidar system 100 may be located remotely from a lidar-system enclosure. As an example, all or part of light source 110 may be located remotely from a lidar-system enclosure, and pulses of light produced by the light source 110 may be conveyed to the enclosure via optical fiber. As another example, all or part of a controller 150 may be located remotely from a lidar-system enclosure.

In particular embodiments, light source 110 may include an eye-safe laser, or lidar system 100 may be classified as an eye-safe laser system or laser product. An eye-safe laser, laser system, or laser product may refer to a system that includes a laser with an emission wavelength, average power, peak power, peak intensity, pulse energy, beam size, beam divergence, exposure time, or scanned output beam such that emitted light from the system presents little or no possibility of causing damage to a person's eyes. As an example, light source 110 or lidar system 100 may be classified as a Class 1 laser product (as specified by the 60825-1:2014 standard of the International Electrotechnical Commission (IEC)) or a Class I laser product (as specified by Title 21, Section 1040.10 of the United States Code of Federal Regulations (CFR)) that is safe under all conditions of normal use. In particular embodiments, lidar system 100 may be an eye-safe laser product (e.g., with a Class 1 or Class I classification) configured to operate at any suitable wavelength between approximately 900 nm and approximately 2100 nm. As an example, lidar system 100 may include a laser with an operating wavelength between approximately 1200 nm and approximately 1400 nm or between approximately 1400 nm and approximately 1600 nm, and the laser or the lidar system 100 may be operated in an eye-safe manner. As another example, lidar system 100 may be an eye-safe laser product that includes a scanned laser with an operating wavelength between approximately 900 nm and approximately 1700 nm. As another example, lidar system 100 may be a Class 1 or Class I laser product that includes a laser diode, fiber laser, or solid-state laser with an operating wavelength between approximately 1200 nm and approximately 1600 nm. As another example, lidar system 100 may have an operating wavelength between approximately 1500 nm and approximately 1510 nm.

In particular embodiments, one or more lidar systems 100 may be integrated into a vehicle. As an example, a truck may include a single lidar system 100 with a 60-degree to 180-degree horizontal FOR directed toward the front of the truck. As another example, multiple lidar systems 100 may be integrated into a car to provide a complete 360-degree horizontal FOR around the car. As another example, 2-10 lidar systems 100, each system having a 45-degree to 180-degree horizontal FOR, may be combined together to form a sensing system that provides a point cloud covering a 360-degree horizontal FOR. The lidar systems 100 may be oriented so that adjacent FORs have an amount of spatial or angular overlap to allow data from the multiple lidar systems 100 to be combined or stitched together to form a single or continuous 360-degree point cloud. As an example, the FOR of each lidar system 100 may have approximately 1-30 degrees of overlap with an adjacent FOR. In particular embodiments, a vehicle may refer to a mobile machine configured to transport people or cargo. For example, a vehicle may include a car used for work, commuting, running errands, or transporting people. As another example, a vehicle may include a truck used to transport commercial goods to a store, warehouse, or residence. A vehicle may include, may take the form of, or may be referred to as a car, automobile, motor vehicle, truck, bus, van, trailer, off-road vehicle, farm vehicle, lawn mower, construction equipment, forklift, robot, golf cart, motorhome, taxi, motorcycle, scooter, bicycle, skateboard, train, snowmobile, watercraft (e.g., a ship or boat), aircraft (e.g., a fixed-wing aircraft, helicopter, or dirigible), unmanned aerial vehicle (e.g., a drone), or spacecraft. In particular embodiments, a vehicle may include an internal combustion engine or an electric motor that provides propulsion for the vehicle.

In particular embodiments, one or more lidar systems 100 may be included in a vehicle as part of an advanced driver assistance system (ADAS) to assist a driver of the vehicle in operating the vehicle. For example, a lidar system 100 may be part of an ADAS that provides information (e.g., about the surrounding environment) or feedback to a driver (e.g., to alert the driver to potential problems or hazards) or that automatically takes control of part of a vehicle (e.g., a braking system or a steering system) to avoid collisions or accidents. A lidar system 100 may be part of a vehicle ADAS that provides adaptive cruise control, automated braking, automated parking, collision avoidance, alerts the driver to hazards or other vehicles, maintains the vehicle in the correct lane, or provides a warning if an object or another vehicle is located in a blind spot.

In particular embodiments, one or more lidar systems 100 may be integrated into a vehicle as part of an autonomous-vehicle driving system. As an example, a lidar system 100 may provide information about the surrounding environment to a driving system of an autonomous vehicle. An autonomous-vehicle driving system may be configured to guide the autonomous vehicle through an environment surrounding the vehicle and toward a destination. An autonomous-vehicle driving system may include one or more computing systems that receive information from a lidar system 100 about the surrounding environment, analyze the received information, and provide control signals to the vehicle's driving systems (e.g., steering mechanism, accelerator, brakes, lights, or turn signals). As an example, a lidar system 100 integrated into an autonomous vehicle may provide an autonomous-vehicle driving system with a point cloud every 0.1 seconds (e.g., the point cloud has a 10 Hz update rate, representing 10 frames per second). The autonomous-vehicle driving system may analyze the received point clouds to sense or identify targets 130 and their respective locations, distances, or speeds, and the autonomous-vehicle driving system may update control signals based on this information. As an example, if lidar system 100 detects a vehicle ahead that is slowing down or stopping, the autonomous-vehicle driving system may send instructions to release the accelerator and apply the brakes.

In particular embodiments, an autonomous vehicle may be referred to as an autonomous car, driverless car, self-driving car, robotic car, or unmanned vehicle. In particular embodiments, an autonomous vehicle may refer to a vehicle configured to sense its environment and navigate or drive with little or no human input. As an example, an autonomous vehicle may be configured to drive to any suitable location and control or perform all safety-critical functions (e.g., driving, steering, braking, parking) for the entire trip, with the driver not expected to control the vehicle at any time. As another example, an autonomous vehicle may allow a driver to safely turn their attention away from driving tasks in particular environments (e.g., on freeways), or an autonomous vehicle may provide control of a vehicle in all but a few environments, requiring little or no input or attention from the driver.

In particular embodiments, an autonomous vehicle may be configured to drive with a driver present in the vehicle, or an autonomous vehicle may be configured to operate the vehicle with no driver present. As an example, an autonomous vehicle may include a driver's seat with associated controls (e.g., steering wheel, accelerator pedal, and brake pedal), and the vehicle may be configured to drive with no one seated in the driver's seat or with little or no input from a person seated in the driver's seat. As another example, an autonomous vehicle may not include any driver's seat or associated driver's controls, and the vehicle may perform substantially all driving functions (e.g., driving, steering, braking, parking, and navigating) without human input. As another example, an autonomous vehicle may be configured to operate without a driver (e.g., the vehicle may be configured to transport human passengers or cargo without a driver present in the vehicle). As another example, an autonomous vehicle may be configured to operate without any human passengers (e.g., the vehicle may be configured for transportation of cargo without having any human passengers onboard the vehicle).

In particular embodiments, an optical signal (which may be referred to as a light signal, a light waveform, an optical waveform, an output beam, an emitted optical signal, or emitted light) may include pulses of light, CW light, amplitude-modulated light, frequency-modulated (FM) light, or any suitable combination thereof. Although this disclosure describes or illustrates example embodiments of lidar systems 100 or light sources 110 that produce optical signals that include pulses of light, the embodiments described or illustrated herein may also be applied, where appropriate, to other types of optical signals, including continuous-wave (CW) light, amplitude-modulated optical signals, or frequency-modulated optical signals. For example, a lidar system 100 as described or illustrated herein may be a pulsed lidar system and may include a light source 110 that produces pulses of light. The distance to a remote target 130 may be determined based on the round-trip time of flight for a pulse of light to travel to the target 130 and back. Alternatively, a lidar system 100 may be configured to operate as a frequency-modulated continuous-wave (FMCW) lidar system and may include a light source 110 that produces a frequency-modulated optical signal. An FMCW lidar system may use frequency-modulated light to determine the distance to a remote target 130 based on the frequency of the received light (which is scattered by the remote target) relative to the frequency of the emitted light. A round-trip time for the emitted light to travel to a target 130 and back to the lidar system may correspond to a frequency difference between the received scattered light and a portion of the emitted light.

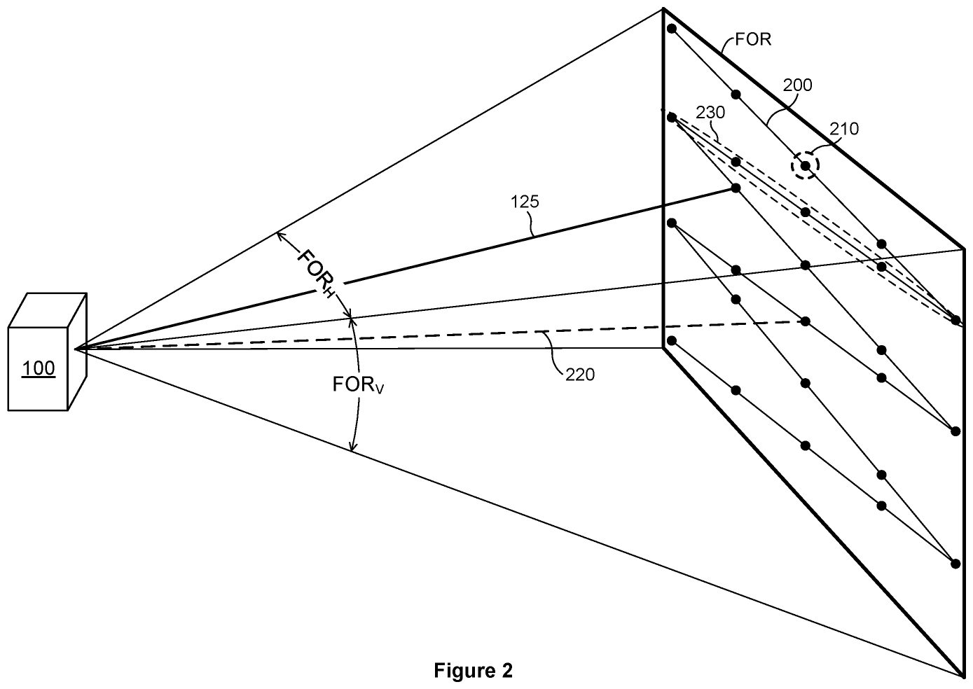

FIG. 2 illustrates an example scan pattern 200 produced by a lidar system 100. A scanner 120 of the lidar system 100 may scan the output beam 125 (which may include multiple emitted optical signals) along a scan pattern 200 that is contained within a field of regard (FOR) of the lidar system 100. A scan pattern 200 (which may be referred to as an optical scan pattern, optical scan path, scan path, or scan) may represent a path or course followed by output beam 125 as it is scanned across all or part of a FOR. Each traversal of a scan pattern 200 by an output beam 125 may correspond to the capture of a single frame or a single point cloud. In particular embodiments, a scan pattern 200 may scan across any suitable field of regard (FOR) having any suitable horizontal FOR (FOR_{H}) and any suitable vertical FOR (FOR_{V}). For example, a scan pattern 200 may have a field of regard represented by angular dimensions (e.g., FOR_{H}×FOR_{V}) 40°×30°, 90°×40°, or 120°×20°. As another example, a scan pattern 200 may have a FOR_{H} greater than or equal to 10°, 25°, 30°, 40°, 60°, 90°, or 120°. As another example, a scan pattern 200 may have a FOR_{V} greater than or equal to 2°, 5°, 10°, 15°, 20°, 30°, or 45°.

In the example of FIG. 2, reference line 220 represents a center of the field of regard of scan pattern 200. In particular embodiments, reference line 220 may have any suitable orientation, such as for example, a horizontal angle of 0° (e.g., reference line 220 may be oriented straight ahead) and a vertical angle of 0° (e.g., reference line 220 may have an inclination of 0°), or reference line 220 may have a non-zero horizontal angle or a non-zero inclination (e.g., a vertical angle of +10° or −10°). In FIG. 2, if the scan pattern 200 has a 60°×15° field of regard, then scan pattern 200 covers a ±30° horizontal range with respect to reference line 220 and a ±7.5° vertical range with respect to reference line 220. Additionally, optical beam 125 in FIG. 2 has an orientation of approximately −15° horizontal and +3º vertical with respect to reference line 220. Optical beam 125 may be referred to as having an azimuth of −15° and an altitude of +3º relative to reference line 220. In particular embodiments, an azimuth (which may be referred to as an azimuth angle) may represent a horizontal angle with respect to reference line 220, and an altitude (which may be referred to as an altitude angle, elevation, or elevation angle) may represent a vertical angle with respect to reference line 220.

In particular embodiments, a scan pattern 200 may include multiple pixels 210, and each pixel 210 may be associated with one or more optical pulses or one or more distance measurements. Additionally, a scan pattern 200 may include multiple scan lines 230, where each scan line represents one scan across at least part of a field of regard, and each scan line 230 may include multiple pixels 210. In FIG. 2, scan line 230 includes five pixels 210 and corresponds to an approximately horizontal scan across the FOR from right to left, as viewed from the lidar system 100. In particular embodiments, a complete cycle or traversal of a scan pattern 200 may include a total of Pₓ×P_{y} pixels 210 (e.g., a two-dimensional distribution of Pₓ by P_{y} pixels). As an example, scan pattern 200 may include a distribution with dimensions of approximately 100-2,000 pixels 210 along a horizontal direction and approximately 4-400 pixels 210 along a vertical direction. As another example, scan pattern 200 may include a distribution of 1,000 pixels 210 along the horizontal direction by 64 pixels 210 along the vertical direction (e.g., the frame size is 1000×64 pixels) for a total of 64,000 pixels per cycle of scan pattern 200.

A pixel 210 may refer to a data element that includes (i) distance information (e.g., a distance from a lidar system 100 to a target 130 from which an associated pulse of light was scattered) or (ii) an elevation angle and an azimuth angle associated with the pixel (e.g., the elevation and azimuth angles along which the associated pulse of light was emitted). In particular embodiments, each pixel 210 may be associated with a distance (e.g., a distance to a portion of a target 130 from which an associated pulse of light was scattered) or one or more angular values. As an example, a pixel 210 may be associated with a distance value and two angular values (e.g., an azimuth and altitude) that represent the angular location of the pixel 210 with respect to the lidar system 100. A distance to a portion of target 130 may be determined based at least in part on a time-of-flight measurement for a corresponding pulse. An angular value (e.g., an azimuth or altitude) may correspond to an angle (e.g., relative to reference line 220) of output beam 125 (e.g., when a corresponding pulse is emitted from lidar system 100) or an angle of input beam 135 (e.g., when an input signal is received by lidar system 100). In particular embodiments, an angular value may be determined based at least in part on a position of a component of scanner 120. As an example, an azimuth or altitude value associated with a pixel 210 may be determined from an angular position of one or more corresponding scan mirrors of the scanner 120.

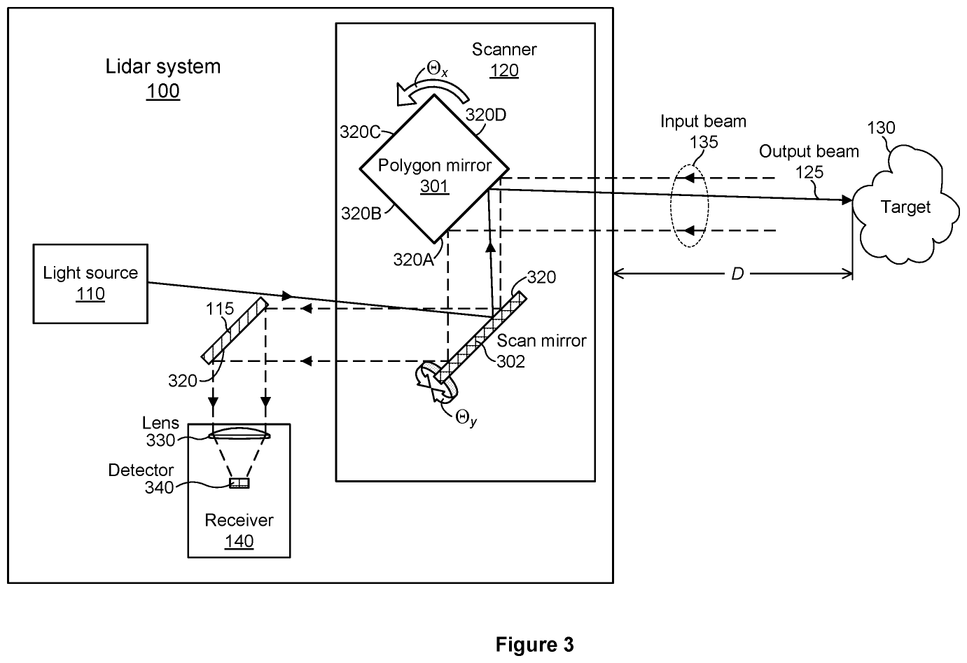

FIG. 3 illustrates an example lidar system 100 with an example rotating polygon mirror 301. In particular embodiments, a scanner 120 may include a polygon mirror 301 configured to scan output beam 125 along a first direction and a scan mirror 302 configured to scan output beam 125 along a second direction different from the first direction (e.g., the first and second directions may be approximately orthogonal to one another, or the second direction may be oriented at any suitable non-zero angle with respect to the first direction). In the example of FIG. 3, scanner 120 includes two scan mirrors: (1) a polygon mirror 301 that rotates along the Θₓ direction and (2) a scan mirror 302 that oscillates back and forth along the Θ_{y} direction. The output beam 125 from light source 110, which passes alongside mirror 115, is reflected by reflecting surface 320 of scan mirror 302 and is then reflected by a reflecting surface (e.g., surface 320A, 320B, 320C, or 320D) of polygon mirror 301. Scattered light from a target 130 returns to the lidar system 100 as input beam 135. The input beam 135 reflects from polygon mirror 301, scan mirror 302, and mirror 115, which directs input beam 135 through focusing lens 330 and to the detector 340 of receiver 140. The detector 340 may be a PN photodiode, a PIN photodiode, an APD, a SPAD, or any other suitable detector. A reflecting surface 320 (which may be referred to as a reflective surface) may include a reflective metallic coating (e.g., gold, silver, or aluminum) or a reflective dielectric coating, and the reflecting surface 320 may have any suitable reflectivity R at an operating wavelength of the light source 110 (e.g., R may be greater than or equal to 70%, 80%, 90%, 95%, 98%, or 99%).

In particular embodiments, a polygon mirror 301 may be configured to rotate along a Θₓ or Θ_{y} direction and scan output beam 125 along a substantially horizontal or vertical direction, respectively. A rotation along a Θₓ direction may refer to a rotational motion of mirror 301 that results in output beam 125 scanning along a substantially horizontal direction. Similarly, a rotation along a Θ_{y} direction may refer to a rotational motion that results in output beam 125 scanning along a substantially vertical direction. In FIG. 3, mirror 301 is a polygon mirror that rotates along the Θₓ direction and scans output beam 125 along a substantially horizontal direction, and mirror 302 pivots along the Θ_{y} direction and scans output beam 125 along a substantially vertical direction. In particular embodiments, a polygon mirror 301 may be configured to scan output beam 125 along any suitable direction. As an example, a polygon mirror 301 may scan output beam 125 at any suitable angle with respect to a horizontal or vertical direction, such as for example, at an angle of approximately 0°, 10°, 20°, 30°, 45°, 60°, 70°, 80°, or 90° with respect to a horizontal or vertical direction.

In particular embodiments, a polygon mirror 301 may refer to a multi-sided object having reflective surfaces 320 on two or more of its sides or faces. As an example, a polygon mirror may include any suitable number of reflective faces (e.g., 2, 3, 4, 5, 6, 7, 8, or 10 faces), where each face includes a reflective surface 320. A polygon mirror 301 may have a cross-sectional shape of any suitable polygon, such as for example, a triangle (with three reflecting surfaces 320), square (with four reflecting surfaces 320), pentagon (with five reflecting surfaces 320), hexagon (with six reflecting surfaces 320), heptagon (with seven reflecting surfaces 320), or octagon (with eight reflecting surfaces 320). In FIG. 3, the polygon mirror 301 has a substantially square cross-sectional shape and four reflecting surfaces (320A, 320B, 320C, and 320D). The polygon mirror 301 in FIG. 3 may be referred to as a square mirror, a cube mirror, or a four-sided polygon mirror. In FIG. 3, the polygon mirror 301 may have a shape similar to a cube, cuboid, or rectangular prism. Additionally, the polygon mirror 301 may have a total of six sides, where four of the sides include faces with reflective surfaces (320A, 320B, 320C, and 320D).

In particular embodiments, a polygon mirror 301 may be continuously rotated in a clockwise or counter-clockwise rotation direction about a rotation axis of the polygon mirror 301. The rotation axis may correspond to a line that is perpendicular to the plane of rotation of the polygon mirror 301 and that passes through the center of mass of the polygon mirror 301. In FIG. 3, the polygon mirror 301 rotates in the plane of the drawing, and the rotation axis of the polygon mirror 301 is perpendicular to the plane of the drawing. An electric motor may be configured to rotate a polygon mirror 301 at a substantially fixed frequency (e.g., a rotational frequency of approximately 1 Hz (or 1 revolution per second), 10 Hz, 50 Hz, 100 Hz, 500 Hz, or 1,000 Hz). As an example, a polygon mirror 301 may be mechanically coupled to an electric motor (e.g., a synchronous electric motor) which is configured to spin the polygon mirror 301 at a rotational speed of approximately 160 Hz (or, 9600 revolutions per minute (RPM)).

In FIG. 3, the output beam 125 may be reflected sequentially from the reflective surfaces 320A, 320B, 320C, and 320D as the polygon mirror 301 is rotated. This results in the output beam 125 being scanned along a particular scan axis (e.g., a horizontal or vertical scan axis) to produce a sequence of scan lines, where each scan line corresponds to a reflection of the output beam 125 from one of the reflective surfaces of the polygon mirror 301. In FIG. 3, the output beam 125 reflects off of reflective surface 320A to produce one scan line. Then, as the polygon mirror 301 rotates, the output beam 125 reflects off of reflective surfaces 320B, 320C, and 320D to produce a second, third, and fourth respective scan line. In particular embodiments, a lidar system 100 may be configured so that the output beam 125 is first reflected from polygon mirror 301 and then from scan mirror 302 (or vice versa). As an example, an output beam 125 from light source 110 may first be directed to polygon mirror 301, where it is reflected by a reflective surface of the polygon mirror 301, and then the output beam 125 may be directed to scan mirror 302, where it is reflected by reflective surface 320 of the scan mirror 302. In the example of FIG. 3, the output beam 125 is reflected from the polygon mirror 301 and the scan mirror 302 in the reverse order. In FIG. 3, the output beam 125 from light source 110 is first directed to the scan mirror 302, where it is reflected by reflective surface 320, and then the output beam 125 is directed to the polygon mirror 301, where it is reflected by reflective surface 320A.

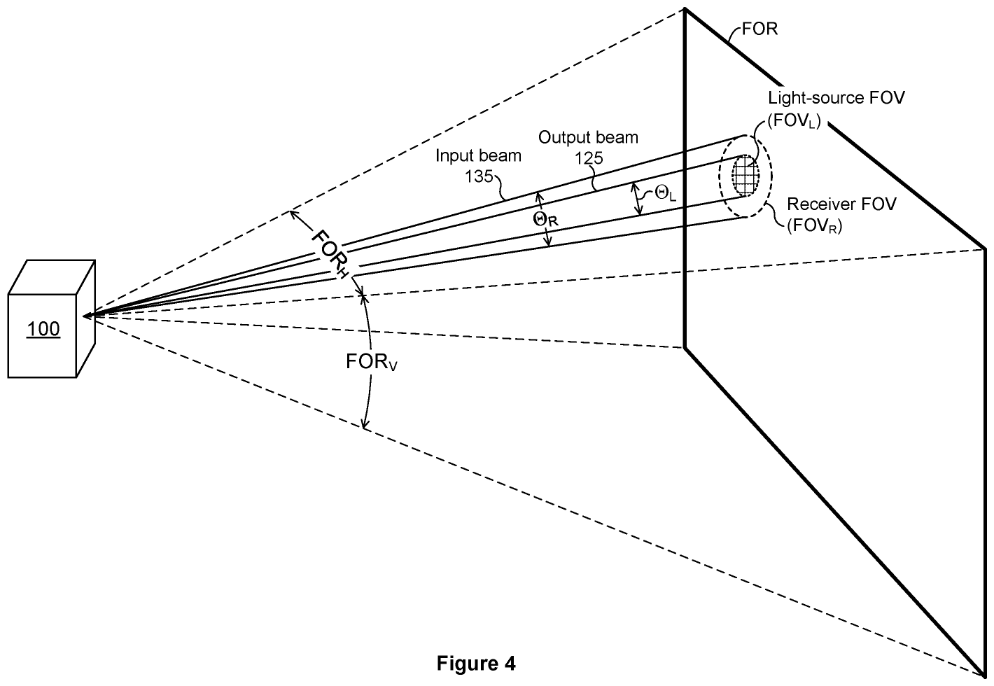

FIG. 4 illustrates an example light-source field of view (FOV_{L}) and receiver field of view (FOV_{R}) for a lidar system 100. A light source 110 of lidar system 100 may emit pulses of light as the FOV_{L} and FOV_{R} are scanned by scanner 120 across a field of regard (FOR). In particular embodiments, a light-source field of view may refer to an angular cone illuminated by the light source 110 at a particular instant of time. Similarly, a receiver field of view may refer to an angular cone over which the receiver 140 may receive or detect light at a particular instant of time, and any light outside the receiver field of view may not be received or detected. As an example, as the light-source field of view is scanned across a field of regard, a portion of a pulse of light emitted by the light source 110 may be sent downrange from lidar system 100, and the pulse of light may be sent in the direction that the FOV_{L} is pointing at the time the pulse is emitted. The pulse of light may scatter off a target 130, and the receiver 140 may receive and detect a portion of the scattered light that is directed along or contained within the FOV_{R}.

In particular embodiments, scanner 120 may be configured to scan both a light-source field of view and a receiver field of view across a field of regard of the lidar system 100. Multiple pulses of light may be emitted and detected as the scanner 120 scans the FOV_{L} and FOV_{R} across the field of regard of the lidar system 100 while tracing out a scan pattern 200. In particular embodiments, the light-source field of view and the receiver field of view may be scanned synchronously with respect to one another, so that as the FOV_{L} is scanned across a scan pattern 200, the FOV_{R} follows substantially the same path at the same scanning speed. Additionally, the FOV_{L} and FOV_{R} may maintain the same relative position to one another as they are scanned across the field of regard. As an example, the FOV_{L} may be substantially overlapped with or centered inside the FOV_{R} (as illustrated in FIG. 4), and this relative positioning between FOV_{L} and FOV_{R} may be maintained throughout a scan. As another example, the FOV_{R} may lag behind the FOV_{L} by a particular, fixed amount throughout a scan (e.g., the FOV_{R} may be offset from the FOV_{L} in a direction opposite the scan direction).

An output beam of light 125 emitted by light source 110 may be a collimated optical beam having any suitable beam divergence, such as for example, a full-angle beam divergence Θ_{L}, of approximately 0.5 to 10 milliradians (mrad). A divergence Θ_{L} of output beam 125 (which may be referred to as an angular size of the output beam) may correspond to an angular measure of an increase in beam size (e.g., a beam radius or beam diameter) as output beam 125 travels away from light source 110 or lidar system 100. An output beam 125 may have a substantially circular cross section with a beam divergence characterized by a single divergence value. As an example, an output beam 125 with a circular cross section and a full-angle beam divergence Θ_{L} of 2 mrad may have a beam diameter or spot size of approximately 20 cm at a distance of 100 m from lidar system 100. An output beam 125 may have a substantially elliptical cross section characterized by two divergence values. As an example, output beam 125 may have a fast axis and a slow axis, where the fast-axis divergence is greater than the slow-axis divergence. As another example, output beam 125 may be an elliptical beam with a fast-axis divergence of 4 mrad and a slow-axis divergence of 2 mrad.

The angular size Θ_{R} of a FOV_{R} may correspond to an angle over which the receiver 140 may receive and detect light. The receiver field of view may be any suitable size relative to the light-source field of view. As an example, the receiver field of view may be smaller than, substantially the same size as, or larger than the angular size of the light-source field of view. The light-source field of view may have an angular size of less than or equal to 50 milliradians, and the receiver field of view may have an angular size of less than or equal to 50 milliradians. The FOV_{L} may have any suitable angular size Θ_{L}, such as for example, an angular size of approximately 0.1 mrad, 0.2 mrad, 0.5 mrad, 1 mrad, 1.5 mrad, 2 mrad, 3 mrad, 5 mrad, 10 mrad, 20 mrad, 40 mrad, or 50 mrad. Similarly, the FOV_{R} may have any suitable angular size Θ_{R}, such as for example, an angular size of approximately 0.1 mrad, 0.2 mrad, 0.5 mrad, 1 mrad, 1.5 mrad, 2 mrad, 3 mrad, 5 mrad, 10 mrad, 20 mrad, 40 mrad, or 50 mrad. The light-source field of view and the receiver field of view may have approximately equal angular sizes. As an example, Θ_{L} and Θ_{R} may both be approximately equal to 0.5 mrad, 1 mrad, or 2 mrad. Alternatively, the receiver field of view may be larger than the light-source field of view, or the light-source field of view may be larger than the receiver field of view. As an example, Θ_{L} may be approximately equal to 1 mrad, and Θ_{R} may be approximately equal to 2 mrad. As another example, Θ_{R} may be approximately L times larger than Θ_{L}, where Lis any suitable factor, such as for example, 1.1, 1.2, 1.5, 2, 3, 5, or 10.

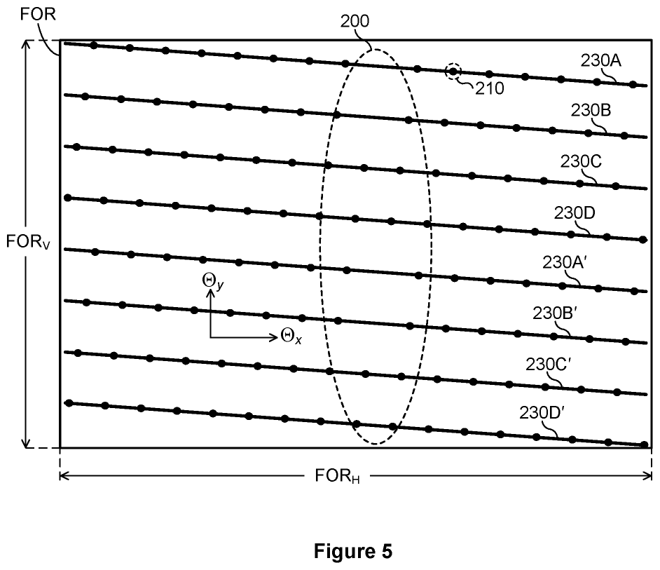

FIG. 5 illustrates an example unidirectional scan pattern 200 that includes multiple pixels 210 and multiple scan lines 230. In particular embodiments, scan pattern 200 may include any suitable number of scan lines 230 (e.g., approximately 1, 2, 5, 10, 20, 50, 100, 500, or 1,000 scan lines), and each scan line 230 of a scan pattern 200 may include any suitable number of pixels 210 (e.g., 1, 2, 5, 10, 20, 50, 100, 200, 500, 1,000, 2,000, or 5,000 pixels). The scan pattern 200 illustrated in FIG. 5 includes eight scan lines 230, and each scan line 230 includes approximately 16 pixels 210. In particular embodiments, a scan pattern 200 where the scan lines 230 are scanned in two directions (e.g., alternately scanning from right to left and then from left to right) may be referred to as a bidirectional scan pattern 200, and a scan pattern 200 where the scan lines 230 are scanned in the same direction may be referred to as a unidirectional scan pattern 200. The scan pattern 200 in FIG. 2 may be referred to as a bidirectional scan pattern, and the scan pattern 200 in FIG. 5 may be referred to as a unidirectional scan pattern 200 where each scan line 230 travels across the FOR in substantially the same direction (e.g., approximately from left to right as viewed from the lidar system 100). In particular embodiments, scan lines 230 of a unidirectional scan pattern 200 may be directed across a FOR in any suitable direction, such as for example, from left to right, from right to left, from top to bottom, from bottom to top, or at any suitable angle (e.g., at a 0°, 5°, 10°, 30°, or 45° angle) with respect to a horizontal or vertical axis. In particular embodiments, each scan line 230 in a unidirectional scan pattern 200 may be a separate line that is not directly connected to a previous or subsequent scan line 230.

In particular embodiments, a unidirectional scan pattern 200 may be produced by a scanner 120 that includes a polygon mirror (e.g., polygon mirror 301 of FIG. 3), where each scan line 230 is associated with a particular reflective surface 320 of the polygon mirror. As an example, reflective surface 320A of polygon mirror 301 in FIG. 3 may produce scan line 230A in FIG. 5. Similarly, as the polygon mirror 301 rotates, reflective surfaces 320B, 320C, and 320D may successively produce scan lines 230B, 230C, and 230D, respectively. Additionally, for a subsequent revolution of the polygon mirror 301, the scan lines 230A′, 230B′, 230C′, and 230D′ may be successively produced by reflections of the output beam 125 from reflective surfaces 320A. 320B, 320C, and 320D, respectively. In particular embodiments, one full revolution of a S-sided polygon mirror may correspond to S successive scan lines 230 of a unidirectional scan pattern 200. As an example, the four scan lines 230A, 230B, 230C, and 230D in FIG. 5 may correspond to one full revolution of the four-sided polygon mirror 301 in FIG. 3. Additionally, a subsequent revolution of the polygon mirror 301 may produce the next four scan lines 230A′, 230B′, 230C′, and 230D′ in FIG. 5.

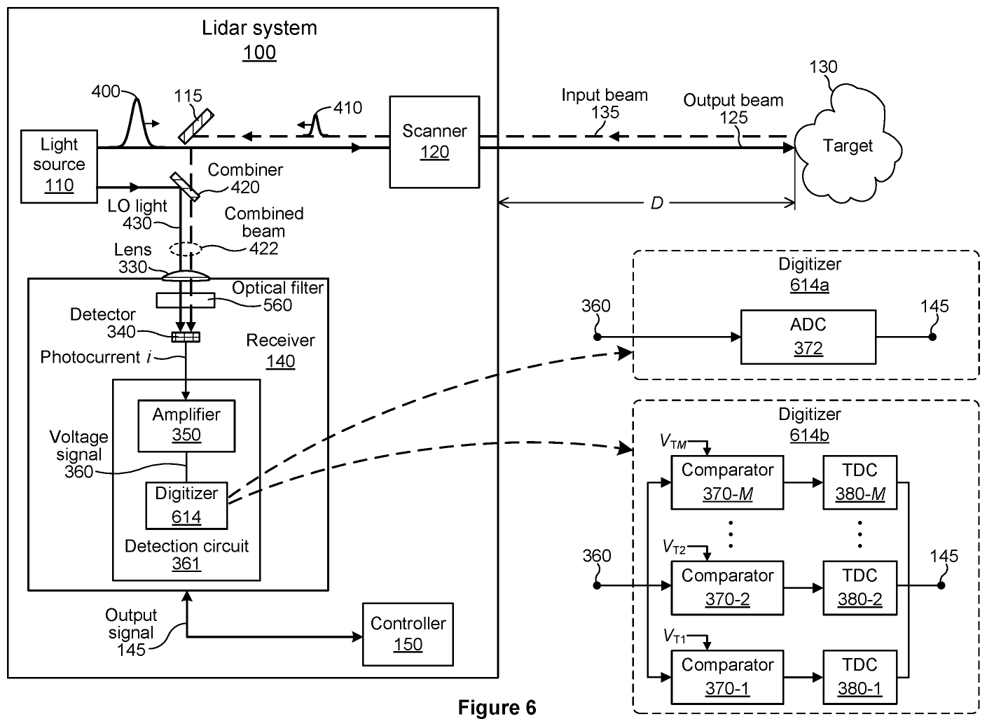

FIG. 6 illustrates an example lidar system 100 with a light source 110 that emits pulses of light 400 and local-oscillator (LO) light 430. The lidar system 100 in FIG. 6 includes a light source 110, a scanner 120, a receiver 140, and a controller 150. The light source 110 emits LO light 430 and pulses of light 400, and each emitted pulse of light 400 may be coherent with a corresponding temporal portion of the LO light 430. The lidar system 100 illustrated in FIG. 6 may be referred to as a coherent pulsed lidar system. The receiver 140 in a coherent pulsed lidar system may detect the LO light 430 and a received pulse of light 410, where the LO light 430 and the received pulse of light 410 (which includes scattered light from one of the emitted pulses of light 400) are coherently mixed together at the receiver 140. The receiver 140 in a coherent pulsed lidar system may include or may be referred to as a heterodyne optical receiver, a heterodyne receiver, a superheterodyne optical receiver, or a superheterodyne receiver. The receiver 140 in FIG. 6 includes a focusing lens 330, a detector 340, and a detection circuit 361 that includes an electronic amplifier 350 and a digitizer 614. The detection circuit 361 may also include one or more components not illustrated in FIG. 6, such as for example, one or more frequency-detection channels, one or more electronic filters, one or more electronic mixers, one or more electronic local oscillators, or one or more rectifiers. The detector 340 in FIG. 6 may be referred to as an optical detector, and the detection circuit 361 may be referred to as an electronic detection circuit.

In particular embodiments, a coherent pulsed lidar system 100 may include a light source 110 configured to emit pulses of light 400 and LO light 430. The light source 110 may produce the pulses of light 400 and the LO light 430 so that the optical frequency of each emitted pulse of light 400 is offset from the optical frequency of the LO light 430 by a particular frequency offset of one or more different frequency offsets. For example, the emitted pulse of light 400 in FIG. 6 may have an optical frequency (f₁) that is offset by +5 gigahertz (GHz) from the optical frequency (f₀) of the LO light 430, so that f₁=f₀+(5 GHZ). The frequency offset of an emitted pulse of light 400 with respect to the LO light 430 may correspond to or may be referred to as a spectral signature, frequency signature, frequency tag, or frequency change of the emitted pulse of light. The emitted pulses of light 400 may be part of an output beam 125 that is scanned by a scanner 120 across a field of regard of the lidar system 100, and the LO light 430 may be sent to a receiver 140 of the lidar system 100. The light source 110 may include a seed laser that produces seed light and the LO light 430. Additionally, the light source 110 may include an optical amplifier that amplifies the seed light to produce the emitted pulses of light 400. For example, the optical amplifier may amplify temporal portions of the seed light to produce the emitted pulses of light 400, where each amplified temporal portion of the seed light corresponds to one of the emitted pulses of light 400.

The pulses of light 400 emitted by a light source 110 of a coherent pulsed lidar system 100 may have one or more of the following optical characteristics: a wavelength between 900 nm and 1700 nm; a pulse energy between 0.01 μJ and 100 μJ; a pulse repetition frequency between 80 kHz and 10 MHz; and a pulse duration between 0.1 ns and 20 ns. For example, a light source 110 may emit pulses of light 400 with a wavelength of approximately 1550 nm, a pulse energy of approximately 0.5 μJ, a pulse repetition frequency of approximately 750 kHz, and a pulse duration of approximately 5 ns. As another example, the emitted pulses of light 400 may have one or more wavelengths between approximately 1530 nm and approximately 1570 nm (e.g., each emitted pulse of light may have a wavelength of approximately 1540 nm, 1545 nm, 1550 nm, or 1555 nm). As another example, each emitted pulse of light 400 may have a wavelength between approximately 1500 nm and approximately 1510 nm.

In particular embodiments, a coherent pulsed lidar system 100 may include a scanner 120 configured to scan an output beam 125 across a field of regard of the lidar system 100. The scanner 120 may receive the output beam 125 (which includes the emitted pulses of light 400) from the light source 110, and the scanner 120 may include one or more scan mirrors configured to scan the output beam 125. In addition to scanning the output beam 125, the scanner may also scan a FOV of the detector 340 across the field of regard so that the output beam 125 and the detector FOV are scanned at the same scanning speed or with the same relative position to one another. Alternatively, the lidar system 100 may be configured so that only the output beam 125 is scanned, and the detector has a static FOV that is not scanned. In this case, the input beam 135 (which includes received pulses of light 410) may bypass the scanner 120 and be directed to the receiver 140 without passing through the scanner 120.

In particular embodiments, a coherent pulsed lidar system 100 may include an optical combiner 420 configured to optically combine LO light 430 with a received pulse of light 410 (which is part of an input beam 135) to produce a combined beam 422. A receiver 140 may be configured to detect a combined beam 422 (e.g., the combined beam may be directed to a detector 340 of the receiver). The combined beam 422 in FIG. 6 includes LO light 430 and input beam 135, where the input beam 135 includes a received pulse of light 410. Optically combining LO light 430 with a received pulse of light 410 may include spatially overlapping the LO light 430 with the input beam 135 to produce a combined beam 422. The combined beam 422 may include light from the LO light 430 and the input beam 135 combined together so that the two beams propagate substantially coaxially along the same path. For example, the combiner 420 in FIG. 6 may be a free-space optical beam-splitter that reflects at least part of the LO light 430 and transmits at least part of the input beam 135 so that the LO light 430 and the input beam 135 are spatially overlapped and propagate coaxially to the detector 340. As another example, the combiner 420 in FIG. 6 may be a mirror that reflects the LO light 430 and directs it to the detector 340. The input beam 135 may pass alongside the combiner 420, and the LO light 430 and input beam 135 may be combined at the detector 340. As another example, a combiner 420 may include an optical-waveguide component or a fiber-optic component that spatially overlaps the LO light 430 and the input beam 135 so that the LO light 430 and the input beam 135 propagate together in a waveguide or in a core of an optical fiber. Alternatively, a coherent pulsed lidar system 100 may not include an optical combiner, and LO light 430 and input beam 135 may be combined within a detector 340. For example, the LO light 430 may be coupled into the detector 340 via a first input surface (e.g., a front surface of the detector), and the input beam 135 may be coupled into the detector via a second input surface (e.g., a back surface) opposite the first surface.

In particular embodiments, a coherent pulsed lidar system 100 may include a receiver 140 that detects LO light 430 and received pulses of light 410. A receiver 140 may include one or more detectors 340, one or more electronic amplifiers 350, one or more digitizers 614, or one or more detection circuits 361. The receiver 140 in FIG. 6 includes one detector 340 and one electronic amplifier 340, where the detector produces a photocurrent signal i that is coupled to the amplifier. As another example, a receiver 140 may include two or more detectors 340 and two or more respective electronic amplifiers 350, where each detector is coupled to one of the electronic amplifiers. A detector 340, which may be referred to as an optical detector, may include an APD, PN photodiode, or PIN photodiode. For example, a detector 340 may include a silicon APD or PIN photodiode configured to detect light at an 800-1100 nm operating wavelength of a lidar system 100, or a detector 340 may include an InGaAs APD or PIN photodiode configured to detect light at a 1200-1600 nm operating wavelength.

In particular embodiments, a coherent pulsed lidar system 100 may include an optical filter 560. An optical filter 560, which may be referred to as an input optical filter, may be configured to optically filter an input beam 135 prior to the input beam being incident on a detector 340. An optical filter 560 may be located in the path of an input beam 135 or in the path of a combined beam 422. The receiver 140 in FIG. 6 includes an optical filter 560 located in the path of the combined beam 422 and positioned between the lens 330 and the detector 340. In other embodiments, an optical filter 560 may be attached to a lens 330 or may be attached to an input surface of a detector 340. For example, an optical filter 560 may be attached with epoxy or adhesive to the input surface of a detector 340, or an optical filter 560 may be incorporated as a dielectric coating that is deposited onto the input surface of a detector. An optical filter 560 may (i) transmit light over an optical pass-band that includes one or more wavelengths of emitted pulses of light 400, received pulses of light 410, or LO light 430 and (ii) substantially block light over one or more wavelength ranges outside of the optical pass-band. For example, the light source 110 in FIG. 6 may emit pulses of light 400 and LO light 430 with one or more wavelengths between 1550 nm and 1552 nm, and the optical filter 560 may be a band-pass filter with an optical pass-band that includes at least the wavelength range 1550-1552 nm. For example, the optical pass-band may extend from 1548 nm to 1554 nm, and the optical filter 560 may transmit greater than or equal to 80%, 90%, 95%, or 99% of light having a wavelength within the optical pass-band. Additionally, the optical filter 560 may block greater than or equal to 80%, 90%, 95%, or 99% of light with wavelengths from 1000 nm to 1540 nm and from 1560 nm to 1600 nm. The optical filter 560 in FIG. 6 may significantly reduce the amount of unwanted light that reaches the detector 340 while transmitting light at the operating wavelengths of the lidar system 100. Unwanted light (which may include sunlight, light from car headlights, or light from other lidar systems) may add excess noise to electronic signals (e.g., photocurrent signal i, voltage signal 360, or output signal 145) produced in the receiver 140. Reducing the amount of unwanted light that reaches the detector 340 may reduce electronic noise within the receiver which may improve the sensitivity of the lidar system 100.

In FIG. 6, the received pulse of light 410 may include a portion of light from the emitted pulse of light 400 that is scattered by the target 130 located a distance D from the lidar system 100. Detecting LO light 430 and a received pulse of light 410 may include coherently mixing the LO light and the received pulse of light together to produce a corresponding photocurrent signal i. For example, a receiver 140 may include one or more detectors 340, and the LO light 430 and a received pulse of light 410 may be coherently mixed together at one or more of the detectors 340. The one or more detectors may each produce a photocurrent signal that corresponds to the coherent mixing of the LO light 430 and the received pulse of light 410. The lidar system 100 in FIG. 6 includes a receiver 140 with one detector 340 that receives a combined beam 422 (which includes LO light 430 and input beam 135). The LO light 430 and the received pulse of light 410 (which is part of the input beam 135) may be coherently mixed together at the detector 340, and the detector may produce a photocurrent signal i that corresponds to the coherent mixing of the LO light and received the pulse of light. The photocurrent signal i produced by the detector 340 may be referred to as a photocurrent or an electrical-current signal. The photocurrent signal i may include an amplitude-modulation (AM) photocurrent signal, and the AM photocurrent signal (which may be referred to as an AM photocurrent or an AM signal) may include a frequency component having a frequency that is related to a frequency offset between the LO light 430 and the corresponding emitted pulse of light 400.

The detection circuit 361 in FIG. 6 includes an electronic amplifier 350 that receives a photocurrent signal i from the detector 340 and amplifies the photocurrent signal to produce a voltage signal 360 corresponding to the photocurrent signal. For example, the detector 340 may be an APD that produces a pulse of photocurrent in response to coherent mixing of LO light 430 and a received pulse of light 410, and the voltage signal 360 may include an analog voltage pulse that corresponds to the pulse of photocurrent. The amplifier 350 may include a transimpedance amplifier configured to receive the photocurrent i and amplify the photocurrent to produce a corresponding voltage signal 360. Additionally or alternatively, the amplifier 350 may include a low-noise amplifier, an input-stage amplifier, or a radio-frequency (RF) amplifier. An amplifier 350 may also include an electronic filter (e.g., a low-pass, high-pass, or band-pass filter) that filters the photocurrent or the voltage signal. A voltage signal 360 may include or may be referred to as an electromagnetic signal, an electromagnetic pulse, an RF signal, an RF pulse, a microwave signal, or a microwave pulse. For example, the voltage signal 360 in FIG. 6 may be an electromagnetic signal with a frequency between 1 GHZ and 50 GHz that propagates along an RF transmission line from the amplifier 350 to the digitizer 614 (or to another electronic component not illustrated in FIG. 6).

The receiver 140 in FIG. 6 includes a detection circuit 361 that receives a photocurrent signal i from a detector 340 and produces an output signal 145 that is sent to a controller 150. The output signal 145 may correspond to the photocurrent signal i that results from the coherent mixing of the LO light 430 and the received pulse of light 410. For example, an output signal 145 produced by a detection circuit 361 of a receiver 140 may include a digital signal that corresponds to an analog voltage signal 360, which in turn corresponds to a photocurrent signal i, which in turn corresponds to the coherent mixing of LO light 430 and a received pulse of light 410. The digital signal (which may be referred to as a digitized signal) may include a series of digital values that represents the voltage signal 360 (e.g., each digital value may correspond to an amplitude of the voltage signal at a particular point in time). As another example, an output signal 145 may include a digital signal that corresponds to an analog voltage signal 360, which in turn corresponds to an AM photocurrent signal, where the AM photocurrent signal is part of a photocurrent signal i produced by a detector 340.

In particular embodiments, a detection circuit 361 may include one or more digitizers 614 configured to produce a digital output signal 145, where the digital output signal corresponds to a photocurrent signal i. The detection circuit 361 in FIG. 6 includes a digitizer 614 that receives a voltage signal 360 from an amplifier 350, and the digitizer may produce a digital output signal 145 that corresponds to the voltage signal 360 (where the voltage signal corresponds to the photocurrent signal i). A detection circuit 361 may also include one or more components (not illustrated in FIG. 6) located between an electronic amplifier 350 and a digitizer 614, such as for example, one or more frequency-detection channels, one or more electronic filters, one or more electronic mixers, one or more electronic local oscillators, or one or more rectifiers.

A detection circuit 361 may include a digitizer 614a that includes an analog-to-digital converter (ADC) 372, as illustrated in the upper dashed-line inset in FIG. 6. For a detection circuit 361 with a digitizer 614a that includes an ADC 372, the ADC may receive an analog voltage signal 360 from an electronic amplifier 350 and produce a digital representation of the voltage signal 360. For example, an ADC 372 may produce an output signal 145 that includes digitized values that correspond to a voltage signal 360. Additionally or alternatively, a detection circuit 361 may include a digitizer 614b that includes multiple comparators 370 and multiple time-to-digital converters (TDCs) 380, as illustrated in the lower dashed-line inset in FIG. 6.

The comparator-TDC digitizer 614b in FIG. 6 includes M comparators (comparators 370-1, 370-2, . . . , 370-M), and each comparator is supplied with a particular threshold or reference voltage (V_{T1}, V_{T2}, . . . , V_{TM}). For example, digitizer 614b may include M=10 comparators, and the threshold voltages may be set to 10 values between 0 volts and 1 volt (e.g., V_{T1}=0.1 V, V_{T2}=0.2 V, and V_{T10}=1.0 V). A comparator 370 may produce an electrical-edge signal (e.g., a rising or falling electrical edge) when the voltage signal 360 rises above or falls below a particular threshold voltage. For example, comparator 370-2 may produce a rising edge when the voltage signal 360 rises above the threshold voltage V_{T2}. Additionally or alternatively, comparator 370-2 may produce a falling edge when the voltage signal 360 falls below the threshold voltage V_{T2}.

The comparator-TDC digitizer 614b in FIG. 6 includes M TDCs (TDCs 380-1, 380-2, . . . , 380-M), and each TDC 380 is coupled to a comparator 370. A comparator 370 may provide an electrical-edge signal to a corresponding TDC 380, and the TDC may act as a timer that produces an electrical output signal (e.g., a digital signal, a digital word, or a digital value) that represents a time when the edge signal is received from the comparator. For example, if the voltage signal 360 rises above the threshold voltage V_{T1}, then the comparator 370-1 may produce a rising-edge signal that is supplied to the input of TDC 380-1, and the TDC 380-1 may produce a digital time value corresponding to a time when the edge signal was received by TDC 380-1. Additionally, if the voltage signal 360 subsequently falls below the threshold voltage V_{T1}, then the comparator 370-1 may produce a falling-edge signal that is supplied to the input of TDC 380-1, and the TDC 380-1 may produce a digital time value corresponding to a time when the edge signal was received by TDC 380-1. The output signal 145 produced by digitizer 614b may include one or more digital time values from each of the TDCs 380 that received one or more edge signals from a comparator 370, and the digital time values may represent or may correspond to the analog voltage signal 360. The digital time values produced by one or more TDCs 380 may be referenced to the time when a pulse of light 400 is emitted, and the digital time values may correspond to or may be used to determine a round-trip time of flight for the pulse of light to travel to a target 130 and back to the lidar system 100.

In FIG. 6, the detection circuit 361 or the controller 150 may determine a time-of-arrival of the received pulse of light 410. The time-of-arrival of a received pulse of light 410 may correspond to a time associated with a rising edge, falling edge, peak, or temporal center of the received pulse of light 410. The time-of-arrival may be determined based at least in part on a photocurrent signal i produced by the detector 340 of the receiver 140. For example, a photocurrent signal i may include a pulse of current corresponding to the received pulse of light 410, and the electronic amplifier 350 may produce a voltage signal 360 with a voltage pulse that corresponds to the pulse of current. The detection circuit 361 or the controller 150 may determine the time-of-arrival of the received pulse of light 410 based on a characteristic of the voltage pulse (e.g., based on a time associated with a rising edge, falling edge, peak, temporal center of the voltage pulse, or a zero crossing of a first derivative associated with the voltage pulse). For example, the detection circuit 361 may receive an electronic trigger signal (e.g., from the light source 110 or the controller 150) when a pulse of light 400 is emitted, and the detection circuit 361 may determine the time-of-arrival of the received pulse of light 410 based on a time associated with an edge, peak, or temporal center of the voltage signal 360. The time-of-arrival may be determined based on a difference between a time when the pulse 400 is emitted and a time when the received pulse 410 is detected.

In particular embodiments, a coherent pulsed lidar system 100 may include a processor (e.g., controller 150) that determines the distance to a target 130 based at least in part on a time-of-arrival of a received pulse of light 410. The time-of-arrival of the received pulse of light 410 may correspond to a round-trip time (ΔT) for at least a portion of an emitted pulse of light 400 to travel to the target 130 and back to the lidar system 100, where the portion of the emitted pulse of light 400 that travels back to the target 130 corresponds to the received pulse of light 410. The distance D to the target 130 may be determined from the expression D=c·ΔT/2. For example, if the detection circuit 361 determines that the time ΔT between emission of optical pulse 400 and receipt of optical pulse 410 is 1 μs, then the controller 150 may determine that the distance to the target 130 is approximately 150 m. In particular embodiments, a round-trip time may be determined by a receiver 140, by a controller 150, or by a receiver 140 and controller 150 together. For example, a receiver 140 may determine a round-trip time by subtracting a time when a pulse 400 is emitted from a time when a received pulse 410 is detected. As another example, a receiver 140 may determine a time when a pulse 400 is emitted and a time when a received pulse 410 is detected. These values may be sent to a controller 150, and the controller 150 may determine a round-trip time by subtracting the time when the pulse 400 is emitted from the time when the received pulse 410 is detected. Additionally, the controller 150 may determine the distance D to the target 130 from the expression D=c·ΔT/2.

In particular embodiments, a detection circuit 361 may provide an output signal 145 that is used to determine time-domain information for a received pulse of light 410 (e.g., a time-of-arrival, a round-trip time, or a duration associated with the received pulse of light). The output signal 145 may be produced by one or more TDCs 380 of a digitizer 614 or by one or more ADCs 372 of a digitizer 614. The output signal 145 may be sent to a controller 150, and the controller may determine the distance to a target 130 based on the output signal. Additionally or alternatively, the controller 150 may determine an optical characteristic of a received pulse of light 410 based on the output signal 145 received from a detection circuit 361. An optical characteristic of a received pulse of light 410 may correspond to a peak optical intensity, a peak optical power, an average optical power, an optical energy, a shape or amplitude, a temporal duration, or a temporal center of the received pulse of light 410.

In addition to or instead of an output signal 145 being used to determine time-domain information for a received pulse of light 410, the output signal 145 may provide frequency-domain information for the received pulse of light 410. For example, an output signal 145 produced by a detection circuit 361 may include amplitude information for one or more frequency components associated with the received pulse of light 410. The frequency components may be associated with a spectral signature of a corresponding emitted pulse of light 400 (e.g., the spectral signature may include a frequency offset between the emitted pulse of light and LO light 430), and the amplitude information for the frequency components may be determined based on an AM photocurrent signal. The output signal 145 may include amplitudes of one or more frequency components of an AM photocurrent signal associated with the coherent mixing of LO light 430 and a received pulse of light 410, and this amplitude information may be sent as part of an output signal 145 to a controller 150 for further processing. The controller 150 may determine, based at least in part on the amplitude information, whether a received pulse of light is a valid received pulse of light 410 or an interfering pulse of light. Additionally or alternatively, the controller 150 may determine, based on an output signal 145, whether a received pulse of light is associated with an emitted pulse of light. For example, the controller 150 in FIG. 6 may receive the output signal 145 and determine that the received pulse of light 410 is associated with the emitted pulse of light 400. As another example, the controller 150 may receive a second output signal 145 associated with a second received pulse of light, and the controller may determine that the second received pulse of light is not associated with the emitted pulse of light 400. Additionally or alternatively, the controller 150 may determine that the second received pulse of light is associated with a different emitted pulse of light. A received pulse of light 410 being associated with an emitted pulse of light 400 may refer to the received pulse of light 410 including a portion of light from the emitted pulse of light. For example, the emitted pulse of light 400 may be scattered from a target 130, and the received pulse of light 410 may include a portion of the scattered light from the emitted pulse of light 400. A received pulse of light 410 may only be associated with one emitted pulse of light 400.

In particular embodiments, a controller 150 of a lidar system 100 may be coupled to one or more components of the lidar system 100 via one or more data links. Each data link may include one or more electrical links, one or more wireless links, or one or more optical links, and the data links may be used to send data, signals, or commands to or from the controller 150. The controller 150 in FIG. 6 may be coupled to another component of the lidar system 100 (e.g., light source 110, scanner 120, receiver 140, or detection circuit 361) by a data link. For example, the controller 150 may send a command via a link to the light source 110 instructing the light source 110 to emit a pulse of light 400. As another example, the detection circuit 361 may send an output signal 145 via a link to the controller with information about a received pulse of light 410 (e.g., a time-of-arrival of the received pulse of light 410). Additionally, the controller 150 may be coupled via a link to a processor of an autonomous-vehicle driving system. The autonomous-vehicle processor may receive point-cloud data from the controller 150 and may make driving decisions based on the received point-cloud data.

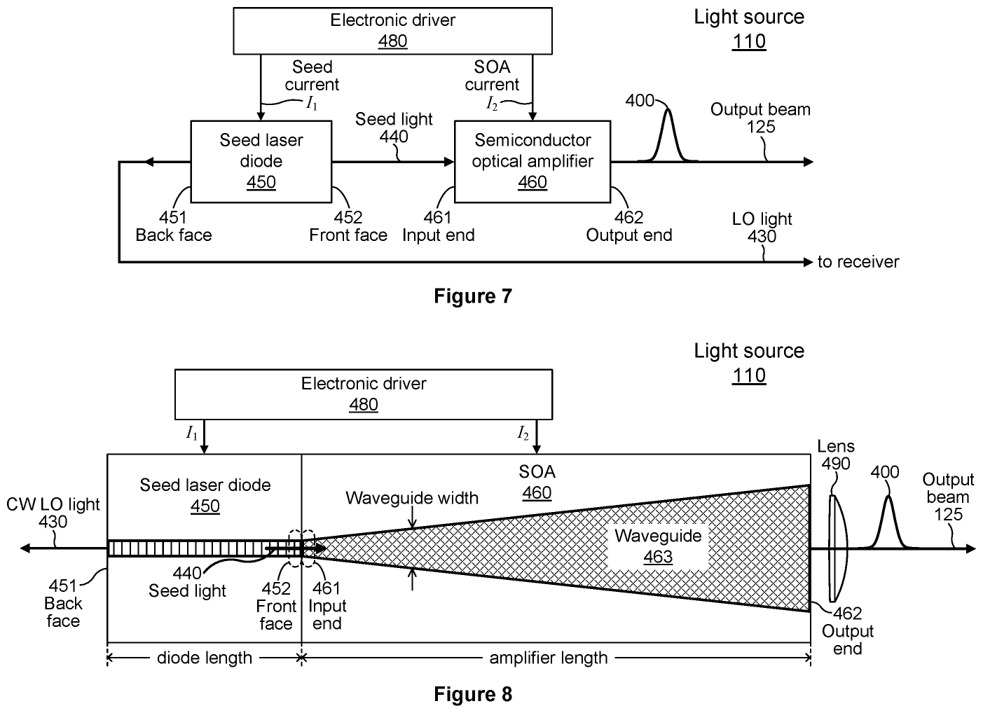

FIG. 7 illustrates an example light source 110 that includes a seed laser diode 450 and a semiconductor optical amplifier (SOA) 460. In particular embodiments, a light source 110 of a coherent pulsed lidar system 100 may include (i) a seed laser 450 that produces seed light 440 and LO light 430 and (ii) an optical amplifier 460 that amplifies temporal portions of the seed light 440 to produce emitted pulses of light 400. In the example of FIG. 7, the seed laser is a seed laser diode 450 that produces seed light 440 and LO light 430. The seed laser diode 450 may include a Fabry-Perot laser diode, a quantum well laser, a DBR laser, a DFB laser, a VCSEL, a quantum dot laser diode, a sampled-grating distributed Bragg reflector (SG-DBR) laser, or any other suitable type of laser diode. In FIG. 7, the optical amplifier is a semiconductor optical amplifier (SOA) 460 that emits a pulse of light 400 that is part of the output beam 125. A SOA 460 may include a semiconductor optical waveguide that receives the seed light 440 from the seed laser diode 450 and amplifies a temporal portion of the seed light 440 as it propagates through the waveguide to produce an emitted pulse of light 400. A SOA 460 may have an optical power gain of 20 decibels (dB), 25 dB, 30 dB, 35 dB, 40 dB, 45 dB, or any other suitable optical power gain. For example, a SOA 460 may have a gain of 40 dB, and a temporal portion of seed light 440 with an energy of 20 μJ may be amplified by the SOA 460 to produce a pulse of light 400 with an energy of approximately 0.2 μJ. A light source 110 that includes a seed laser diode 450 that supplies seed light 440 that is amplified by a SOA 460 may be referred to as a master-oscillator power-amplifier laser (MOPA laser). The seed laser diode 450 may be referred to as a master oscillator, and the SOA 460 may be referred to as a power amplifier.

In particular embodiments, seed light 440 produced by a light source 110 may have a substantially constant optical power or a substantially constant optical frequency. For example, the optical power of the seed light 440 may vary by less than 5%, 2%, 1%, or 0.2% over a particular time interval (e.g., a time interval of approximately 1 s, 10 s, 100 s, 10 minutes, 1 hour, or 1 day). In particular embodiments, LO light 430 produced by a light source 110 may have a substantially constant optical power or a substantially constant optical frequency. For example, the optical frequency of the LO light 430 may vary by less than 0.1%, 0.01%, 0.001%, 0.0001%, 0.00001%, 0.000001% over a particular time interval (e.g., a time interval of approximately 1 s, 10 s, 100 s, 10 minutes, 1 hour, or 1 day).

In particular embodiments, a light source 110 may include an electronic driver 480 that (i) supplies electrical current to a seed laser 450 and (ii) supplies electrical current to a SOA 460. In FIG. 7, the electronic driver 480 supplies seed current I₁ to the seed laser diode 450 to produce the seed light 440 and the LO light 430. The seed current I₁ supplied to the seed laser diode 450 may be a substantially constant DC electrical current so that the seed light 440 and the LO light 430 each include continuous-wave (CW) light or light having a substantially constant optical power. For example, the seed current I₁ may include a DC current of approximately 1 mA, 10 mA, 100 mA, 200 mA, 500 mA, or any other suitable DC electrical current. Additionally or alternatively, the seed current I₁ may include a pulse of electrical current. The seed laser 450 may be pulsed with a pulse of current having a duration that is long enough so that the wavelength of the seed-laser light emitted by the seed laser 450 (e.g., seed light 440 and LO light 430) stabilizes or reaches a substantially constant value at some time during the pulse. For example, the duration of the current pulse may be between 20 ns and 2 μs, and the SOA 460 may be configured to amplify a 5-ns temporal portion of the seed light 440 to produce the emitted pulse of light 400. The temporal portion of the seed light 440 that is selected for amplification may be located in time near the middle or end of the electrical current pulse to allow sufficient time for the wavelength of the seed-laser light to stabilize.

In FIG. 7, the electronic driver 480 supplies SOA current I₂ to the SOA 460, and the SOA current I₂ provides optical gain to temporal portions of the seed light 440 that propagate through the waveguide of the SOA 460. The SOA current I₂ may include pulses of electrical current, where each pulse of current causes the SOA 460 to amplify one temporal portion of the seed light 440 to produce a corresponding emitted pulse of light 400. The SOA current I₂ may have a duration of approximately 0.5 ns, 1 ns, 2 ns, 5 ns, 10 ns, 20 ns, 50 ns, 100 ns, or any other suitable duration. The SOA current I₂ may have a peak amplitude of approximately 1 A, 2 A, 5 A, 10 A, 20 A, 50 A, 100 A, 200 A, 500 A, or any other suitable peak current. For example, the SOA current I₂ supplied to the SOA 460 may include a series of current pulses having a duration of approximately 5-10 ns and a peak current of approximately 100 A. The series of current pulses may result in the emission of a corresponding series of pulses of light 400, and each emitted pulse of light 400 may have a duration that is less than or equal to the duration of the corresponding electrical current pulse. For example, an electronic driver 480 may supply 5-ns duration current pulses to the SOA 460 at a repetition frequency of 700 kHz. This may result in emitted pulses of light 400 that have a duration of approximately 4 ns and a pulse repetition frequency of 700 KHz.

An optical amplifier may include a SOA, a fiber-optic amplifier, or a SOA followed by a fiber-optic amplifier. For example, an optical amplifier may include a SOA 460 that is operated in a pulsed mode by supplying the SOA 460 with pulses of current. The seed light 440 may include CW light or light having a substantially constant optical power, and each pulse of current supplied to the SOA 460 may amplify a temporal portion of seed light to produce an emitted pulse of light 400. As another example, an optical amplifier may include an optical modulator as well as a SOA or a fiber-optic amplifier. The optical modulator may be an acousto-optic modulator (AOM) or an electro-optic modulator (EOM) operated in a pulsed mode so that the modulator selectively transmits pulses of light. The SOA 460 may also be operated in a pulsed mode in synch with the optical modulator to amplify the temporal portions of the seed light, or the SOA 460 may be supplied with substantially DC current to operate as a CW optical amplifier. The optical modulator may be located between the seed laser diode 450 and the SOA 460, and the optical modulator may be operated in a pulsed mode to transmit temporal portions of the seed light 440 which are then amplified by the SOA 460. Alternatively, the optical modulator may be located after the SOA 460, and the optical modulator may be operated in a pulsed mode to transmit the emitted pulses of light 400.

The seed laser diode 450 illustrated in FIG. 7 includes a front face 452 and a back face 451. The seed light 440 is emitted from the front face 452 and directed to the input end 461 of the SOA 460. The LO light 430 is emitted from the back face 451 and directed to the receiver 140 of the lidar system 100. The seed light 440 or the LO light 430 may be emitted as a free-space beam, and a light source 110 may include one or more lenses (not illustrated in FIG. 7) that (i) collimate the LO light 430 emitted from the back face 451, (ii) collimate the seed light 440 emitted from the front face 452, or (iii) focus the seed light 440 into the SOA 460. Alternatively, the seed light 440 or the LO light 430 may be coupled into an optical waveguide or an optical fiber. For example, the seed light 440 may be coupled into an optical waveguide that directs the seed light to the SOA 460.

In particular embodiments a front face 452 or a back face 451 may include a discrete facet formed by a semiconductor-air interface (e.g., a surface formed by cleaving or polishing a semiconductor structure to form the seed laser diode 450). Additionally, the front face 452 or the back face 451 may include a dielectric coating with a reflectivity (at the seed-laser operating wavelength) of between approximately 50% and approximately 99.9%. For example, the back face 451 may have a reflectivity of 90% to 99.9% at a wavelength of the LO light 430. The average power of the LO light 430 emitted from the back face 451 may depend at least in part on the reflectivity of the back face 451, and a value for the reflectivity of the back face 451 may be selected to provide a particular average power of the LO light 430. For example, the back face 451 may be configured to have a reflectivity between 90% and 99%, and the seed laser diode 450 may emit LO light 430 having an average optical power of 10 μW to 1 mW. In some conventional laser diodes, the reflectivity of the back face may be designed to be relatively high or as close to 100% as possible in order to minimize the amount of light produced from the back face or to maximize the amount of light produced from the front face. In the seed laser diode 450 of FIG. 7, the reflectivity of the back face 451 may be reduced to a lower value compared to a conventional laser diode so that a particular power of LO light 430 is emitted from the back face 451. As an example, a conventional laser diode may have a back face with a reflectivity of greater than 98%, and a seed laser diode 450 may have a back face with a reflectivity between 90% and 98%.

In particular embodiments, the wavelength of the seed light 440 and the wavelength of the LO light 430 may be approximately equal. For example, a seed laser diode 450 may have a seed-laser operating wavelength of approximately 1508 nm, and the seed light 440 and the LO light 430 may each have the same wavelength of approximately 1508 nm. As another example, the wavelength of the seed light 440 and the wavelength of the LO light 430 may be equal to within some percentage (e.g., to within approximately 0.1%, 0.01%, or 0.001%) or to within some wavelength range (e.g., to within approximately 0.1 nm, 0.01 nm, or 0.001 nm). If the wavelengths are within 0.01% of 1508 nm, then the wavelengths of the seed light 440 and the LO light 430 may each be in the range from 1507.85 nm to 1508.15 nm).

In particular embodiments, a light source 110 may be configured to produce seed light 440 and LO light 430 having a particular frequency offset of one or more different frequency offsets. Each of the frequency offsets between the seed light 440 and the LO light 430 may have any suitable value between approximately 10 MHz and approximately 50 GHZ (e.g., a value of approximately 10 MHZ, 100 MHZ, 200 MHZ, 500 MHZ, 1 GHZ, 2 GHZ, 10 GHZ, or 50 GHz). For example, the optical frequency of the LO light 430 may be approximately constant, and the seed light 440 may have an optical frequency that is offset by approximately +20 GHz from the optical frequency of the LO light 430. As another example, the optical frequency of the LO light 430 may be approximately constant, and the light source 110 may produce seed light 440 having two or more different frequency offsets with respect to the LO light 430. Each temporal portion of the seed light 440 that is amplified to produce a corresponding emitted pulse of light 400 may be offset from the optical frequency of the LO light 430 by a particular frequency offset (Δf) of the two or more different frequency offsets. A temporal portion with a Δf frequency offset that is amplified may produce a corresponding pulse of light 400 that is offset by approximately Δf from the optical frequency of the LO light 430. For example, a first temporal portion of the seed light 440 may be offset by +4 GHz with respect to the LO light 430, and a second temporal portion of the seed light may be offset by +8 GHZ with respect to the LO light. Each of the temporal portions may be amplified to produce two emitted pulses of light having respective frequency offsets of approximately +4 GHZ and +8 GHZ. As another example, the optical frequency of the LO light 430 may be approximately 193.50 THz (corresponding to a wavelength of approximately 1549.32 nm), and the optical frequency of the seed light 440 may include one or more frequencies between 193.501 THz and 193.51 THz, which corresponds to a frequency offset between +1 GHZ and +10 GHz. The 193.501-THz to 193.51-THz optical frequency of the seed light 440 corresponds to a wavelength between approximately 1549.23 nm and approximately 1549.31 nm. A frequency offset Δf between a pulse of light (e.g., an emitted pulse of light 400 or a received pulse of light 410) and LO light 430 may be referred to as a frequency difference, a frequency shift, a frequency change, a spectral shift, or a spectral signature.

An optical frequency f (which may be referred to as a frequency or a carrier frequency) and a wavelength 2 may be related by the expression λ·f=c. For example, seed light 440 with a wavelength of 1550 nm corresponds to seed light 440 with an optical frequency of approximately 193.55 THz. In some cases herein, the terms wavelength and frequency may be used interchangeably when referring to an optical property of light. For example, LO light 430 having a substantially constant optical frequency may be equivalent to the LO light 430 having a substantially constant wavelength. As another example, LO light 430 having approximately the same wavelength as seed light 440 may also be referred to as the LO light 430 having approximately the same frequency as the seed light 440. As another example, LO light 430 having a particular wavelength offset from seed light 440 may also be referred to as the LO light 430 having a particular frequency offset from the seed light 440. An optical frequency offset (Δf) and a wavelength offset (Δλ) may be related by the expression Δf/f=−Δλ/λ. For example, for seed light 440 with a 1550-nm wavelength, LO light 430 that has a +10-GHz frequency offset from the seed light 440 corresponds to LO light 430 with a wavelength offset of approximately −0.08-nm from the 1550-nm wavelength of the seed light 440 (e.g., a wavelength for the LO light 430 of approximately 1549.92 nm). The term optical frequency may refer to the frequency of an optical signal. For example, LO light 430, seed light 440, or an emitted pulse of light 400 may have a center or peak optical frequency between 175 THz and 335 THz (which corresponds to a wavelength between approximately 895 nm and approximately 1713 nm).

FIG. 8 illustrates an example light source 110 that includes a semiconductor optical amplifier (SOA) 460 with a tapered optical waveguide 463. In particular embodiments, a SOA 460 may include an input end 461, an output end 462, and an optical waveguide 463 extending from the input end 461 to the output end 462. The input end 461 may receive the seed light 440 from the seed laser diode 450. The waveguide 463 may amplify a temporal portion of the seed light 440 as the temporal portion propagates along the waveguide 463 from the input end 461 to the output end 462. The amplified temporal portion may be emitted from the output end 462 as an emitted pulse of light 400. The emitted pulse of light 400 may be part of the output beam 125, and the light source 110 may include a lens 490 configured to collect and collimate emitted pulses of light 400 from the output end 462 to produce a collimated free-space output beam 125. The seed laser diode 450 in FIG. 8 may have a diode length of approximately 100 μm, 200 μm, 500 μm, 1 mm, or any other suitable length. The SOA 460 may have an amplifier length of approximately 1 mm, 2 mm, 3 mm, 5 mm, 10 mm, 20 mm, or any other suitable length. For example, the seed laser diode 450 may have a diode length of approximately 300 μm, and the SOA 460 may have an amplifier length of approximately 4 mm.

In particular embodiments, a waveguide 463 may include a semiconductor optical waveguide formed at least in part by the semiconductor material of the SOA 460, and the waveguide 463 may confine light along transverse directions while the light propagates through the SOA 460. In particular embodiments, a waveguide 463 may have a substantially fixed width or a waveguide 463 may have a tapered width. For example, a waveguide 463 may have a substantially fixed waveguide width of approximately 5 μm, 10 μm, 20 μm, 50 μm, 100 μm, 200 μm. 500 μm, or any other suitable width. In FIG. 8, the SOA 460 has a tapered waveguide 463 with a waveguide width that increases from the input end 461 to the output end 462. For example, the width of the tapered waveguide 463 at the input end 461 may be approximately equal to the width of the waveguide of the seed laser diode 450 (e.g., the input end 461 may have a width of approximately 1 μm. 2 μm, 5 μm, 10 μm, or 50 μm). At the output end 462 of the SOA 460, the tapered waveguide 463 may have a width of approximately 50 μm, 100 μm, 200 μm, 500 μm, 1 mm, or any other suitable width. As another example, the width of the tapered waveguide 463 may increase linearly from a width of approximately 20 μm at the input end 461 to a width of approximately 250 μm at the output end 462.

In particular embodiments, the input end 461 or the output end 462 of a SOA 460 may be a discrete facet formed by a semiconductor-air interface. Additionally, the input end 461 or the output end 462 may include a dielectric coating (e.g., an anti-reflection coating to reduce the reflectivity of the input end 461 or the output end 462). An anti-reflection (AR) coating may have a reflectivity at the seed-laser operating wavelength of less than 5%, 2%, 0.5%, 0.1%, or any other suitable reflectivity value. In FIG. 7, the input end 461 may have an AR coating that reduces the amount of seed light 440 reflected by the input end 461. In FIG. 7 or FIG. 8, the output end 462 may have an AR coating that reduces the amount of amplified seed light reflected by the output end 462. An AR coating applied to the input end 461 or the output end 462 may also prevent the SOA 460 from acting as a laser where the SOA emits coherent light when no seed light 440 is present.

In particular embodiments, a light source 110 may include a seed laser diode 450 and a SOA 460 that are integrated together and disposed on or in a single chip or substrate. For example, a seed laser diode 450 and a SOA 460 may each be fabricated separately and then attached to the same substrate (e.g., using epoxy or solder). The substrate may be electrically or thermally conductive, and the substrate may have a coefficient of thermal expansion (CTE) that is approximately equal to the CTE of the seed laser 450 and the SOA 460. As another example, the seed laser diode 450 and the SOA 460 may be fabricated together on the same substrate (e.g., using semiconductor-fabrication processes, such as for example, lithography, deposition, and etching). The seed laser diode 450 and the SOA 460 may each include InGaAs or InGaAsP semiconductor structures, and the substrate may include indium phosphide (InP). The InP substrate may be n-doped or p-doped so that it is electrically conductive, and a portion of the InP substrate may act as an anode or cathode for the seed laser diode 450 or the SOA 460. The substrate may be thermally coupled to (i) a heat sink that dissipates heat produced by the seed laser diode 450 or the SOA 460 or (ii) a temperature-control device (e.g., a thermoelectric cooler) that stabilizes the temperature of the seed laser diode 450 or the SOA 460 to a particular temperature setpoint or to within a particular temperature range. In the example of FIG. 7, the seed laser 450 and the SOA 460 may be separate devices that are not disposed on a single substrate, and the seed light 440 may be a free-space beam. Alternatively, in the example of FIG. 7, the seed laser 450 and the SOA 460 may be separate devices that are disposed together on a single substrate. In the example of FIG. 8, the seed laser 450 and the SOA 460 may be integrated together and disposed on or in a single chip or substrate.

In FIG. 8, rather than having a discrete facet formed by a semiconductor-air interface, the front face 452 of the seed laser diode 450 and the input end 461 of the SOA 460 may be coupled together without a semiconductor-air interface. For example, the seed laser diode 450 may be directly connected to the SOA 460 so that the seed light 440 is directly coupled from the seed laser diode 450 into the waveguide 463 of the SOA 460. The front face 452 may be butt-coupled or affixed (e.g., using an optically transparent adhesive) to the input end 461, or the seed laser diode 450 and the SOA 460 may be fabricated together so that there is no separate front face 452 or input end 461 (e.g., the front face 452 and the input end 461 may be merged together to form a single interface between the seed laser diode 450 and the SOA 460). Alternatively, the seed laser diode 450 may be coupled to the SOA 460 via a passive optical waveguide or by a modulator that transmits the seed light 440 from the front face 452 of the seed laser diode 450 to the input end 461 of the SOA 460.

In particular embodiments, during a period of time between two successive temporal portions of seed light 440, a SOA 460 may be configured to optically absorb most of the seed light 440 propagating in the SOA 460. The seed light 440 from the seed laser diode 450 may be coupled into the waveguide 463 of the SOA 460. Depending on the amount of SOA current I₂ supplied to the SOA 460, the seed light 440 may be optically amplified or optically absorbed while propagating along the waveguide 463. If the SOA current I₂ exceeds a threshold gain value (e.g., 100 mA) that overcomes the optical loss of the SOA 460, then the seed light 440 may be optically amplified by stimulated emission of photons. Otherwise, if the SOA current I₂ is less than the threshold gain value, then the seed light 440 may be optically absorbed. The process of optical absorption of the seed light 440 may include photons of the seed light 440 being absorbed by electrons located in the semiconductor structure of the SOA 460.

In particular embodiments, the SOA current I₂ may include pulses of current separated by a period of time that corresponds to the pulse period t of the light source 110, and each pulse of current may result in the emission of a pulse of light 400. For example, if the SOA current I₂ includes 20-A current pulses with a 10-ns duration, then for each current pulse, a corresponding 10-ns temporal portion of the seed light 440 may be amplified, resulting in the emission of a pulse of light 400. During the time periods t between successive pulses of current, the SOA current I₂ may be set to approximately zero or to some other value below the threshold gain value, and the seed light 440 present in the SOA 460 during those time periods may be optically absorbed. The optical absorption of the SOA 460 when the SOA current I₂ is zero may be greater than or equal to approximately 10 decibels (dB), 15 dB, 20 dB, 25 dB, or 30 dB. For example, if the optical absorption is greater than or equal to 20 dB, then less than or equal to 1% of the seed light 440 that is coupled into the input end 461 of the waveguide 463 may be emitted from the output end 462 as unwanted leakage light. Having most of the seed light 440 absorbed in the SOA 460 may prevent unwanted seed light 440 (e.g., seed light 440 located between successive pulses of light 400) from leaking out of the SOA 460 and propagating through the rest of the lidar system 100. Additionally, optically absorbing the unwanted seed light 440 may allow the seed laser 450 to be operated with a substantially constant current I₁ or a substantially constant output power so that the wavelengths of the seed light 440 and LO light 430 are stable and substantially constant.

In particular embodiments, a SOA 460 may include an anode and a cathode that transmit SOA current I₂ from an electronic driver 480 to or from the SOA 460. For example, the anode of the SOA 460 may include or may be electrically coupled to a conductive electrode material (e.g., gold) deposited onto the top surface of the SOA 460, and the cathode may include or may be electrically coupled to a substrate located on the opposite side of the SOA 460. Alternatively, the anode of the SOA 460 may include or may be electrically coupled to the substrate of the SOA 460, and the cathode may include or may be electrically coupled to the electrode on the top surface of the SOA 460. The anode and cathode may be electrically coupled to the electronic driver 480, and the driver 480 may supply a positive SOA current I₂ that flows from the driver 480 into the anode, through the SOA 460, out of the cathode, and back to the driver 480. When considering the electrical current as being made up of a flow of electrons, then the electrons may be viewed as flowing in the opposite direction (e.g., from the driver 480 into the cathode, through the SOA 460, and out of the anode and back to the driver 480).

In particular embodiments, an electronic driver 480 may electrically couple the SOA anode to the SOA cathode during a period of time between two successive pulses of current. For example, for most or all of the time period t between two successive pulses of current, the electronic driver 480 may electrically couple the anode and cathode of the SOA 460. Electrically coupling the anode and cathode may include electrically shorting the anode directly to the cathode or coupling the anode and cathode through a particular electrical resistance (e.g., approximately 1 Ω, 10Ω, or 100Ω. Alternatively, electrically coupling the anode and the cathode may include applying a reverse-bias voltage (e.g., approximately −1 V, −5 V, or −10 V) to the anode and cathode, where the reverse-bias voltage has a polarity that is opposite the forward-bias polarity associated with the applied pulses of current. By electrically coupling the anode to the cathode, the optical absorption of the SOA may be increased. For example, the optical absorption of the SOA 460 when the anode and cathode are electrically coupled may be increased (compared to the anode and cathode not being electrically coupled) by approximately 3 dB, 5 dB, 10 dB, 15 dB, or 20 dB. The optical absorption of the SOA 460 when the anode and cathode are electrically coupled may be greater than or equal to approximately 20 dB, 25 dB, 30 dB, 35 dB, or 40 dB. For example, the optical absorption of a SOA 460 when the SOA current I₂ is zero and the anode and cathode are not electrically coupled may be 20 dB. When the anode and cathode are electrically shorted together, the optical absorption may increase by 10 dB to 30 dB. If the optical absorption of the SOA 460 is greater than or equal to 30 dB, then less than or equal to 0.1% of the seed light 440 that is coupled into the input end 461 of the waveguide 463 may be emitted from the output end 462 as unwanted leakage light.

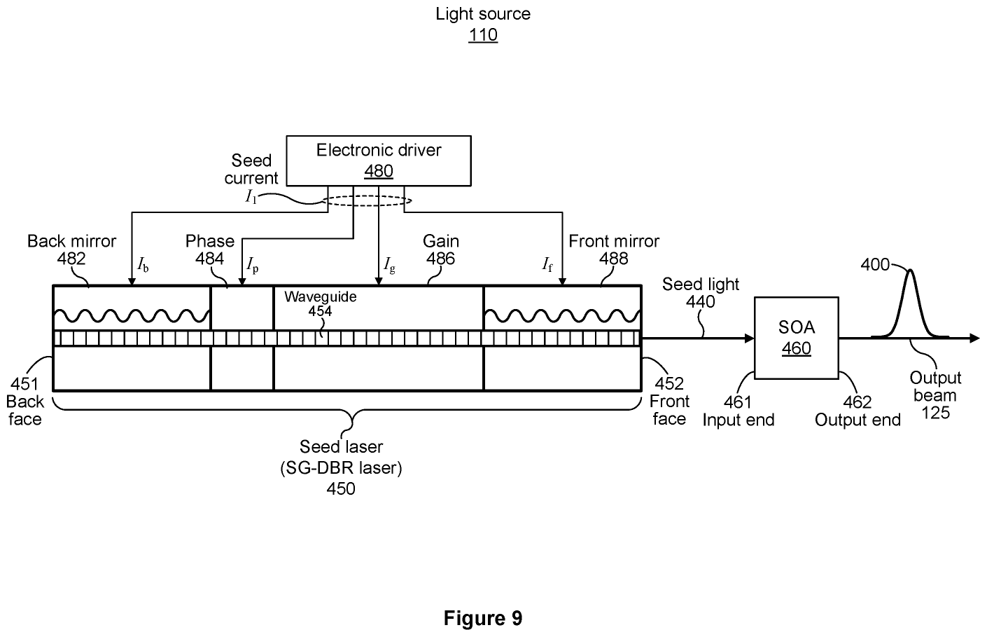

FIG. 9 illustrates an example light source 110 that includes a sampled-grating distributed Bragg reflector (SG-DBR) laser 450. The light source 110 in FIG. 9 may be referred to as a wavelength-tunable light source, a frequency-tunable light source, or a tunable light source. A frequency-tunable light source 110 may include a frequency-tunable seed laser diode 450 that produces seed light 440 at one or more different optical frequencies. A frequency-tunable seed laser diode 450 may be referred to as a tunable seed laser, a frequency-tunable laser diode, or a tunable laser diode. The seed light 440 may be amplified by an optical amplifier to produce an output beam 125 that includes pulses of light 400, where each emitted pulse of light has a particular optical frequency of one or more different frequencies. In addition to producing seed light 440, a frequency-tunable light source 110 may also produce LO light 430, and each emitted pulse of light 400 may be offset from the optical frequency of the LO light by a particular frequency offset of one or more different frequency offsets. Each of the one or more different optical frequencies of seed light 440 produced by the frequency-tunable seed laser diode 450 may correspond to one of the one or more different frequency offsets of the emitted pulses of light 400. For example, a temporal portion of seed light 440 having a particular frequency offset may be amplified to produce an emitted pulse of light 400 having approximately the same frequency offset with respect to the LO light 430.

One or more of the light sources 110 described herein may be a frequency-tunable light source and may include a frequency-tunable seed laser diode 450. A frequency-tunable seed laser diode 450 may include any suitable laser diode configured to produce seed light 440 at multiple different frequencies. For example, a frequency-tunable seed laser diode 450 may include a frequency-tunable distributed Bragg reflector (DBR) laser, a frequency-tunable SG-DBR laser (as illustrated in FIG. 9), a frequency-tunable VCSEL, or a frequency-tunable external-cavity laser diode (e.g., an external-cavity laser diode may include an intracavity diffraction grating or electro-optic device that provides frequency tuning).

In particular embodiments, a light source 110 of a coherent pulsed lidar system 100 may be a frequency-tunable light source that emits pulses of light 400, where each pulse of light has a particular optical frequency of one or more different optical frequencies (or, equivalently, a particular wavelength of one or more different wavelengths). For example, each pulse of light 400 emitted by a frequency-tunable light source 110 may have a particular optical frequency of 1, 2, 5, 10, 20, 50, 100, or any other suitable number of different optical frequencies. The different optical frequencies may be distributed over any suitable frequency range between 175 THz and 335 THz (which corresponds to a wavelength range between approximately 895 nm and approximately 1713 nm). For example, the different optical frequencies may be within a 10-MHz to 50-GHz frequency range centered at approximately 193 THz, 199 THz, or 331 THZ.

The SG-DBR laser 450 in FIG. 9 may produce seed light 440 at one or more different optical frequencies, and the SOA 460 may amplify the seed light to produce an output beam 125 that includes pulses of light 400, where each emitted pulse of light has a particular frequency of the one or more different frequencies. For example, the SG-DBR laser 450 may produce seed light 440 with an optical frequency of approximately 193.4 THz (which corresponds to a wavelength of approximately 1550.1 nm), and the SOA 460 may amplify a first temporal portion of the seed light to produce a first emitted pulse of light 400 having a corresponding optical frequency of approximately 193.4 THz. Then, the SG-DBR laser 450 may produce seed light 440 at approximately 193.39 THz (which corresponds to a wavelength of approximately 1550.2 nm), and the SOA 460 may amplify a second temporal portion of the seed light to produce a second emitted pulse of light 400 having a corresponding optical frequency of approximately 193.39 THz. Additionally, the SG-DBR laser 450 or another laser diode may produce LO light 430 with an optical frequency of approximately 193.405 THz. The optical frequency of each emitted pulse of light 400 may be offset from the optical frequency of the LO light 430 by a particular frequency offset of one or more different frequency offsets. In this example, the optical frequency of the first emitted pulse of light is offset from the optical frequency of the LO light by approximately −5 GHz, and the optical frequency of the second emitted pulse of light is offset from the LO light by approximately −15 GHZ.

In addition to the tunable seed laser 450, the light source 110 in FIG. 9 may also include a local-oscillator laser (not illustrated in FIG. 9) that produces LO light 430. The local-oscillator laser may produce LO light 430 having a substantially constant optical frequency, and the tunable seed laser 450 may produce seed light 440 having one or more different frequency offsets with respect to the LO light. Alternatively, a tunable seed laser 450 may produce both seed light 440 as well as LO light 430. For example, the tunable seed laser 450 in FIG. 9 may produce a temporal portion of seed light 440 with an optical frequency of f₁, and the SOA 460 may amplify the temporal portion to produce an emitted pulse of light 400 with an optical frequency of approximately f₁. Subsequent to producing the temporal portion at frequency f₁, the tunable seed laser 450 may switch its operating frequency to produce LO light at an optical frequency of f₀ that is offset from the frequency f₁ by a particular frequency offset.

In FIG. 9, the SG-DBR laser 450 and the SOA 460 may be integrated together so that the seed light 440 is coupled from the front mirror 488 of the SG-DBR laser directly into the input end 461 of the SOA 460. Alternatively, the light source 110 in FIG. 9 may include a modulator or passive optical waveguide (not illustrated in FIG. 9) located between the SG-DBR laser 450 and the SOA 460, and the modulator or passive waveguide may convey the seed light 440 from the front face 452 of the SG-DBR laser to the input end 461 of the SOA 460.

The SG-DBR laser 450 in FIG. 9 includes a back mirror 482, a phase section 484, a gain section 486, and a front mirror 488, where the phase and gain sections are located between the front and back mirrors. A frequency-tunable light source 110 may include an electronic driver 480 that supplies particular combinations of electrical currents to the back mirror 482, phase section 484, gain section 486, and front mirror 488, where each particular combination of electrical currents causes the SG-DBR laser 450 to produce seed light 440 at a particular frequency of one or more different frequencies. The electrical currents supplied to an SG-DBR laser 450 may be referred to collectively as the seed current I₁ and may include the following: current I_{b} supplied to the back mirror 482, current Iₚ supplied to the phase section 484, current I_{g} supplied to the gain section 486, and current I_{f} supplied to the front mirror 488. The gain current I_{g} may provide optical gain to the seed light 440 while the seed light propagates within the waveguide 454 of the SG-DBR laser 450. The seed light 440 produced by the SG-DBR laser 450 may be coupled to the SOA 460, and the electronic driver 480 may supply pulses of electrical current to the SOA, where each pulse of current causes the SOA 460 to amplify a temporal portion of seed light to produce a corresponding emitted pulse of light 400. The optical frequency of each emitted pulse of light 400 may be approximately equal to the optical frequency of the corresponding temporal portion of the seed light 440 that is amplified. Equivalently, the wavelength of each emitted pulse of light 400 may be approximately equal to the wavelength of the corresponding temporal portion of the seed light 440.

The optical frequency of seed light 440 produced by an SG-DBR laser 450 may be determined at least in part by the currents I_{b}, Iₚ, and I_{f} supplied to the respective back mirror 482, phase section 484, and front mirror 488 of the SG-DBR laser. The gain current I_{g} may include a substantially constant current supplied to the gain section 486 that causes the SG-DBR laser 450 to produce seed light 440 having a substantially constant optical power. The back mirror 482 and the front mirror 488 may each act as a distributed mirror similar to a distributed Bragg reflector, and the seed light 440 may be at least partially reflected by the back and front mirrors as the seed light propagates along the waveguide 454 back and forth within the SG-DBR laser 450. The optical frequency of the seed light 440 may be selected by applying particular values of the currents I_{b}, Iₚ, and I_{f} to the SG-DBR laser 450. For example, a controller 150 may store a look-up table that includes one or more combinations of current values for I_{b}, Iₚ, and I_{f}, where each combination of currents results in the seed laser 450 producing seed light 440 having a particular frequency. By instructing the electronic driver 480 to supply particular values of the currents I_{b}, Iₚ, and I_{f} to the SG-DBR laser 450, a temporal portion of seed light having a particular corresponding optical frequency may be produced.

A controller 150 may provide instructions to the electronic driver 480 to switch between different sets of the currents I_{b}, Iₚ, and I_{f} to produce temporal portions of seed light having different optical frequencies. For example, supplying a first set of electrical currents to the back mirror 482, phase section 484, and front mirror 488 may cause the SG-DBR laser 450 to produce a first temporal portion of seed light 440 having a first optical frequency. The SOA 460 may amplify the first temporal portion to produce a first emitted pulse of light having an optical frequency approximately equal to the first optical frequency. Then, supplying a second set of electrical currents to the SG-DBR laser 450 (e.g., by adjusting the current supplied to the back mirror 482, phase section 484, or front mirror 488) may cause the SG-DBR laser 450 to produce a second temporal portion of seed light 440 having a second optical frequency different from the first optical frequency. The SOA 460 may amplify the second temporal portion to produce a second emitted pulse of light having an optical frequency approximately equal to the second optical frequency. An SG-DBR laser 450 may be capable of switching frequencies on a nanosecond time scale, allowing a light source 110 to have fast frequency-tuning agility and to produce emitted pulses of light 400 having different optical frequencies. For example, a light source 110 with an SG-DBR seed laser 450 may produce pulses of light 400 at a 500-kHz pulse repetition frequency, and the SG-DBR seed laser may be operated so that the frequencies of the emitted pulses of light 400 change from pulse to pulse. Each emitted pulse of light 400 may have a different optical frequency than one or more of the immediately preceding pulses of light and one or more of the immediately following pulses of light.

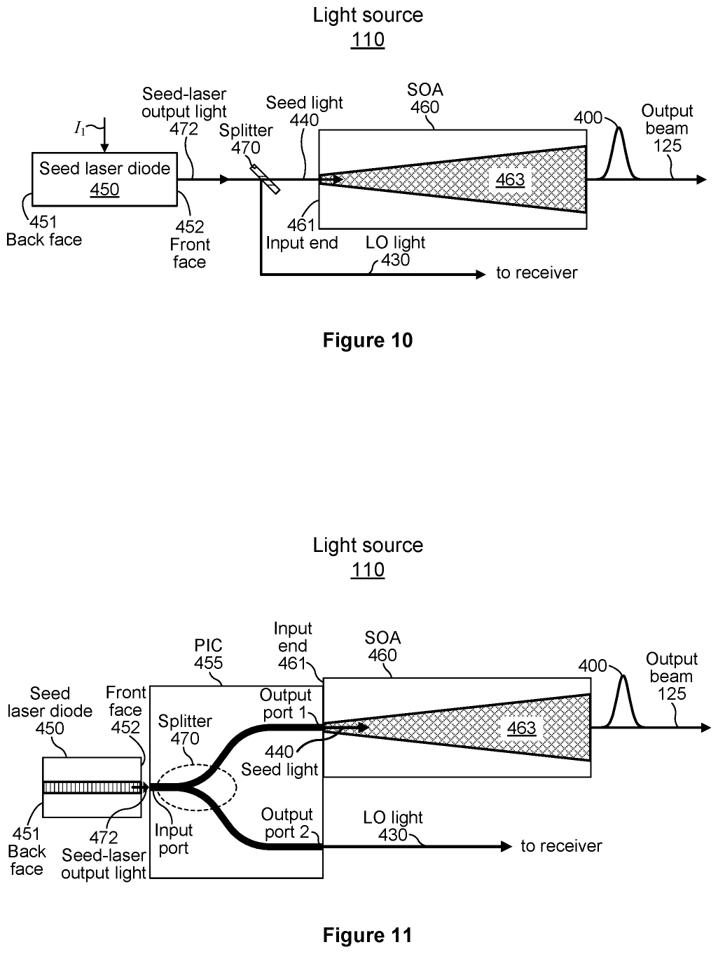

FIG. 10 illustrates an example light source 110 with an optical splitter 470 that splits output light 472 from a seed laser diode 450 to produce seed light 440 and local-oscillator (LO) light 430. In particular embodiments, a light source 110 may include (i) a seed laser diode 450 with a front face 452 from which seed-laser output light 472 is emitted and (ii) an optical splitter 470 that splits the output light 472 to produce seed light 440 and LO light 430. An optical splitter 470 may be referred to as a splitter or as a beam-splitter. In FIG. 10, the output light 472 emitted by the seed laser diode 450 is a free-space optical beam, and the optical splitter 470 is a free-space optical beam-splitter that produces the free-space beams: seed light 440 and LO light 430. In the examples of FIGS. 7 and 8, light emitted from the back face 451 of the seed laser diode 450 is used to produce the LO light 430. In contrast, in the example of FIG. 10, both the seed light 440 and the LO light 430 are produced from the output light 472 emitted from the front face 452 of the seed laser diode 450. The seed light 440 is transmitted through the splitter 470 and directed to the SOA 460, and the LO light 430 is reflected by the splitter 470 and directed to the receiver 140 of the lidar system 100. A light source 110 may include one or more lenses (not illustrated in FIG. 10) that collimate the seed-laser output light 472 or focus the seed light 440 into the waveguide 463 of the SOA 460.

The optical splitter 470 in FIG. 10 is a free-space optical splitter that receives the seed-laser output light 472 as a free-space optical beam and produces two free-space beams: seed light 440 and LO light 430. In FIG. 10, the free-space optical beam-splitter 470 reflects a first portion of the incident seed-laser output light 472 to produce the LO light 430 and transmits a second portion of the output light 472 to produce the seed light 440. Alternatively, the beam-splitter 470 may be arranged to reflect a portion of the output light 472 to produce the seed light 440 and transmit a portion of the output light 472 to produce the LO light 430. The free-space beam-splitter 470 in FIG. 10 may have a reflectivity of less than or equal to 1%, 2%, 5%, 10%, 20%, 50%, or any other suitable reflectivity value. For example, the splitter 470 may reflect 10% or less of the incident seed-laser output light 472 to produce the LO light 430, and the remaining 90% or more of the output light 472 may be transmitted through the splitter 470 to produce the seed light 440. As another example, if the output light 472 has an average power of 25 mW and the splitter 470 reflects approximately 4% of the output light 472, then the LO light 430 may have an average power of approximately 1 mW, and the seed light 440 may have an average power of approximately 24 mW. As used herein, a splitter 470 may refer to a free-space optical splitter, a fiber-optic splitter, or an optical-waveguide splitter.

In particular embodiments, a light source 110 may include a fiber-optic splitter 470 that splits the seed-laser output light 472 to produce seed light 440 and LO light 430. Instead of using a free-space optical splitter 470 (as illustrated in FIG. 10), a light source 110 may use a fiber-optic splitter 470. The fiber-optic splitter 470 may include one input optical fiber and two or more output optical fibers, and light that is coupled into the input optical fiber may be split between the output optical fibers. The output light 472 may be coupled from the front face 452 of the seed laser diode 450 into the input optical fiber of the fiber-optic splitter 470, and the fiber-optic splitter 470 may split the output light 472 into the seed light 440 and the LO light 430. The output light 472 may be coupled into the input optical fiber using one or more lenses, or the output light 472 may be directly coupled into the input optical fiber (e.g., the input optical fiber may be butt-coupled to the front face 452 of the seed laser diode 450). The seed light 440 may be directed to the SOA 460 by a first output fiber, and the LO light 430 may be directed to a receiver 140 by a second output fiber. The seed light 440 may be coupled from the first output fiber into the waveguide 463 of the SOA 460 by one or more lenses, or the seed light 440 may be directly coupled into waveguide 463 (e.g., the first output fiber may be butt-coupled to the input end 461 of the SOA 460). A fiber-optic splitter 470 may split off less than or equal to 1%, 2%, 5%, 10%, 20%, 50%, or any other suitable amount of the output light 472 to produce the LO light 430, and the remaining light may form the seed light 440. For example, a fiber-optic splitter 470 may split off 10% or less of the output light 472 to produce the LO light 430, which is directed to one output fiber. The remaining 90% or more of the output light 472 may be directed to the other output fiber as the seed light 440.

FIG. 11 illustrates an example light source 110 with a photonic integrated circuit (PIC) 455 that includes an optical-waveguide splitter 470. In particular embodiments, a light source 110 may include an optical splitter 470 and a PIC 455, where the optical splitter 470 is an optical-waveguide splitter of the PIC. A PIC 455 (which may be referred to as a planar lightwave circuit (PLC), an integrated-optic device, an integrated optoelectronic device, or a silicon optical bench) may include one or more optical waveguides or one or more optical-waveguide devices (e.g., optical-waveguide splitter 470) integrated together into a single device. A PIC 455 may include or may be fabricated from a substrate that includes silicon, InP, glass (e.g., silica), a polymer, an electro-optic material (e.g., lithium niobate (LiNbO₃) or lithium tantalate (LiTaO₃)), or any suitable combination thereof. One or more optical waveguides may be formed on or in a PIC substrate using micro-fabrication techniques, such as for example, lithography, deposition, or etching. For example, an optical waveguide may be formed on a glass or silicon substrate by depositing and selectively etching material to form a ridge or channel waveguide on the substrate. As another example, an optical waveguide may be formed by implanting or diffusing a material into a substrate (e.g., by diffusing titanium into a LiNbO₃ substrate) to form a region in the substrate having a higher refractive index than the surrounding substrate material.

In particular embodiments, an optical-waveguide splitter 470 may include an input port and two or more output ports. In FIG. 11, the seed-laser output light 472 from the seed laser diode 450 is coupled into the input optical waveguide (input port) of the waveguide splitter 470, and the waveguide splitter 470 splits the output light 472 between two output waveguides, output port 1 and output port 2. The seed-laser output light 472 may be coupled from the front face 452 of the seed laser diode 450 to the input port of the splitter 470 using one or more lenses, or the seed laser diode 450 may be butt-coupled to the input port so that the output light 472 is directly coupled into the input port. The seed light 440 is formed by the portion of output light 472 that is sent by the splitter 470 to output port 1, and the LO light 430 is formed by the portion of output light 472 that is sent by the splitter 470 to output port 2. The waveguide splitter 470 directs the seed light 440 to output port 1, which is coupled to waveguide 463 of the SOA 460. Additionally, the waveguide splitter 470 directs the LO light 430 to output port 2, which sends the LO light 430 to a receiver 140. An optical-waveguide splitter 470 may split off less than or equal to 1%, 2%, 5%, 10%, 20%, 50%, or any other suitable amount of the output light 472 to produce the LO light 430, and the remaining light may form the seed light 440. For example, the optical-waveguide splitter 470 may send 10% or less of the output light 472 to output port 2 to produce the LO light 430, and the remaining 90% or more of the output light 472 may be sent to output port 1 to produce the seed light 440.

In particular embodiments, a light source 110 may include one or more discrete optical devices combined with a PIC 455. The discrete optical devices (which may include a seed laser diode 450, a SOA 460, one or more lenses, or one or more optical fibers) may be configured to couple light into the PIC 455 or to receive light emitted from the PIC 455. In the example of FIG. 11, the light source 110 includes a PIC 455, a seed laser diode 450, and a SOA 460. The seed laser diode 450 and the SOA 460 may each be attached or bonded to the PIC 455, or the seed laser diode 450, the SOA 460, and the PIC 455 may be attached to a common substrate. For example, the front face 452 of the seed laser diode 450 may be bonded to the input port of the PIC 455 so that the seed-laser output light 472 is directly coupled into the input port. As another example, the input end 461 of the SOA 460 may be bonded to the output port 1 of the PIC 455 so that the seed light 440 is directly coupled into the waveguide 463 of the SOA 460. As another example, the light source 110 may include a lens (not illustrated in FIG. 11) attached to or positioned near output port 2, and the lens may collect and collimate the LO light 430. As another example, the light source 110 may include an optical fiber (not illustrated in FIG. 11) attached to or positioned near output port 2, and the LO light 430 may be coupled into the optical fiber, which directs the LO light 430 to a receiver 140.

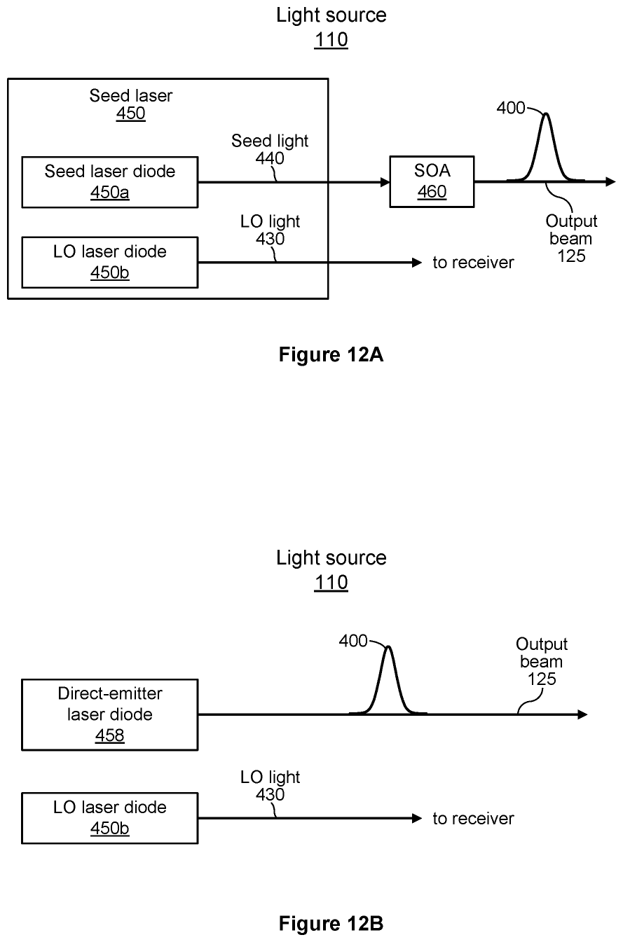

FIG. 12A illustrates an example light source 110 with a seed laser 450 that includes a seed laser diode 450a and a local-oscillator (LO) laser diode 450b. In particular embodiments, a seed laser 450 of a light source 110 may include a seed laser diode 450a that produces seed light 440 and an LO laser diode 450b that produces LO light 430. Instead of having a single laser diode that produces both the seed light 440 and the LO light 430 (e.g., as illustrated in FIGS. 7-8 and 10-11), a seed laser 450 may include two laser diodes: one to produce the seed light 440 and the other to produce the LO light 430. A light source 110 that includes a seed laser 450 with two laser diodes may not include an optical splitter 470. Rather, the seed light 440 produced by the seed laser diode 450a may be coupled to a SOA 460, and the LO light 430 produced by the LO laser diode 450b may be sent to a receiver 140. For example, the seed laser diode 450a may be integrated with the SOA 460. The LO light 430 from the LO laser diode 450b may be coupled into an optical fiber or optical waveguide, which may direct the LO light 430 to a receiver 140.

The LO light 430 produced by the LO laser diode 450b in FIG. 12A may have a substantially constant optical power or a substantially constant optical frequency. For example, the optical frequency of the LO light 430 may vary by less than 0.1%, 0.01%, 0.001%, 0.0001%, 0.00001%, 0.000001% over a particular time interval (e.g., a time interval of approximately 1 s, 10 s, 100 s, 10 minutes, 1 hour, or 1 day). The seed light 440 produced by the seed laser diode 450a may have a fixed frequency offset with respect to the substantially constant optical frequency of the LO light 430, or the seed laser diode 450a may produce seed light having two or more different frequency offsets with respect to the LO light.

In particular embodiments, a seed laser diode 450a or an LO laser diode 450b may be frequency locked so that they each emit light having a substantially fixed wavelength or so that there is a substantially fixed frequency offset between the seed light 440 and the LO light 430. Frequency locking a laser diode may include locking the wavelength of the light emitted by the laser diode to a stable frequency reference using, for example, an external optical cavity, an atomic optical absorption line, or light injected into the laser diode. For example, the seed laser diode 450a may be frequency locked (e.g., using an external optical cavity), and some of the light from the seed laser diode 450a may be injected into the LO laser diode 450b to frequency lock the LO laser diode 450 to approximately the same wavelength as the seed laser diode 450a. As another example, the seed laser diode 450a and the LO laser diode 450b may each be separately frequency locked so that the two laser diodes have a particular frequency offset (e.g., a frequency offset of approximately 2 GHZ).

In particular embodiments, a seed laser diode 450a and an LO laser diode 450b may be operated so that the seed light 440 and the LO light 430 have a particular frequency offset of one or more different frequency offsets. For example, the seed light 440 and the LO light 430 may have an optical frequency offset of approximately 10 MHZ, 100 MHZ, 1 GHZ, 2 GHZ, 5 GHZ, 10 GHz, 20 GHz, or any other suitable frequency offset. A seed laser diode 450a and an LO laser diode 450b may have a single, fixed frequency offset. For example, the seed laser diode 450a in FIG. 12A may be a fixed-frequency laser diode configured to produce seed light 440 at one particular optical frequency with a fixed frequency offset (e.g., +5 GHZ) with respect to the LO light, and each of the emitted pulses of light 400 may have a corresponding fixed frequency offset with respect to the LO light. Alternatively, a seed laser diode 450a may be a frequency-tunable seed laser diode (e.g., an SG-DBR laser as illustrated in FIG. 9). For example, the seed laser diode 450a in FIG. 12A may be a frequency-tunable laser diode that produces seed light 440 at two or more different optical frequencies, and the LO laser diode 450b may produce LO light 430 having a substantially constant optical frequency. A frequency-tunable seed laser diode 450a may produce temporal portions of seed light, each temporal portion having a particular optical frequency of two or more different optical frequencies, and each temporal portion may be amplified to produce a pulse of light 400 having a corresponding optical frequency. Each of the emitted pulses of light 400 produced by the light source in FIG. 12A may have an optical frequency that is offset from the optical frequency of the LO light 430 by a particular frequency offset of two or more different frequency offsets. The different frequency offsets may include 2, 3, 4, 5, 10, 20, 50, or any other suitable number of different frequency offsets. For example, the seed laser diode 450a may produce temporal portions of seed light at four different optical frequencies (e.g., 194.003 THz, 194.005 THz, 194.007 THz, and 194.009 THz), and each emitted pulse of light may have an optical frequency approximately equal to one of the four different optical frequencies. The LO light 430 may have an optical frequency of 194 THz, which corresponds to each emitted pulse of light 400 having a frequency offset of approximately 3 GHZ, 5 GHZ, 7 GHZ, or 9 GHZ.

The seed laser 450 in FIG. 12A includes one seed laser diode 450a and one LO laser diode 450b. In other embodiments, a seed laser 450 may include two or more seed laser diodes, each seed laser diode configured to produce seed light at one particular optical frequency of two or more different optical frequencies. Each of the seed laser diodes may be a fixed-frequency laser diode configured to operate solely at one of the different optical frequencies, and each of the different optical frequencies of seed light produced by the seed laser diodes may have a fixed frequency offset with respect to the LO light 430. For example, a seed laser 450 may include four seed laser diodes configured to produce seed light at four different respective optical frequencies (e.g., 194.003 THz, 194.005 THz, 194.007 THz, and 194.009 THz). The LO light 430 may have an optical frequency of 194 THz, which corresponds to the four seed laser diodes having respective frequency offsets of 3 GHZ, 5 GHZ, 7 GHZ, and 9 GHz. The seed light produced by the multiple seed laser diodes may be combined and sent to an optical amplifier, or the seed light produced by each seed laser diode may be separately amplified by a corresponding optical amplifier. A fixed-frequency laser diode may include any suitable laser diode configured to operate at one particular optical frequency without switching to different frequencies during operation. For example, the SG-DBR laser 450 in FIG. 9 may operate as a fixed-frequency laser diode by supplying a substantially constant set of electrical currents to the back mirror 482, phase section 484, and front mirror 488. As another example, a DFB laser may operate as a fixed-frequency laser diode by operating the device at a substantially constant temperature.

FIG. 12B illustrates an example light source 110 that includes a direct-emitter laser diode 458 and a local-oscillator (LO) laser diode 450b. In particular embodiments, a light source 110 may include a direct-emitter laser diode 458 that produces emitted pulses of light 400. Additionally, the light source 110 may include a LO laser diode 450b that produces LO light 430. The light source 110 may include an electronic driver 480 that supplies pulses of electrical current to the direct-emitter laser diode 458, where each pulse of current causes the laser diode 458 to produce a corresponding emitted pulse of light 400. The light source 110 in FIG. 12B does not include an optical amplifier. The pulse of light 400 is emitted by the direct-emitter laser diode 458 without being further amplified by a subsequent optical amplification stage located after the laser diode 458. A direct-emitter laser diode 458 may be a fixed-frequency laser diode that produces pulses of light 400 having a particular fixed frequency offset with respect to LO light 430. Alternatively, a direct-emitter laser diode 458 may be a frequency-tunable laser diode that produces pulses of light 400 at two or more different optical frequencies.

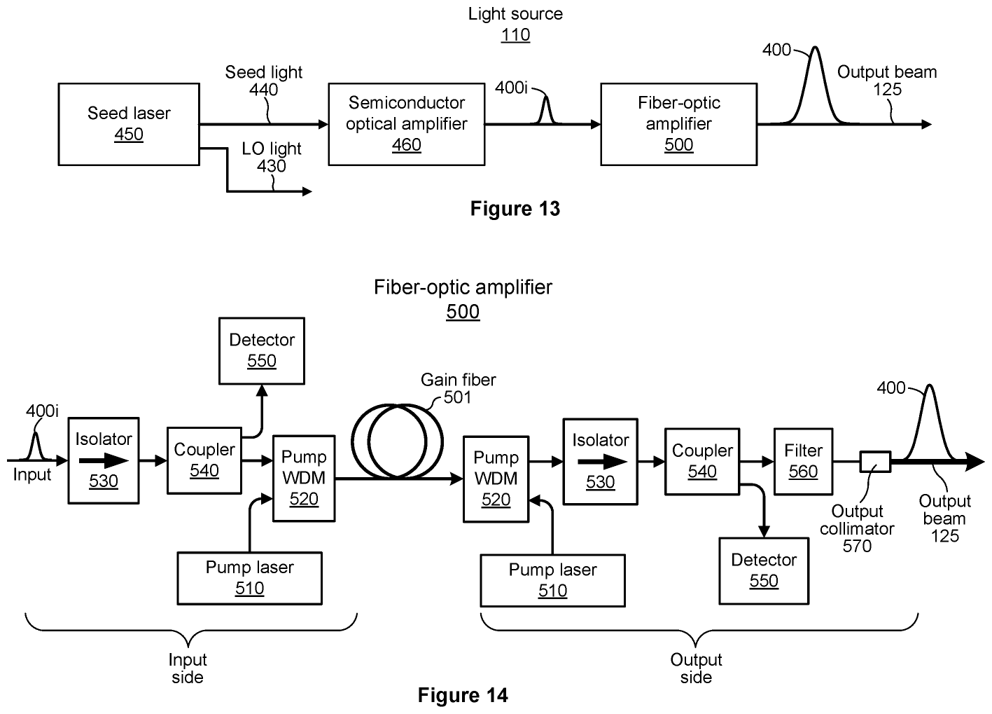

FIG. 13 illustrates an example light source 110 that includes a seed laser 450, a semiconductor optical amplifier (SOA) 460, and a fiber-optic amplifier 500. In particular embodiments, in addition to a seed laser 450 and a SOA 460, a light source 110 may also include a fiber-optic amplifier 500 that amplifies pulses of light 400i produced by the SOA 460. In FIG. 13, the SOA 460 may amplify temporal portions of seed light 440 from the seed laser 450 to produce intermediate pulses of light 400i, and the fiber-optic amplifier 500 may amplify the intermediate pulses of light 400i from the SOA 460 to produce emitted pulses of light 400. The emitted pulses of light 400 may be part of a free-space output beam 125 that is sent to a scanner 120 and scanned across a field of regard of a lidar system 100.

A SOA 460 and a fiber-optic amplifier 500 may each have an optical power gain of 10 dB, 15 dB, 20 dB, 25 dB, 30 dB, 35 dB, 40 dB, or any other suitable optical power gain. In the example of FIG. 13, the SOA 460 may have a gain of 30 dB, and the fiber-optic amplifier 500 may have a gain of 20 dB, which corresponds to an overall gain of 50 dB. A temporal portion of seed light 440 with an energy of 5 pJ may be amplified by the SOA 460 (with a gain of 30 dB) to produce an intermediate pulse of light 400i with an energy of approximately 5 nJ. The fiber-optic amplifier 500 may amplify the 5-nJ pulse of light 400i by 20 dB to produce an output pulse of light 400 with an energy of approximately 0.5 μJ. The seed laser 450 in FIG. 13 produces seed light 440 and LO light 430. The seed light 440 may be emitted from a front face 452 of a seed laser diode 450, and the LO light 430 may be emitted from a back face 451 of the seed laser diode 450. Alternatively, the light source 110 may include a splitter 470 that splits seed-laser output light 472 to produce the seed light 440 and the LO light 430, or the seed laser 450 may include one or more seed laser diodes and an LO laser diode (e.g., as illustrated in FIG. 12A).

FIG. 14 illustrates an example fiber-optic amplifier 500. In particular embodiments, a light source 110 of a coherent pulsed lidar system 100 may include a fiber-optic amplifier 500 that amplifies pulses of light 400i produced by a SOA 460 to produce an output beam 125 with pulses of light 400. A fiber-optic amplifier 500 may be terminated by a lens (e.g., output collimator 570) that produces a collimated free-space output beam 125 which may be directed to a scanner 120. In particular embodiments, a fiber-optic amplifier 500 may include one or more pump lasers 510, one or more pump WDMs 520, one or more optical gain fibers 501, one or more optical isolators 530, one or more couplers 540, one or more detectors 550, one or more optical filters 560, or one or more output collimators 570.

A fiber-optic amplifier 500 may include an optical gain fiber 501 that is optically pumped (e.g., provided with energy) by one or more pump lasers 510. The optically pumped gain fiber 501 may provide optical gain to each input pulse of light 400i while the pulse propagates through the gain fiber 501. The pump-laser light may travel through the gain fiber 501 in the same direction (co-propagating) as the pulse of light 400i or in the opposite direction (counter-propagating). The fiber-optic amplifier 500 in FIG. 14 includes one co-propagating pump laser 510 on the input side of the amplifier 500 and one counter-propagating pump laser 510 on the output side. A pump laser 510 may produce light at any suitable wavelength to provide optical excitation to the gain material of gain fiber 501 (e.g., a wavelength of approximately 808 nm, 810 nm, 915 m, 940 nm, 960 nm, 976 nm, or 980 nm). A pump laser 510 may be operated as a CW light source and may produce any suitable amount of average optical pump power, such as for example, approximately 1 W. 2 W, 5 W, 10 W, or 20 W of pump power. The pump-laser light from a pump laser 510 may be coupled into gain fiber 501 via a pump wavelength-division multiplexer (WDM) 520. A pump WDM 520 may be used to combine or separate pump light and the pulses of light 400i that are amplified by the gain fiber 501.

The fiber-optic core of a gain fiber 501 may be doped with a gain material that absorbs pump-laser light and provides optical gain to pulses of light 400i as they propagate along the gain fiber 501. The gain material may include rare-earth ions, such as for example, erbium (Er³⁺), ytterbium (Yb³⁺), neodymium (Nd³⁺), prascodymium (Pr³⁺), holmium (Ho³⁺), thulium (Tm³⁺), dysprosium (Dy³⁺), or any other suitable rare-earth element, or any suitable combination thereof. For example, the gain fiber 501 may include a core doped with erbium ions or with a combination of erbium and ytterbium ions. The rare-earth dopants absorb pump-laser light and are “pumped” or promoted into excited states that provide amplification to the pulses of light 400i through stimulated emission of photons. The rare-earth ions in excited states may also emit photons through spontaneous emission, resulting in the production of amplified spontaneous emission (ASE) light by the gain fiber 501.

A gain fiber 501 may include a single-clad or multi-clad optical fiber with a core diameter of approximately 6 μm, 7 μm. 8 μm, 9 μm, 10 μm, 12 μm, 20 μm, 25 μm, or any other suitable core diameter. A single-clad gain fiber 501 may include a core surrounded by a cladding material, and the pump light and the pulses of light 400i may both propagate substantially within the core of the gain fiber 501. A multi-clad gain fiber 501 may include a core, an inner cladding surrounding the core, and one or more additional cladding layers surrounding the inner cladding. The pulses of light 400i may propagate substantially within the core, while the pump light may propagate substantially within the inner cladding and the core. The length of gain fiber 501 in an amplifier 500 may be approximately 0.5 m, 1 m, 2 m, 4 m, 6 m, 10 m, 20 m, or any other suitable gain-fiber length.

A fiber-optic amplifier 500 may include one or more optical filters 560 located at the input or output side of the amplifier 500. An optical filter 560 (which may include an absorptive filter, dichroic filter, long-pass filter, short-pass filter, band-pass filter, notch filter, or fiber Bragg grating) may transmit light over a particular optical pass-band and substantially block light outside of the pass-band. The optical filter 560 in FIG. 14 is located at the output side of the amplifier 500 and may reduce the amount of ASE from the gain fiber 501 that accompanies the output pulses of light 400. For example, the filter 560 may transmit light at the wavelength of the pulses of light 400 (e.g., 1550 nm) and may attenuate light at wavelengths away from a 5-nm pass-band centered at 1550 nm.

A fiber-optic amplifier 500 may include one or more optical isolators 530. An isolator 530 may reduce or attenuate backward-propagating light, which may destabilize or cause damage to a seed laser diode 450, SOA 460, pump laser 510, or gain fiber 501. The isolators 530 in FIG. 14 may allow light to pass in the direction of the arrow drawn in the isolator and block light propagating in the reverse direction. Backward-propagating light may arise from ASE light from gain fiber 501, counter-propagating pump light from a pump laser 510, or optical reflections from one or more optical interfaces of a fiber-optic amplifier 500. An optical isolator 530 may prevent the destabilization or damage associated with backward-propagating light by blocking most of the backward-propagating light (e.g., by attenuating backward-propagating light by greater than or equal to 5 dB. 10 dB, 20 dB, 30 dB, 40 dB, 50 dB, or any other suitable attenuation value).

A fiber-optic amplifier 500 may include one or more couplers 540 and one or more detectors 550. A coupler 540 may split off a portion of light (e.g., approximately 0.1%, 0.5%, 1%, 2%, or 5% of light received by the coupler 540) and direct the split-off portion to a detector 550. In FIG. 14, each coupler 540 may split off and send approximately 1% of each pulse of light (400i or 400) to a detector 550. One or more detectors 550 may be used to monitor the performance or health of a fiber-optic amplifier 500. If an electrical signal from a detector 550 drops below a particular threshold level, then a controller 150 may determine that there is a problem with the amplifier 500 (e.g., there may be insufficient optical power in the input pulses of light 400i or a pump laser 510 may be failing). In response to determining that there is a problem with the amplifier 500, the controller 150 may shut down or disable the amplifier 500, shut down or disable the lidar system 100, or send a notification that the lidar system 100 is in need of service or repair.

In particular embodiments, a fiber-optic amplifier 500 may include an input optical fiber configured to receive input pulses of light 400i from a SOA 460. The input optical fiber may be part of or may be coupled or spliced to one of the components of the fiber-optic amplifier 500. For example, pulses of light 400i may be coupled into an optical fiber which is spliced to an input optical fiber of the isolator 530 located at the input to the amplifier 500. As another example, the pulses of light 400i from a SOA 460 may be part of a free-space beam that is coupled into an input optical fiber of fiber-optical amplifier 500 using one or more lenses. As another example, an input optical fiber of fiber-optic amplifier 500 may be positioned at or near the output end 462 of a SOA 460 so that the pulses of light 400i are directly coupled from the SOA 460 into the input optical fiber.

In particular embodiments, the optical components of a fiber-optic amplifier 500 may be free-space components, fiber-coupled components, or a combination of free-space and fiber-coupled components. As an example, each optical component in FIG. 14 may be a free-space optical component or a fiber-coupled optical component. As another example, the input pulses of light 400i may be part of a free-space optical beam, and the isolator 530, coupler 540, and pump WDM 520 located on the input side of the amplifier 500 may each be free-space optical components. Additionally, the light from the pump laser 510 on the input side may be a free-space beam that is combined with the input pulses of light 400i by the pump WDM 520 on the input side, and the combined pump-seed light may form a free-space beam that is coupled into the gain fiber 501 via one or more lenses.

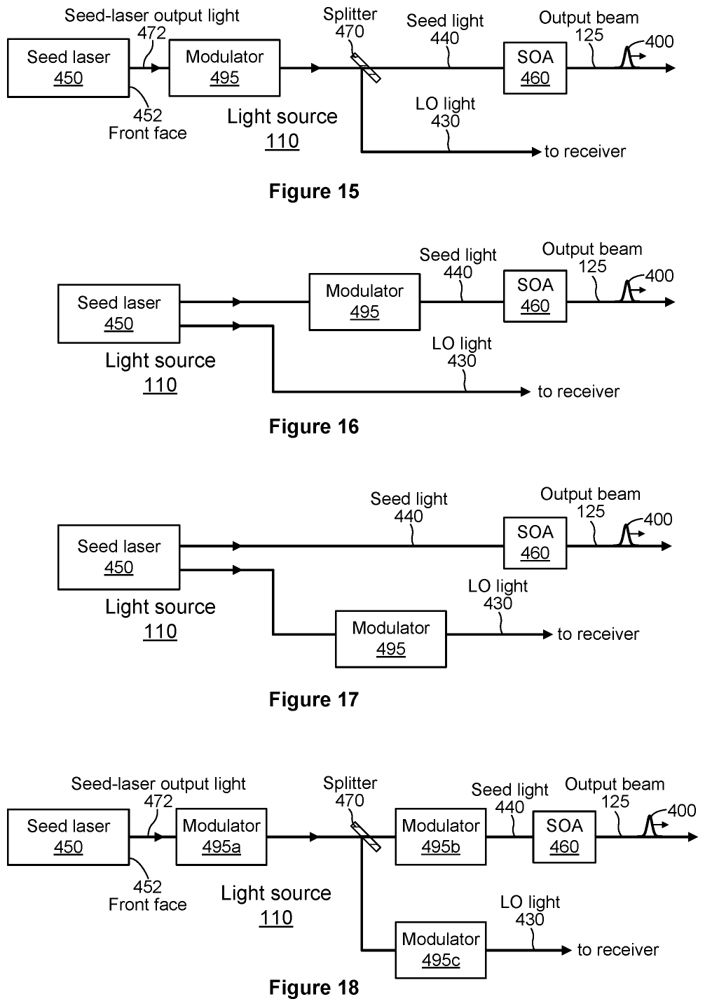

FIGS. 15-18 each illustrate an example light source 110 that includes a seed laser 450, a semiconductor optical amplifier (SOA) 460, and one or more optical modulators 495. In particular embodiments, a light source 110 may include an optical phase or amplitude modulator 495 configured to change a frequency, phase, or amplitude of seed light 440, LO light 430, or emitted pulse of light 400. For example, a light source 110 may include an optical modulator that shifts a frequency of the seed light 440 or the LO light 430 so that the seed light and the LO light are offset by a particular frequency offset of one or more different frequency offsets. An optical phase or amplitude modulator 495 may include an electro-optic modulator (EOM), an acousto-optic modulator (AOM), an electro-absorption modulator, a liquid-crystal modulator, or any other suitable type of optical phase or amplitude modulator. For example, an optical modulator 495 may include an electro-optic phase modulator or an AOM that changes the frequency or phase of seed light 440 or LO light 430. As another example, an optical modulator 495 may include an electro-optic amplitude modulator, an electro-absorption modulator, or a liquid-crystal modulator that changes the amplitude of the seed light 440 or LO light 430. An optical modulator 495 may be a free-space modulator, a fiber-optic modulator (e.g., with fiber-optic input or output ports), or an integrated-optic modulator (e.g., a waveguide-based modulator integrated into a PIC).

In particular embodiments, an optical modulator 495 may be included in a seed laser diode 450 or a SOA 460. For example, a seed laser diode 450 may include a waveguide section to which an external electrical current or electric field may be applied to change the carrier density or refractive index of the waveguide section, resulting in a change in the frequency or phase of seed light 440 or LO light 430. As another example, the frequency, phase, or amplitude of seed light 440 or LO light 430 may be changed by changing or modulating the seed current I₁ or the SOA current I₂. In this case, the seed laser diode 450 or SOA 460 may not include a separate or discrete modulator, but rather, a modulation function may be distributed within the seed laser diode 450 or SOA 460. For example, the optical frequency of the seed light 440 or LO light 430 may be changed by changing the seed current I₁. Changing the seed current I₁ may cause a refractive-index change in the seed laser diode 450, which may result in a change in the optical frequency of light produced by the seed laser diode 450.

In FIG. 15, the light source 110 includes a modulator 495 located between the seed laser 450 and the optical splitter 470. The seed-laser output light 472 passes through the modulator 495 and is then split by the splitter 470 to produce the seed light 440 and LO light 430. The modulator 495 in FIG. 15 may be configured to change a frequency, phase, or amplitude of the seed-laser output light 472. For example, the modulator 495 may be a phase modulator that applies a time-varying phase shift to the seed-laser output light 472, which may result in a frequency change of the seed-laser output light 472. The modulator 495 may be driven in synch with the emitted pulses of light 400 so that the emitted pulses of light 400 and the LO light 430 each have a different frequency change imparted by the modulator 495.

In FIG. 16, the light source 110 includes a modulator 495 located between the seed laser 450 and the SOA 460. The modulator 495 in FIG. 16 may be configured to change a frequency, phase, or amplitude of the seed light 440. For example, since the LO light 430 does not pass through the modulator 495, the modulator 495 may change the optical frequency of the seed light 440 so that it is offset from the optical frequency of the LO light 430. In FIG. 17, the light source 110 includes a modulator 495 located in the path of the LO light 430. The modulator 495 in FIG. 17 may be configured to change a frequency, phase, or amplitude of the LO light 430. For example, since the seed light 440 does not pass through the modulator 495, the modulator 495 may change the optical frequency of the LO light 430 so that it is offset from the optical frequency of the seed light 440. In FIG. 16 or 17, the seed light 440 and LO light 430 may be produced by an optical splitter 470 that splits seed-laser output light 472 to produce the seed light 440 and the LO light 430. Alternatively, in FIG. 16 or 17, the seed light 440 may be emitted from a front face 452 of a seed laser diode, and the LO light 430 may be emitted from the back face 451 of the seed laser diode. Alternatively, in FIG. 16 or 17, the seed laser 450 may include one or more seed laser diodes that produce seed light 440 and an LO laser diode that produces LO light 430 (e.g., as illustrated in FIG. 12A).

In FIG. 18, the light source 110 includes three optical modulators 495a, 495b, and 495c. In particular embodiments, a light source 110 may include one, two, three, or any other suitable number of modulators 495. Each of the modulators 495a, 495b, and 495c may be configured to change a frequency, phase, or amplitude of the seed-laser output light 472, seed light 440, or LO light 430. For example, modulator 495b may be an amplitude modulator that modulates the amplitude of the seed light 440 before passing through the SOA 460. As another example, modulator 495b may be a phase modulator that changes the frequency of the seed light 440. As another example, modulator 495c may be a phase modulator that changes the frequency of the LO light 430.

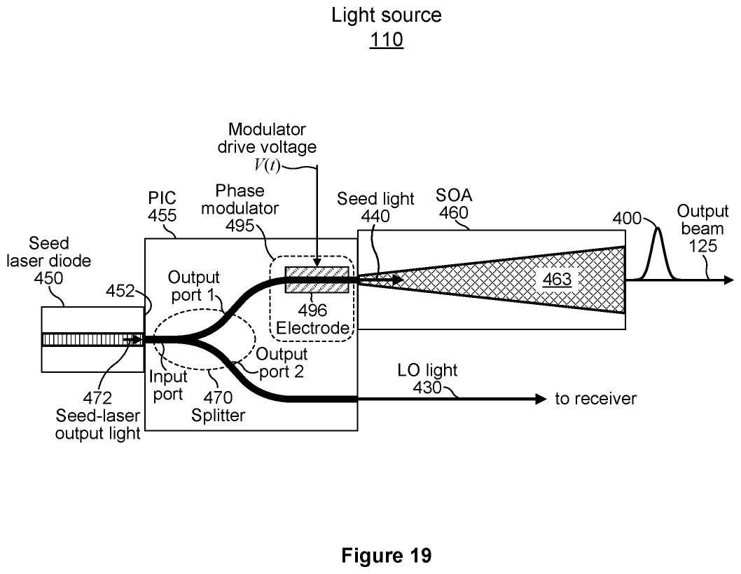

FIG. 19 illustrates an example light source 110 with a photonic integrated circuit (PIC) 455 that includes a phase modulator 495. The arrangement in FIG. 19 corresponds to that in FIG. 16 where a modulator 495 located between seed laser 450 and SOA 460 applies a modulation to the seed light 440. A phase modulator 495 may be used to change the optical frequency of light that travels through the modulator. For example, a light source 110 may include a phase modulator 495 that changes the optical frequency of seed-laser output light 472, seed light 440, LO light 430, or emitted pulses of light 400. A phase modulator 495 may include an electrode 496 to which a modulator drive voltage V(t) may be applied. The section of PIC waveguide located near the electrode 496 may include an electro-optic material (e.g., lithium niobate) or a semiconductor material (e.g., silicon or InP) that exhibits a change in refractive index when an electric field is applied to the material. The electric field from an applied voltage signal may cause a refractive-index change in the waveguide section near the electrode 496, and the refractive-index change may impart a corresponding phase shift to light propagating through the phase modulator 495. If a time-varying modulator drive-voltage signal V(t) is applied, the corresponding time-varying phase shift imparted to the light propagating through the phase modulator 495 may result in a frequency change of the light.

The phase modulator 495 illustrated in FIG. 19 may be configured to change the optical frequency of the seed light 440 that travels through the modulator. In FIG. 19, the optical frequency f₀ of the seed light 440 that propagates through the phase modulator 495 may be changed by applying one or more particular time-varying voltage signals to the electrode 496. For example, applying a sinusoidal voltage signal V(t) with frequency Δf (e.g., V(t)=V₀ sin(2π·Δf·t)) to the electrode 496 may cause a corresponding sinusoidal refractive-index variation that results in the generation of frequency sidebands of the seed light 440 at frequencies f₀±nΔf, where n is a positive integer. Other voltage signals (e.g., linear voltage ramp, square wave, sawtooth wave, or triangle wave) applied to the electrode 496 may result in other frequency changes. For example, a linear voltage ramp may produce a shift of Δf in the frequency of the seed light 440 to an optical frequency f₀+Δf or f₀−Δf. The PIC 455 in FIG. 19 includes an optical splitter 470 that splits the seed-laser output light 472 to produce the seed light 440 and the LO light 430. In other embodiments, the seed light 440 may be coupled from the seed laser diode 450 to the SOA 460 without traveling through an optical splitter. For example, the LO light 430 may be emitted from the back face of the seed laser diode 450, or another laser diode may be used to produce the LO light. The seed light 440 produced by the seed laser diode 450 may travel to the phase modulator 495 via an optical waveguide of the PIC 455 and then into the waveguide 463 of the SOA 460 without traveling through an optical splitter.

In particular embodiments, a light source 110 may include an optical phase modulator 495 that changes an optical frequency of seed light 440 or LO light 430 by Δf so that the seed light 440 and the LO light 430 have a frequency offset of Δf. The frequency offset Δf may be a particular frequency offset of one or more different frequency offsets, where the one or more different frequency offsets are between approximately 10 MHz and approximately 50 GHz. A light source 110 may include a phase modulator 495 that shifts the frequency of seed light 440 or a phase modulator 495 that shifts the frequency of LO light 430. For example, a light source 110 may include a phase modulator 495 that shifts the frequency of LO light 430 by 1 GHz so that the seed light 440 and the LO light 430 have a 1-GHz frequency offset. In FIG. 19, the seed-laser output light 472 is split by the splitter 470 to produce the seed light 440 (which is sent to output port 1) and the LO light 430 (which is sent to output port 2). The seed-laser output light 472 and the LO light 430 may each have an optical frequency of f₀. A temporal portion of the seed light 440 may pass through the phase modulator 495, and the phase modulator 495 may shift the optical frequency of the temporal portion by Δf to a frequency f₁, where f₁=f₀+Δf. The emitted pulse of light 400 may have a corresponding frequency offset of approximately Δf with respect to the LO light 430. The offset frequency Δf may be a particular frequency offset of one or more different frequency offsets applied to temporal portions of seed light 440 by the phase modulator 495, and each emitted pulse of light 400 may have a corresponding frequency offset. In FIG. 19, the phase modulator 495 may be driven in synch with current pulses that are supplied to the SOA 460 so that a particular frequency change is applied to each of the emitted pulses of light 400. During time periods between successive emitted pulses of light 400 when the seed light 440 may be substantially absorbed by the SOA 460, the phase modulator 495 may be inactive or may not be driven with a particular voltage signal, and a frequency change may not be applied to the seed light 440.

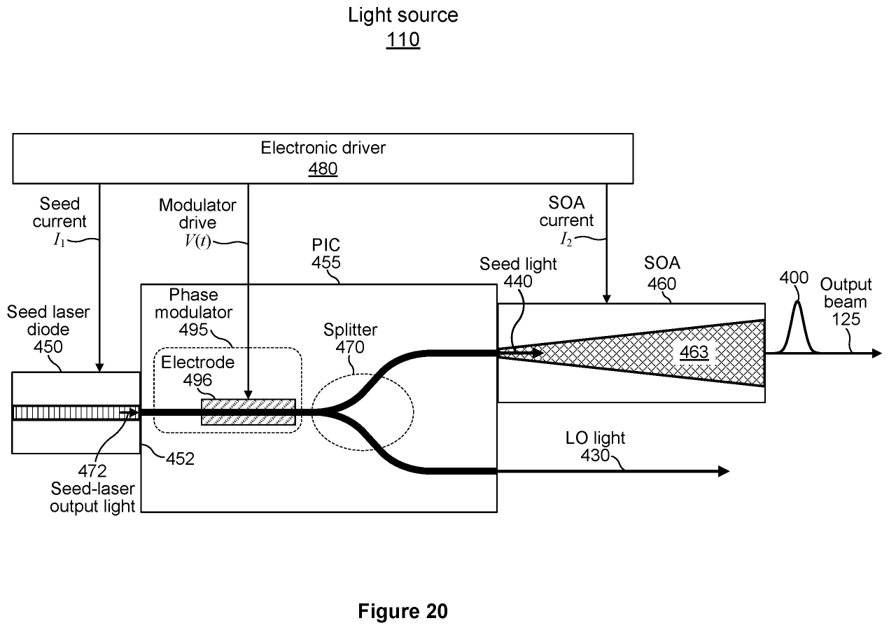

FIG. 20 illustrates an example light source 110 with a photonic integrated circuit (PIC) 455 that includes a phase modulator 495 located before an optical splitter 470. In particular embodiments, a light source 110 may include a modulator 495 that modulates seed-laser output light 472 prior to the output light 472 being split to produce seed light 440 and LO light 430. The arrangement in FIG. 20 corresponds to that in FIG. 15 where a modulator 495 is located between the seed laser 450 and the optical splitter 470. The seed-laser output light 472 emitted from the front face 452 of seed laser diode 450 is directed to a phase modulator 495. The modulator 495 may be driven with a time-varying drive voltage V(t) supplied to the electrode 496 to change the optical frequency of the seed-laser output light 472. After passing through the phase modulator 495, the seed-laser output light 472 is split by the splitter 470 to produce the seed light 440 and LO light 430.

In particular embodiments, a phase modulator 495 may be operated so that different frequency changes are applied to different portions of the seed-laser output light 472. For example, a phase modulator 495 may (i) apply a first frequency change to portions of the seed-laser output light 472 corresponding to temporal portions of seed light 440 that are amplified by the SOA 460 and (ii) apply a second frequency change (different from the first frequency change) to other portions of the seed-laser output light 472. The emitted pulses of light 400 may include the first frequency change, and the LO light 430 located between the emitted pulses of light 400 may include the second frequency change. The first and second frequency changes may each be any suitable frequency offset between approximately 0 MHz and approximately 50 GHZ. For example, the first frequency change applied to an emitted pulse of light 400 may be 5 GHZ, and no frequency change may be applied by the phase modulator 495 to portions of LO light 430 located between emitted pulses of light (e.g., the second frequency change may be approximately 0 Hz). In particular embodiments, a phase modulator 495 may be driven in synch with SOA current pulses (I₂) supplied to the SOA 460 so that a particular frequency change is applied to each of the emitted pulses of light 400. During the time period between successive emitted pulses of light 400, the phase modulator 495 may be inactive (e.g., the drive voltage may be set to zero volts) so that little or no frequency change is applied to the LO light 430. In the example of FIG. 20, the phase modulator 495 may be activated when a pulse of light 400 is emitted to apply a frequency change to the emitted pulse of light 400, and at other times, the phase modulator 495 may be inactive so that no frequency change is applied to the LO light 430. A received pulse of light 410 may be coherently mixed with the LO light 430 to produce a photocurrent signal that includes an AM photocurrent signal with a frequency component corresponding to the frequency difference between the received pulse of light and the LO light 430.

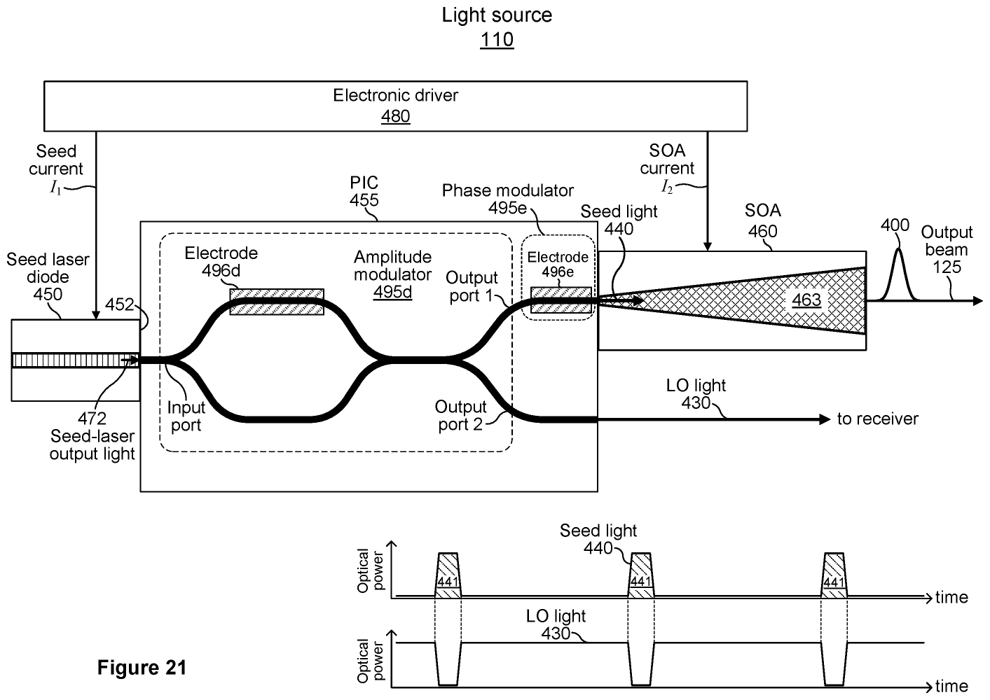

FIG. 21 illustrates an example light source 110 with a photonic integrated circuit (PIC) 455 that includes an amplitude modulator 495d and a phase modulator 495c. In particular embodiments, a light source 110 may include an amplitude modulator 495d with: (i) an input port that receives seed-laser output light 472 from a seed laser diode 450, (ii) a first output port coupled to a SOA 460, and (iii) a second output port coupled to a receiver 140. The integrated-optic amplitude modulator 495d illustrated in FIG. 21 (which may be referred to as a switch or an optical switch) includes a Mach-Zehnder interferometer with an electrode 496d disposed on one path of the interferometer. By applying different voltages to the electrode 496d, the seed-laser output light 472 received at the input port may be switched between the two output ports. The seed light 440 includes the portion of output light 472 directed by the amplitude modulator 495d to output port 1, and the LO light 430 includes the portion of output light 472 that is directed to output port 2. For example, a first voltage applied to electrode 496d may cause the amplitude modulator 495d to direct substantially all of the output light 472 to output port 1. This portion of the output light 472 forms the seed light 440 which is sent through phase modulator 495c and then to SOA 460. A second voltage, different from the first voltage, applied to electrode 496d may cause the amplitude modulator 495d to direct substantially all of the output light 472 to output port 2, and this portion of the output light 472 forms the LO light 430 which may be sent to a receiver 140.

The seed laser diode 450 may be provided with a substantially constant seed current I₁ so that the power of the seed-laser output light 472 is substantially constant. A time-varying voltage signal may be supplied to the amplitude modulator 495d to switch the seed-laser output light 472 between output port 1 and output port 2. For example, a voltage signal applied to electrode 496d may alternate between the first and second voltages so that the output light 472 is switched between output ports 1 and 2, respectively. Switching the output light 472 alternately between the two output ports may result in the seed light 440 and the LO light 430 being time-interleaved so that when the seed light 440 is maximized, the LO light 430 is minimized, and vice versa, as illustrated by the two graphs in FIG. 21. Pulses of voltage may be applied to the electrode 496d to direct corresponding pulses of the output light 472 to output port 1. Each pulse of output light 472 corresponds to a temporal portion 441 of the seed light 440 that is amplified by the SOA 460 to produce an emitted pulse of light 400. The portions of the output light 472 located between the pulses of voltage may be directed to output port 2 as the LO light 430. The amplitude modulator 495d may be driven in synch with SOA current pulses (I₂) supplied to the SOA 460 so that each portion of output light 472 directed to output port 1 is amplified by the SOA 460 to produce an emitted pulse of light 400.

The example PIC 455 in FIG. 21 includes a phase modulator 495e which may be similar to the phase modulator 495 illustrated in FIG. 19. A particular voltage signal V(t) applied to the electrode 496e may produce a frequency change in each temporal portion 441 of the seed light 440, which results in a corresponding frequency change in each of the emitted pulses of light 400. The drive voltages supplied to each of the modulators 495d and 495e may be in synch with the SOA current pulses supplied to the SOA 460 so that a frequency change is imparted to each temporal portion 441 which is then amplified by the SOA 460. A received pulse of light 410 may be coherently mixed with the LO light 430 to produce a photocurrent signal that includes an AM photocurrent signal with a frequency component corresponding to the frequency difference between the received pulse of light and the LO light 430.

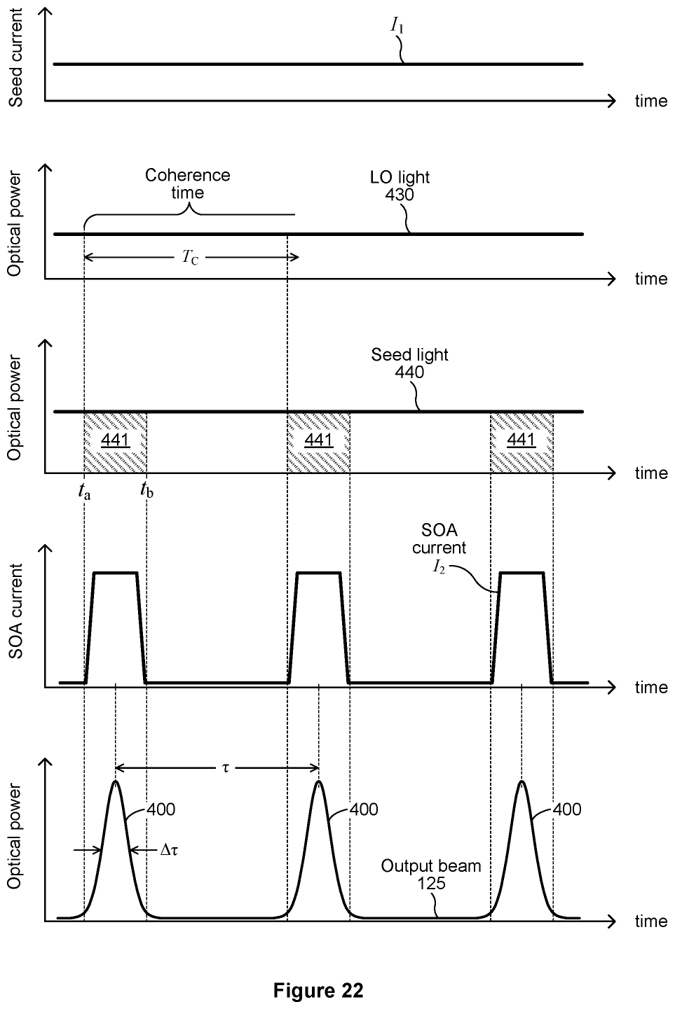

FIG. 22 illustrates example graphs of seed current (I₁), LO light 430, seed light 440, SOA current (I₂), and an output beam 125 that includes emitted optical pulses 400. Each of the parameters (I₁, LO light 430, seed light 440, 12, and emitted optical pulses 400) in FIG. 22 is plotted versus time. The graph of seed current I₁ corresponds to a substantially constant DC electrical current that is supplied to a seed laser diode 450. Based on the DC electrical current I₁, the seed light 440 produced by the seed laser diode 450 may include CW light or light having a substantially constant optical power, as represented by the graph of seed light 440 in FIG. 22. Additionally, the LO light 430 (which may be produced by the same seed laser diode 450 or by an LO laser diode 450b) may also include CW light or light having a substantially constant optical power. For example, the LO light 430 may have a substantially constant average optical power of approximately 1 μW, 10 μW, 100 μW. 1 mW. 10 mW, 20 mW, 50 mW, or any other suitable average optical power. As another example, the seed light 440 may have a substantially constant average optical power of approximately 1 mW. 10 mW, 20 mW, 50 mW, 100 mW, 200 mW or any other suitable average optical power. As another example, the LO light 430 may have a substantially constant optical power of approximately 10 μW, and the seed light 440 may have a substantially constant optical power of approximately 100 mW. The LO light 430 or the seed light 440 having a substantially constant optical power may correspond to the optical power being substantially constant over a particular time interval (e.g., a time interval greater than or equal to the pulse period τ, the coherence time T_{c}, the time interval t_{b}−tₐ, 1 s, 10 s, 100 s, 10 minutes, 1 hour, or 1 day). For example, the power of the LO light 430 may vary by less than +1% over a time interval greater than or equal to the pulse period t.

In particular embodiments, CW light may refer to light having a substantially fixed, stable, or constant optical frequency or wavelength over a particular time interval (e.g., over pulse period τ, over coherence time T_{c}, over the time interval t_{b}−tₐ, or over a time interval of approximately 1 s, 10 s, 100 s. 10 minutes, 1 hour, or 1 day). Light with a substantially fixed, stable, or constant optical frequency may refer to light having a variation in optical frequency over a particular time interval of less than or equal to ±0.1%, ±0.01%, ±0.001%, ±0.0001%, ±0.00001%, ±0.000001%, or any other suitable variation. For example, if LO light 430 with a 1550-nm wavelength (which corresponds to a frequency of approximately 193.41 THz) has a frequency variation of less than or equal to ±0.000001% over a particular time interval, then the frequency of the LO light 430 may vary by less than or equal to approximately ±1.93 MHz over the time interval.

In particular embodiments, the average optical power for LO light 430 may be set to a particular value based at least in part on a saturation value of a receiver 140. For example, a seed laser 450 may be configured to emit LO light 430 having an average optical power that is less than a saturation value of a receiver 140 (e.g., less than a saturation value of a detector 340 or an amplifier 350 of the receiver 140). If a receiver 140 receives an input optical signal (e.g., combined beam 422) that exceeds an optical-power saturation value of the detector 340, then the detector 340 may saturate or produce a photocurrent i that is different from or distorted with respect to the input optical signal. A detector 340 may saturate with an input optical power of approximately 0.1 mW, 0.5 mW, 1 mW, 5 mW, 10 mW, 20 mW, or 100 mW. If an amplifier 350 of a receiver 140 receives an input photocurrent i that exceeds an electrical-current saturation value, then the amplifier 350 may saturate or produce a voltage signal 360 that is different from or distorted with respect to the photocurrent signal i. To prevent saturation of the detector 340 or amplifier 350, the optical power of the input beam 135 or of the LO light 430 may be selected to be below a saturation power of the receiver 140. For example, a detector 340 may saturate with an input optical power of 10 mW, and to prevent the detector 340 from saturating, the optical power of a combined beam 422 may be limited to less than 10 mW. In particular embodiments, a limit may be applied to the average power of the LO light 430 to prevent saturation. For example, a detector 340 may saturate with an average optical power of 1 mW, and to prevent the detector 340 from saturating, the average optical power of LO light 430 that is sent to the detector 340 may be configured to be less than 1 mW. As another example, the average optical power of the LO light 430 may be set to a value between 1 μW and 100 μW to prevent saturation effects in a detector 340.

In particular embodiments, the average optical power of LO light 430 may be configured by adjusting or setting (i) an amount of seed current I₁ supplied to a seed laser diode 450, (ii) a reflectivity of the back face 451 of the seed laser diode 450, (iii) a reflectivity of a free-space splitter 470, or (iv) an amount of light split off by a fiber-optic or optical-waveguide splitter 470. In the example of FIG. 7 or FIG. 8, the seed current I₁ and the reflectivity of the back face 451 of the seed laser diode 450 may be configured so that the average optical power of the LO light 430 is set to a particular value (e.g., a value between 10 μW and 100 μW). In the example of FIG. 10, the seed current I₁ and the reflectivity of the splitter 470 may be configured so that the average optical power of the LO light 430 is set to a particular value (e.g., a value below 10 mW). In the example of FIG. 11, the seed current supplied to the seed laser diode 450 and the amount of light split off to output port 2 by the optical-waveguide splitter 470 may be configured so that the average optical power of the LO light 430 is set to a particular value (e.g., a value below 1 mW).

In FIG. 22, the hatched regions 441 of the seed light 440 correspond to temporal portions of the seed light 440 that are amplified by a SOA 460. The SOA current I₂ includes pulses of electrical current, and each pulse of current may cause the SOA 460 to amplify a temporal portion 441 of the seed light 440 to produce a corresponding emitted pulse of light 400. A temporal portion 441 of seed light 440 may refer to a portion of the seed light 440 located in a particular interval of time over which a pulse of current I₂ is applied to a SOA 460. For example, the portion of seed light 440 located in the time interval between times tₐ and t_{b} in FIG. 22 corresponds to one temporal portion 441 of the seed light 440. The corresponding pulse of SOA current between the times tₐ and t_{b} results in the amplification of the temporal portion 441 and the emission of a pulse of light 400. Each temporal portion 441 of seed light 440 that is amplified may correspond to a pulse of light 400 that is produced by a light source 110. A temporal portion 441 that corresponds to an emitted pulse of light 400 may refer to the temporal portion being optically amplified to produce the emitted pulse of light, where the emitted pulse of light includes at least some of the photons from the temporal portion. The duration of a temporal portion 441 (e.g., as represented by the time t_{b}−tₐ) or the duration of a SOA current pulse may be approximately 0.5 ns, 1 ns, 2 ns, 5 ns, 10 ns, 20 ns, 50 ns, 100 ns, or any other suitable duration.

Each emitted pulse of light 400 in FIG. 22 may include a temporal portion 441 of seed light 440 that is amplified by a SOA 460, and during the time period between successive pulses of SOA current I₂, the seed light 440 may be substantially absorbed by the SOA 460. The emitted pulses of light 400 are part of an output beam 125 and have a pulse duration of Δτ and a pulse period of τ. For example, the emitted pulses of light 400 may have a pulse period of approximately 100 ns, 200 ns, 500 ns, 1 μs, 2 μs, 5 μs, 10 μs, or any other suitable pulse period. As another example, the emitted pulses of light 400 may have a pulse duration of 1-10 ns and a pulse period of 0.5-2.0 μs. In particular embodiments, when a current pulse is applied to a SOA 460, there may be a time delay until the optical gain of the SOA 460 builds up to exceed the optical loss of the SOA 460. As a result, the pulse duration Δτ of an emitted pulse of light 400 may be less than or equal to the duration of a corresponding pulse of SOA current I₂. For example, a SOA current pulse with a duration of 8 ns may produce an emitted pulse of light 400 with a duration of 6 ns. In the example of FIG. 22, the emitted pulses of light 400 may have a duration of approximately 5 ns, and the SOA current pulses may have a duration (e.g., as represented by t_{b}−tₐ) of approximately 5 ns to 10 ns.

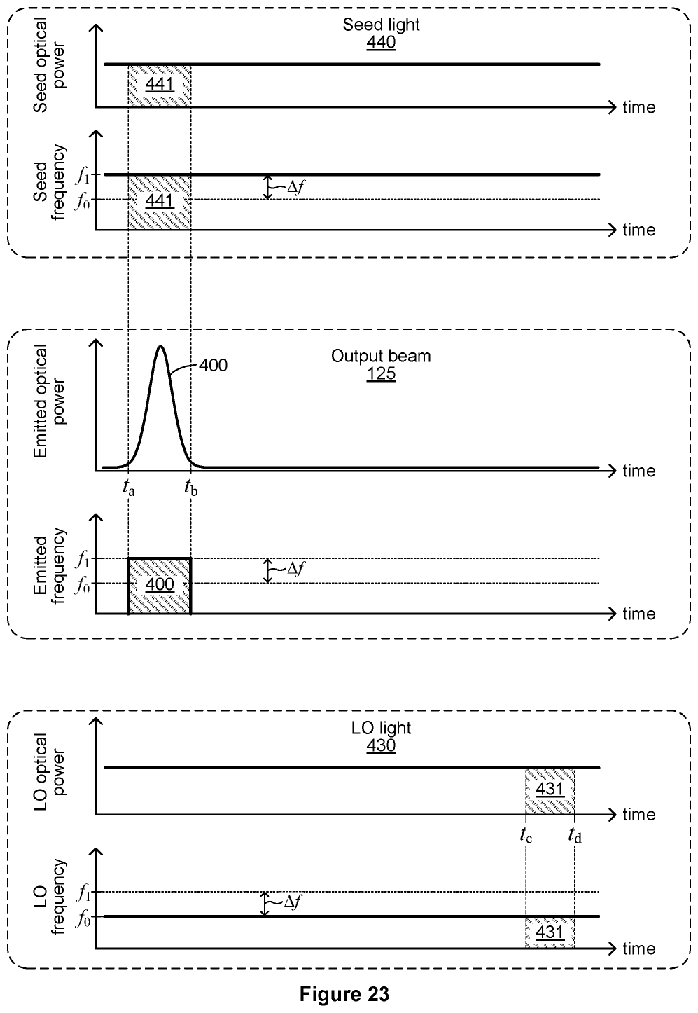

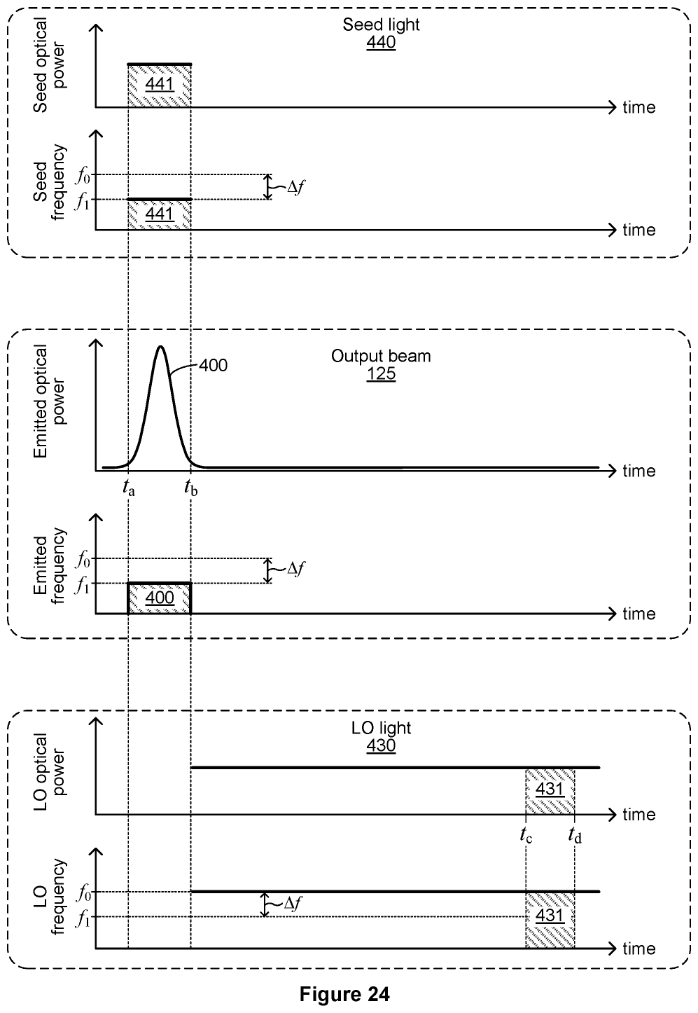

FIGS. 23-24 each illustrate example graphs of optical power and frequency for seed light 440, an output beam 125, and LO light 430. The optical power and the optical frequency for each of the parameters in FIGS. 23 and 24 (seed light 440, output beam 125, LO light 430) are plotted versus time. In each dashed-line section, the upper graph illustrates the optical power versus time, and the lower graph illustrates the optical frequency versus time. In FIG. 23, the seed light 440 may be produced by a seed laser diode 450a, and the LO light 430 may be produced by an LO laser diode 450b (e.g., as illustrated in FIG. 12A). The seed light 440 in FIG. 23 has a substantially constant optical power and a substantially constant optical frequency of f₁, and the LO light 430 has a substantially constant optical power and a substantially constant optical frequency of f₀. In FIG. 24, the seed light 440 and the LO light 430 may be produced by a single seed laser diode 450 (e.g., as illustrated in FIGS. 7-11). The single seed laser diode 450 may switch between (i) operating at frequency f₁ in the time interval between times tₐ and t_{b} to produce a temporal portion 441 of seed light 440 and (ii) operating at frequency f₀ in the time interval from time t_{b} to at least time t_{d} to produce the LO light 430. For example, the seed light 440 and LO light 430 in FIG. 24 may be produced by a frequency-tunable laser diode 450, such as for example a SG-DBR laser (e.g., as illustrated in FIG. 9). An electronic driver 480 may supply a first set of electrical currents to the frequency-tunable laser diode 450, causing the laser diode to produce the temporal portion 441 in FIG. 24 (with frequency f₁). Subsequent to the pulse of light 400 being emitted (e.g., at or just after time t_{b} in FIG. 24), the electronic driver 480 may supply a second set of electrical currents to the laser diode 450, causing the laser diode to produce the LO light 430 (with frequency f₀) extending from approximately time t_{b} to at least time t_{d}. Prior to a subsequent pulse of light being produced and emitted, the electronic driver 480 may supply a third set of currents to the frequency-tunable laser diode 450 at some time after time t_{d} to produce a subsequent temporal portion 441 (not illustrated in FIG. 24). The third set of currents may be the same as the first set of currents (so that the subsequent temporal portion has a frequency of approximately f₁), or the third set of currents may be different from the first and second sets of electrical currents.

In FIGS. 23 and 24, the temporal portion 441 of seed light in the time interval between times tₐ and t_{b} is amplified to produce an emitted pulse of light 400. The pulse of light 400 has approximately the same optical frequency (f₁) as the corresponding temporal portion 441. The temporal portion 431 of LO light 430 located in the time interval between times t_{c} and t_{d} may represent a portion of the LO light 430 that is temporally coincident with a received pulse of light 410 (not illustrated in FIG. 23). A temporal portion 431 of LO light 430 may refer to a portion of the LO light that is received or detected by a receiver 140 at the same time as a pulse of light 410. A temporal portion 431 of LO light 430 may be coherently mixed with a received pulse of light 410 to produce a corresponding photocurrent signal i.

The optical frequency of the seed light 440 (including temporal portion 441) and the optical frequency of the emitted pulse of light 400 are each offset from the optical frequency of the LO light 430 by a frequency offset of approximately Δf, where Δf=f₁−f₀. A frequency offset Δf, which represents the frequency offset of seed light 440 or an emitted pulse of light 400 with respect to LO light 430, may have a positive value when f₁ is greater than f₀ (e.g., as illustrated in FIG. 23) or a negative value when f₁ is less than f₀ (e.g., as illustrated in FIG. 24). For example, the optical frequency f₁ in FIG. 23 may be 192.010 THz, and the optical frequency f₀ may be 192.005 THz, which corresponds to a positive frequency offset Δf of +5 GHz. In FIG. 24, the emitted pulse of light may have an optical frequency f₁ of 199.200 THz, and the optical frequency f₀ of LO light 430 may be 199.210 THz, which corresponds to the pulse of light having a negative frequency offset Δf of −10 GHz with respect to the LO light.

The optical frequency f₀ of LO light 430 in a coherent pulsed lidar system 100 may have any suitable value between approximately 175 THz and approximately 335 THz (which corresponds to a wavelength between approximately 895 nm and approximately 1713 nm). Additionally, the frequency offset Δf of an emitted pulse of light 400 with respect to the LO light 430 may have any suitable value between approximately 10 MHZ and 50 GHz or between approximately −10 MHz and approximately −50 GHz. For example, the LO light 430 may have an optical frequency of approximately 331.2 THz (which corresponds to a wavelength of approximately 905 nm), and each emitted pulse of light 400 may have a frequency offset of approximately −10 GHz with respect to the LO light. As another example, the LO light 430 may have an optical frequency of approximately 187.4 THz (which corresponds to a wavelength of approximately 1600 nm), and each emitted pulse of light 400 may have a frequency offset between +1 GHz and +10 GHz with respect to the LO light. A frequency offset Δf of an emitted pulse of light 400 with respect to LO light 430 may correspond to or may be referred to as a spectral signature of the emitted pulse of light.

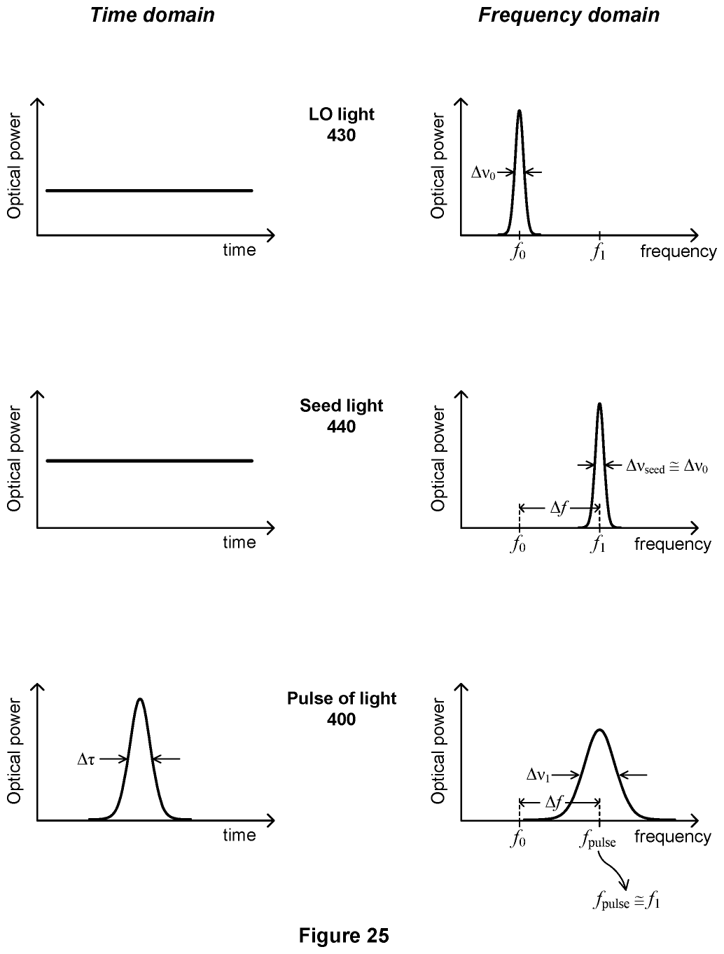

FIG. 25 illustrates example time-domain and frequency-domain graphs of LO light 430, seed light 440, and an emitted pulse of light 400. The time-domain graphs (on the left side of FIG. 25) each illustrate relative optical power versus time, and the frequency-domain graphs (on the right side of FIG. 25) each illustrate relative optical power versus optical frequency. A frequency-domain graph may be referred to as an optical spectrum or as a graph of an optical spectrum. The time-domain graph of the LO light 430 indicates that the optical power of the LO light is substantially constant. The frequency-domain graph of the LO light 430 indicates that the LO light has a center optical frequency of f₀ and a relatively narrow spectral linewidth of Δν₀. For example, the optical frequency f₀ may be approximately 199.2 THz (corresponding to a wavelength of approximately 1505 nm), and the spectral linewidth Δν₀ may be approximately 2 MHZ. The time-domain graph of the seed light 440 indicates that the optical power of the seed light is substantially constant, and the frequency-domain graph indicates that the seed light has a center optical frequency of f₁ and a relatively narrow spectral linewidth of Δν_{seed}. The spectral linewidth of the seed light 440 (Δν_{seed}) may be approximately equal to the spectral linewidth of the LO light 430 (Δν₀). For example, the spectral linewidths of the LO light 430 and the seed light 440 may be equal to within approximately 10%, 5%, 2%, or 1%.

The optical frequency f₁ of the seed light 440 is offset by the frequency offset Δf with respect to the LO light 430 so that f₁=f₀+Δf. The emitted pulse of light 400, which is produced when a temporal portion 441 of the seed light 440 is amplified, has a duration of Δt. The optical frequency of an emitted pulse of light 400 may be approximately equal to the optical frequency of the corresponding temporal portion 441 of seed light 440 that is amplified. The pulse of light 400 in FIG. 25 has a center optical frequency of fₚᵤₗₛₑ and a relatively broad spectral linewidth of Δν₁. The spectral linewidth Δν₁ may be referred to as being relatively broad in relation to the spectral linewidth Δν₀ (e.g., Δν₁/Δν₀ may be greater than or equal to 10, 100, or 1,000). The optical frequency fₚᵤₗₛₑ of the pulse of light 400 may be approximately equal to the optical frequency f₁ of the seed light 440, and the optical frequency of the pulse of light may be offset by approximately Δf with respect to the LO light 430. One or more optical nonlinearities associated with the optical amplification process may cause the optical frequency of an emitted pulse of light to be shifted slightly with respect to the corresponding temporal portion. For example, the optical frequencies fₚᵤₗₛₑ and f₁ may be equal to within approximately 0.1%, 0.01%, or 0.001%. As another example, the optical frequency difference (fₚᵤₗₛₑ−f₁) may be relatively small with respect to the frequency offset Δf (e.g., |fₚᵤₗₛₑ−f₁|/Δf may be less than approximately 0.01 or 0.001). As another example the optical frequency difference |fₚᵤₗₛₑ−f₁| may be less than the spectral linewidth Δν₀. The optical frequency fₚᵤₗₛₑ of a pulse of light 400 may refer to the frequency of the spectral center or spectral peak of the pulse of light. Similarly, the optical frequency offset Δf of a pulse of light 400 may refer to the difference between (i) the spectral center or spectral peak of the pulse of light and (ii) f₀, the optical frequency of the LO light 430.

A spectral linewidth of an optical signal (e.g., seed light 440, LO light 430, or pulse of light 410) may be referred to as a linewidth, optical linewidth, bandwidth, or optical bandwidth. The spectral linewidth may refer to an approximate width of an optical spectrum as measured at the half-power points of the spectrum (which may be referred to as the 3-dB points). A spectral linewidth may be specified over a particular time period, such as for example, over a period of time approximately equal to a pulse duration (e.g., Δτ or t_{b}−tₐ), a temporal-portion duration (e.g., t_{d}−t_{c}), a pulse period τ, a coherence time T_{c}, or a time interval of approximately 1 s. 10 s, 100 s, 10 minutes, 1 hour, or 1 day, or any other suitable period of time. For example, the LO light 430 may have a spectral linewidth Δν₀ of 4 MHz when measured over a 100-ms time interval. A spectral linewidth for an optical signal may be related to a variation in optical frequency of the optical signal. For example, LO light 430 having a spectral linewidth Δν₀ of 4 MHz over a 100-ms time interval may correspond to LO light 430 having a frequency variation of approximately ±2 MHz over a 100-ms time interval.

In particular embodiments, seed light 440 or LO light 430 may have a spectral linewidth Δν₀ of less than approximately 50 MHZ, 10 MHZ, 5 MHZ, 3 MHZ, 1 MHZ, 0.5 MHZ, 100 kHz, or any other suitable spectral-linewidth value. In the example of FIG. 25, the LO light 430 may have a spectral linewidth Δν₀ of approximately 3 MHZ, and the corresponding seed light 440 may have approximately the same spectral linewidth. When a temporal portion 441 of the seed light 440 is amplified to produce an emitted pulse of light 400, the spectral linewidth of the emitted pulse of light 400 may have a broadened linewidth Δν₁ that is greater than Δν₀. For example, an emitted pulse of light 400 and a corresponding received pulse of light 410 may each have a spectral linewidth Δν₁ of approximately 10 MHZ, 50 MHZ, 100 MHZ, 200 MHZ, 300 MHZ, 500 MHZ, 1 GHz, 10 GHz, or any other suitable linewidth. As another example, the LO light 430 in FIG. 25 may have a spectral linewidth Δν₀ of 5 MHz, and the emitted pulse of light 400 may have a spectral linewidth Δν₁ of 100 MHZ. As another example, the emitted pulse of light 400 in FIG. 25 may have a duration Δτ of approximately 3-6 ns and a spectral linewidth Δν₁ of approximately 75-150 MHZ.

A pulse duration (Δτ) and spectral linewidth (Δν) of a pulse of light may have an inverse relationship where the product Δτ·Δν (which may be referred to as a time-bandwidth product) is equal to a particular value. For example, a pulse of light with a Gaussian temporal shape may have a time-bandwidth product equal to a value that is greater than or equal to 0.441. If a Gaussian pulse has a time-bandwidth product that is approximately equal to 0.441, then the pulse may be referred to as a transform-limited pulse. For a transform-limited Gaussian pulse, the pulse duration (Δτ) and spectral linewidth (Δν₁) may be related by the expression Δτ·Δν=0.441. This inverse relationship between pulse duration and spectral linewidth indicates that a shorter-duration pulse has a larger spectral linewidth (and vice versa). The inverse relationship between pulse duration and spectral linewidth results from the Fourier-transform relationship between time-domain and frequency-domain representations of a pulse. In the example of FIG. 25, the pulse of light 400 may be a transform-limited Gaussian pulse with a pulse duration Δτ of 2 ns and a spectral linewidth Δν₁ of approximately 220 MHz. As another example, the pulse of light 400 may be a transform-limited Gaussian pulse with a pulse duration Δτ of 4 ns and a spectral linewidth Δν₁ of approximately 110 MHz. If a Gaussian pulse of light has a time-bandwidth product that is greater than 0.441, then the pulse of light may be referred to as a non-transform-limited pulse of light. For example, if the pulse of light 400 in FIG. 25 is non-transform-limited with a time-bandwidth product of 1, then the pulse of light may have a pulse duration Δτ of 2 ns and a spectral linewidth Δν₁ of approximately 500 MHZ. As another example, the pulse of light 400 may have a pulse duration Δτ of 4 ns and a spectral linewidth Δν₁ of approximately 250 MHZ.

Seed light 440 may have a relatively narrow spectral linewidth that is approximately equal to the spectral linewidth of the LO light 430, and amplifying a temporal portion 441 of seed light 440 may result in the linewidth being broadened according to the inverse relationship between pulse duration and spectral linewidth. In FIG. 25, the pulse duration (Δτ) and the spectral linewidth (Δν1) of the received pulse of light 410 may be related by the expression Δτ·Δν₁≥0.441. For example, if the pulse duration Δτ is 2 ns, then the spectral linewidth Δν₁ may be greater than approximately 220 MHz. At least part of the spectral broadening imparted to an emitted pulse of light may result from the time-bandwidth relationship between pulse duration and spectral linewidth. In addition to broadening the spectral linewidth of an emitted pulse of light 400 based on the time-bandwidth relationship, a light source 110 may also impart additional spectral broadening to the emitted pulse of light 400 through one or more nonlinear optical effects. For example, in a light source 110 that includes a seed laser diode 450 and a SOA 460, one or more of the following effects occurring in the seed laser diode 450 or the SOA 460 may cause spectral broadening in an emitted pulse of light: four-wave mixing, Kerr nonlinear optical effect, self-phase modulation, coupled-cavity effects between the seed laser diode and the SOA, stimulated Raman scattering (SRS), stimulated Brillouin scattering (SBS), and plasma dispersion effect. For example, a 2-ns pulse of light 400 may have a spectral linewidth Δν₁ of 400 MHZ, where approximately 220 MHz of the spectral broadening may be attributed to the time-bandwidth relationship between pulse duration and spectral linewidth, and approximately 180 MHz of the spectral broadening may be attributed to one or more nonlinear optical effects. Nonlinear optical effects may cause a broadening of the spectral linewidth of an emitted pulse of light 400 or may cause a shift in the optical frequency of an emitted pulse of light 400.

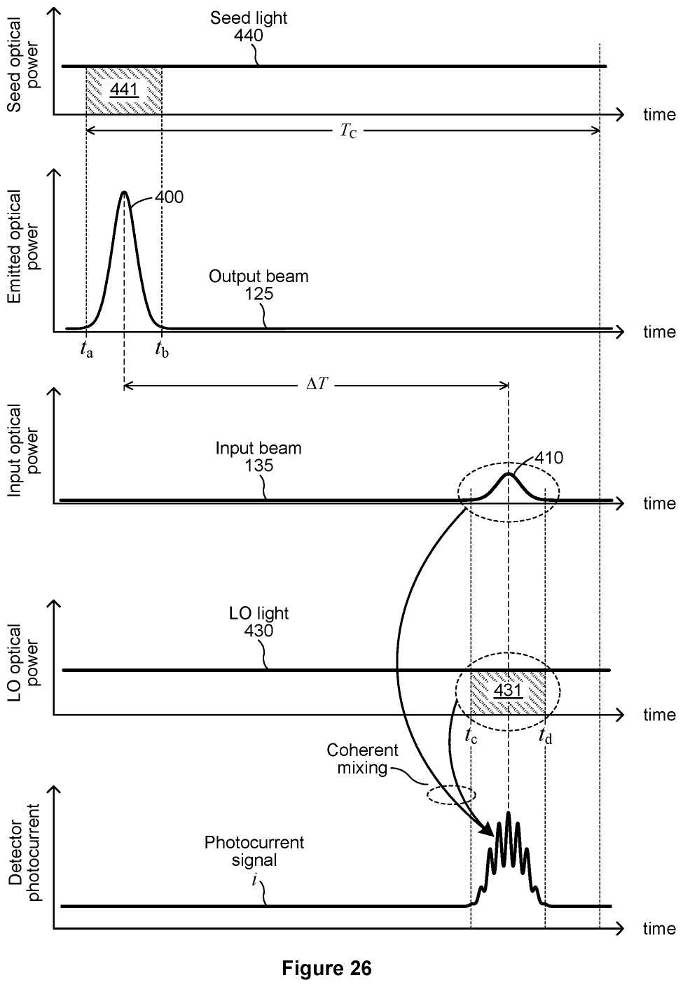

FIG. 26 illustrates example graphs of seed light 440, an emitted optical pulse 400, a received optical pulse 410, LO light 430, and detector photocurrent i. Each of the parameters (seed light 440, emitted optical pulse 400, received optical pulse 410, LO light 430, and photocurrent i) in FIG. 26 is plotted versus time. The seed light 440 may include CW light or light having a substantially constant optical power, and the temporal portion 441 of the seed light 440 may be amplified by a SOA 460 to produce the emitted pulse of light 400. The emitted pulse of light 400 is part of output beam 125, and the received pulse of light 410 is part of input beam 135. The received pulse of light 410, which is received a time interval ΔT after the pulse of light 400 is emitted, may include light from the emitted optical pulse 400 that is scattered by a target 130. The distance D from the lidar system 100 to the target 130 may be determined from the expression D=c·ΔT/2.

In particular embodiments, a received pulse of light 410 and LO light 430 may be combined and coherently mixed together at one or more detectors 340 of a receiver 140. Each detector 340 may produce a photocurrent signal i that corresponds to coherent mixing of the received pulse of light 410 and the LO light 430. In FIG. 26, the received pulse of light 410 is coherently mixed with a temporal portion 431 of the LO light 430 to produce a corresponding photocurrent signal i. In FIG. 26, temporal portion 431 and the received pulse of light 410 are each located in the time interval between times t_{c} and tₐ and may be received by a detector 340 at the same time. The coherent mixing of the pulse of light 410 and the temporal portion 431 may occur at a detector 340 of the receiver 140, and the detector 340 may produce a photocurrent signal i in response to the coherent mixing. In FIG. 26, the photocurrent signal i between times t_{c} and tₐ includes a pulse of current that includes an amplitude-modulation (AM) current signal. The AM photocurrent signal may have a frequency that is related to a frequency offset between the received pulse of light 410 and the LO light 430. Coherent mixing of two optical signals (e.g., a received pulse of light 410 and LO light 430) may be referred to as optical mixing, mixing, optical interfering, coherent combining, coherent detection, homodyne detection, or heterodyne detection.

In particular embodiments, coherent mixing may occur when two optical signals that are coherent with one another are optically combined and then detected by a detector 340. If two optical signals can be coherently mixed together, the two optical signals may be referred to as being coherent with one another. Two optical signals being coherent with one another may include two optical signals (i) that have approximately the same optical frequency, (ii) that have a particular, substantially fixed optical frequency offset (Δf), or (iii) that each have a substantially fixed or stable optical frequency over a particular period of time. For example, seed light 440 and LO light 430 in FIG. 26 may be coherent with one another since they may have a substantially constant optical frequency offset or since each of their frequencies may be substantially fixed over a time period greater than or equal to a coherence time T_{c}. As another example, the emitted pulse of light 400 and the temporal portion 431 of LO light 430 in FIG. 26 may be coherent with one another. And since the received pulse of light 410 may include a portion of the emitted pulse of light 400, the received pulse of light 410 and the temporal portion 431 may also be coherent with one another.

In particular embodiments, if two optical signals each have a stable frequency over a particular period of time, then the two optical signals may be (i) optically combined together and (ii) coherently mixed at a detector 340. Optically combining two optical signals (e.g., an input beam 135 and LO light 430) may refer to combining two optical signals so that their respective electric fields are summed together. Optically combining two optical signals may include overlapping the two optical signals (e.g., with an optical combiner 420) so that they are substantially coaxial and travel together in the same direction and along approximately the same optical path. Additionally, optically combining two optical signals may include overlapping the two optical signals so that at least a portion of their respective polarizations have the same orientation. Once the two optical signals are optically combined, they may be coherently mixed at a detector 340, and the detector 340 may produce a photocurrent signal i corresponding to the square of the summed electrical fields of the two optical signals. For example, at least part of the electric field of a received pulse of light 410 may be combined or summed with at least part of the electric field of a temporal portion 431 of LO light 430, and a detector may produce a photocurrent signal i that is proportional to the square of the summed electric fields. A detector 340 that produces a photocurrent signal i that is proportional to the square of a received electric field may be referred to as a square-law detector.

In particular embodiments, a portion of seed light 440 may be coherent with a portion of LO light 430. For example, LO light 430 and seed light 440 may be coherent with one another over a time period approximately equal to the coherence time T_{c}. In each of FIGS. 7-11, the LO light 430 and the seed light 440 may be coherent with one another since the two optical signals are derived from the same seed laser diode 450. In FIG. 12A, the LO light 430 and the seed light 440 may be coherent with one another since the two optical signals may have a particular frequency offset that is substantially fixed over an interval of time. In FIG. 26, the temporal portion 441 of the seed light 440 may be coherent with the temporal portion 431 of the LO light 430. Additionally, the temporal portion 441 may be coherent with any portion of the LO light 430 extending over at least the time interval ΔT or T_{c} (e.g., from approximately time tₐ to at least time tₐ). The coherence time T_{c} may correspond to a time over which light emitted by a seed laser diode 450 is coherent (e.g., the emitted light may have a substantially fixed or stable frequency over a time interval of T_{c}). The coherence length L_{c} is the distance over which the light from a seed laser diode 450 is coherent, and the coherence time and coherence length may be related by the expression L_{c}=c·T_{c}. For example, a seed laser diode 450 may have a coherence length of approximately 500 m, which corresponds to a coherence time of approximately 1.67 μs. The seed light 440 and LO light 430 emitted by a seed laser diode 450 may have a coherence length of approximately 1 m, 10 m, 50 m, 100 m, 300 m, 500 m, 1 km, or any other suitable coherence length. Similarly, the seed light 440 and LO light 430 may have a coherence time of approximately 3 ns, 30 ns, 150 ns, 300 ns, 1 μs, 1.5 μs, 3 μs, or any other suitable coherence time.

In particular embodiments, each emitted pulse of light 400 may be coherent with a corresponding portion of LO light 430. In FIG. 26, the corresponding portion of the LO light 430 may include any portion of the LO light 430 (including temporal portion 431) extending from approximately time tₐ to at least time t_{d}, and the emitted pulse of light 400 may be coherent with any portion of the LO light 430 from time tₐ to time t_{d}. In FIG. 22, each emitted pulse of light 400 may be coherent with the LO light 430 over a time period from when the pulse of light 400 is emitted until at least a time t (the pulse period) after the pulse is emitted. Similarly, in each of FIGS. 7-12, the emitted pulse of light 400 may be coherent with the LO light 430 for at least a time t after the pulse 400 is emitted. In FIG. 13, the fiber-optic amplifier 500 may preserve the coherence of the pulse of light 400i, and the emitted pulse of light 400 may be coherent with the LO light 430 for at least a time t after the pulse 400b is emitted.

In particular embodiments, each emitted pulse of light 400 may include a temporal portion 441 of the seed light 440 that is amplified by a SOA 460, and the amplification process may be a coherent amplification process that preserves the coherence of the temporal portion 441. Since the temporal portion 441 may be coherent with a corresponding portion of the LO light 430, the emitted pulse of light 400 may also be coherent with the same portion of the LO light 430. An emitted pulse of light 400 being coherent with a corresponding portion of LO light 430 may correspond to temporal portion 441 being coherent with the corresponding portion of the LO light 430. In the example of FIG. 26, the temporal portion 441 may be coherent with the LO light 430 over at least the time interval ΔT or T_{c} (e.g., from approximately time tₐ to at least time t_{d}). Since the emitted pulse of light 400 may be coherent with the temporal portion 441, the emitted pulse of light 400 may also be coherent with any portion of the LO light 430 (including the temporal portion 431) from approximately time tₐ until at least time t_{d}. An emitted pulse of light 400 being coherent with any portion of LO light 430 in the time period from time tₐ until at least time tₐ indicates that the emitted pulse of light 400 may be coherently mixed with any portion of the LO light 430 (including the temporal portion 431) over this same time period. The received pulse of light 410 includes light from the emitted pulse of light 400 (e.g., light from the emitted pulse of light 400 that is scattered by a target 130), and so the received pulse of light 410 may be coherent with the emitted pulse of light 400. Based on this, the received pulse of light 410 may also be coherently mixed with any portion of the LO light 430 over the tₐ to tₐ time period.

In particular embodiments, an emitted pulse of light 400 being coherent with a corresponding portion of LO light 430 may correspond to the LO light 430 having a coherence length greater than or equal to 2×R_{OP}, where R_{OP} is an operating range of the lidar system 100. The coherence length L_{c} being greater than or equal to 2×R_{OP} corresponds to the coherence time T_{c} being greater than or equal to 2×R_{OP}/c. Since the quantity 2×R_{OP}/c may be approximately equal to the pulse period τ, the coherence length Le being greater than or equal to 2×R_{OP} may correspond to the coherence time T_{c} being greater than or equal the pulse period τ. The LO light 430 and the seed light 440 may be coherent with one another over the coherence time T_{c}, which corresponds to the temporal portion 441 in FIG. 26 being coherent with the LO light 430 over the coherence time T_{c}. Similarly, the emitted pulse of light 400, which includes the temporal portion 441 amplified by the SOA 460, may be coherent with the LO light 430 over the coherence time T_{c}. If the coherence length of the LO light 430 is greater than or equal to 2×R_{OP} (or, if T_{c} is greater than or equal to τ), then an emitted pulse of light 400 may be coherent with any portion of the LO light 430 (including the temporal portion 431) from a time when the pulse of light 400 is emitted until at least a time τ after the pulse is emitted. This indicates that a received pulse of light 410 (which includes light from the emitted pulse of light 400 scattered from a target 130) may be coherently mixed with the LO light 430 as long as the distance D to the target 130 is within the operating range of the lidar system 100 (e.g., D≤R_{OP}).

In particular embodiments, each emitted pulse of light 400 may be coherent with a corresponding portion of LO light 430, and the corresponding portion of the LO light 430 may include temporal portion 431 of the LO light 430. The temporal portion 431 represents the portion of the LO light 430 that is detected by a receiver 140 at the time when the received pulse of light 410 is detected by the receiver 140. In FIG. 26, the temporal portion 431 is coincident with the received pulse of light 410, and both optical signals are located between times t_{c} and t_{d}. Since the received pulse of light 410 includes scattered light from the emitted pulse of light 400, the received pulse of light 410 may be coherent with the temporal portion 431 of the LO light 430. The received pulse of light 410 and the temporal portion 431 may be coherently mixed together at a detector 340 of the receiver, and the coherent mixing may result in a pulse of amplitude-modulated detector photocurrent i, as illustrated in FIG. 26.

In particular embodiments, a received pulse of light 410 may be coherent with a temporal portion 431 of LO light 430. In FIG. 26, the received pulse of light 410 and the temporal portion 431, which are coherently mixed together, are coherent with one another. In particular embodiments, the coherent mixing of a received pulse of light 410 and a temporal portion 431 may not require that the coherence time T_{c} associated with seed light 440 or LO light 430 be greater than or equal to the pulse period τ. For example, the received pulse of light 410 and the temporal portion 431 may be coherently mixed even if the coherence time is less than ΔT or less than the pulse period τ. Coherent mixing may occur if the coherence time T_{c} associated with the seed light 440 or the LO light 430 is greater than or equal to the duration of the received pulse of light 410 or the duration of the temporal portion 431. If a received pulse of light 410 and a temporal portion 431 each has a substantially fixed frequency over at least the duration of the temporal portion 431, then the received pulse of light 410 and the temporal portion 431 may be coherently mixed together. As long as the received pulse of light 410 and the temporal portion 431 each has an optical frequency that is substantially stable over the duration of the pulse of light 410 or over the duration of the temporal portion 431, then the two optical signals may be coherently mixed together. In the example of FIG. 26, the received pulse of light 410 and the temporal portion 431 may be coherent over the duration of the temporal portion 431 (e.g., the coherence time T_{c} may be greater than or equal to t_{d}−t_{c}), and their electric fields may be coherently combined (e.g., summed together) and coherently mixed together.

In particular embodiments, a photocurrent signal i produced by a detector 340 in response to the coherent mixing of LO light 430 and a received pulse of light 410 may be expressed as i(t)=k|ε_{Rx}(t)+ε_{LO}(t)|², where k is a constant (e.g., k may account for the responsivity of the detector 340 as well as other constant parameters or conversion factors). For clarity, the constant k or other constants (e.g., conversion constants or factors of 2 or 4) may be excluded from expressions herein related to the photocurrent i. In the expression for i(t), ε_{Rx}(t) is the electric field of the received pulse of light 410, and ε_{LO}(t) is the electric field of the LO light 430. The electric field of the received pulse of light 410 may be expressed as E_{Rx} cos[ω_{Rx}t+ϕ_{Rx}(t)], where E_{Rx} is the amplitude of the electric field of the received pulse of light 410, which may be expressed as E_{Rx}(t), since the electric field amplitude may vary with time. Similarly, the electric field of the LO light 430 may be expressed as E_{LO} cos[ω_{LO}t+ϕ_{LO}(t)], where E_{LO} is the amplitude of the electric field of the LO light 430, which may also be expressed as E_{LO}(t). The frequency ω_{Rx} represents the optical frequency of the electric field of the received pulse of light 410, and ω_{LO} represents the optical frequency of the electric field of the LO light 430. A frequency represented by ω is a radial frequency (with units radians/s) and is related to the optical frequency F (with units cycles/s) by the expression ω=2πF. Each of the frequencies ω_{Rx} and ω_{LO}, which may be expressed as ω_{Rx}(t) or ω_{LO}(t), may vary with time or may be substantially constant with time. The parameter ϕ_{Rx}(t) represents a phase of the electric field of the received pulse of light 410, and ϕ_{LO}(t) represents a phase of the electric field of the LO light 430. Each of the phases ϕ_{Rx}(t) and ϕ_{LO}(t), which may be expressed as ϕ_{Rx} and ϕ_{LO}, may vary with time or may be substantially constant with time.

The above expression for the photocurrent signal i may be expanded and written as i(t)=E_{Rx}²+E_{LO}²+2E_{Rx}E_{LO} cos[(ω_{Rx}−ω_{LO})t+ϕ_{Rx}(t)−ϕ_{LO}(t)], where, for clarity, the constant k is not included. In this expanded expression for the photocurrent signal i(t), the first term E_{Rx}² corresponds to the power of the received pulse of light 410, and the second term E_{LO}² corresponds to the power of the LO light 430. If the received pulse of light 410 is a Gaussian pulse with a pulse width of Δτ, the first term may be expressed as E_{Rx}²(t)=Pₚₑₐₖexp[−(2\sqrt{ln 2}t/Δτ)²], where Pₚₑₐₖ is the peak power of the received pulse of light 410. If the LO light 430 has a substantially constant optical power, the second term may be expressed as E_{LO}²=P_{LO}, where P_{LO} is the average power of the LO light 430. In particular embodiments, a photocurrent signal i corresponding to the coherent mixing of LO light 430 and a received pulse of light 410 may include a coherent-mixing term. The third term in the above expression, 2E_{Rx}E_{LO} cos[(ω_{Rx}−ω_{LO})t+ω_{Rx}(t)−ϕ_{LO}(t)], corresponds to an AM photocurrent signal and may be referred to as a coherent-mixing term. If the phases ϕ_{Rx} and ϕ_{LO} are substantially constant over the duration of the temporal portion 431, then the phase term (ϕ_{Rx}−ϕ_{LO}) may be written as Δϕ. Additionally, the frequency term (ω_{Rx}−ω_{LO}) may be written as Δω or 2πΔF, where ΔF is the frequency offset between the received pulse of light 410 and the LO light 430. Then, the coherent-mixing term may be expressed as 2E_{Rx}E_{LO} cos[2πΔF·t+Δϕ], or equivalently 2\sqrt{P_{Rx}}\sqrt{P_{LO}} cos[2πΔF·t+Δϕ], where P_{Rx} is the time-dependent power of the received pulse of light 430. The coherent-mixing term represents coherent mixing between the electric fields of the received pulse of light 410 and the LO light 430. The coherent-mixing term is proportional to the product of (i) E_{Rx}, the amplitude of the electric field of the received pulse of light 410 and (ii) E_{LO}, the amplitude of the electric field of the LO light 430. The amplitude of the electric field of the received pulse of light 410 may be time dependent (e.g., corresponding to a Gaussian or other pulse shape), and the E_{LO} term may be substantially constant, corresponding to an optical power of LO light 430 that is substantially constant.

A coherent pulsed lidar system 100 as described herein may have a higher sensitivity than a conventional non-coherent pulsed lidar system. For example, compared to a conventional non-coherent pulsed lidar system, a coherent pulsed lidar system may be able to detect targets 130 that are farther away or that have lower reflectivity. In a conventional non-coherent pulsed lidar system, a received pulse of light may be directly detected by a detector, without LO light and without coherent mixing. The photocurrent signal produced in a conventional non-coherent pulsed lidar system may correspond to the E_{Rx} term discussed herein, which represents the power of a received pulse of light. The size of the E_{Rx} term may be determined primarily by the distance to the target 130 and the reflectivity of the target 130, and aside from boosting the energy of the emitted pulses of light 400, increasing the size of the E_{Rx} term may not be practical or feasible. In a coherent pulsed lidar system 100 as discussed herein, the detected signal includes a coherent-mixing term, which is proportional to the product of E_{Rx} and E_{LO}, and the improved sensitivity of a coherent pulsed lidar system 100 may result from the coherent-mixing term. While it may not be practical or feasible to increase the amplitude of E_{Rx} for far-away or low-reflectivity targets 130, the amplitude of the E_{LO} term may be increased by increasing the power of the LO light 430. The power of the LO light 430 can be set to a level that results in an effective boosting of the size of the coherent-mixing term, which results in an increased sensitivity of the lidar system 100. In the case of a conventional non-coherent pulsed lidar system, the signal of interest depends on E_{Rx}², the power of the received pulse of light. In a coherent pulsed lidar system 100, the signal of interest, which depends on the product of E_{Rx} and E_{LO}, may be increased by increasing the power of the LO light 430. The LO light 430 acts to effectively boost the coherent-mixing term, which may result in an improved sensitivity of the lidar system 100.

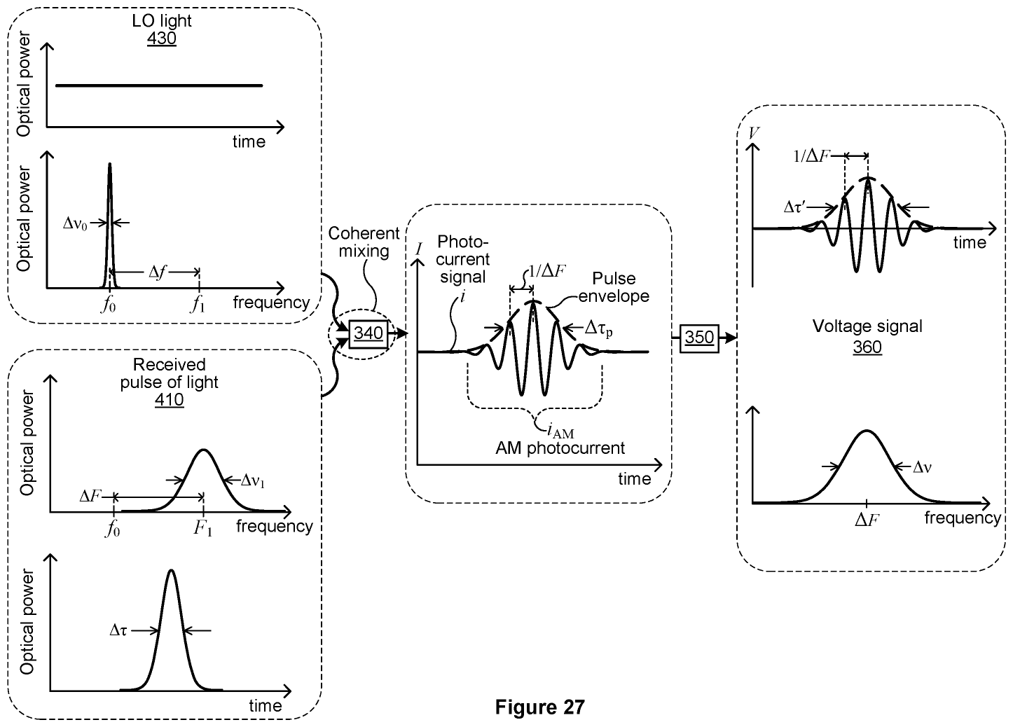

FIG. 27 illustrates an example photocurrent signal i and voltage signal 360 that result from the coherent mixing of LO light 430 and a received pulse of light 410. The optical spectrum of the LO light 430 indicates that the LO light 430 has a center optical frequency of f₀ and a relatively narrow spectral linewidth of Δν₀. The received pulse of light 410 has a duration of Δτ and an optical spectrum with a center optical frequency of F₁ and a relatively broad spectral linewidth of Δν₁. The optical frequency of the received pulse of light 410 is offset by ΔF with respect to the frequency of the LO light 430 so that F₁=f₀+ΔF. The received pulse of light 410 includes scattered light from an emitted pulse of light 400, where the emitted pulse of light has a center optical frequency of f₁ and a frequency offset of Δf with respect to the frequency of the LO light 430 so that f₁=f₀+Δf. The optical frequencies f₁ and F₁ of the emitted and received pulses of light may be approximately equal, or the two optical frequencies may differ based on a Doppler frequency shift of the received pulse of light 410. Similarly, the optical frequency offsets Δf and ΔF may be approximately equal or may differ based on a Doppler frequency shift of the received pulse of light 410.

The coherent mixing of the LO light 430 and the received pulse of light 410 at a detector 340 results in a photocurrent signal i with a pulse of photocurrent having a duration of Δτₚ. The photocurrent signal i includes an AM photocurrent signal i_{AM} that includes temporal pulsations with period 1/ΔF. The AM photocurrent signal is bounded by a dashed-line pulse envelope which may have a shape similar to the received pulse of light 410. The AM photocurrent signal may represent the coherent-mixing term resulting from the coherent mixing of the LO light 430 and the received pulse of light 410. The photocurrent signal i may be amplified by an amplifier 350 that produces a corresponding voltage signal 360 which includes a corresponding AM voltage signal with periodic temporal pulsations. The upper voltage-signal graph illustrates the voltage signal 360 in the time domain and includes a pulse of voltage with a duration of Δτ′. The duration Δτ′ of the voltage pulse may be greater than the duration Δτ of a corresponding emitted or received pulse of light. For example, the duration of an emitted pulse of light 400 may increase while propagating to and from a target 130 or due to pulse-broadening effects of scattering from the target 130. Additionally or alternatively, the finite temporal response of a detector 340 or amplifier 350 may result in a voltage pulse with a longer duration than the duration of a corresponding emitted pulse of light 400 or received pulse of light 410.

In FIG. 27, the photocurrent signal i and the corresponding voltage signal 360 each includes an AM signal with periodic temporal pulsations (which may be referred to as pulsations, periodic pulsations, temporal pulsations, or amplitude modulation). Each pulsation is separated by a time interval 1/ΔF, which corresponds to the temporal pulsations occurring at a frequency of ΔF. The photocurrent signal i, the AM photocurrent signal i_{AM}, and the voltage signal 360 may each be referred to as having a frequency component with a frequency of ΔF. The lower voltage-signal graph is a frequency-domain graph of the voltage signal 360 that indicates that the voltage signal 360 is centered at a frequency of ΔF and has an electrical bandwidth of Δν. The voltage signal 360 being centered at the frequency ΔF indicates that the voltage signal 360 has a frequency component at approximately ΔF, which corresponds to the periodic time-domain pulsations with time interval 1/ΔF. The frequency component ΔF in the voltage signal 360 arises at least in part from the frequency offset of Δf between the received pulse of light 410 and the LO light 430, where the frequency component ΔF is related to the frequency offset Δf. For example, the frequency offset Δf and the frequency component ΔF may be approximately equal or may differ based on a Doppler frequency shift of the received pulse of light 410. If the received pulse of light 410 has a Doppler frequency shift of FD, then the frequencies Δf and ΔF may be related by the expression ΔF=|Δf+F_{D}|. The coherent mixing of LO light 430 and the received pulse of light 410 may result in a photocurrent signal i with a coherent-mixing term that may be expressed as E_{Rx}E_{LO} cos[2πΔF·t+ϕ_{Rx}−ϕ_{LO}] or as E_{Rx}E_{LO} cos[Δω·t+ϕ_{Rx}−ϕ_{LO}], where Δω=2πΔF. Here, since the optical frequencies of the LO light 430 and the received pulse of light 410 are offset by ΔF, the coherent-mixing term varies periodically with a frequency of ΔF. This temporal variation in the coherent-mixing term corresponds to the periodic temporal pulsations and the frequency component of ΔF in the ΔM photocurrent signal i_{AM} and the voltage signal 360 in FIG. 27. A frequency-domain graph of an electrical signal (e.g., a voltage or current signal) may have a y-axis with units of the electrical signal (e.g., voltage or current) or with units of electrical power (e.g., watts), which may be referred to as radio-frequency (RF) power. For example, the y-axis of the frequency-domain graph of the voltage signal 360 in FIG. 27 may have units of electrical power.

The photocurrent signal i in FIG. 27 includes a DC offset that may correspond to substantially constant optical power from residual LO light 430 that is not coherently mixed or from other background light. The detector 340 may be coupled to the electronic amplifier 350 by a high-pass or band-pass filter or by an alternating-current-coupled (AC-coupled) electrical connection, or the amplifier 350 may include a high-pass or band-pass filter or an AC-coupled electrical connection. A high-pass filter, a band-pass filter, or an AC-coupled electrical connection may remove or attenuate the DC offset of the photocurrent signal i so that the resulting voltage signal 360 includes little or no DC offset, as illustrated in FIG. 27.

In particular embodiments, a frequency offset Δf of an emitted pulse of light 400 or a corresponding frequency offset ΔF of a received pulse of light 410 may be configured to be greater than 1/Δτ (where Δτ is the duration of an emitted pulse of light 400 or a received pulse of light 410) or greater than 1/Δτ′ (where Δτ′ is the duration of a voltage pulse corresponding to a received pulse of light 410). For example, the frequency offset Δf may be approximately equal to 2/Δτ, 4/Δτ, 10/Δτ, 20/Δτ, or any other suitable factor of 1/Δτ. As another example, an emitted pulse of light 400 with a duration Δτ of 5 ns may have a frequency offset Δf of greater than 200 MHZ. As another example, a light source 110 that emits 5-ns pulses of light 400 may be configured so that the emitted pulses of light have a 1-GHz frequency offset with respect to the LO light 430. Having Δf or ΔF greater than 1/Δτ may ensure that voltage signal 360 includes a sufficient number of pulsations that are distinct from the overall pulse envelope of the voltage signal 360. In FIG. 27, ΔF is approximately equal to 3/Δτ′, and the voltage signal 360 includes approximately nine pulsations superimposed on the pulse envelope. For example, the received pulse of light 410 may have a duration Δτ of 4 ns, and the frequency offset ΔF may be approximately 750 MHZ. This 3× difference between ΔF and 1/Δτ may allow the frequency component ΔF in the voltage signal 360 to be determined distinctly from a frequency component associated with the overall pulse envelope of the voltage signal 360. A frequency offset Δf or ΔF may be selected to be less than a maximum electrical bandwidth of a receiver 140 so that the receiver is able to detect the temporal pulsations associated with the frequency offset. For example, the receiver 140 may have an electrical bandwidth from approximately 100 MHz to approximately 5 GHZ, and a light source 110 may be configured so that the frequency offset Δf is greater than 1/Δτ and within the 100-MHz to 5-GHZ frequency range.

In particular embodiments, an electrical bandwidth Δν of a voltage signal 360 may be approximately equal to a numeric combination of the linewidths of the corresponding LO light 430 and received pulse of light 410. The electrical bandwidth Δν may be greater than both of the linewidths Δν₀ and Δν₁. For example, the electrical bandwidth Δν may be approximately equal to the sum of the linewidths of the LO light 430 and the received pulse of light 410 (e.g., Δν≈Δν₀+Δν₁). In FIG. 27, the LO light 430 may have a spectral linewidth Δν₀ of approximately 3 MHz, and the received pulse of light 410 may have a spectral linewidth Δν₁ of approximately 150 MHz. The electrical bandwidth Δν of the voltage signal 360 may be approximately equal to the sum of the two linewidths, or 153 MHZ. As another example, the electrical bandwidth Δν may be approximately equal to \sqrt{Δν₀²+Δν₁²}.

In particular embodiments, a frequency offset of Δf applied to an emitted pulse of light 400 may correspond to or may be referred to as a spectral signature imparted to the emitted pulse of light. For example, a receiver 140 may include a detection circuit 361 to determine the amplitude of a frequency component having a frequency of approximately Δf in a voltage signal 360. The detection circuit 361 may include a frequency-detection channel with an electronic band-pass filter that transmits a range of frequencies around the frequency Δf, and a signal produced by the detection circuit may be used to determine an amplitude of the Δf frequency component. The signal produced by a detection circuit 361 may be used to determine (i) whether a received pulse of light 410 is valid and is associated with a pulse of light 400 emitted by the light source 110 or (ii) whether a received pulse of light is not valid or is associated with an interfering optical signal. For a coherent pulsed lidar system 100, a pulse of light that is valid may refer to a received pulse of light 410 that includes scattered light from a corresponding pulse of light 400 that was emitted by a light source 110 of the lidar system 100. A pulse of light that is not valid may refer to a pulse of light or an interfering optical signal received by the lidar system 100 that did not originate from the lidar system (e.g., the pulse of light may have been emitted by a different lidar system or some other interfering optical source external to the lidar system 100).

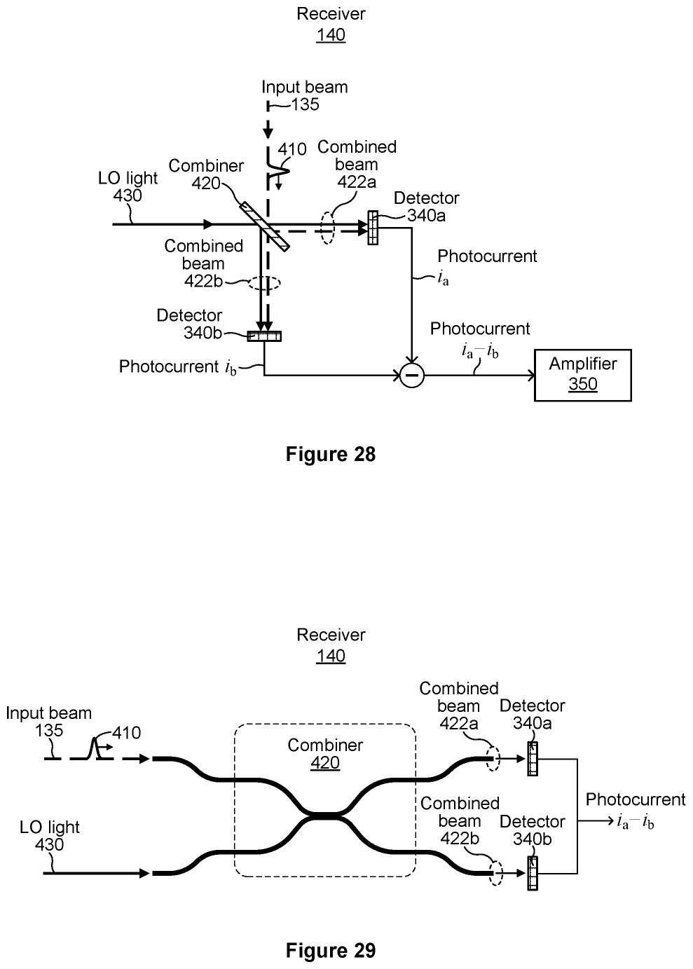

FIG. 28 illustrates an example receiver 140 that includes a combiner 420 and two detectors (340a, 340b). In particular embodiments, a receiver 140 of a lidar system 100 may include an optical combiner 420 that (i) combines LO light 430 with a received pulse of light 410 (which is part of an input beam 135) and (ii) directs a first portion 422a of the combined light to a first output and directs a second portion 422b of the combined light to a second output. For example, combiner 420 may be a 50-50 free-space optical beam-splitter that reflects approximately 50% of incident light and transmits approximately 50% of incident light. In FIG. 28, the combined beam 422a is directed to detector 340a and includes a transmitted portion of LO light 430 and a reflected portion of the received pulse of light 410 (e.g., approximately 50% of the incident LO light 430 and approximately 50% of the received pulse of light 410). Similarly, the combined beam 422b is directed to detector 340b and includes a reflected portion of LO light 430 and a transmitted portion of the received pulse of light 410.

In particular embodiments, a receiver 140 of a lidar system 100 may include one or more detectors 340 configured to produce one or more respective photocurrent signals i corresponding to coherent mixing of LO light 430 and a received pulse of light 410. The receiver 140 in FIG. 28 includes two detectors 340a and 340b, and each detector produces a respective photocurrent signal iₐ and i_{b}. The portions of LO light 430 and received pulse of light 410 that make up the combined beam 422a may be coherently mixed at detector 340a to produce the photocurrent signal iₐ. Similarly, the portions of LO light 430 and received pulse of light 410 that make up the combined beam 422b may be coherently mixed at detector 340b to produce the photocurrent signal i_{b}.

In particular embodiments, each of the detectors 340a and 340b may produce a photocurrent signal, and the two detectors 340a and 340b may be configured so that their respective photocurrents iₐ and i_{b} are subtracted. For example, the anode of detector 340a may be electrically connected to the cathode of detector 340b, and the subtracted photocurrent signal iₐ−i_{b} from the anode-cathode connection may be sent to amplifier 350. The subtracted photocurrent signal may be expressed as iₐ(t)−i_{b}(t)=2E_{Rx}E_{LO} cos[(ω_{Rx}−ω_{LO})t+ω_{Rx}(t)−ϕ_{LO}(t)], or equivalently as iₐ(t)−i_{b}(t)=2E_{Rx}E_{LO} cos[2πΔF·t+Δϕ], which corresponds to the coherent-mixing term discussed herein. The subtracted photocurrent signal does not include the terms E_{Rx} and E_{LO}². By subtracting the two photocurrents, the common-mode terms E_{Rx}² and E_{LO}² (as well as common-mode noise) that appear in each of the photocurrent signals iₐ and i_{b} are removed, leaving the coherent-mixing term, which is the quantity of interest. Since subtracting may remove common-mode noise, the subtracted photocurrent signal may have a reduced noise compared to each of the photocurrent signals iₐ and i_{b} alone.

FIG. 29 illustrates an example receiver 140 that includes an integrated-optic combiner 420 and two detectors (340a, 340b). The integrated-optic combiner 420 in FIG. 29 may function similar to the free-space optical combiner 420 in FIG. 28, but the integrated-optic combiner 420 may include optical waveguides that direct, combine, or split light (rather than having the light propagate as free-space beams). The integrated-optic combiner 420 may be part of a PIC that includes two input ports and two output ports. In FIG. 29, one input port receives the input beam 135 (which includes a received pulse of light 410), and the other input port receives the LO light 430. The combiner 420 combines the input beam 135 with the LO light 430 and directs combined beam 422a to one output port and combined beam 422b to the other output port. The combined beam 422a is directed to detector 340a and includes portions of the LO light 430 and the received pulse of light 410 (e.g., approximately 50% of the LO light 430 and approximately 50% of the received pulse of light 410). The combined beam 422b is directed to detector 340b and includes the other portions of the LO light 430 and the received pulse of light 410. In FIG. 29 (as in FIG. 28), the photocurrents from each of the detectors 340a and 340b are subtracted to produce a subtracted photocurrent signal iₐ−i_{b} that may be sent to an amplifier. The subtracted photocurrent signal in FIG. 29 (as in FIG. 28) may be expressed as iₐ(t)−i_{b}(t)=2E_{Rx}E_{LO} cos[2πΔF·t+Δϕ], where ΔF is the frequency offset between the received pulse of light 410 and the LO light 430.

In particular embodiments, a receiver 140 may include one or more lenses. For example, the receiver 140 in FIG. 28 may include one or more lenses (not illustrated in FIG. 28) that focus the combined beam 422a onto the detector 340a or that focus the combined beam 422b onto the detector 340b. As another example, the receiver 140 in FIG. 29 may include one or more lenses (not illustrated in FIG. 29) that focus the input beam 135 or the LO light 430 into an optical waveguide of the combiner 420. As another example, the receiver 140 in FIG. 29 may include one or more lenses (not illustrated in FIG. 29) that focus the combined beam 422a as a free-space optical beam onto the detector 340a or that focus the combined beam 422b as a free-space optical beam onto the detector 340b. Alternatively, each of the detectors 340a and 340b in FIG. 29 may be butt-coupled or affixed to an output port of the combiner 420 without an intervening lens. For example, detectors 340a and 340b may each be positioned close to an output port of the combiner 420 to directly receive the respective combined beams 422a and 422b. In FIG. 29, rather than being free-space optical beams, the combined beams 422a and 422b may primarily be confined beams that propagate through a waveguide of the combiner 420 and are directly coupled, with a minimum of free-space propagation (e.g., less than 1 mm of free-space propagation), onto the detectors 340a and 340b.

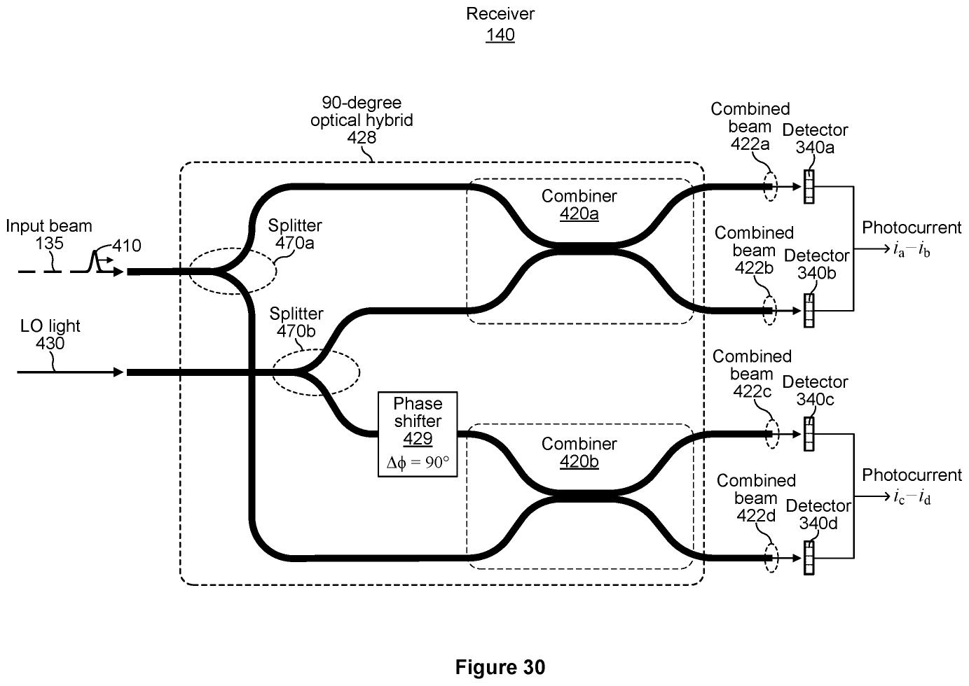

FIG. 30 illustrates an example receiver 140 that includes a 90-degree optical hybrid 428 and four detectors (340a, 340b, 340c, 340d). A 90-degree optical hybrid 428 is an optical-combiner component that may include two input ports and four output ports. Input light received at each of the two input ports is combined and split between each of the four output ports. In particular embodiments, a receiver 140 may include a 90-degree optical hybrid 428 that combines LO light 430 and an input beam 135 (which includes a received pulse of light 410) and produces four combined beams (422a, 422b, 422c, 422d). Each of the combined beams may include a portion of the LO light 430 and a portion of the received pulse of light 410, and each of the combined beams may be directed to one of the four detectors of the receiver 140. In FIG. 30, each of the four detectors may produce a photocurrent signal that corresponds to the coherent mixing of a portion of LO light 430 with a portion of the received pulse of light 410.

In particular embodiments, a 90-degree optical hybrid 428 may be configured so that the combined beams directed to each of the output ports may have approximately the same optical power or energy. For example, the 90-degree optical hybrid 428 in FIG. 30 may split the input beam 135 into four approximately equal portions and direct each of the input-beam portions to one of the detectors. Similarly, the LO light 430 may be split into four approximately equal portions directed to each of the four detectors. In the example of FIG. 30, the combined beam 422a, which is directed to detector 340a, may include approximately one-quarter of the power of the LO light 430 and approximately one-quarter of the energy of the received pulse of light 410. Similarly, each of the other combined beams (422b, 422c, 422d) in FIG. 30 may also include approximately one-quarter of the LO light 430 and approximately one-quarter of the received pulse of light 410.

In particular embodiments, a 90-degree optical hybrid 428 may be implemented as an integrated-optic device. The 90-degree optical hybrid 428 in FIG. 30 is an integrated-optic device that includes two integrated-optic splitters (470a, 470b) and two integrated-optic combiners (420a, 420b). Splitter 470a may split the received pulse of light 410 into two parts having substantially equal pulse energy, a first part directed to combiner 420a and a second part directed to combiner 420b. Similarly, splitter 470b may split the LO light 430 into two parts having substantially equal power, a first part directed to combiner 420a and a second part directed to combiner 420b. Each optical combiner may combine a part of the received pulse of light 410 with a part of the LO light 430, and the combined parts may be split into a first combined beam (e.g., combined beam 422a) and a second combined beam (e.g., combined beam 422b). The combined beam 422a is directed to detector 340a and includes portions of the LO light 430 and the received pulse of light 410 (e.g., approximately 25% of the LO light 430 and approximately 25% of the received pulse of light 410). The combined beam 422b is directed to detector 340b and may include approximately 25% of the LO light 430 and approximately 25% of the received pulse of light 410.

In particular embodiments, a 90-degree optical hybrid 428 may be implemented as a free-space optical device. For example, a free-space 90-degree optical hybrid 428 may include a beam-splitter cube that receives input beam 135 and LO light 430 as free-space beams and produces four free-space combined beams (422a, 422b, 422c, 422d). In particular embodiments, a 90-degree optical hybrid 428 may be implemented as a fiber-optic device. For example, a free-space 90-degree optical hybrid 428 may be contained in a package with two input optical fibers that direct the input beam 135 and LO light 430 into the package and four output optical fibers that receive the four respective combined beams and direct them to four respective detectors.

In particular embodiments, a 90-degree optical hybrid 428 may include an optical phase shifter 429 that imparts a 90-degree phase change (Δϕ) to a part of a received pulse of light 410 or to a part of the LO light 430. For example, a splitter 470a may split the received pulse of light 410 into two parts, and a phase shifter 429 may impart a 90-degree phase change to one part of the pulse of light 410 with respect to the other part. As another example, a splitter 470b may split the LO light 430 into two parts, and a phase shifter 429 may impart a 90-degree phase change to one part of the LO light 430 with respect to the other part. In FIG. 30, splitter 470b splits the LO light 430 into two parts, and the phase shifter 429 imparts a 90-degree phase change to the part of LO light 430 directed to combiner 420b. The other part of LO light 430 directed to combiner 420a does not pass through the phase shifter 429 and does not receive a phase shift from the phase shifter 429. A 90-degree phase change may also be expressed in radians as a π/2 phase change.

In particular embodiments, an optical phase shifter 429 may be implemented as a part of an integrated-optic 90-degree optical hybrid 428. For example a phase shifter 429 may be implemented as a portion of optical waveguide that only one part of the LO light 430 propagates through. The portion of optical waveguide may be temperature controlled to adjust the refractive index of the waveguide portion and produce a relative phase delay of approximately 90 degrees between the two parts of LO light 430. Additionally or alternatively, the 90-degree optical hybrid 428 as a whole may be temperature controlled to set and maintain a 90-degree phase delay. As another example, a phase shifter 429 may be implemented by applying an external electric field to a portion of optical waveguide to change the refractive index of the waveguide portion and produce a 90-degree phase delay. In particular embodiments, a phase shifter 429 may be implemented as a part of a free-space or fiber-coupled 90-degree optical hybrid 428. For example the input and output beams in a free-space 90-degree optical hybrid 428 may be reflected by or transmitted through the optical surfaces of the optical hybrid 428 so that a relative phase shift of 90 degrees is imparted to one part of LO light 430 with respect to the other part of LO light 430.

In FIG. 30, the photocurrents from detectors 340a and 340b are subtracted to produce the subtracted photocurrent signal iₐ(t)−i_{b}(t)=E_{Rx}E_{LO} cos[(ω_{Rx}−ω_{LO})t+ω_{Rx}(t)−ϕ_{LO}(t)]. Similarly, the photocurrents from detectors 340c and 340d are subtracted to produce the photocurrent signal i_{c}(t)−i_{d}(t)=E_{Rx}E_{LO} Sin[(ω_{Rx}−ω_{LO})t+ω_{Rx}(t)−ϕ_{LO}(t)]. Each of the subtracted photocurrent signals represents a coherent-mixing term corresponding to the coherent mixing of a portion of the received pulse of light 410 and a portion of the LO light 430. The two subtracted photocurrent signals are similar, except iₐ−i_{b} includes a cosine function, while i_{c}−iₐ includes a sine function. This difference between the two subtracted photocurrent signals arises from the 90-degree phase shift provided by the phase shifter 429. Because a 90-degree phase shift is imparted to the LO light 430 directed to the combiner 420b, the subtracted photocurrent signal i_{c}−iₐ includes a sine function (which has a 90-degree phase offset with respect to a cosine function).

In particular embodiments, a receiver 140 of a lidar system 100 may include one or more detectors 340. A receiver 140 may include one detector 340 (e.g., as illustrated in FIGS. 3 and 6), or a receiver 140 may include multiple detectors 340 (e.g., as illustrated in FIGS. 28-31). A receiver 140 with multiple detectors 340 may include 2, 3, 4, 5, 10, 20, or any other suitable number of detectors. For example, a receiver 140 may include two detectors arranged so that their respective photocurrents are subtracted (e.g., as illustrated in FIGS. 28 and 29). As another example, a receiver 140 may include a one-dimensional array of detectors (e.g., a 1×4 array of four detectors) or a two-dimensional array of detectors (e.g., a 16×16 array of 64 detectors). In a receiver 140 with multiple detectors 340, a received pulse of light 410 and LO light 430 may be coherently mixed together at one or more of the multiple detectors 340, and each of these one or more detectors may produce a photocurrent signal i corresponding to the coherent mixing of the received pulse of light and the LO light. Any of the receivers 140 described herein as having a single detector 340 may also be configured to have two or more detectors. For example, the receiver 140 in FIG. 6 (which includes one detector 340) may include a second detector (not illustrated in FIG. 6), and the detection circuit 361 may be configured to receive and process photocurrent signals from each of the two detectors.

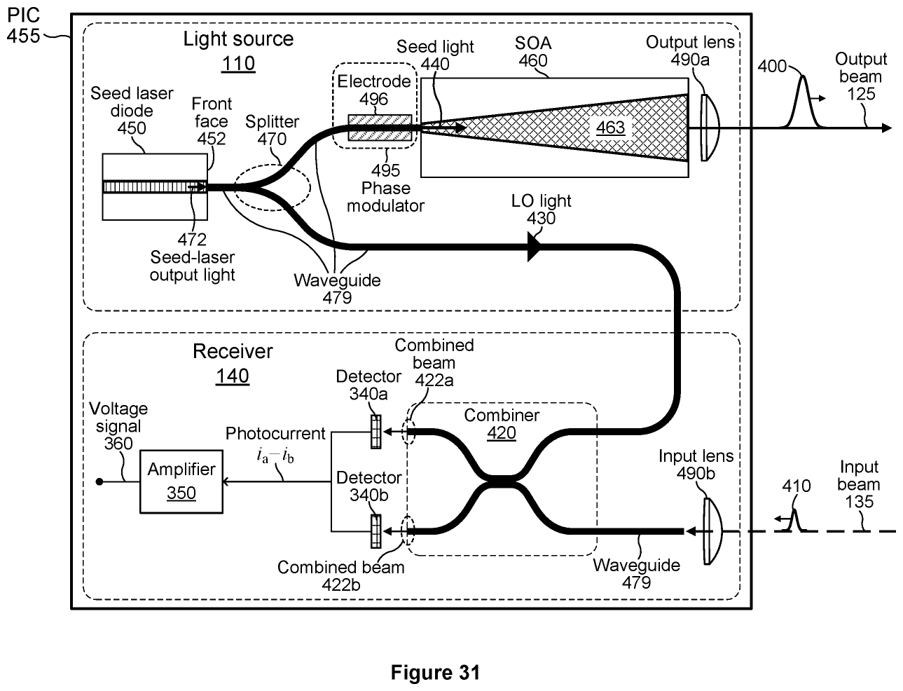

FIG. 31 illustrates an example light source 110 and receiver 140 integrated into a photonic integrated circuit (PIC) 455. In particular embodiments, a lidar system 100 may include a PIC 455 where at least part of the light source 110 or at least part of the receiver 140 is disposed on or in the PIC 455. The PIC 455 in FIG. 31 includes the following optical components: seed laser diode 450, splitter 470, phase modulator 495, SOA 460, output lens 490a, input lens 490b, combiner 420, and detectors 340a and 340b. Additionally, the PIC 455 includes optical waveguides 479 that convey light from one optical component to another. The waveguides 479 may be passive optical waveguides formed in a PIC substrate material that includes silicon, InP, glass, polymer, or lithium niobate. The amplifier 350 in FIG. 31 may be attached to, electrically coupled to, or located near the PIC 455. One or more optical components of the light source 110 or receiver 140 may be fabricated separately and then integrated with the PIC 455. For example, the seed laser diode 450, SOA 460, lenses 490a and 490b, or detectors 340a and 340b may be fabricated separately and then integrated into the PIC 455. An optical component may be integrated into the PIC 455 by attaching or connecting the optical component to the PIC 455 or to a substrate to which the PIC 455 is also attached. For example, an optical component may be attached to a PIC 445 using epoxy or solder.

In particular embodiments, a PIC 455 may include a phase or amplitude modulator 495 that changes a frequency or amplitude of seed light 440, emitted pulses of light 400, or LO light 430. The phase modulator 495 in FIG. 31 is located after the splitter 470 and may be used to change the optical frequency of the seed light 440. In particular embodiments, a phase modulator 495 may be fabricated directly into a PIC 455. For example, a PIC substrate may be made from lithium niobate, and a phase modulator 495 may be fabricated by depositing an electrode 496 near a portion of a lithium-niobate waveguide 479. Alternatively, a phase modulator 495 may be fabricated separately and then integrated into a PIC 455. For example, the PIC waveguides 479 may be glass-based waveguides, and the phase modulator 495 may be fabricated from lithium niobate. The lithium-niobate phase modulator 495 may be incorporated into the PIC 455 by aligning the waveguide of the modulator 495 with a PIC waveguide 479 and then attaching the modulator 495 to the PIC 455. In particular embodiments, a PIC 455 may not include a phase modulator 495. For example, instead of using a phase modulator 495 to impart frequency changes, a light source 110 that is incorporated into a PIC 455 may impart frequency changes to seed light 440, emitted pulses of light 400, or LO light 430 based on the seed current hi supplied to a seed laser diode 450 or based on the SOA current I₂ supplied to a SOA 460. Alternatively, the seed laser diode 450 may be a frequency-tunable laser diode. As another example, the light source 110 may include two or more laser diodes (e.g., a seed laser diode 450a and an LO laser diode 450b, as illustrated in FIG. 12A).

In particular embodiments, a PIC 455 may include one or more optical waveguides 479 that direct seed light 440 to a SOA 460 and direct LO light 430 to a receiver 140. For example, a light source 110 may include a PIC 455 with an optical waveguide 479 that receives seed light 440 from a seed laser diode 450 and directs the seed light 440 to a SOA 460. As another example, an optical waveguide 479 may receive seed-laser output light 472 from a seed laser diode 450 and direct a portion of the seed-laser output light 472 (which corresponds to the seed light 440) to a SOA 460. In FIG. 31, an optical waveguide 479 of the PIC 455 receives the seed-laser output light 472 from the front face 452 of the seed laser diode 450 and directs the output light 472 to the splitter 470. The splitter 470 splits the seed-laser output light 472 to produce the seed light 440 and the LO light 430. One optical waveguide 479 directs the seed light 440 from the splitter 470 to the SOA, and along the way, the seed light 440 passes through a phase modulator 495, which may impart a frequency change to the seed light 440. Another optical waveguide 479 directs the LO light 430 from the splitter 470 to the combiner 420 of the receiver 140.

In particular embodiment, a PIC 455 may include one or more optical splitters 470, one or more optical combiners 420, or one or more optical modulators 495. The one or more splitters 470, combiners 420, or modulators 495 may be configured to split, combine, or modulate the seed-laser output light 472, seed light 440, LO light 430, emitted pulses of light 400, or received pulses of light 410. In FIG. 31, the optical splitter 470 is an optical-waveguide splitter 470 that splits the seed-laser output light 472 to produce the seed light 440 and the LO light 430. The phase modulator 495 is an integrated-optic phase modulator 495 configured to change the frequency of the seed light 440. The integrated-optic optical combiner 420 in FIG. 31 (which is similar to the combiner 420 illustrated in FIG. 29) combines the input beam 135, which includes the received pulse of light 410, with the LO light 430 and directs combined beam 422a to detector 340a and combined beam 422b to detector 340b.

In particular embodiments, a PIC 455 may include one or more lenses 490 configured to collimate light emitted from the PIC 455 or focus light into the PIC 455. A lens 490 may be attached to, connected to, or integrated with the PIC 455. For example, a lens 490 may be fabricated separately and then attached to the PIC 455 (or to a substrate to which the PIC 455 is attached) using epoxy or solder. The output lens 490a in FIG. 31 may collimate the emitted pulses of light 400 from the SOA 460 to produce a collimated output beam 125. The output beam 125 may be scanned across a field of regard by a scanner 120 (not illustrated in FIG. 31). Light from an emitted pulse of light 400 may be scattered by a target 130, and a portion of the scattered light may be directed to the receiver 140 as a received pulse of light 410. The input lens 490b in FIG. 31 may focus the received pulse of light 410 into a waveguide 479 of the PIC 455, which directs the received pulse of light 410 to the combiner 420. The combiner 420 combines the received pulse of light 410 with the LO light 430, and portions of the received pulse of light 410 and the LO light 430 are coherently mixed at each of the detectors 340a and 340b.

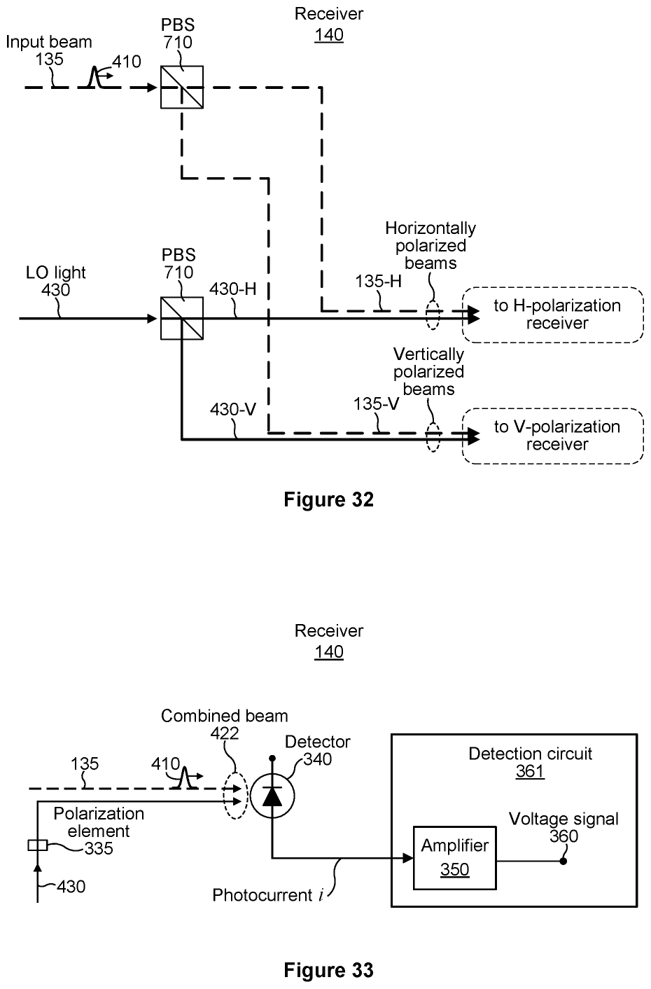

FIG. 32 illustrates an example receiver 140 that includes two polarization beam-splitters 710. In particular embodiments, a receiver 140 may include an LO-light polarization splitter 710 that splits LO light 430 into two orthogonal polarization components (e.g., horizontal and vertical). Additionally, the receiver 140 may include an input-beam polarization splitter 710 that splits an input beam 135 (which includes a received pulse of light 410) into the same two orthogonal polarization components. In FIG. 32, the LO-light polarization beam-splitter (PBS) 710 splits the LO light 430 into a horizontally polarized LO-light beam 430-H and a vertically polarized LO-light beam 430-V. Similarly, the input-beam PBS 710 splits the input beam 135 into a horizontally polarized input beam 135-H and a vertically polarized input beam 135-V. The horizontally polarized beams are directed to a horizontal-polarization receiver, and the vertically polarized beams are directed to a vertical-polarization receiver. The receiver 140 illustrated in FIG. 32 may be referred to as a polarization-insensitive receiver since the receiver 140 may be configured to detect received pulses of light 410 regardless of the polarization of the received pulses of light 410.

In particular embodiments, a polarization-insensitive receiver 140 as illustrated in FIG. 32 may be implemented with free-space components, fiber-optic components, integrated-optic components, or any suitable combination thereof. For example, the two PBSs 710 may be free-space polarization beam-splitting cubes, and the input beam 135 and the LO light 430 may be free-space optical beams. As another example, the two PBSs 710 may be fiber-optic components, and the input beam 135 and the LO light 430 may be conveyed to the PBSs 710 via optical fiber (e.g., single-mode optical fiber or polarization-maintaining optical fiber). Additionally, the horizontally and vertically polarized beams may be conveyed to the respective H-polarization and V-polarization receivers via polarization-maintaining optical fiber.

In particular embodiments, a receiver 140 may include a horizontal-polarization receiver and a vertical-polarization receiver. The H-polarization receiver may combine a horizontally polarized LO-light beam 430-H and a horizontally polarized input beam 135-H and produce one or more photocurrent signals corresponding to coherent mixing of the two horizontally polarized beams. Similarly, the V-polarization receiver may combine the vertically polarized LO-light beam 430-V and the vertically polarized input beam 135-V and produce one or more photocurrent signals corresponding to coherent mixing of the two vertically polarized beams. Each of the H-polarization and V-polarization receivers may include (i) an optical combiner 420 and two detectors 340 (e.g., as illustrated in FIG. 28 or 29), (ii) a 90-degree optical hybrid 428 and four detectors 340 (e.g., as illustrated in FIG. 30), or (iii) a single detector 340 (e.g., as illustrated in FIG. 6). The H-polarization and V-polarization receivers may each preserve the polarization of the respective horizontally and vertically polarized beams. For example, the H-polarization and V-polarization receivers may each include polarization-maintaining optical fiber that maintains the polarization of the beams. Additionally or alternatively, the H-polarization and V-polarization receivers may each include a PIC with optical waveguides configured to maintain the polarization of the beams.

The polarization of an input beam 135 may vary with time or may not be controllable by a lidar system 100. For example, the polarization of received pulses of light 410 may vary depending at least in part on (i) the optical properties of a target 130 from which pulses of light 400 are scattered or (ii) atmospheric conditions encountered by pulses of light 400 while propagating to the target 130 and back to the lidar system 100. However, since the LO light 430 is produced and contained within the lidar system 100, the polarization of the LO light 430 may be set to a particular polarization state. For example, the polarization of the LO light 430 sent to the LO-light PBS 710 may be configured so that the LO-light beam 430-H and 430-V produced by the PBS 710 have approximately the same power. The LO light 430 produced by a seed laser 450 may be linearly polarized, and a half-wave plate may be used to rotate the polarization of the LO light 430 so that it is oriented at approximately 45 degrees with respect to the LO-light PBS 710. The LO-light PBS 710 may split the 45-degree polarized LO light 430 into horizontal and vertical components having approximately the same power. By providing a portion of the LO light 430 to both the H-polarization receiver and the V-polarization receiver, the receiver 140 in FIG. 32 may produce a valid, non-zero output electrical signal regardless of the polarization of the received pulse of light 410.

Coherent mixing of LO light 430 and a received pulse of light 410 may require that the electric fields of the LO light 430 and the received pulse of light 410 are oriented in approximately the same direction. For example, if LO light 430 and input beam 135 are both vertically polarized, then the two beams may be optically combined together and coherently mixed at a detector 340. However, if the two beams are orthogonally polarized (e.g., LO light 430 is vertically polarized and input beam 135 is horizontally polarized), then the two beams may not be coherently mixed, since their electric fields are not oriented in the same direction. Orthogonally polarized beams that are incident on a detector 340 may not be coherently mixed, resulting in little to no output signal from a receiver 140. To mitigate problems with polarization-related signal variation, a lidar system 100 may include (i) a polarization-insensitive receiver 140 (e.g., as illustrated in FIG. 32) or (ii) an optical polarization element (e.g., polarization element 335 in FIG. 33) to ensure that at least a portion of the LO light 430 and input beam 135 have the same polarization.

A polarization-insensitive receiver 140 as illustrated in FIG. 32 may ensure that the receiver 140 produces a valid, non-zero output electrical signal in response to a received pulse of light 410, regardless of the polarization of the received pulse of light 410. For example, the output electrical signals from the H-polarization and V-polarization receivers may be added together, resulting in a combined output signal that is insensitive to the polarization of the received pulse of light 410. If a received pulse of light 410 is horizontally polarized, then the H-polarization receiver may generate a non-zero output signal and the V-polarization receiver may generate little to no output signal. Similarly, if a received pulse of light 410 is vertically polarized, then the H-polarization receiver may generate little to no output signal and the V-polarization receiver may generate a non-zero output signal. If a received pulse of light 410 has a polarization that includes a vertical component and a horizontal component, then each of the H-polarization and V-polarization receivers may generate a non-zero output signal corresponding to the respective polarization component. By adding together the signals from the H-polarization and V-polarization receivers, a valid, non-zero output electrical signal may be produced by the receiver 140 regardless of the polarization of the received pulse of light 410.

FIG. 33 illustrates an example receiver 140 that includes an optical polarization element 335. In particular embodiments, a receiver 140 may include an optical polarization element 335 that alters the polarization of an emitted pulse of light 400, LO light 430, or a received pulse of light 410. For example, an optical polarization element 335 (which may be referred to as a polarization element) may convert the polarization of an emitted pulse of light 400, LO light 430, or a received pulse of light 410 into circularly or elliptically polarized light. As another example, a polarization element 335 may depolarize the polarization of an emitted pulse of light 400, LO light 430, or a received pulse of light 410.

An optical polarization element 335 may allow LO light 430 and a received pulse of light 410 to be coherently mixed. For example, an optical polarization element may alter the polarization of the LO light 430 so that, regardless of the polarization of a received pulse of light 410, the LO light 430 and the received pulse of light 410 may be coherently mixed together. The optical polarization element may ensure that at least a portion of the received pulse of light 410 and the LO light 430 have polarizations that are oriented in the same direction so that their electric fields may be added together. An optical polarization element may include one or more quarter-wave plates, one or more half-wave plates, one or more optical polarizers, one or more optical depolarizers, or any suitable combination thereof. For example, the polarization element 335 in FIG. 33 may include a quarter-wave plate that converts the polarization of the LO light 430 to a substantially circular or elliptical polarization. An optical polarization element may include a free-space optical component, a fiber-optic component, an integrated-optic component, or any suitable combination thereof. In FIG. 33, the LO light 430 may be sent through the polarization element 335 prior to being combined with the input beam 135.

In particular embodiments, an optical polarization element 335 may be included in a receiver 140 as an alternative to configuring a receiver to be a polarization-insensitive receiver. For example, rather than producing horizontally polarized beams and vertically polarized beams and having two receiver channels (e.g., H-polarization receiver and V-polarization receiver, as illustrated in FIG. 32), a receiver 140 may include an optical polarization element that ensures that at least a portion of the LO light 430 and the received pulse of light 410 may be coherently mixed together. An optical polarization element 335 may be included in one or more of the receivers 140 described herein to allow the receiver to coherently mix the LO light 430 and a received pulse of light 410 regardless of the polarization of the received pulse of light 410.

The optical polarization element 335 in FIG. 33 may be a quarter-wave plate that converts the polarization of the LO light 430 into circularly or elliptically polarized light. For example, the LO light 430 produced by a laser diode may be linearly polarized, and a quarter-wave plate may convert the linearly polarized LO light 430 into circularly polarized light. The circularly polarized LO light 430 may include both vertical and horizontal polarization components. So, regardless of the polarization of a received pulse of light 410, at least a portion of the circularly polarized LO light 430 may be coherently mixed with the received pulse of light 410.

The optical polarization element 335 in FIG. 33 may be a depolarizer that depolarizes the polarization of the LO light 430. For example, the LO light 430 produced by a laser diode may be linearly polarized, and an optical depolarizer may convert the linearly polarized LO light 430 into depolarized light having a polarization that is substantially random or scrambled. The depolarized LO light 430 may include two or more different polarizations so that, regardless of the polarization of a received pulse of light 410, at least a portion of the depolarized LO light 430 may be coherently mixed with the received pulse of light 410. An optical depolarizer may include a Cornu depolarizer, a Lyot depolarizer, a wedge depolarizer, or any other suitable depolarizer element.

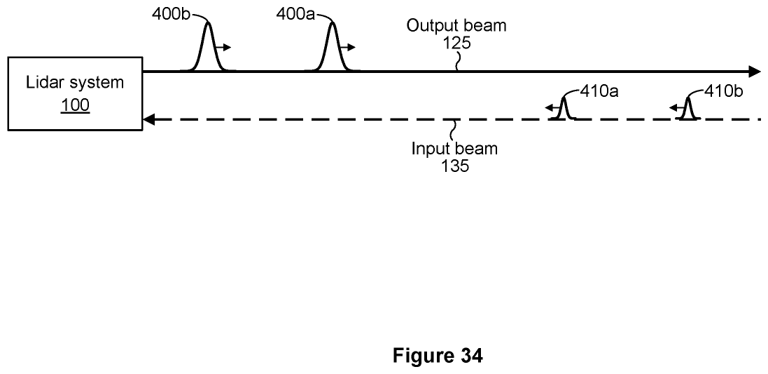

FIG. 34 illustrates an example lidar system 100 with two emitted pulses of light (400a, 400b) and two received pulses of light (410a, 410b). The lidar system 100 may include a light source 110 that emits the two pulses of light 400a and 400b which are part of an output beam 125 that is scanned across a field of regard of the lidar system. The input beam 135 includes received pulses of light 410a and 410b, which may be detected by a receiver 140 of the lidar system 100. Received pulse of light 410a may be associated with emitted pulse of light 400a (e.g., received pulse of light 410a may include light from emitted pulse of light 400a that is scattered by a target 130), and received pulse of light 410b may be associated with emitted pulse of light 400b. The lidar system 100 in FIG. 34 may be a coherent pulsed lidar system in which each received pulse of light (410a, 410b) is coherently mixed with LO light 410. Based on the frequency components of the AM photocurrent signals that result from the coherent mixing of the received pulses of light, the lidar system 100 may determine that received pulse of light 410a is associated with emitted pulse of light 400a. Additionally, the lidar system 100 may determine that received pulse of light 410b is associated with emitted pulse of light 400b.

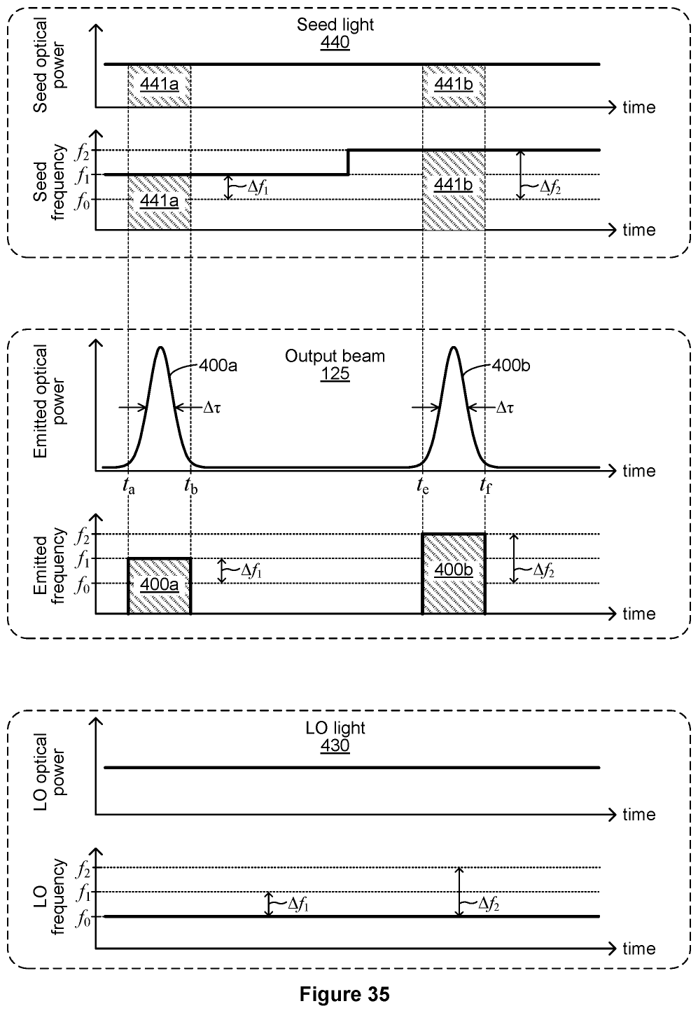

FIG. 35 illustrates example graphs of optical power and frequency for seed light 440, an output beam 125, and LO light 430. The output beam 125 includes two emitted pulses of light 400a and 400b, which correspond to the two emitted pulses of light in FIG. 34. The LO light 430 has a substantially constant optical frequency of f₀, and each emitted pulse of light (400a, 400b) has a different frequency offset with respect to the LO light. The seed light 440 is initially set to frequency f₁, and temporal portion 441a is then amplified to produce a first emitted pulse of light 400a at frequency f₁. The seed light 440 is then switched to frequency f₂, and temporal portion 441b is amplified to produce a second emitted pulse of light 400b at frequency f₂. The seed light 440 may be produced by a frequency-tunable laser diode 450, such as for example a SG-DBR laser (e.g., as illustrated in FIG. 9). The emitted pulse of light 400a has a frequency offset of Δf₁ with respect to the LO light 430, and the emitted pulse of light 400b has a different frequency offset of Δf₂, where frequency offset Δf₂ is greater than frequency offset Δf₁. Each of the frequency offsets may be fixed or substantially constant. For example, the frequency offset Δf₁ of the emitted pulse of light 400a may be 5 GHZ and may vary by less than 1%, 0.1%, or 0.01% over the pulse duration Δτ. Similarly, the frequency offset Δf₁ of the temporal portion 441a may be 5 GHZ and may vary by less than 1%, 0.1%, or 0.01% over the time interval from tₐ to t_{b} As another example, the optical frequency of the LO light may be 190.00 THz, and the optical frequency of pulse of light 400b may be 190.01 THz, which corresponds to a frequency offset Δf₂ of 10 GHZ. The 10-GHZ frequency offset Δf₂ of the pulse of light 400b may vary by less than 0.5 MHz over the pulse duration Δτ, and the frequency offset Δf₂ of the temporal portion 441b may vary by less than 0.5 MHz over the time interval from tₑ to t_{f}.

In particular embodiments, a light source 110 of a coherent pulsed lidar system 100 may emit pulses of light 400 where each pulse of light is offset from the optical frequency of LO light 430 by a particular, substantially fixed frequency offset of one or more different frequency offsets. While a light source 110 may emit pulses of light 400 having different frequency offsets, the optical frequency of each emitted pulse of light may have a particular frequency offset that is substantially fixed or constant with time (e.g., the optical frequency of a pulse of light and the optical frequency offset may not vary significantly over the duration of the pulse). Pulses of light 400 having a fixed frequency offset may be a characteristic of a pulsed coherent lidar system 100 that is different from an FMCW lidar system. An FMCW lidar system may emit frequency-modulated optical signals in which each optical signal has an optical frequency that varies over the duration of the optical signal (e.g., the optical frequency of an optical signal may vary linearly with time or may exhibit a sawtooth or triangle-wave frequency variation with time). Thus, while a coherent pulsed lidar system 100 as described herein may employ pulses of light 400 where each pulse of light has a substantially fixed optical frequency (as well as a substantially fixed frequency offset with respect to LO light 430), an FMCW lidar system may not employ optical signals having a substantially fixed optical frequency over time.

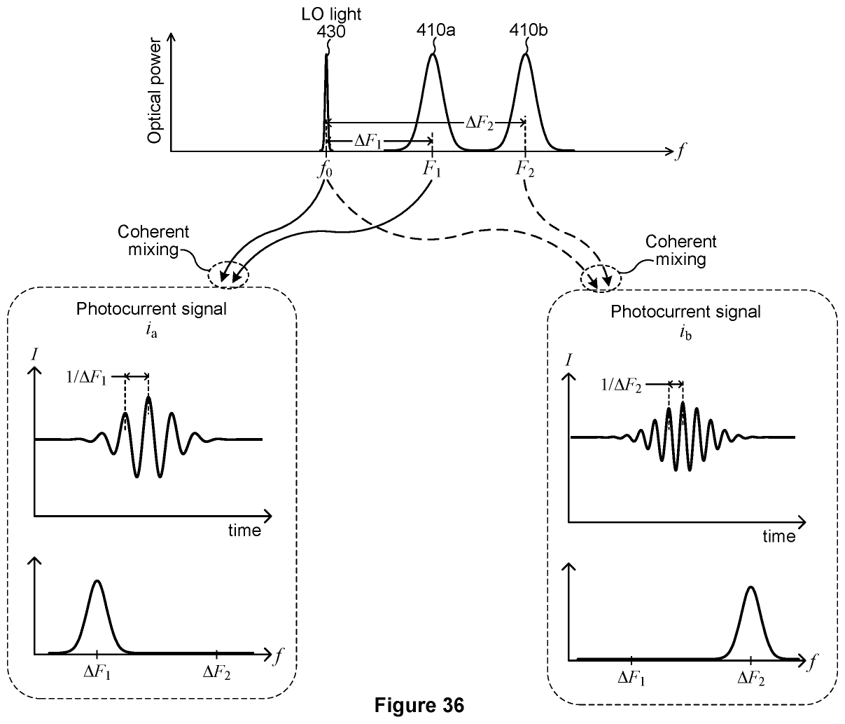

FIG. 36 illustrates two example photocurrent signals (iₐ, i_{b}) that result from coherent mixing of LO light 430 with two respective received pulses of light (410a, 410b). The two received pulses of light 410a and 410b correspond to the two received pulses of light in FIG. 34. The two received pulses may be detected at different times, and the corresponding photocurrent signals may be produced at different times. The LO light 430 has a center optical frequency of f₀, and the received pulses of light 410a and 410b have respective optical frequencies of F₁ and F₂. The optical frequency of received pulse of light 410a is offset by ΔF₁ with respect to the LO light 430, and the optical frequency of received pulse of light 410b is offset by ΔF₂, where frequency offset ΔF₂ is greater than frequency offset ΔF₁. Photocurrent signal iₐ, which results from the coherent mixing of received pulse of light 410a and LO light 430, includes an AM photocurrent signal with pulsations separated by a time interval of 1/ΔF₁ (which corresponds to the AM signal having a frequency of ΔF₁). Photocurrent signal in, which results from the coherent mixing of received pulse of light 410b and LO light 430, includes an AM signal with pulsations separated by a time interval of 1/ΔF₂ (which corresponds to the AM signal having a frequency of ΔF₂, where frequency ΔF₂ is greater than frequency ΔF₁).

In particular embodiments, different frequency offsets applied to emitted pulses of light 400 may correspond to different spectral signatures that may be used to associate a received pulse of light 410 with a particular emitted pulse of light 400. A conventional pulsed lidar system may encounter problems determining which emitted pulse of light a received pulse of light is associated with. In a coherent pulsed lidar system 100 in which emitted pulses of light 400 are “tagged” with particular frequency offsets, the different frequency offsets may prevent problems with ambiguity as to which emitted pulse of light a received pulse is associated with. For example, the different frequency offsets may allow a received pulse of light 410 to be unambiguously associated with a particular emitted pulse of light 400 based on the different frequency components associated with different received pulses of light 410.

A received pulse of light 410 that results in a photocurrent signal i with a frequency component at ΔF may be associated with an emitted pulse of light 400 having a corresponding Δf frequency offset. A lidar system 100 may determine that a received pulse of light 410 is associated with an emitted pulse of light 400 (which indicates that the received pulse of light includes light from the emitted pulse of light that is scattered by a target) based on a frequency component ΔF associated with the received pulse of light 410 matching the frequency offset Δf of the emitted pulse of light 400. The frequency ΔF matching the frequency offset Δf may refer to the two frequencies being approximately equal or being equal to within a particular threshold value. The frequency ΔF matching the frequency offset Δf may correspond to: (i) the frequency ΔF being within a particular percentage (e.g., within 10%, 5%, or 1%) of the frequency offset Δf; or (ii) the frequency ΔF being within a particular frequency (e.g., within 10 MHZ, 50 MHz, 100 MHz, or 200 MHZ) of the frequency offset Δf. For example, a frequency component ΔF that is within ±10% of a 10-GHz frequency offset Δf (e.g., the frequency ΔF is between 0.9 GHZ and 1.1 GHz) may be determined to match the frequency offset. As another example, a frequency component ΔF that is within ±50 MHz of a 5-GHz frequency offset Δf (e.g., the frequency ΔF is between 4.95 GHz and 5.05 GHZ) may be determined to match the frequency offset. As another example, a frequency component ΔF that is within ±100/−50 MHz of a 3-GHz frequency offset Δf (e.g., the frequency ΔF is between 2.95 GHZ and 3.1 GHZ) may be determined to match the frequency offset.

In FIG. 36, the received pulse of light 410a has a frequency offset of ΔF₁, which results in a photocurrent signal iₐ having an AM frequency component at frequency ΔF₁. The AM frequency component at frequency ΔF₁ may match the frequency offset Δf₁ of emitted pulse of light 400a in FIGS. 34-35, which indicates that the received pulse of light 410a is associated with the emitted pulse of light 400a. Similarly, the received pulse of light 410b has a frequency offset of ΔF₂, which results in a photocurrent signal in having an AM frequency component at frequency ΔF₂. The AM frequency component at frequency ΔF₂ may match the frequency offset Δf₂ of emitted pulse of light 400b in FIGS. 34-35, which indicates that the received pulse of light 410b is associated with the emitted pulse of light 400b. Since the two frequency offsets Δf₁ and Δf₂ of the emitted pulses of light are different, the two received pulses of light 410a and 410b may be unambiguously associated with the respective emitted pulses of light 400a and 400b.

In particular embodiments, a controller 150 of the lidar system 100 in FIG. 34 may determine which received pulses of light are associated with which emitted pulses of light based on electronic signals (e.g., voltage signal 360 or output signal 145) corresponding to the two AM photocurrent signals in FIG. 36: (i) the AM signal with frequency ΔF₁ associated with received pulse of light 410a and (ii) the AM signal with frequency ΔF₂ associated with received pulse of light 410b. For example, a controller 150 may determine that received pulse of light 410a is associated with emitted pulse of light 400a (e.g., received pulse of light 410a includes a portion of scattered light from emitted pulse of light 400a). The determination that received pulse of light 410a is associated with emitted pulse of light 400a may be based on the frequency ΔF₁ of the AM photocurrent signal iₐ matching the frequency offset Δf₁ between the emitted pulse of light 400a and the LO light 430. As another example, a controller 150 may determine that received pulse of light 410b is associated with emitted pulse of light 400b based on the frequency ΔF₂ of the AM photocurrent signal i_{b} matching the frequency offset Δf₂ between the emitted pulse of light 400b and the LO light 430. As another example, a controller 150 may determine that received pulse of light 410a is not associated with emitted pulse of light 400b based on the frequency ΔF₁ of the AM photocurrent signal iₐ not matching the frequency offset Δf₂ of the emitted pulse of light 400b. As another example, a controller 150 may determine that received pulse of light 410b is not associated with emitted pulse of light 400a based on the frequency ΔF₂ of the AM photocurrent signal is not matching the frequency offset Δf₁ of the emitted pulse of light 400a.

In particular embodiments, a light source 110 may emit pulses of light 400 where each emitted pulse of light 400 has a particular spectral signature of one or more different spectral signatures. A frequency change Δf imparted to an emitted pulse of light 400 may be referred to as a spectral signature and may be used to (i) determine whether a received pulse of light is a valid received pulse of light 410, (ii) associate a received pulse of light 410 with a particular emitted pulse of light 400 (e.g., based on the received pulse of light matching the spectral signature of the emitted pulse of light), or (iii) determine whether a received pulse of light is not valid or is an interfering optical signal. A light source 110 may impart a spectral signature (e.g., a frequency offset) of one or more different spectral signatures to seed light 440 or to an amplified temporal portion 441 of the seed light 440 so that each emitted pulse of light 400 includes one of the spectral signatures. For example, a light source 110 may impart the same frequency change Δf to each emitted pulse of light 400. If coherent mixing of a received pulse of light 410 with LO light 430 produces a frequency component at approximately the same frequency Δf, then the received pulse of light 410 may be determined to be a valid received pulse of light that is associated with one of the emitted pulses of light 400. If coherent mixing of a received pulse of light with LO light 430 does not produce a frequency component within a particular threshold of Δf (or the amplitude of the frequency component near Δf is below a particular threshold value), then the received pulse of light may be ignored or may be determined to be a non-valid optical signal. As another example, a light source 110 may impart one of N different frequency changes to each emitted pulse of light 400 (where N equals 1, 2, 3, 4, 5, 10, 20, 50, 100, or any other suitable positive integer). The frequency changes may be imparted in a repeating manner having a particular sequence or in a pseudo-random manner. If coherent mixing of a received pulse of light 410 with LO light 430 produces a frequency component within a particular threshold of one of the N frequencies Δfₙ, then the received pulse of light 410 may be determined to be associated with a particular emitted pulse of light 400 having a corresponding frequency change Δfₙ. If coherent mixing of a received pulse of light with LO light 430 does not produce a frequency component corresponding to one of the imparted frequency changes (or the amplitudes of the frequency components are below a particular threshold value), then the received pulse of light may be ignored or may be determined to be a non-valid optical signal.

In particular embodiments, a light source 110 may emit pulses of light 400 so that each emitted pulse of light 400 has a frequency offset that is different from (i) the frequency offset of the immediately preceding pulse of light and (ii) the frequency offset of the immediately following pulse of light. In FIG. 35, the emitted pulse of light 400b has a frequency offset Δf₂ that is different from the frequency offset Δf₁ of the previous pulse of light 400a. Additionally, a subsequent pulse of light 400 (not illustrated in FIG. 35) that is emitted after the pulse of light 400b (with no other intervening pulses between those two pulses) may have a frequency offset that is different from the frequency offset Δf₂ of the pulse of light 400b. The subsequent pulse of light may have a frequency offset of Δf₁ (e.g., the same as pulse of light 400a) or may have a frequency offset that is different from both Δf₁ and Δf₂. Emitting a sequence of pulses of light that have different frequency offsets may allow a lidar system 100 to associate each received pulse of light 410 with a particular emitted pulse of light 400 based on the different frequency offsets.

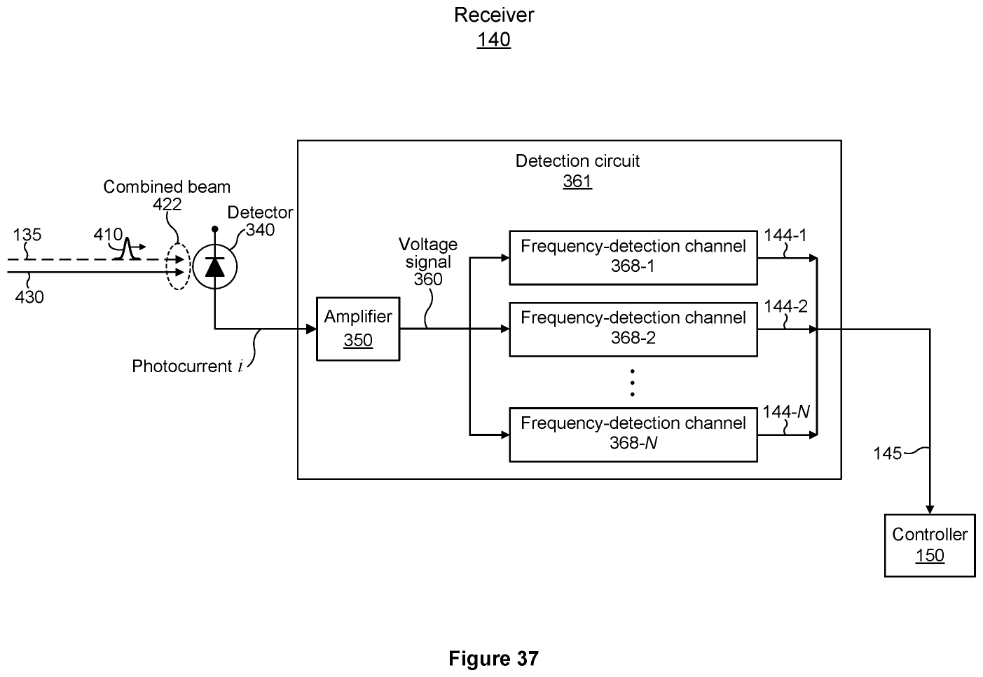

FIG. 37 illustrates an example receiver 140 that includes a detector 340 and a detection circuit 361. The receiver 140 may be part of a coherent pulsed lidar system 100 that includes a light source 110 that emits LO light 430 and pulses of light 400, where each emitted pulse of light is offset from the LO light by a particular frequency offset of one or more different frequency offsets. The receiver 140 in FIG. 37 detects the LO light 430 and the received pulse of light 410, which may include light from one of the emitted pulses of light 400 scattered by a target 130. The received pulse of light 410 and the LO light 430 may be coherently mixed together at the detector 340, and the detector 340 may produce a photocurrent signal i corresponding to the coherent mixing of the received pulse of light 410 and the LO light 430. The photocurrent signal i, which may include an AM photocurrent signal, is sent to a detection circuit 361 that produces an output signal 145. The output signal 145 may correspond to or may include an electronic representation of the AM photocurrent signal or the received pulse of light 410. The detector 340 in FIG. 37 may be referred to as an optical detector, and the detection circuit 361 may be referred to as an electronic detection circuit.

The controller 150 in FIG. 37 may receive the output signal 145 and determine, based on the output signal 145, that the received pulse of light 410 is associated with a particular emitted pulse of light 400. Additionally, the controller may determine, based on the output signal 145, a time-of-arrival of the received pulse of light 410. The controller 150 may be located within the receiver 140, within the lidar system 100 but outside the receiver 140, or outside the lidar system 100. For example, the controller 150 may include an ASIC located within the receiver 140. As another example, parts of the controller 150 may be located in two or more different places (e.g., an ASIC of the controller may be located within the receiver, and another part of the controller may be located external to the receiver).

The detection circuit 361 in FIG. 37 includes an electronic amplifier 350 and N frequency detection channels 368, where N is an integer greater than or equal to 1 (e.g., N may equal 1, 2, 3, 4, 5, 10, 20, 50, 100, or any other suitable positive integer). The electronic amplifier 350 receives the photocurrent signal i and produces a voltage signal 360 corresponding to the photocurrent signal. For example, the photocurrent signal i may include an AM photocurrent signal, and the voltage signal 360 may include a corresponding AM voltage signal (e.g., as illustrated in FIG. 27). The voltage signal 360 in FIG. 37 is sent to each of the N frequency-detection channels 368, and each frequency detection channel produces a portion 144 of the output signal 145. Each frequency-detection channel 368 may include one or more electronic filters, electronic mixers, electronic local oscillators, rectifiers, or digitizers. In FIG. 37, frequency-detection channel 368-1 produces output-signal portion 144-1, frequency-detection channel 368-2 produces output-signal portion 144-2, and frequency-detection channel 368-N produces output-signal portion 144-N. The output signal 145 which is sent to the controller 150 may include each of the output-signal portions 144-1 through 144-N.

In particular embodiments, a light source 110 of a coherent pulsed lidar system 100 may emit LO light 430 and pulses of light 400, where each emitted pulse of light is offset from the optical frequency of the LO light by a particular frequency offset of N different frequency offsets (where N is an integer greater than or equal to 1). Additionally, a receiver 140 of the lidar system 100 may include a detection circuit 361 with N frequency-detection channels 368, where each of the N frequency-detection channels 368 is associated with one of the N frequency offsets. For example, the output-signal portion 144 produced by each frequency-detection channel 368 may be associated with a particular frequency offset of the N frequency offsets. The output-signal portion 144 produced by a particular frequency-detection channel 368 may correspond to a particular frequency component of the AM photocurrent signal. For example, frequency-detection channel 368-1 may be associated with a 4-GHz frequency offset, and the output-signal portion 144-1 produced by frequency-detection channel 368-1 may correspond to a 4-GHz frequency component of the AM photocurrent signal. Similarly, frequency-detection channel 368-2 may be associated with a 5.5-GHz frequency offset, and the output-signal portion 144-2 produced by frequency-detection channel 368-2 may correspond to a 5.5-GHz frequency component of the AM photocurrent signal.

In FIG. 37, the parameter N may equal 3 so that the detection circuit 361 includes three frequency detection channels (368-1, 368-2, and 368-3) that produce three respective output-signal portions (144-1, 144-2, and 144-3). For example, each emitted pulse of light 400 may have one of the following three frequency offsets: 4 GHZ, 5.5 GHZ, and 7 GHZ. Frequency-detection channel 368-1 may be associated with the 4-GHz frequency offset, and the output-signal portion 144-1 may correspond to a 4-GHz frequency component of the AM photocurrent signal. Similarly, frequency-detection channel 368-2 may be associated with the 5.5-GHz frequency offset, and the output-signal portion 144-2 may correspond to a 5.5-GHz frequency component of the AM photocurrent signal. Additionally, frequency-detection channel 368-N (where N=3) may be associated with the 7-GHz frequency offset, and the output-signal portion 144-N may correspond to a 7-GHz frequency component of the AM photocurrent signal. If the received pulse of light 410 in FIG. 37 includes scattered light from an emitted pulse of light 400 with a 4-GHz frequency offset, then the photocurrent signal i may include an AM photocurrent signal with a frequency component of approximately 4 GHZ. Frequency-detection channel 368-1 may produce an output-signal portion 144-1 having a relatively large amplitude, corresponding to the presence of a 4-GHZ frequency component in the voltage signal 360. Additionally, frequency-detection channels 368-2 and 368-3 may each produce output-signal portions 144 having relatively small amplitudes, indicating the presence of little or no 5.5-GHZ and 7-GHz frequency components in the voltage signal 360. Based on the amplitudes of the three output-signal portions 144, the controller 150 may determine that the received pulse of light 410 is associated with the emitted pulse of light 400 having the 4-GHz frequency offset. For example, the determination that the received pulse of light 410 is associated with the emitted pulse of light 400 having the 4-GHz frequency offset may be based on the amplitude of output-signal portion 144-1 (i) exceeding a particular threshold value and (ii) being the largest of the three output-signal portions.

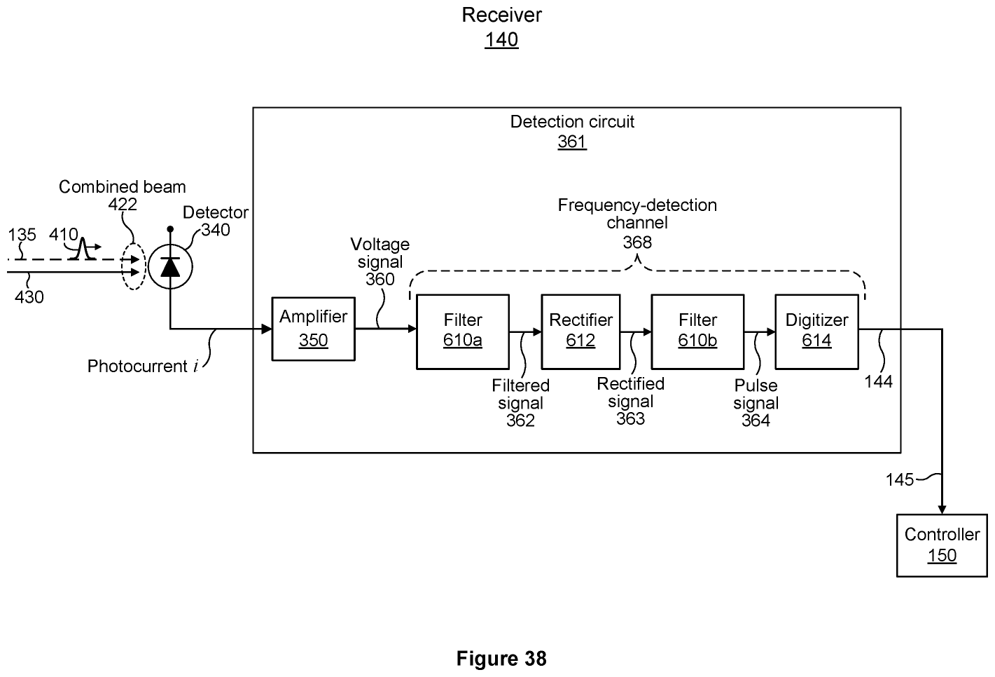

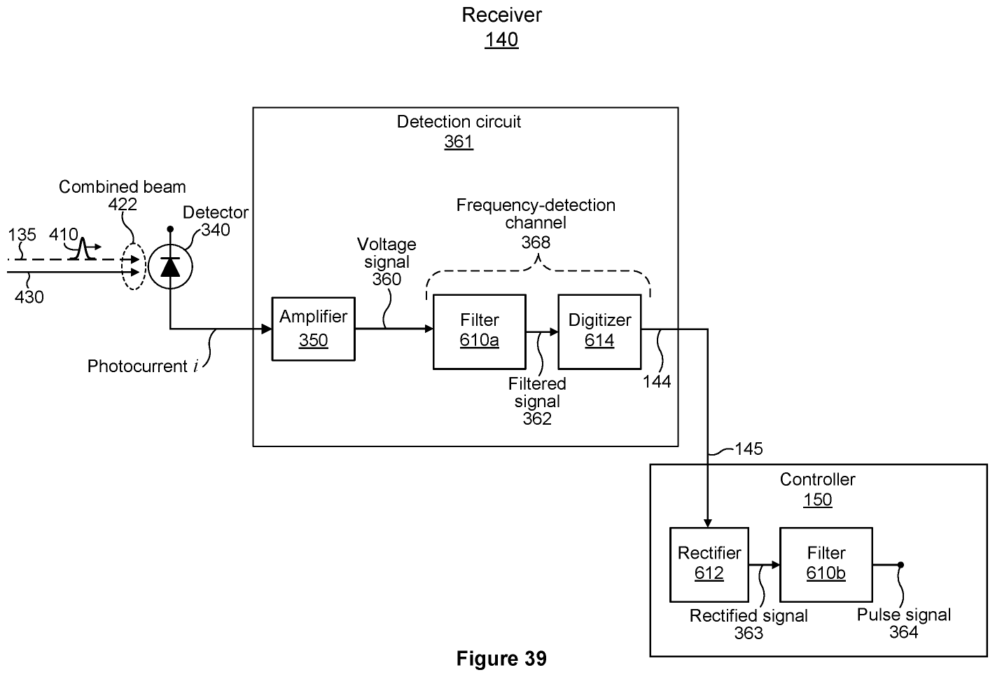

FIGS. 38-39 each illustrate an example receiver 140 with a detection circuit 361 that includes one frequency-detection channel 368. The receivers 140 in FIGS. 38-39 correspond to the receiver 140 in FIG. 37 with the parameter N equal to 1. In each of FIGS. 38-39, a received pulse of light 410 and LO light 430 are coherently mixed together at a detector 340, and the detector 340 produces a corresponding photocurrent signal i, which may include an AM photocurrent signal. The electronic amplifier 350 receives the photocurrent signal i and produces a voltage signal 360 corresponding to the photocurrent signal, and the voltage signal is sent to the frequency-detection channel 368. The frequency-detection channel 368 produces an output-signal portion 144, and since the detection circuit 361 in FIGS. 38-39 includes just one frequency-detection channel, the output-signal portion 144 and the output signal 145 may be substantially the same. The output signal 145 in each of FIGS. 38 and 39 may be referred to as corresponding to the AM photocurrent signal. For example, the output signal 145 in FIG. 38 may correspond to or may include an electronic representation of the received pulse of light 410, where the electronic representation (e.g., pulse signal 364) is produced from the AM photocurrent signal. As another example, the output signal 145 in FIG. 39 may correspond to or may include an electronic representation of the AM photocurrent signal.

The controller 150 in each of FIGS. 38-39 may receive the output signal 145 and determine (i) whether the received pulse of light 410 is valid or (ii) whether the received pulse of light is not valid and is not associated with an emitted pulse of light 400. For example, the receiver 140 may be part of a lidar system 100 with a light source 110 that imparts the same frequency change Δf to each emitted pulse of light 400. The frequency-detection channel 368 may include an electronic band-pass filter 610 with a pass-band that includes the frequency offset Δf. The controller 150 may determine, based on the output signal 145 produced by the frequency-detection channel 368, whether the AM photocurrent signal i includes a corresponding frequency component at or within a particular threshold of the frequency Δf, which indicates that a received pulse of light 410 is associated with one of the emitted pulses of light 400. For example, if the amplitude of an output signal 145 associated with a received pulse of light 410 is greater than a particular threshold value, then the controller 150 may determine that the received pulse of light 410 matches the Δf frequency offset and thus is associated with one of the emitted pulses of light. Otherwise, if the amplitude of the output signal 145 is below the particular threshold value, then the controller 150 may determine that the received pulse of light is not associated with an emitted pulse of light.

The detection circuit 361 in FIG. 38 includes two electronic filters 610, a rectifier 612, and a digitizer 614. The electronic filter 610a receives the voltage signal 360 and produces a filtered signal 362. The rectifier 612 (which may be referred to as an electronic rectification circuit or an electronic rectifier) receives the filtered signal 362 and produces a rectified signal 363. The electronic filter 610b receives the rectified signal 363 and produces a pulse signal 364. The digitizer 614 receives the pulse signal 364 and produces the output-signal portion 144, which is sent to the controller. The filter 610a, rectifier 612, filter 610b, and digitizer 614 in FIG. 38 may be hardware components that are implemented in electronic circuitry. In FIG. 38, the voltage signal 360, filtered signal 362, rectified signal 363, and pulse signal 364 may each be analog electronic signals, and the output-signal portion 144 may be a digital electronic signal.

The detection circuit 361 in FIG. 39 includes an electronic filter 610a and a digitizer 614. The detection circuit 361 in FIG. 39 is similar to the detection circuit 361 in FIG. 38, except in FIG. 39, the rectifier 612 and filter 610b components are located in the controller 150. In FIG. 39, the electronic filter 610a receives the voltage signal 360 and produces a filtered signal 362. The digitizer 614 receives the filtered signal 362 and produces the output-signal portion 144, which is sent to the controller 150. The filter 610a and digitizer 614 in FIG. 38 may be hardware components that are implemented in electronic circuitry, while the rectifier 612 and filter 610b in FIG. 39 may be software components that are implemented as algorithms in the controller 150. In FIG. 39, the voltage signal 360 and the filtered signal 362 may each be analog electronic signals, and the output-signal portion 144, rectified signal 363, and pulse signal 364 may each be digital electronic signals.

In particular embodiments, an electronic filter 610 may be a low-pass filter, a high-pass filter, or a band-pass filter. A low-pass electronic filter 610 may refer to a filter that transmits electronic signals with frequencies below a cutoff frequency and attenuates signals with frequencies above the cutoff frequency. The cutoff frequency for a low-pass electronic filter may be referred to as an upper cutoff frequency. A high-pass electronic filter 610 may refer to a filter that transmits electronic signals with frequencies above a cutoff frequency and attenuates signals with frequencies below the cutoff frequency. The cutoff frequency for a high-pass electronic filter may be referred to as a lower cutoff frequency. A band-pass electronic filter 610 may refer to a filter with a pass-band having lower and upper cutoff frequencies, where the filter transmits electronic signals with frequencies within the pass-band (between the lower and upper cutoff frequencies) and attenuates signals that are outside the pass-band (e.g., signals that are below the lower cutoff frequency and signals that are above the upper cutoff frequency). An electronic filter 610 may be a non-adjustable electronic filter where the one or more cutoff frequencies of the electronic filter are fixed and are non-adjustable. An electronic filter 610 may be an analog filter implemented in hardware using (i) passive electronic components (e.g., resistors, inductors, or capacitors) or (ii) active electronic components (e.g., transistors or op-amps) along with passive components. For example, filter 610a in FIGS. 38-39 or filter 610b in FIG. 38 may be an analog filter that filters an analog voltage signal (e.g., voltage signal 360 in FIGS. 38-39 or rectified signal 363 in FIG. 38). Alternatively, an electronic filter 610 may be a digital filter implemented in software using a filtering algorithm. For example, filter 610b in FIG. 39 may be a digital filter that applies a digital filtering operation to a digital signal (e.g., rectified signal 363 in FIG. 39). As another example, the digitizer 614 in FIG. 39 may receive the voltage signal 360 from the amplifier 350 and produce a digitized version of the voltage signal, and the filter 610a may be a digital filter that is located after the digitizer and that applies a digital filtering operation (e.g., band-pass filtering) to the digitized voltage signal.

The electronic filter 610a in each of FIGS. 38 and 39 may be a band-pass filter having a particular pass-band center frequency and a particular pass-band frequency width. For example, the pass-band center frequency may be approximately equal to a frequency offset Δf applied to an emitted pulse of light 400, or the pass-band of the filter 610a may include the frequency offset Δf. A band-pass filter 610a that receives a voltage signal 360 may (i) transmit a spectral portion of the voltage signal located within the pass-band and (ii) attenuate any spectral portions of the voltage signal outside the pass-band. The center frequency of an electronic band-pass filter 610 may have any suitable value between approximately 10 MHz and approximately 50 GHz (e.g., a value of approximately 10 MHZ, 100 MHz, 200 MHZ, 500 MHZ, 1 GHZ, 2 GHZ, 10 GHz, or 50 GHz). The width of the pass-band of an electronic band-pass filter 610 may be 10 MHz, 50 MHZ, 100 MHZ, 200 MHZ, 500 MHz, or any other suitable pass-band frequency width. For example, the pass-band frequency width (which may be referred to as a pass-band width) of an electronic band-pass filter 610 may depend at least in part on a maximum expected Doppler frequency shift of a received pulse of light 410. As another example, filter 610a in each of FIGS. 38 and 39 may be an analog band-pass filter with a center frequency of 3 GHZ and a pass-band width of 300 MHz. A 3-GHz band-pass filter 610 with a 300-MHz pass-band may pass or transmit frequency components from a lower cutoff frequency (approximately 2.85 GHZ) to an upper cutoff frequency (approximately 3.15 GHZ) and may attenuate frequency components outside of the pass-band frequency range. The filtered signal 362 may include the transmitted portion of the voltage signal 360 having frequency components within the pass-band of the electronic filter 610a. The output-signal portion 144 produced by a frequency-detection channel 368 may correspond to the portion of the voltage signal 360 that is transmitted by the band-pass filter 610a.

An emitted pulse of light 400 or a received pulse of light 410 with optical frequency f₁ may have a frequency offset of Δf with respect to LO light 430, where Δf=f₁−f₀, and f₀ is the optical frequency of the LO light. A frequency offset Δf may have a positive value when f₁ is greater than f₀ or a negative value when f₁ is less than f₀. When considering an electronic filter 610, the frequencies associated with the electronic filter may be considered to be positive values. For example, the center frequency and cutoff frequencies of an electronic band-pass filter 610 are expressed as positive values of frequency. When considering a frequency offset Δf in relation to the frequencies of an electronic filter 610, the frequency offset Δf may be considered to be a positive value. For example, an electronic band-pass filter 610 may be referred to as having a pass-band that includes a frequency offset Δf, in which case the frequency offset Δf is considered to be a positive value. The statement that the pass-band of an electronic band-pass filter 610 includes a frequency offset Δf may be equivalent to the statement that the pass-band of an electronic band-pass filter 610 includes the frequency |Δf| (where |Δf| represents the absolute value of the frequency offset Δf). For example, a 5-GHz band-pass filter 610 with a 200-MHz pass-band that extends from 4.9 GHZ to 5.1 GHZ may be referred to as including a frequency offset of +5.05 GHZ. Additionally, the pass-band of the 5-GHz band-pass filter 610 may be referred to as including a frequency offset of −5.05 GHz. In some discussions or equations herein, a frequency offset Δf may be written as an absolute value |Δf| for clarity. In other discussions or equations herein, a frequency offset Δf may not include the absolute-value symbol when (i) the frequency offset Δf may have a positive or negative value (e.g., when discussing the frequency offset of an emitted pulse of light 400 with respect to LO light 430) or (ii) the frequency offset Δf is understood to be a positive value (e.g., when considering a frequency offset Δf in relation to the pass-band of an electronic filter 610). For example, a band-pass filter 610 may be described as having a pass-band that includes a frequency ||Δf|−F_{LO}|, where Δf is a frequency offset that may be positive or negative, and F_{LO} is the frequency of an electronic local oscillator. In this case, the frequency offset includes an absolute value to clearly indicate that the frequency offset is to be expressed as a positive value. As another example, the pass-band of a band-pass filter 610 may be referred to as including a frequency offset of Δf, in which case the value of the frequency offset Δf is to be interpreted as a positive value regardless of whether the actual frequency offset is positive or negative.

Each receiver 140 in FIGS. 38 and 39 may be part of a lidar system 100 with a light source 110 that imparts approximately the same frequency offset Δf to each emitted pulse of light 400. The electronic filter 610a in each of FIGS. 38 and 39 may be an analog band-pass filter with a pass-band center frequency that is approximately equal to the frequency offset Δf applied to the emitted pulses of light 400. For example, a 3-GHz frequency offset may be applied to each emitted pulse of light 400, and coherent mixing of the received pulse of light 410 with LO light 430 may produce a photocurrent signal i with an AM photocurrent signal having a frequency of approximately 3 GHZ. The voltage signal 360 may include a corresponding AM voltage signal having a frequency of approximately 3 GHZ, and the filter 610a may have a 3-GHz pass-band center frequency and a 300-MHz pass-band width. The electronic band-pass filter 610a may transmit the spectral portion of the voltage signal 360 that is located around 3 GHZ and within the 300-MHz pass-band of the filter. If a received pulse of light 410 produces a photocurrent signal i with a 3-GHz AM signal, then the received pulse may be determined to be a valid pulse of light that is associated with one of the emitted pulses of light 400.

In particular embodiments, a detection circuit 361 may include one or more rectifiers 612 that each receive an electrical signal corresponding to a photocurrent signal i and produce a rectified signal that includes a unipolar version of the received electrical signal. An electrical signal that corresponds to a photocurrent signal i may include voltage signal 360 or filtered signal 362 (e.g., voltage signal 360 may correspond to photocurrent signal i, and filtered signal 362 may correspond to a particular range of frequency components of the voltage signal 360). A rectifier 612 may be a hardware or software component that receives an input electronic signal that is bipolar (e.g., the input signal may include both positive and negative voltages or positive and negative digital values) and produce a corresponding rectified signal 363 that is a unipolar version of the bipolar input signal. A unipolar signal (e.g., rectified signal 363) may include voltages or digital values that are only non-negative (e.g., greater than or equal to zero) or are only non-positive (e.g., less than or equal to zero). A rectifier 612 may rectify an input signal in any suitable manner, such as for example, by (i) taking the absolute value of the input signal, (ii) squaring the input signal, (iii) or truncating the input signal (e.g., setting any negative input value to zero). In FIG. 38, the voltage signal 360 or the filtered signal 362 may be a bipolar signal that includes both positive and negative voltages. The electronic rectification circuit 612 in FIG. 38 may be an analog electronic circuit that receives the filtered voltage signal 362 and produces a rectified signal 363 that is a unipolar version of the filtered voltage signal. For example, the electronic rectification circuit 612 in FIG. 38 may produce a rectified signal 363 that is proportional to the square of the filtered signal 362. In FIG. 39, the output signal 145 produced by the digitizer 614 may include positive and negative digital values that represent the filtered signal 362, and the rectifier 612 may be a software component. The rectifier 612 may produce the rectified signal 363 by rectifying the digitized filtered signal 362 (e.g., by squaring or taking the absolute value of the digital values that represent the filtered signal 362).

Filter 610b in FIG. 38 may be an analog electronic filter that receives the rectified signal 363 and produces a pulse signal 364. The pulse signal 364 in FIG. 38 may include an analog representation of the received pulse of light 410 (e.g., the pulse signal 364 may have a shape or duration that is similar to that of the received pulse of light 410). The electronic filter 610b may be a low-pass or band-pass filter with an upper cutoff frequency greater than or equal to 1/Δτ, where Δτ is a duration of the received pulse of light 410 or an associated emitted pulse of light 400. The cutoff frequency of the electronic filter 610b may be selected so that temporal pulsations (e.g., pulsations with frequency greater than 1/Δτ) are attenuated by the filter while an overall pulse shape (e.g., with an associated frequency less than 1/Δτ) is transmitted by the filter. For example, the upper cutoff frequency may be greater than or equal to 1/Δτ and less than a frequency offset Δf of the received pulse of light 410 or an associated emitted pulse of light 400. In FIG. 38, the rectified signal 363 may include temporal pulsations associated with an AM photocurrent signal, and the pulse signal 364 may be an analog signal with a shape that corresponds to the received pulse of light 410 (and with little or no temporal pulsations associated with the AM photocurrent signal). Filter 610b in FIG. 39 may be a digital filter that applies a digital filtering operation (e.g., band-pass filtering or low-pass filtering) to the rectified signal 363 to produce the pulse signal 364. The digital filter 610b in FIG. 39 may have an upper cutoff frequency greater than or equal to 1/Δt and less than a frequency offset Δf of the received pulse of light 410 or an associated emitted pulse of light 400. In FIG. 39, the rectified signal 363 and the pulse signal 364 may be digital signals, and the pulse signal produced by the filter 610b may include a series of digital values that represent the received pulse of light 410.

The digitizer 614 in each of FIGS. 38 and 39 may include any suitable hardware device that receives an analog input signal and produces a digital output signal corresponding to the input signal. For example, a digitizer 614 may include an ADC 372 (e.g., as illustrated by digitizer 614a in FIG. 6), multiple comparators 370 and TDCs 380 (e.g., as illustrated by digitizer 614b in FIG. 6), a sample-and-hold circuit, a peak-detector circuit, or an integrator circuit. The digitizer 614 in FIG. 38 receives the analog pulse signal 364 from filter 610b and produces an output-signal portion 144, which is sent as output signal 145 to the controller 150. The output-signal portion 144 in FIG. 38 may include a digital representation of the received pulse of light 410. For example, the pulse signal 364 may include an analog representation of the received pulse of light 410, and the output-signal portion 144 may include a series of digital values that represents the pulse signal 364 (e.g., each digital value corresponds to an amplitude of the pulse signal 364 at a particular point in time). The digitizer 614 in FIG. 39 receives the analog filtered signal 362 from filter 610a and produces an output-signal portion 144, which is sent as output signal 145 to the controller 145. The output-signal portion 144 in FIG. 39 may include a digital representation of an AM photocurrent signal. For example, the photocurrent signal i may include an AM photocurrent signal, and the voltage signal 360 may include an AM voltage signal that corresponds to the AM photocurrent signal (e.g., as illustrated in FIG. 27). The AM voltage signal may have one or more frequency components within the pass-band of the electronic filter 610a, and those frequency components may be transmitted by the filter to produce the filtered signal 362. The filtered signal 362 may include the transmitted portion of the voltage signal 360, and the filtered signal may correspond to the AM photocurrent signal. The output-signal portion 144 produced by the digitizer 614 in FIG. 39 may include a digitized version of the filtered signal 362, which may correspond to a digital representation of the AM photocurrent signal.

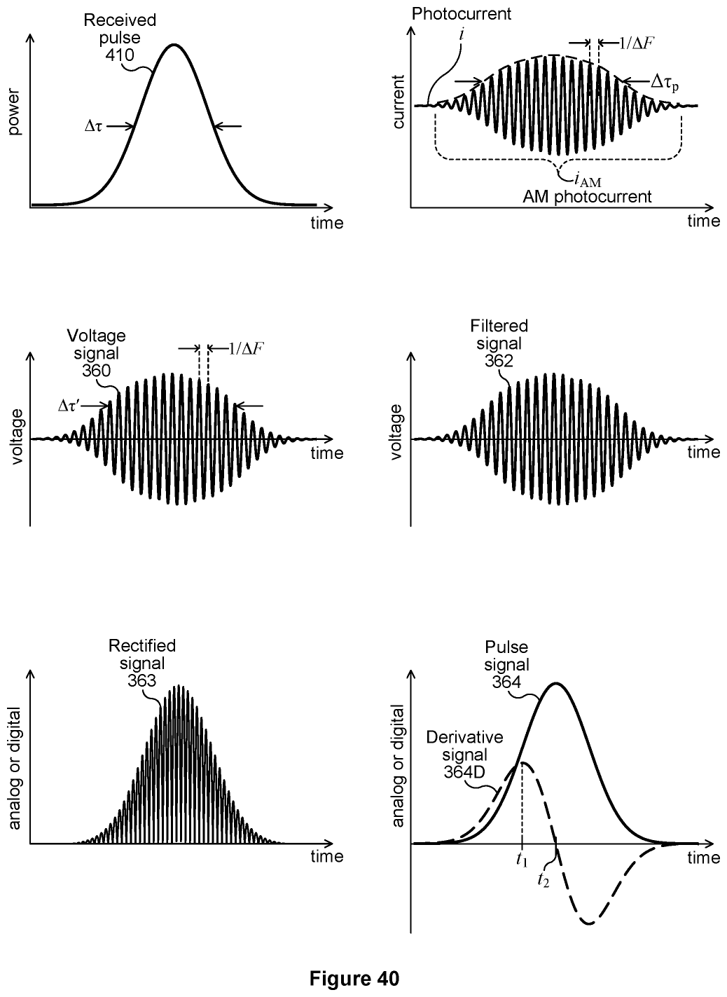

FIG. 40 illustrates example graphs of signals associated with the receivers of FIGS. 38-39. The graphs of the received pulse of light 410, photocurrent signal i, voltage signal 360, filtered signal 362, rectified signal 363, and pulse signal 364 illustrated in FIG. 40 may represent the respective signals in FIGS. 38 and 39. In discussing FIG. 38, the photocurrent signal i, voltage signal 360, filtered signal 362, rectified signal 363, and pulse signal 364 illustrated in FIG. 40 may be considered to be analog electronic signals. In discussing FIG. 39, the photocurrent signal i, voltage signal 360, and filtered signal 362 illustrated in FIG. 40 may be considered to be analog electronic signals, while the rectified signal 363 and pulse signal 364 illustrated in FIG. 40 may be considered to be digital electronic signals.

The received pulse of light 410 in FIG. 40 has a duration of Δτ, and coherent mixing of LO light 430 and the received pulse of light 410 at a detector 340 results in a pulse of photocurrent with a duration of Δτₚ (as indicated by the dashed-line pulse envelope). The received pulse of light 410 may have a frequency offset of ΔF with respect to the LO light, and the photocurrent signal i includes an AM photocurrent signal i_{AM} with temporal pulsations having a frequency of ΔF. The voltage signal 360 produced by an electronic amplifier 350 has a duration of approximately Δτ′. The voltage signal 360 includes an AM voltage signal that corresponds to the AM photocurrent signal, and the AM voltage signal has temporal pulsations with a frequency of ΔF. The received pulse of light 410 in FIG. 40 may be associated with an emitted pulse of light 400 having a frequency offset Δf with respect to the LO light 430, and the frequency component ΔF may be within a particular threshold of the frequency offset Δf. For example, the frequencies Δf and ΔF may be approximately equal or may differ based on a Doppler frequency shift of the received pulse of light 410. If the received pulse of light 410 has a Doppler frequency shift of F_{D}, then the frequency offset Δf and the frequency component ΔF may be related by the expression ΔF=|Δf+F_{D}|. The absolute-value symbol in this expression accounts for the possibility that the term Δf+F_{D} may have a negative value (since Δf or F_{D} may be negative), while the frequency component ΔF may be an inherently positive value.

The electronic filter 610a in FIGS. 38 and 39 may be an analog band-pass filter with a pass-band that includes the frequency ΔF of the voltage signal 360 in FIG. 40. Since the frequency component of the voltage signal 360 is within the pass-band of the electronic filter 610a, the filter may transmit most or all of the voltage signal to produce the filtered signal 362 in FIG. 40. For a different voltage signal having a frequency component outside the pass-band of the electronic filter 610a, the filter may attenuate most of the voltage signal, and the resulting filtered signal may have a relatively small amplitude (e.g., <10% of the amplitude of the filtered signal 362 in FIG. 40). The output-signal portion 144 produced by a frequency-detection channel 368 may correspond to the portion of the voltage signal 360 that is transmitted by the band-pass filter 610a. For example, an output-signal portion 144 may have a relatively large amplitude if the voltage signal 360 has a frequency component within the pass-band of the band-pass filter 610a. Alternatively, an output-signal portion 144 may have a relatively small amplitude if the voltage signal 360 has little or no frequency components within the pass-band.

The rectifier 612 in FIG. 38 may include an analog electronic circuit that squares or takes the absolute value of the filtered signal 362 to produce the analog rectified signal 363 in FIG. 40. The electronic filter 610b in FIG. 38 may be an analog filter that low-pass filters or band-pass filters the rectified signal 363 to produce the pulse signal 364 in FIG. 40. For example, the electronic filter 610b may be a low-pass or band-pass filter with an upper cutoff frequency greater than or equal to 1/Δτ, 1/Δτρ, or 1/Δτ′. Additionally, the upper cutoff frequency may be less than the frequency offset Δf or the frequency ΔF of the temporal pulsations. The filter 610b may attenuate the temporal pulsations in the rectified signal 363 and may transmit the overall pulse shape to produce the pulse signal 364 in FIG. 40. For example, the received pulse of light 410 may have a duration Δτ of 5 ns, and the AM photocurrent signal may have temporal pulsations with a frequency ΔF of 2 GHZ. If the electronic filter 610b is a low-pass filter with a 0.5-GHz upper cutoff frequency (or a band-pass filter with a 10-MHz lower cutoff frequency and a 0.5-GHz upper cutoff frequency), then the temporal pulsations may be substantially attenuated while the overall pulse-envelope shape of the pulse of light may be transmitted by the filter. The pulse signal 364 in FIG. 38 may be an analog signal having a shape that is similar to the received pulse of light 410. The digitizer 614 in FIG. 38 receives the analog pulse signal 364 and produces an output-signal portion 144 which may include a series of digital values that represent the pulse signal 364. Since the pulse signal 364 is produced from the AM photocurrent signal (e.g., the pulse signal 364 is produced from the rectified signal 363, which is produced from the filtered signal 362, which is produced from the voltage signal 360, which is produced from the photocurrent signal i, which includes the AM photocurrent signal), the output-signal portion 144 may be referred to as corresponding to the AM photocurrent signal.

In FIG. 39, the digitizer 614 may produce an output-signal portion 144 that includes digital values representing the filtered signal 362 in FIG. 40. Since the filtered signal 362 is produced from the AM photocurrent signal (e.g., the filtered signal 362 is produced from the voltage signal 360, which is produced from the photocurrent signal i, which includes the AM photocurrent signal), the output-signal portion 144 may be referred to as corresponding to the AM photocurrent signal. The output-signal portion 144 is sent as output signal 145 to the controller 150. Based on the output signal 145 (which may include a digital representation of the filtered signal 362, which corresponds to the AM photocurrent signal), the controller 150 may produce a digital representation of the received pulse of light 410 by (i) rectifying the digital representation of the filtered signal 362 and (ii) low-pass or band-pass filtering the rectified digital signal. The rectifier 612 in FIG. 39 may be a software component that squares or takes the absolute value of the digital values representing the filtered signal 362 to produce the rectified signal 363 in FIG. 40. The filter 610b in FIG. 39 may be a low-pass or band-pass digital filter that applies a digital filtering operation to the digital values of the rectified signal 363 to produce the pulse signal 364 in FIG. 40. The pulse signal 364 may include a series of digital values that correspond to a digital representation of the received pulse of light 410.

The controller 150 in FIGS. 38-39 may receive or determine a digital representation of the pulse signal 364 in FIG. 40. The digital representation of the pulse signal 364 may be part of an output signal 145 or may be determined from an output signal 145. Based on the pulse signal 364 associated with a received pulse of light 410, the controller 150 may determine whether the received pulse of light 410 includes a frequency offset within a particular threshold of Δf. Additionally or alternatively, the controller 150 may determine whether the received pulse of light 410 is associated with one of the emitted pulses of light 400. For example, if the amplitude of the pulse signal 364 associated with a received pulse of light 410 is greater than a particular threshold value, then the controller 150 may determine that the received pulse of light 410 (i) includes a frequency offset that matches the frequency offset Δf of the emitted pulses of light 400 or (ii) is a valid pulse of light that is associated with one of the emitted pulses of light.

In particular embodiments, a time-of-arrival of a received pulse of light 410 may be determined from a derivative of an electronic representation of the received pulse of light. In FIG. 40, the derivative signal 364D represents the first derivative with respect to time of the pulse signal 364, where the pulse signal 364 is a digital signal that represents the received pulse of light 410. The controller 150 in FIGS. 38 and 39 may determine the derivative of the pulse signal 364, and the resulting derivative signal 364D may be used to determine the time-of-arrival of the received pulse of light. For example, the time-of-arrival may be identified as time t₁ in FIG. 40, which corresponds to the maximum value of the derivative signal 364D. The maximum value of the derivative signal 364D corresponds to the rising edge of the pulse signal 364, which may correspond to the rising edge of the received pulse of light 410. As another example, the time-of-arrival may be identified as time t₂ in FIG. 40, which corresponds to a zero crossing of the derivative signal 364D. The zero crossing of the derivative signal 364D corresponds to the peak of the pulse signal 364, which may correspond to the peak of the received pulse of light 410.

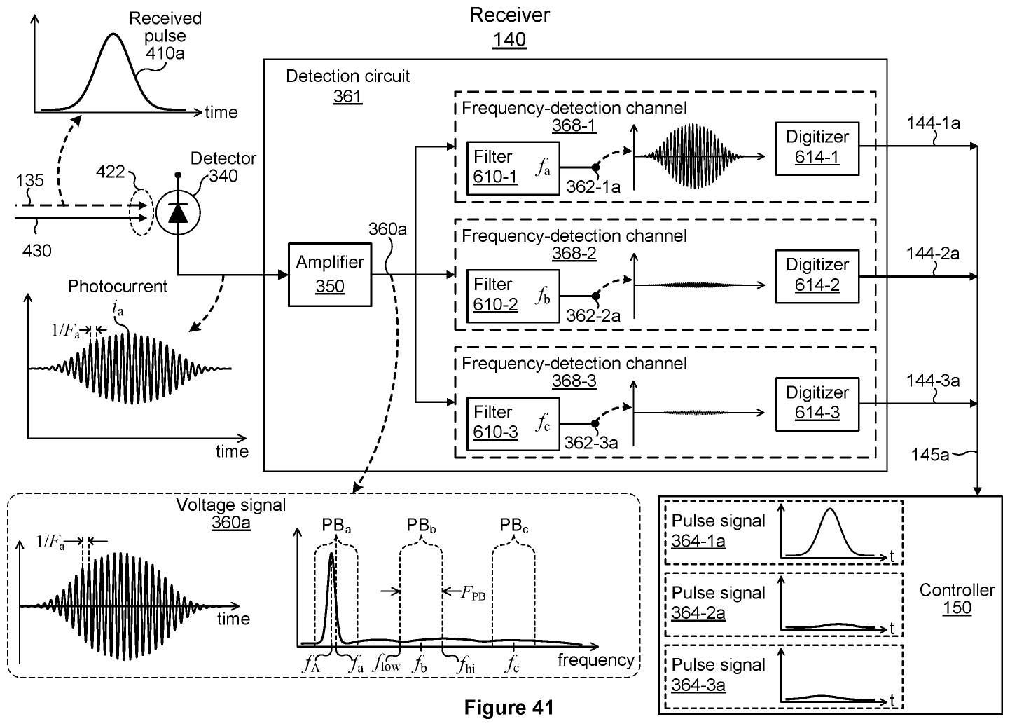

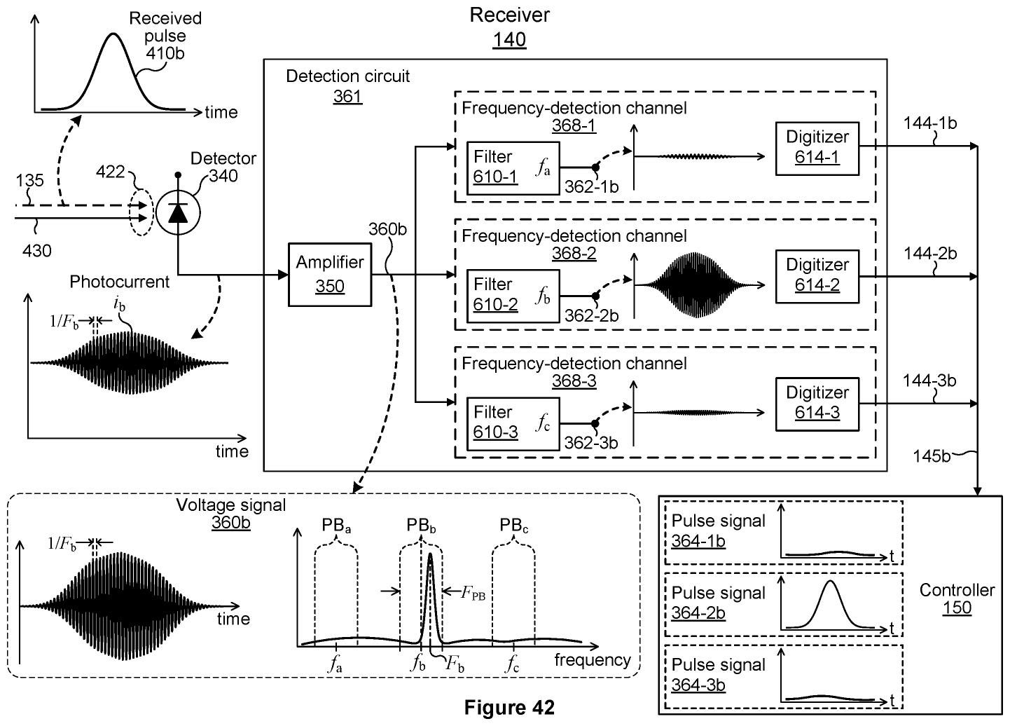

FIGS. 41-42 illustrate an example receiver 140 with a detection circuit 361 that includes three frequency-detection channels (368-1, 368-2, 368-3). A receiver 140 of a coherent pulsed lidar system 100 may include a detection circuit 361 with one or more frequency-detection channels 368. The receiver 140 in FIGS. 41-42 corresponds to the receiver 140 in FIG. 37 with the parameter N equal to 3. FIG. 41 includes example signals associated with a first received pulse of light 410a having a frequency offset of Fₐ with respect to the LO light 430, and FIG. 42 includes example signals associated with a second received pulse of light 410b having a different frequency offset of F_{b}. The received pulse of light 410a may include scattered light from an emitted pulse of light 400a with a frequency offset of fₐ, and the received pulse of light 410b may include scattered light from an emitted pulse of light 400b with a frequency offset of f_{b}.

The frequency-detection channels 368-1, 368-2, and 368-3 in FIGS. 41-42 may be similar to the frequency-detection channel 368 in FIG. 38, in which each frequency-detection channel includes two filters 610, a rectifier 612, and a digitizer 614. For example, in addition to filter 610-1 and digitizer 614-1, the frequency-detection channel 368-1 may also include a rectifier 612 that produces a rectified signal 363 and an electronic filter 610b that produces a pulse signal 364-1a. The digitizer 614-1 may produce a digital representation of the pulse signal 364-1a that is sent as output-signal portion 144-1a to the controller 150. Alternatively, the frequency-detection channels 368-1, 368-2, and 368-3 in FIGS. 41-42 may be similar to the frequency-detection channel 368 in FIG. 39, in which each frequency-detection channel includes one filter 610a and a digitizer 614, and the rectifier 612 and filter 610b are part of the controller 150. For example, digitizer 614-1 of frequency-detection channel 368-1 may produce a digital representation of the filtered signal 362-1a that is sent as output-signal portion 144-1a to the controller 150, and the controller may rectify and filter the digital representation of the filtered signal to produce the digital representation of the pulse signal 364-1a. In either case, in FIGS. 41-42, the controller 150 receives or determines a digital representation of three pulse signals (364-1, 364-2, and 364-3), from which the controller 150 may determine (i) the frequency offset of a received pulse of light 410 or (ii) which emitted pulse of light 400 a received pulse of light 410 is associated with.

In particular embodiments, a light source 110 of a coherent pulsed lidar system 100 may emit LO light 430 and pulses of light 400, where each emitted pulse of light is offset from the optical frequency of the LO light by a particular frequency offset of N different frequency offsets (where N is an integer greater than or equal to 1). Additionally, a receiver 140 of the lidar system 100 may include a detection circuit 361 with N frequency-detection channels 368, where each of the N frequency-detection channels 368 is associated with one of the N frequency offsets. For example, each frequency-detection channel 368 may include an electronic band-pass filter 610 with a pass-band that includes one and only one of the frequency offsets. In FIGS. 41-42, the parameter N is 3, and the receiver 140 may be part of a lidar system 100 with a light source 110 that imparts a particular frequency offset of three different frequency offsets to each emitted pulse of light 400. In FIGS. 41-42, the three different frequency offsets are represented as fₐ, f_{b}, and f_{c} (e.g., the three frequency offsets may be 4 GHZ, 5.5 GHZ, and 7 GHZ, respectively). The detection circuit 361 includes three frequency-detection channels (368-1, 368-2, 368-3), and each frequency-detection channel is associated with one of the three frequency offsets: channel 368-1 is associated with frequency offset fₐ, channel 368-2 is associated with frequency offset f_{b}, and channel 368-3 is associated with frequency offset f_{c}. Each frequency-detection channel 368 includes an electronic band-pass filter 610 having a particular pass-band center frequency that corresponds to one of the three frequency offsets: filter 610-1 has a pass-band center frequency of fₐ, filter 610-2 has a pass-band center frequency of f_{b}, and filter 610-3 has a pass-band center frequency of f_{c}. Each of the three band-pass filters 610 has a pass-band (PB) that includes one and only one of the frequency offsets: PBₐ of filter 610-1 includes frequency offset fₐ, PB_{b} of filter 610-2 includes frequency offset f_{b}, and PB_{c} of filter 610-3 includes frequency offset f_{c}. Each band-pass filter 610 may receive a voltage signal 360 and transmit a spectral portion of the voltage signal that is located within the pass-band of the filter. Additionally, any spectral portion of the voltage signal that is located outside the pass-band may be substantially blocked or attenuated.

In FIG. 41, coherent mixing of the received pulse of light 410a and LO light 430 results in a photocurrent signal iₐ with an AM photocurrent signal having a frequency of Fa and a corresponding voltage signal 360a with an AM voltage signal having a corresponding frequency of Fₐ. The frequency-domain graph of the voltage signal 360a indicates the pass-bands PBₐ, PB_{b}, and PB_{c} of the three respective band-pass filters 610-1, 610-2, and 610-3. Each filter 610 has a lower cutoff frequency f_{low}, an upper cutoff frequency fₕᵢ, and a pass-band frequency width F_{PB}, where F_{PB}=fₕᵢ−f_{low}. The frequency Fₐ of the voltage signal 360a is within the pass-band PBₐ of the band-pass filter 610-1 (e.g., between the lower and upper cutoff frequencies of the pass-band). Since the frequency component Fₐ of voltage signal 360a is located within the pass-band of band-pass filter 610-1, the filter may transmit most or all of the voltage signal 360a (which corresponds to the AM photocurrent signal) to produce the filtered signal 362-1a. Additionally, since the voltage signal 360a has little or no frequency components within the pass-bands PB_{b} of band-pass filter 610-2 and PB_{c} of band-pass filter 610-3, the filters 610-2 and 610-3 may attenuate most of the voltage signal, resulting in filtered signals 362-2a and 362-3a having relatively small amplitudes (e.g., <10% of the amplitude of the filtered signal 362-1a).

The three digitizers 614-1, 614-2, 614-3 in FIG. 41 produce three respective output-signal portions 144-1a, 144-2a, 144-3a that are sent to the controller 150 as output signal 145a. Each output-signal portion 144 may include a digital representation of a filtered signal 362 (which may be rectified or filtered at the controller 150 to produce a corresponding pulse signal 364) or a pulse signal 364 (which may be produced at the frequency-detection channel 368 by rectifying or filtering a filtered signal 362). The output-signal portion 144 produced by each frequency-detection channel 368 may correspond to the portion of the voltage signal 360a that is transmitted by the band-pass filter 610. For example, output signal portion 144-1a may have a relatively large amplitude since the voltage signal 360a has a frequency component Fₐ within the pass-band PBₐ of the band-pass filter 610-1. Additionally, output signal portions 144-2a and 144-3a may have relatively small amplitudes since the voltage signal 360a has little or no frequency components within the pass-bands PB_{b} and PB_{c} of the band-pass filters 610-2 and 610-3.

Based on the output signal 145a, the controller 150 receives or determines a digital representation of three pulse signals (364-1a, 364-2a, and 364-3a). Based on the three pulse signals, the controller 150 may determine that the received pulse of light 410a includes a frequency offset within a particular threshold of fₐ. Additionally or alternatively, the controller 150 may determine that the received pulse of light 410a is associated with a particular emitted pulse of light 400a that has a frequency offset fₐ that matches the frequency offset Fₐ of the received pulse of light 410a. Additionally or alternatively, the controller 150 may determine that the received pulse of light 410a is not associated with an emitted pulse of light 400 that has a frequency offset of f_{b} or f_{c}. The determination that the received pulse of light 410a includes a frequency offset within a particular threshold of fₐ or that the received pulse of light 410a is associated with a particular emitted pulse of light 400a may be based on one or more amplitudes of one or more output-signal portions 144. For example, the received pulse of light 410a may be determined to correspond to the frequency offset fₐ or the received pulse of light 410a may be determined to be associated with a particular emitted pulse of light 400a based on (i) the amplitude of the pulse signal 364-1a exceeding a particular threshold amplitude or (ii) the amplitude of the pulse signal 364-1a being greater than the amplitudes of the pulse signals 364-2a and 364-3a. For another received pulse of light 410, if each of the pulse signals 364 associated with the received pulse of light have amplitudes that are below a particular threshold value, then the controller 150 may determine that the received pulse of light is not a valid pulse of light and is not associated with an emitted pulse of light 400.

In FIG. 42, coherent mixing of the received pulse of light 410b and LO light 430 results in a photocurrent signal in with an AM photocurrent signal having a frequency of F_{b} and a corresponding voltage signal 360b with an AM voltage signal having a corresponding frequency of F_{b}. The frequency F_{b} of the voltage signal 360b is different from the frequency Fₐ and is within the pass-band PB_{b} of the band-pass filter 610-2. Since the frequency component F_{b} of voltage signal 360b is located within the pass-band of band-pass filter 610-2, the filter may transmit most or all of the voltage signal 360b to produce the filtered signal 362-2b. Additionally, since the voltage signal 360b has little or no frequency components within the pass-bands PBₐ of band-pass filter 610-1 and PB_{c} of band-pass filter 610-3, the filters 610-1 and 610-3 may attenuate most of the voltage signal, resulting in filtered signals 362-1b and 362-3b having relatively small amplitudes (e.g., <10% of the amplitude of the filtered signal 362-2b).

The three digitizers 614-1, 614-2, 614-3 in FIG. 42 produce three respective output-signal portions 144-1b, 144-2b, 144-3b that are sent to the controller 150 as output signal 145b. Each output-signal portion 144 may include a digital representation of a filtered signal 362 (which may be rectified or filtered at the controller 150 to produce a corresponding pulse signal 364) or a pulse signal 364 (which may be produced at the frequency-detection channel 368 by rectifying or filtering a filtered signal 362). The output-signal portion 144 produced by each frequency-detection channel 368 may correspond to the portion of the voltage signal 360b that is transmitted by the band-pass filter 610. For example, output signal portion 144-2b may have a relatively large amplitude since the voltage signal 360b has a frequency component F_{b} within the pass-band PB_{b} of the band-pass filter 610-2. Additionally, output signal portions 144-1b and 144-3b may have relatively small amplitudes since the voltage signal 360b has little or no frequency components within the pass-bands PBₐ and PB_{c} of the band-pass filters 610-1 and 610-3.

Based on the output signal 145b, the controller 150 receives or determines a digital representation of three pulse signals (364-1b, 364-2b, and 364-3b). Based on the three pulse signals, the controller 150 may determine that the received pulse of light 410b includes a frequency offset within a particular threshold of f_{b}. Additionally or alternatively, the controller 150 may determine that the received pulse of light 410b is associated with a particular emitted pulse of light 400b that has a frequency offset f_{b} that matches the frequency offset F_{b} of the received pulse of light 410b. Additionally or alternatively, the controller 150 may determine that the received pulse of light 410b is not associated with an emitted pulse of light 400 that has a frequency offset of fₐ or f_{c}. The determination that the received pulse of light 410b includes a frequency offset within a particular threshold of f_{b} or that the received pulse of light 410b is associated with a particular emitted pulse of light 400b may be based on one or more amplitudes of one or more output-signal portions 144. For example, the received pulse of light 410b may be determined to correspond to the frequency offset f_{b} or the received pulse of light 410b may be determined to be associated with a particular emitted pulse of light 400b based on (i) the amplitude of the pulse signal 364-2b exceeding a particular threshold amplitude or (ii) the amplitude of the pulse signal 364-2b being greater than the amplitudes of the pulse signals 364-1b and 364-3b.

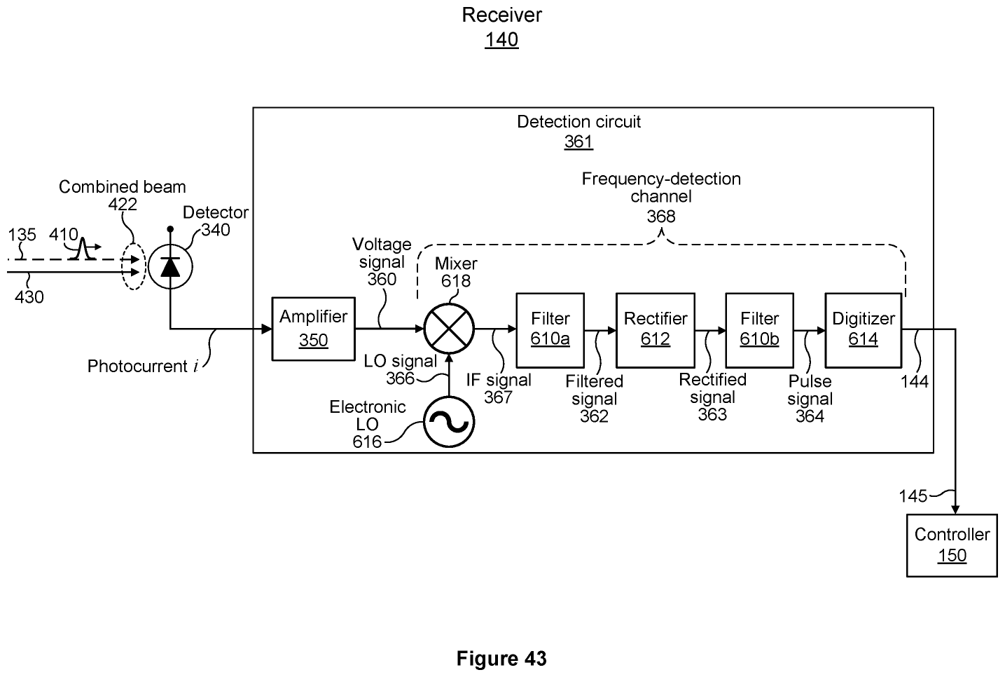

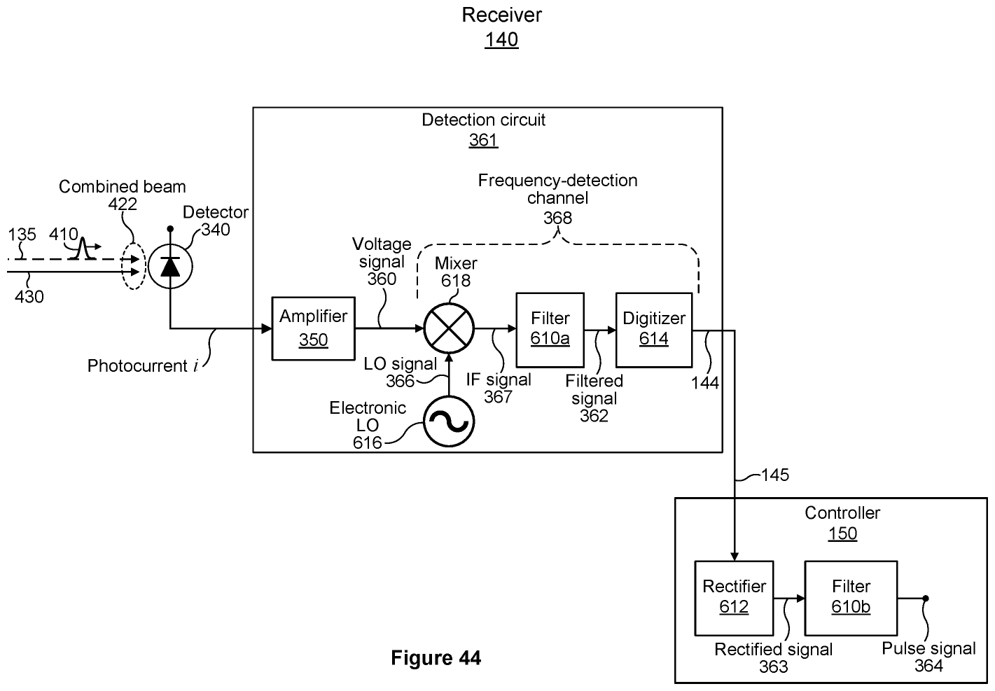

FIGS. 43-44 each illustrate an example receiver 140 with a detection circuit 361 that includes one frequency-detection channel 368. The receivers 140 in FIGS. 43-44 correspond to the receiver 140 in FIG. 37 with the parameter N equal to 1. In each of FIGS. 43-44, a received pulse of light 410 and LO light 430 are coherently mixed together at a detector 340, and the detector 340 produces a corresponding photocurrent signal i, which may include an AM photocurrent signal. The electronic amplifier 350 receives the photocurrent signal i and produces a voltage signal 360 corresponding to the photocurrent signal, and the voltage signal is sent to the frequency-detection channel 368. The frequency-detection channel 368 produces an output-signal portion 144, and since the detection circuit 361 in FIGS. 43-44 includes just one frequency-detection channel, the output-signal portion 144 and the output signal 145 may be substantially the same. The output signal 145 in each of FIGS. 43 and 44 may be referred to as corresponding to the AM photocurrent signal. For example, the output signal 145 in FIG. 43 may correspond to or may include an electronic representation of the received pulse of light 410, where the electronic representation (e.g., pulse signal 364) is produced from the AM photocurrent signal. As another example, the output signal 145 in FIG. 44 may correspond to or may include an electronic representation of a filtered signal 362, which is produced from the AM photocurrent signal.

The controller 150 in each of FIGS. 43-44 may receive the output signal 145 and determine (i) whether the received pulse of light 410 is valid or (ii) whether the received pulse of light is not valid and is not associated with an emitted pulse of light 400. For example, the receiver 140 may be part of a lidar system 100 with a light source 110 that imparts the same frequency change Δf to each emitted pulse of light 400. The controller 150 may determine, based on the output signal 145 produced by the frequency-detection channel 368, whether the AM photocurrent signal i includes a corresponding frequency component at or near the frequency Δf, which indicates that a received pulse of light 410 is associated with one of the emitted pulses of light 400. For example, if the amplitude of an output signal 145 associated with a received pulse of light 410 is greater than a particular threshold value, then the controller 150 may determine that the received pulse of light 410 matches the Δf frequency offset and thus is associated with one of the emitted pulses of light. Otherwise, if the amplitude of the output signal 145 is below the particular threshold value, then the controller 150 may determine that the received pulse of light is not associated with an emitted pulse of light.

The receiver 140 in FIG. 43 is similar to the receiver 140 in FIG. 38, except the frequency-detection channel 368 in FIG. 43 includes an electronic local oscillator (LO) 616 and an electronic mixer 618. Additionally, the receiver 140 in FIG. 44 is similar to the receiver 140 in FIG. 39, except the frequency-detection channel 368 in FIG. 44 includes an electronic LO 616 and an electronic mixer 618. Each of the receivers in FIGS. 38-39 and FIG. 41-42 may be referred to as an optical heterodyne receiver, and each of the receivers in FIGS. 43-44 may be referred to as an optical superheterodyne receiver. An optical heterodyne receiver may include a detector 340 at which two optical signals (e.g., a pulse of light 410 and LO light 430) are coherently mixed to produce an electronic signal (e.g., photocurrent signal i) having a frequency component equal to the frequency difference between the two optical signals. The resulting electronic signal may be processed using electronic amplifiers, filters, rectifiers, or digitizers. An optical superheterodyne receiver may include two stages of mixing: a first stage of optical mixing followed by a second stage of electronic mixing. The optical-mixing stage is similar to an optical heterodyne receiver where two optical signals (e.g., a pulse of light 410 and LO light 430) are coherently mixed at a detector 340 to produce a first electronic signal (e.g., photocurrent signal i) having a frequency component equal to the frequency difference between the two optical signals. At the electronic-mixing stage, the first electronic signal (or a signal corresponding to the first electronic signal, such as for example, a voltage signal 360) is mixed with an electronic local oscillator signal 366 to produce a second electronic signal (e.g., IF signal 367) at a different frequency from the first electronic signal. The resulting second electronic signal may be processed using electronic amplifiers, filters, rectifiers, or digitizers.

Each of the frequency-detection channels 368 in FIGS. 43 and 44 includes an electronic LO 616 and an electronic mixer 618. The electronic LO 616 produces an electronic LO signal 366, and the electronic mixer 618 mixes the LO signal 366 with the voltage signal 360 to produce an intermediate-frequency (IF) signal 367. The LO signal 366 is an electronic signal having a particular electronic frequency F_{LO}. For example, the LO signal 366 may have any suitable local-oscillator frequency between approximately 10 MHz and approximately 50 GHZ. The IF signal 367 produced by the mixer 618 may have a frequency equal to the difference between the frequencies of the voltage signal 360 and the LO signal 366. For example, if the photocurrent signal i and voltage signal 360 have a frequency component at frequency ΔF, and the frequency of the LO signal 366 is F_{LO}, then the IF signal 367 may have a frequency of |ΔF−F_{LO}|. If the frequency component ΔF is 5 GHZ, and the frequency F_{LO} of the LO signal 366 is 4 GHZ, then the IF signal 367 may have a frequency of approximately 1 GHz. If the frequency component ΔF is 5 GHz, and the frequency F_{LO} of the LO signal 366 is 6 GHZ, then the IF signal 367 may have a frequency of approximately 1 GHZ. The IF signal 367 produced by a mixer 618 may have a frequency equal to the sum or difference between the frequencies of the voltage signal 360 and the LO signal 366. For example, if the photocurrent signal i and voltage signal 360 have a frequency component at frequency ΔF, and the frequency of the LO signal 366 is F_{LO}, then the IF signal 367 may have a frequency of |ΔF+F_{LO}| or |ΔF−F_{LO}|. Herein, the frequency of an IF signal 367 may be expressed in terms of the difference between two frequencies (e.g., the frequency of an IF signal may be expressed as |ΔF−F_{LO}|). This disclosure also contemplates the frequency of an IF signal 367 being expressed as the sum of two frequencies (e.g., the frequency of an IF signal may be expressed additionally or alternatively as |ΔF+F_{LO}|).

In addition to the electronic LO 616 and mixer 618, the detection circuit 361 in FIG. 43 includes two electronic filters 610, a rectifier 612, and a digitizer 614. The electronic mixer 618 mixes the voltage signal 360 and the LO signal 366 to produce the IF signal 367. The electronic filter 610a receives the IF signal 367 and produces a filtered signal 362. The rectifier 612 receives the filtered signal 362 and produces a rectified signal 363. The electronic filter 610b receives the rectified signal 363 and produces a pulse signal 364. The digitizer 614 receives the pulse signal 364 and produces the output-signal portion 144, which is sent to the controller. The electronic LO 616, mixer 618, filter 610a, rectifier 612, filter 610b, and digitizer 614 in FIG. 43 may be hardware components that are implemented in electronic circuitry. In FIG. 43, the voltage signal 360, IF signal 367, filtered signal 362, rectified signal 363, and pulse signal 364 may each be analog electronic signals, and the output-signal portion 144 may be a digital electronic signal.

In addition to the electronic LO 616 and mixer 618, the detection circuit 361 in FIG. 44 includes an electronic filter 610a and a digitizer 614. The detection circuit 361 in FIG. 44 is similar to the detection circuit 361 in FIG. 43, except in FIG. 44, the rectifier 612 and filter 610b components are located in the controller 150. In FIG. 44, the electronic mixer 618 mixes the voltage signal 360 and the LO signal 366 to produce the IF signal 367. The electronic filter 610a receives the IF signal 367 and produces a filtered signal 362. The digitizer 614 receives the filtered signal 362 and produces the output-signal portion 144, which is sent to the controller 150. The electronic LO 616, mixer 618, filter 610a, and digitizer 614 in FIG. 44 may be hardware components that are implemented in electronic circuitry, while the rectifier 612 and filter 610b in FIG. 44 may be software components that are implemented as algorithms in the controller 150. In FIG. 44, the voltage signal 360, IF signal 367, and the filtered signal 362 may each be analog electronic signals, and the output-signal portion 144, rectified signal 363, and pulse signal 364 may each be digital electronic signals.

Filter 610a or 610b in FIG. 43 or filter 610a in FIG. 44 may be an analog electronic filter that filters an analog voltage signal (e.g., IF signal 367 or rectified signal 363 in FIG. 43 or IF signal 367 in FIG. 44). Alternatively, filter 610a in FIG. 44 may be a digital filter that is located after the digitizer 614. In this embodiment, the digitizer 614 in FIG. 44 may receive the IF signal 367 from the mixer 618 to produce a digitized version of the IF signal, and the filter 610a (which may be a digital-filtering algorithm located in the controller 150) may apply a digital filtering operation to the digitized IF signal to produce a digitized filtered signal 362. Filter 610b in FIG. 44 may be a digital filter that applies a digital filtering operation to the digitized rectified signal 363 to produce a digitized pulse signal 364.

Each receiver 140 in FIGS. 43 and 44 may be part of a lidar system 100 with a light source 110 that imparts approximately the same frequency offset Δf to each emitted pulse of light 400. The electronic filter 610a in each of FIGS. 43 and 44 may be a low-pass filter or a band-pass filter. For example, the electronic filter 610a may be a low-pass filter with an upper cutoff frequency that is greater than the frequency ||Δf|−F_{LO}, where F_{LO} is the frequency of the electronic LO signal 366. As another example, the electronic filter 610a may be a band-pass filter having a particular pass-band center frequency and a particular pass-band frequency width. The pass-band center frequency may be approximately equal to or may include the frequency ||Δf|−F_{LO}|. If the frequency offset Δf is 5 GHZ, and the frequency F_{LO} of the LO signal 366 is 4 GHz, then the pass-band may include the frequency 1 GHZ. A received pulse of light 410 with a frequency offset ΔF of approximately 5 GHz may result in an IF signal 367 at approximately 1 GHz, and the IF signal 367 may be substantially transmitted by the filter 610a. As another example, the electronic filter 610a may be a band-pass filter having a pass-band center frequency that includes the frequency ||Δf|+F_{LO}|. A band-pass filter 610a that receives an IF signal 367 may (i) transmit a spectral portion of the IF signal located within the pass-band and (ii) attenuate any spectral portions of the IF signal outside the pass-band. The filtered signal 362 may include the transmitted portion of the IF signal 367 having frequency components within the pass-band of the electronic filter 610a. The output-signal portion 144 produced by a frequency-detection channel 368 may correspond to the portion of the IF signal 367 that is transmitted by the band-pass filter 610a.

The electronic filter 610a in each of FIGS. 43 and 44 may be an analog-electronic band-pass filter with a pass-band that includes the frequency ||Δf|−F_{LO}, where Δf is a frequency offset applied to an emitted pulse of light 400. The IF signal 367 produced by the mixer 618 may have a frequency of ||ΔF|−F_{LO}|, where ΔF is a frequency offset of an associated received pulse of light 410. If the frequency of the IF signal 367 is located within the pass-band of the filter 610a, then the IF signal 367 may be substantially transmitted by the filter 610a to produce the filtered signal 362. For example, a 3-GHz frequency offset may be applied to an emitted pulse of light 400, and coherent mixing of the associated received pulse of light 410 with LO light 430 may produce a photocurrent signal i with an AM photocurrent signal having a frequency component ΔF of approximately 3 GHZ. The voltage signal 360 may include a corresponding AM voltage signal having a frequency of approximately 3 GHZ. The LO signal 366 may have a frequency of 2 GHz, which results in an IF signal 367 with a frequency of approximately 1 GHZ. The electronic band-pass filter 610a may have a 1-GHz pass-band center frequency and a 200-MHz pass-band width, and the filter 610a may transmit the spectral portion of the IF signal 367 that is located between approximately 0.9 GHZ and 1.1 GHZ. If a received pulse of light 410 produces a photocurrent signal i with a 2.9-GHz to 3.1-GHz AM signal, then band-pass filter 610a may transmit substantially all of the resulting 1-GHz IF signal 367 to produce the filtered signal 362, and the received pulse may be determined to be a valid pulse of light that is associated with one of the emitted pulses of light 400.

The rectifier 612 in FIG. 43 may be an analog electronic circuit that receives the filtered signal 362 (which corresponds to the portion of the IF signal 362 that is transmitted by the electronic filter 610a) and produces a rectified signal 363 that is a unipolar version of the filtered signal 362 (which corresponds to a unipolar version of the transmitted portion of the IF signal 362). In FIG. 44, the output signal 145 produced by the digitizer 614 may include positive and negative digital values that represent the filtered signal 362 (which corresponds to the portion of the IF signal 362 that is transmitted by the electronic filter 610a). The rectifier 612 in FIG. 44 may be a software component that produces the rectified signal 363 by rectifying the digitized filtered signal 362 produced by the digitizer 614.

Filter 610b in FIG. 43 may be an analog electronic filter that receives the rectified signal 363 and produces a pulse signal 364. The pulse signal 364 in FIG. 43 may include an analog representation of the received pulse of light 410. The electronic filter 610b may be a low-pass or band-pass filter with an upper cutoff frequency greater than or equal to 1/Δt, where Δτ is a duration of the received pulse of light 410 or an associated emitted pulse of light 400. The upper cutoff frequency of the electronic filter 610b may be selected so that temporal pulsations (e.g., pulsations with frequency greater than 1/Δτ) are attenuated by the filter while an overall pulse shape (e.g., with an associated frequency less than 1/Δτ) is transmitted by the filter. For example, the upper cutoff frequency may be greater than or equal to 1/Δτ and less than |Δf−F_{LO}|, which corresponds to the frequency of the IF signal 367 for a received pulse of light 410 with a frequency offset of Δf. In FIG. 43, the rectified signal 363 may include temporal pulsations associated with an AM photocurrent signal, and the pulse signal 364 may be an analog signal with a shape that corresponds to the received pulse of light 410 (and with little or no temporal pulsations associated with the AM photocurrent signal). Filter 610b in FIG. 44 may be a digital filter that applies a digital filtering operation (e.g., band-pass filtering or low-pass filtering) to the rectified signal 363 to produce the pulse signal 364. The digital filter 610b in FIG. 44 may have an upper cutoff frequency greater than or equal to 1/Δτ and less than |Δf−F_{LO}|. In FIG. 44, the rectified signal 363 and the pulse signal 364 may be digital signals, and the pulse signal produced by the filter 610b may include a series of digital values that represent the received pulse of light 410.

The digitizer 614 in each of FIGS. 43 and 44 may include any suitable hardware device that receives an analog input signal and produces a digital output signal corresponding to the input signal. The digitizer 614 in FIG. 43 receives the analog pulse signal 364 from filter 610b and produces an output-signal portion 144, which is sent as output signal 145 to the controller 150. The output-signal portion 144 in FIG. 43 may include a digital representation of the received pulse of light 410. For example, the pulse signal 364 may include an analog representation of the received pulse of light 410, and the output-signal portion 144 may include a series of digital values that represents the pulse signal 364. The digitizer 614 in FIG. 44 receives the analog filtered signal 362 from filter 610a and produces an output-signal portion 144, which is sent as output signal 145 to the controller 145. The output-signal portion 144 in FIG. 44 may include a digital representation of the portion of the IF signal 367 that is transmitted by the filter 610a. The IF signal 367 may have frequency components within the pass-band of the electronic filter 610a, and those frequency components may be transmitted by the filter to produce the filtered signal 362. The output-signal portion 144 produced by the digitizer 614 in FIG. 44 may include a digitized version of the filtered signal 362.

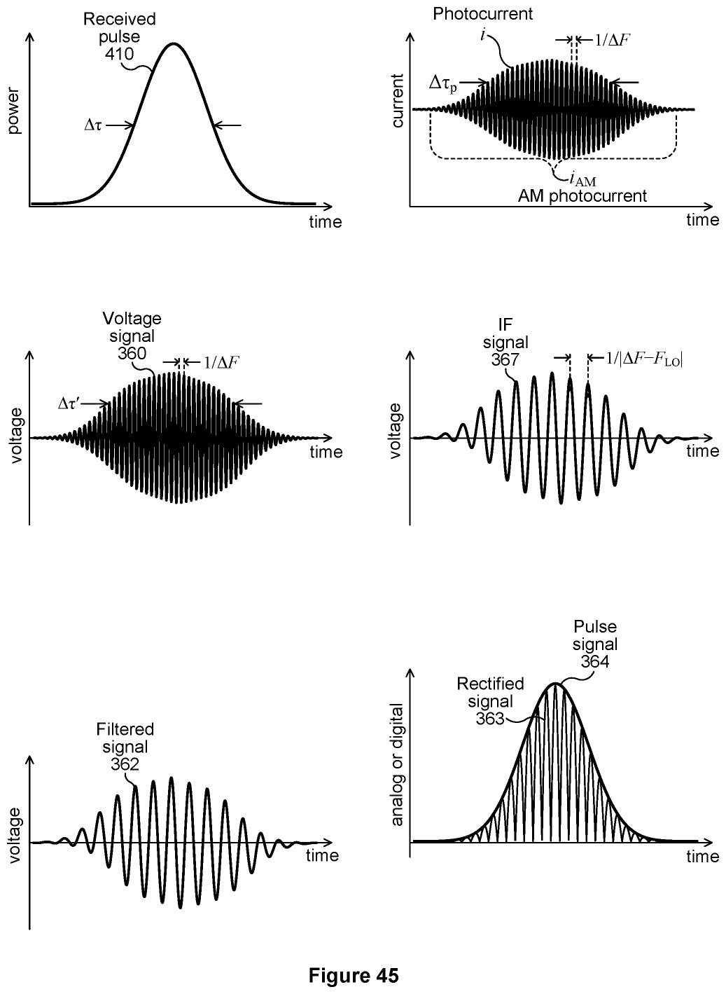

FIG. 45 illustrates example graphs of signals associated with the receivers 140 of FIGS. 43-44. The graphs of the received pulse of light 410, photocurrent signal i, voltage signal 360, IF signal 367, filtered signal 362, rectified signal 363, and pulse signal 364 illustrated in FIG. 45 may represent the respective signals in FIGS. 43 and 44. In discussing FIG. 43, the photocurrent signal i, voltage signal 360, IF signal 367, filtered signal 362, rectified signal 363, and pulse signal 364 illustrated in FIG. 45 may be considered to be analog electronic signals. In discussing FIG. 44, the photocurrent signal i, voltage signal 360, IF signal 367, and filtered signal 362 illustrated in FIG. 45 may be considered to be analog electronic signals, while the rectified signal 363 and pulse signal 364 illustrated in FIG. 45 may be considered to be digital electronic signals.

In FIG. 45, the received pulse of light 410 has a frequency offset of ΔF with respect to LO light 430, and coherent mixing of the received pulse of light 410 with LO light 430 results in a photocurrent signal i that includes an AM photocurrent signal i_{AM}. The AM photocurrent signal has periodic temporal pulsations, with each pulsation separated by a time period of 1/ΔF, which corresponds to a frequency of ΔF for the AM photocurrent signal. The voltage signal 360 includes an AM voltage signal that corresponds to the AM photocurrent signal, and the AM voltage signal has corresponding temporal pulsations with a frequency of ΔF. The received pulse of light 410 in FIG. 45 may be associated with an emitted pulse of light 400 having a frequency offset Δf with respect to the LO light 430. The frequency offset Δf of the emitted pulse of light 400 or the frequency offset ΔF of the associated received pulse of light 410 may be configured to be greater than 1/Δτ (where Δτ is the duration of the emitted pulse of light 400 or the received pulse of light 410).

The frequency component ΔF may be related to the frequency offset Δf by an amount of Doppler frequency shift of the received pulse of light 410. The Doppler frequency shift of the received pulse of light 410 may be imparted by a radial speed of a target 130 (relative to the lidar system) from which the emitted pulse of light 400 was scattered. If the received pulse of light 410 has a Doppler frequency shift of FD, then the frequency offset Δf and the frequency component ΔF may be related by the expression ΔF=|Δf+F_{D}|. An emitted pulse of light 400 with a 5-GHZ frequency shift that produces a received pulse of light 410 with a +100-MHz Doppler frequency shift (due to motion of the target 130 with respect to the lidar system 100) may result in an AM photocurrent signal with a frequency ΔF of 5.1 GHZ. Similarly, an emitted pulse of light 400 with a 5-GHz frequency shift that produces a received pulse of light 410 with a −100-MHz Doppler frequency shift may result in an AM photocurrent signal with a frequency ΔF of 4.9 GHZ.

In FIG. 45, the voltage signal 360 with frequency ΔF is electronically mixed with an electronic LO signal 366 with frequency F_{LO} to produce the IF signal 367 with frequency |ΔF—F_{LO}|. The electronic filter 610a in FIGS. 43 and 44 may be an analog band-pass filter with a pass-band that includes the frequency |ΔF−F_{LO}| of the IF signal 367. Since the frequency component of the IF signal 367 is within the pass-band of the electronic filter 610a, the filter may transmit most or all of the IF signal to produce the filtered signal 362 in FIG. 45. For a different IF signal having a frequency component outside the pass-band of the electronic filter 610a, the filter may attenuate most of the IF signal, and the resulting filtered signal may have a relatively small amplitude (e.g., <10% of the amplitude of the filtered signal 362 in FIG. 45). The output-signal portion 144 produced by a frequency-detection channel 368 may correspond to the portion of the IF signal 367 that is transmitted by the band-pass filter 610a. For example, an output-signal portion 144 may have a relatively large amplitude if the IF signal 367 has a frequency component within the pass-band of the band-pass filter 610a. Alternatively, an output-signal portion 144 may have a relatively small amplitude if the IF signal 367 has little or no frequency components within the pass-band.

The rectifier 612 in FIG. 43 may include an analog electronic circuit that squares or takes the absolute value of the filtered signal 362 to produce the analog rectified signal 363 in FIG. 45. The electronic filter 610b in FIG. 43 may be an analog filter that low-pass filters or band-pass filters the rectified signal 363 to produce the pulse signal 364 in FIG. 45. For example, the electronic filter 610b may be a low-pass or band-pass filter with an upper cutoff frequency greater than or equal to 1/Δτ, 1/Δτρ, or 1/Δτ′. Additionally, the upper cutoff frequency may be less than |Δf−F_{LO}|, which corresponds to the frequency of the IF signal 367 for a received pulse of light 410 with a frequency offset of Δf. The filter 610b may attenuate the temporal pulsations in the rectified signal 363 and may transmit the overall pulse shape to produce the pulse signal 364 in FIG. 43. The pulse signal 364 may be an analog signal having a shape that is similar to the received pulse of light 410. The digitizer 614 in FIG. 43 receives the analog pulse signal 364 and produces an output-signal portion 144 which may include a series of digital values that represent the pulse signal 364. Since the pulse signal 364 in FIG. 43 is produced from the AM photocurrent signal (e.g., the pulse signal 364 is produced from the rectified signal 363, which is produced from the filtered signal 362, which is produced from the IF signal 367, which is produced from the voltage signal 360, which is produced from the photocurrent signal i, which includes the AM photocurrent signal), the output-signal portion 144 may be referred to as corresponding to the AM photocurrent signal.

In FIG. 44, the digitizer 614 may produce an output-signal portion 144 that includes digital values representing the filtered signal 362 in FIG. 45. Since the filtered signal 362 is produced from the AM photocurrent signal (e.g., the filtered signal 362 is produced from the IF signal 367, which is produced from the voltage signal 360, which is produced from the photocurrent signal i, which includes the AM photocurrent signal), the output-signal portion 144 may be referred to as corresponding to the AM photocurrent signal. The output-signal portion 144 is sent as output signal 145 to the controller 150. Based on the output signal 145 (which may include a digital representation of the filtered signal 362, which corresponds to the AM photocurrent signal), the controller 150 may produce a digital representation of the received pulse of light 410 by (i) rectifying the digital representation of the filtered signal 362 and (ii) low-pass or band-pass filtering the rectified digital signal. The rectifier 612 in FIG. 44 may be a software component that squares or takes the absolute value of the digital values representing the filtered signal 362 to produce the rectified signal 363 in FIG. 45. The filter 610b in FIG. 44 may be a low-pass or band-pass digital filter that applies a digital filtering operation to the digital values of the rectified signal 363 to produce the pulse signal 364 in FIG. 45. The pulse signal 364 may include a series of digital values that correspond to a digital representation of the received pulse of light 410.

The controller 150 in FIGS. 43-44 may receive or determine a digital representation of the pulse signal 364 in FIG. 45. The digital representation of the pulse signal 364 may be part of an output signal 145 or may be determined from an output signal 145. In FIG. 43, the output signal 145 may include a digital representation of the pulse signal 364. In FIG. 44, the controller 150 may determine a digital representation of the pulse signal 364 from the output signal 145 (e.g., by rectifying the digital representation of the filtered signal 362 and low-pass or band-pass filtering the rectified digital signal). Based on the pulse signal 364 associated with a received pulse of light 410, the controller 150 may determine whether the received pulse of light 410 includes a frequency offset within a particular threshold of Δf. Additionally or alternatively, the controller 150 may determine whether the received pulse of light 410 is associated with one of the emitted pulses of light 400. For example, if the amplitude of the pulse signal 364 associated with a received pulse of light 410 is greater than a particular threshold value, then the controller 150 may determine that the received pulse of light 410 (i) includes a frequency offset that matches the frequency offset Δf of the emitted pulses of light 400 or (ii) is a valid pulse of light that is associated with one of the emitted pulses of light.

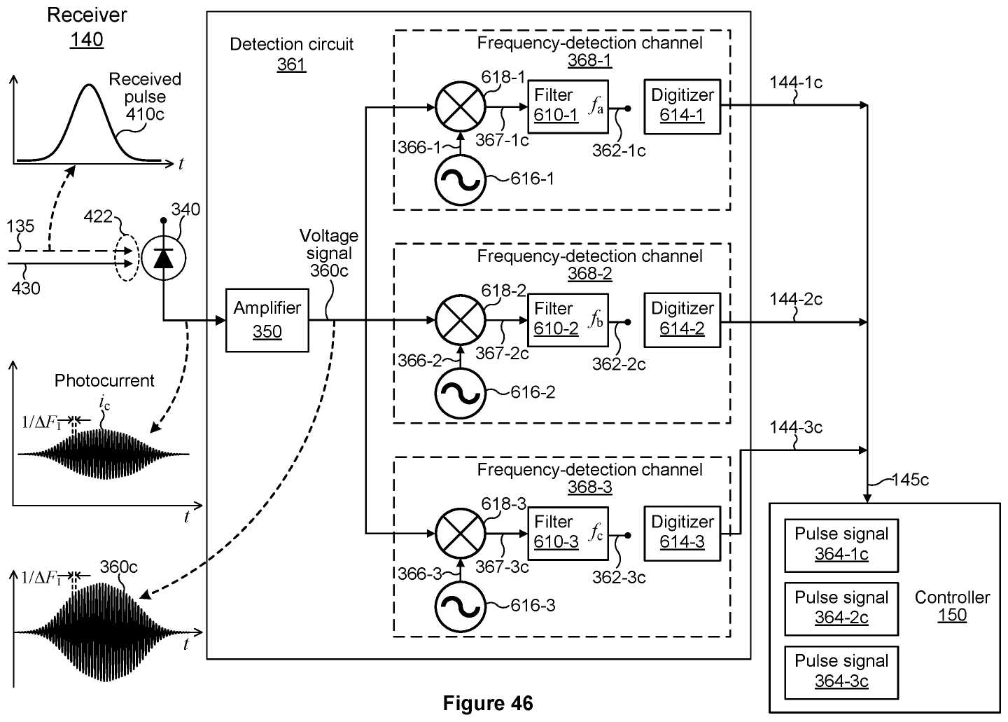

FIG. 46 illustrates an example receiver 140 with a detection circuit 361 that includes three frequency-detection channels (368-1, 368-2, 368-3). The receiver 140 in FIG. 46 corresponds to the receiver 140 in FIG. 37 with the parameter N equal to 3. The receiver 140 in FIG. 46 is similar to the receiver 140 in FIGS. 41-42, except the receiver 140 in FIG. 46 is a superheterodyne receiver in which each frequency-detection channel 368 includes an electronic LO 616 and an electronic mixer 618, while the receiver 140 in FIGS. 41-42 is a heterodyne receiver. In FIG. 46, a received pulse of light 410c with a frequency offset of ΔF₁ is coherently mixed with LO light 430 to produce a photocurrent signal i_{c} that includes an AM signal with frequency ΔF₁. The electronic amplifier 350 amplifies the photocurrent signal i_{c} to produce a voltage signal 360c that includes an AM signal with frequency ΔF₁. The received pulse of light 410c may include scattered light from an emitted pulse of light 400 with a frequency offset of Δf₁, where the Δf₁ frequency offset is associated with frequency-detection channel 368-2 (e.g., the frequency offset Δf₁ may be equal to f_{b}+F_{LO2}, where f_{b} is the center frequency of filter 610-2 and F_{LO2} is the oscillation frequency of the LO signal 366-2). If the received pulse of light 410c has a Doppler frequency shift of F_{D}, then the frequencies Δf₁ and ΔF₁ may be related by the expression ΔF₁=|Δf₁+F_{D}|.

The frequency-detection channels 368-1, 368-2, and 368-3 in FIG. 46 may be similar to the frequency-detection channel 368 in FIG. 43, in which each frequency-detection channel includes a mixer 618, an electronic LO 616, two filters 610, a rectifier 612, and a digitizer 614. For example, in addition to mixer 618-1, electronic LO 616-1, filter 610-1, and digitizer 614-1, the frequency-detection channel 368-1 in FIG. 46 may also include a rectifier 612 that produces a rectified signal 363 and an electronic filter 610b that produces a pulse signal 364-1c. The digitizer 614-1 may produce a digital representation of the pulse signal 364-1c that is sent as output-signal portion 144-1c to the controller 150. Alternatively, the frequency-detection channels 368-1, 368-2, and 368-3 in FIG. 46 may be similar to the frequency-detection channel 368 in FIG. 44, in which each frequency-detection channel includes a mixer 618, an electronic LO 616, one filter 610a, and a digitizer 614, and the rectifier 612 and filter 610b are part of the controller 150. For example, digitizer 614-1 of frequency-detection channel 368-1 in FIG. 46 may receive the filtered signal 362-1c and produce a digital representation of the filtered signal 362-1c that is sent as output-signal portion 144-1c to the controller 150. The controller 150 may rectify and filter the digital representation of the filtered signal to produce the digital representation of the pulse signal 364-1c. In either case, in FIG. 46, the controller 150 receives an output signal 145c that includes the three output-signal portions 144-1c, 144-2c, and 144-3c produced by the three respective digitizers 614-1, 614-2, and 614-3 of the three respective frequency-detection channels 368-1, 368-2, and 368-3. Each of the output-signal portions 144-1c, 144-2c, and 144-3c may correspond to the portion of the respective IF signals 367-1c. 367-2c, and 367-3c transmitted by the respective filters 610-1, 610-2, and 610-3. Based on the output signal 145c, the controller 150 receives or determines a digital representation of three pulse signals (364-1c, 364-2c, and 364-3c), from which the controller 150 may determine (i) a frequency offset of the received pulse of light 410c or (ii) which emitted pulse of light 400 the received pulse of light 410c is associated with.

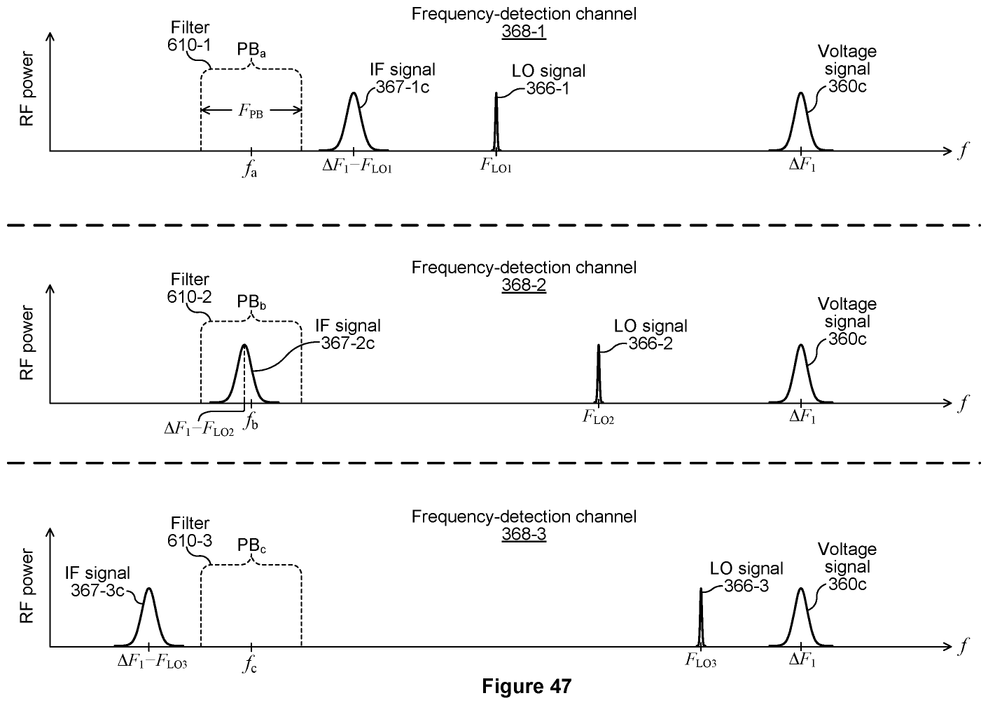

FIG. 47 illustrates example frequency-domain graphs of signals associated with the receiver 140 of FIG. 46. Each of the three frequency-detection channels 368 in FIG. 46 receives a voltage signal 360c, which has a frequency component at frequency ΔF₁. Each voltage signal 360c is mixed with an electronic LO signal 366 having a particular frequency F_{LO} to produce an IF signal 367. A detection circuit 361 with multiple frequency-detection channels 368 may include multiple electronic LOs 616 that each produce LO signals 366 at approximately the same frequency or at multiple different frequencies. In FIG. 47, the three LO signals 366-1, 366-2, and 366-3 produced by the three respective electronic LOs electronic LOs 616-1, 616-2, and 616-3 each have a different oscillator frequency. In frequency-detection channel 368-1, the voltage signal 360c is mixed at mixer 618-1 with an LO signal 366-1 having a frequency of F_{LO1} to produce an IF signal 367-1c at frequency ΔF₁−F_{LO1}. In frequency-detection channel 368-2, the voltage signal 360c is mixed at mixer 618-2 with an LO signal 366-2 having a frequency of F_{LO2} to produce an IF signal 367-2c at frequency ΔF₁−F_{LO2}. In frequency-detection channel 368-3, the voltage signal 360c is mixed at mixer 618-3 with an LO signal 366-3 having a frequency of F_{LO3} to produce an IF signal 367-3c at frequency ΔF₁−F_{LO3}.

A detection circuit 361 with multiple frequency-detection channels 368 may include multiple electronic band-pass filters 610 having approximately the same pass-band center frequency or having different pass-band center frequencies. The electronic filters 610-1, 610-2, and 610-3 illustrated in FIGS. 46-47 are band-pass filters with respective center frequencies fₐ, f_{b}, and f_{c} that are approximately equal and with respective pass bands PBₐ, PB_{b}, PB_{c} that are approximately the same. In FIG. 47, IF signal 367-2c has a frequency ΔF₁−F_{LO2} that is within the pass-band PB_{b} of the band-pass filter 610-2. The filter 610-2 may transmit most or all of the IF signal 367-2c to produce the filtered signal 362-2c, which may have a relatively large amplitude. In FIG. 47, IF signal 367-1c is located outside of the filter pass-band PBₐ, which indicates that the filter 610-1 may attenuate most of the IF signal 367-1c, resulting in a filtered signal 362-1c having a relatively small amplitude (e.g., <10% of the amplitude of the filtered signal 362-2c). Similarly, IF signal 367-3c is located outside of the filter pass-band PB_{c}, which indicates that the filter 610-3 may attenuate most of the IF signal 367-3c, resulting in a filtered signal 362-3c having a relatively small amplitude.

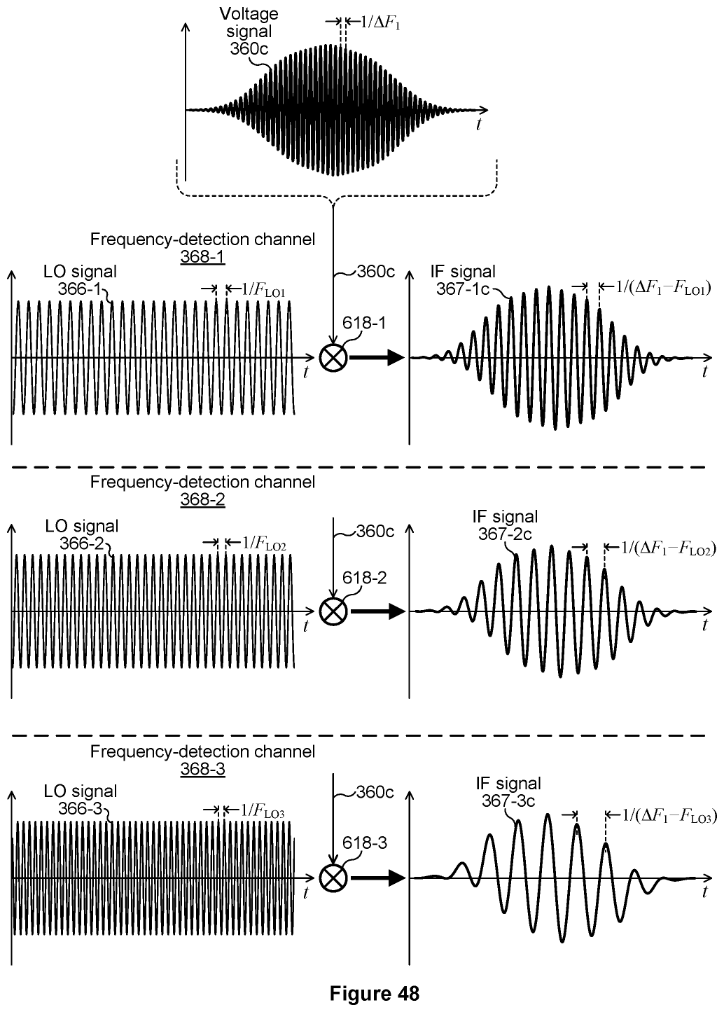

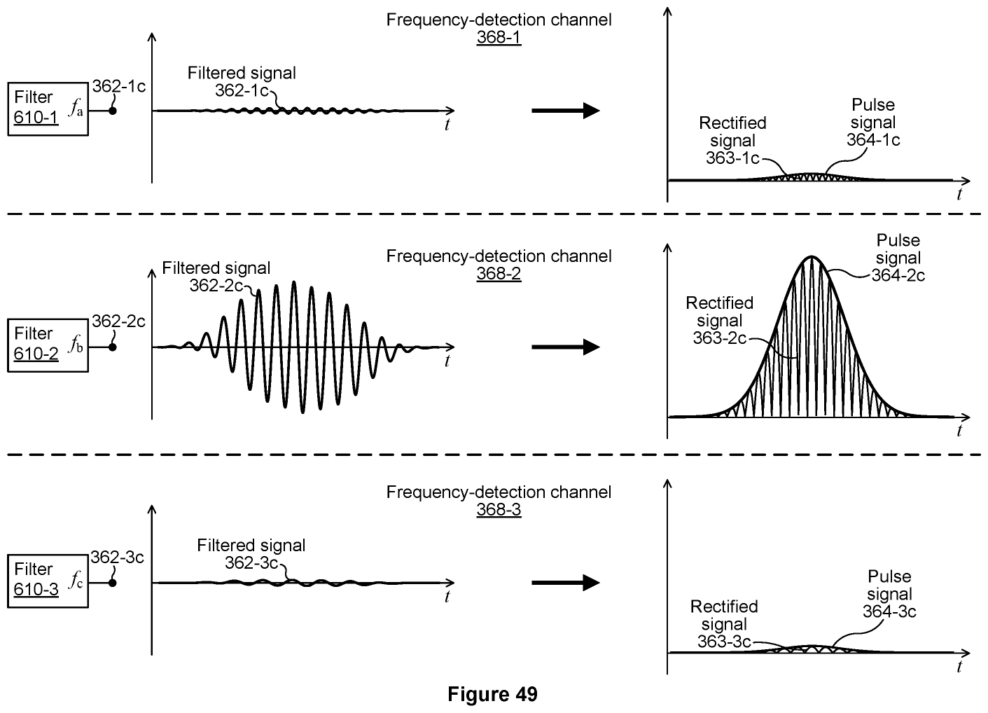

FIGS. 48-49 illustrate example time-domain graphs of signals associated with the receiver 140 of FIG. 46. The y-axis of each of the graphs in FIGS. 48 and 49 may have units of voltage. FIG. 48 provides time-domain versions of the frequency-domain signals illustrated in FIG. 47. The voltage signal 360c, which has a frequency component at frequency ΔF₁, is electronically mixed with the three LO signals 366-1, 366-2, and 366-3 having three different respective oscillator frequencies F_{LO1}, F_{LO2}, and F_{LO3}. The electronic mixing produces IF signal 367-1c at frequency ΔF₁−F_{LO1}, IF signal 367-2c at frequency ΔF₁−F_{LO2}, and IF signal 367-3c at frequency ΔF₁−F_{LO3}.

FIG. 49 illustrates the filtered signal 362, rectified signal 363, and pulse signal 364 associated with each frequency-detection channel 368. The IF signal 367-1c in FIG. 47 is located outside pass-band PBₐ of filter 610-1, and the resulting filtered signal 362-1c in FIG. 49 has a relatively small amplitude. The associated rectified signal 363-1c and pulse signal 364-1c in FIG. 49 also have correspondingly small amplitudes. The IF signal 367-2c in FIG. 47 is located within pass-band PB_{b} of filter 610-2, and the resulting filtered signal 362-2c in FIG. 49 has a relatively large amplitude. The associated rectified signal 363-2c and pulse signal 364-2c in FIG. 49 also have correspondingly large amplitudes, and the pulse signal 364-2c includes a representation of the received pulse of light 410c. The IF signal 367-3c in FIG. 47 is located outside pass-band PB_{c} of filter 610-3, and the resulting filtered signal 362-3c in FIG. 49 has a relatively small amplitude. The associated rectified signal 363-3c and pulse signal 364-3c in FIG. 49 also have correspondingly small amplitudes.

Based on the output signal 145c in FIG. 46, the controller 150 receives or determines a digital representation of the three pulse signals 364-1c, 364-2c, and 364-3c illustrated in FIG. 49. Based on the three pulse signals, the controller 150 may determine (i) the frequency offset of the received pulse of light 410c or (ii) which emitted pulse of light 400 the received pulse of light 410c is associated with. For example, the controller 150 may determine, based at least in part on the amplitude of the pulse signal 364-2c, that the received pulse of light 410c in FIG. 46 includes a frequency offset of approximately f_{b}+F_{LO2} that is associated with frequency-detection channel 368-2. Additionally or alternatively, the controller 150 may determine that the received pulse of light 410c is associated with a particular emitted pulse of light 400 having a frequency offset Δf of f_{b}+F_{LO2} that is associated with frequency-detection channel 368-2. For example, the received pulse of light 410c may be associated with an emitted pulse of light 400 with a frequency offset Δf of 4 GHZ, and the voltage signal 360c may have a frequency ΔF₁ of approximately 4 GHz. The frequency F_{LO2} of the LO signal 366-2 may be 3 GHZ, and the IF signal 367-2c may have a frequency of approximately 1 GHZ. The filter 610-2 may have a center frequency f_{b} of 1 GHz so that the IF signal 367-2c is substantially transmitted by the filter 610-2 to produce the filtered signal 362-2c.

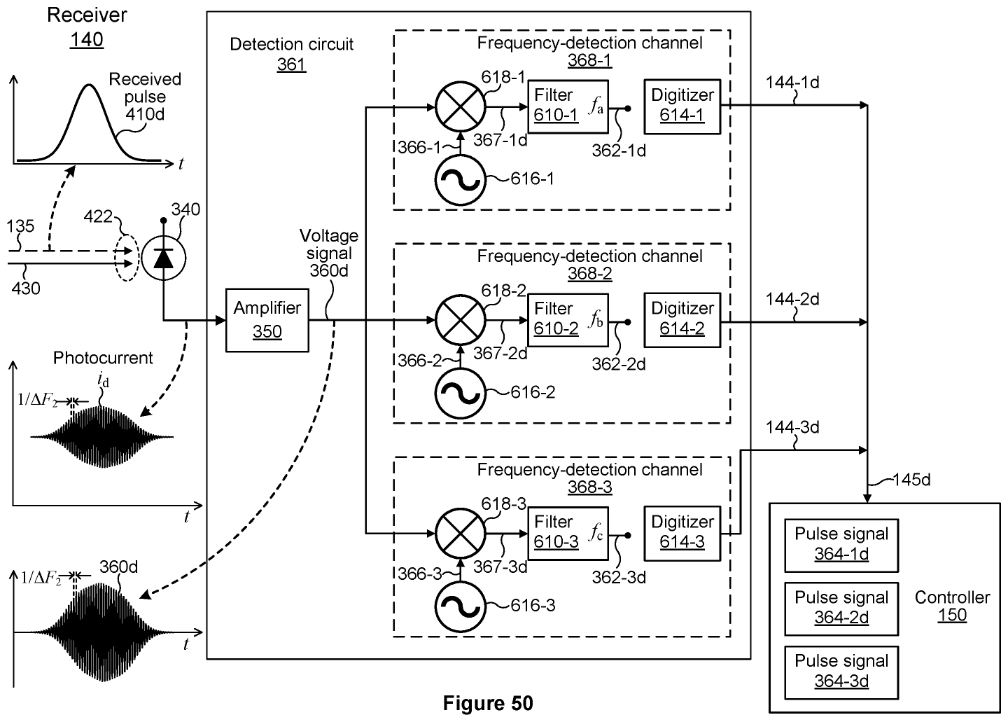

FIG. 50 illustrates the example receiver 140 of FIG. 46 with a second received pulse of light 410d. In FIG. 50, a received pulse of light 410d with a frequency offset of ΔF₂ is coherently mixed with LO light 430 to produce a photocurrent signal i_{d} that includes an AM signal with frequency ΔF₂. The electronic amplifier 350 amplifies the photocurrent signal i_{d} to produce a voltage signal 360d that includes an AM signal with frequency ΔF₂. The received pulse of light 410d may include scattered light from an emitted pulse of light 400 with a frequency offset of Δf₂, where the Δf₂ frequency offset is associated with frequency-detection channel 368-3 (e.g., the frequency offset Δf₂ may be equal to f_{c}+F_{LO3}). If the received pulse of light 410d has a Doppler frequency shift of F_{D}, then the frequencies Δf₂ and ΔF₂ may be related by the expression ΔF₂=|Δf₂+F_{D}|. The frequency offset ΔF₂ of the received pulse of light 410d in FIG. 50 is different from the frequency offset ΔF₁ of the received pulse of light 410c in FIG. 46. Based on the different frequency offsets, the controller 150 may determine which emitted pulse of light 400 each of the received pulses of light 410c and 410d is associated with. For example, the controller 150 may determine that the received pulse of light 410c is associated with a particular emitted pulse of light 400 that has a frequency offset Δf₁ that matches the frequency offset ΔF₁ of the received pulse of light 410c. Similarly, the controller 150 may determine that the received pulse of light 410d is associated with a different particular emitted pulse of light 400 that has a frequency offset Δf₂ that matches the frequency offset ΔF₂ of the received pulse of light 410d.

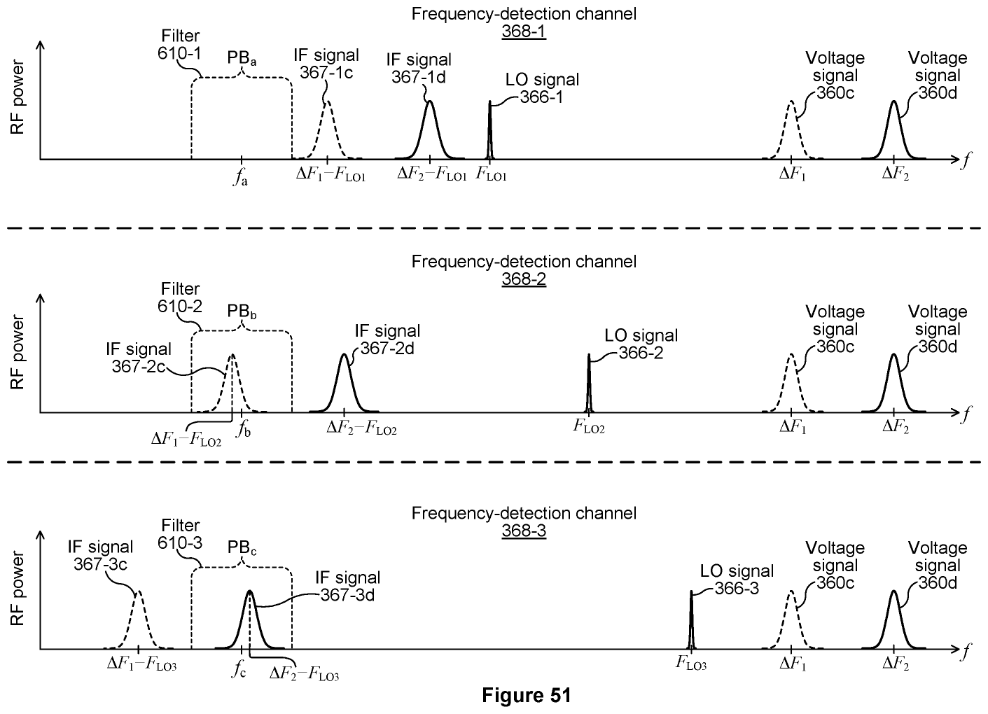

FIG. 51 illustrates example frequency-domain graphs of signals associated with the receiver 140 of FIGS. 46 and 50. The solid-line signals in FIG. 51 are associated with the second received pulse of light 410d. The dashed-line signals in FIG. 51 are included for reference to indicate the signals from FIG. 47 associated with the first received pulse of light 410c. Each of the three frequency-detection channels 368 in FIGS. 50-51 receives a voltage signal 360d, which has a frequency component at frequency ΔF₂. Each voltage signal 360d is mixed with an LO signal 366 having a particular frequency F_{LO} to produce an IF signal 367. In frequency-detection channel 368-1, as illustrated in FIG. 51, the voltage signal 360d is mixed with an LO signal 366-1 having a frequency of F_{LO1} to produce an IF signal 367-1d at frequency ΔF₂−F_{LO1}. In frequency-detection channel 368-2, the voltage signal 360d is mixed with an LO signal 366-2 having a frequency of F_{LO2} to produce an IF signal 367-2d at frequency ΔF₂−F_{LO2}. In frequency-detection channel 368-3, the voltage signal 360d is mixed with an LO signal 366-3 having a frequency of F_{LO3} to produce an IF signal 367-3d at frequency ΔF₂−F_{LO3}.

In FIG. 51, IF signal 367-3d has a frequency ΔF₁−F_{LO3} that is within the pass-band PB of the band-pass filter 610-3. The filter 610-3 may transmit most or all of the IF signal 367-3d to produce the filtered signal 362-3d in FIG. 50, which may have a relatively large amplitude. IF signal 367-1d is located outside of the filter pass-band PBₐ, which indicates that the filter 610-1 may attenuate most of the IF signal 367-1d, resulting in a filtered signal 362-1d having a relatively small amplitude (e.g., <10% of the amplitude of the filtered signal 362-3d). Similarly, IF signal 367-2d is located outside of the filter pass-band PB_{b}, which indicates that the filter 610-2 may attenuate most of the IF signal 367-2d, resulting in a filtered signal 362-2d having a relatively small amplitude.

In FIG. 50, the controller 150 receives an output signal 145d that includes the three output-signal portions 144-1d. 144-2d, and 144-3d. Based on the output signal 145d, the controller 150 receives or determines a digital representation of three pulse signals (364-1d, 364-2d, and 364-3d), from which the controller 150 may determine (i) the frequency offset of the received pulse of light 410d or (ii) which emitted pulse of light 400 the received pulse of light 410d is associated with.

The lidar system 100 associated with the receiver 140 of FIGS. 46 and 50 may emit pulses of light 400 having a particular frequency offset of three different frequency offsets: (i) a frequency offset of fₐ+F_{LO1} (which is associated with frequency-detection channel 368-1), (ii) a frequency offset of f_{b}+F_{LO2} (which is associated with frequency-detection channel 368-2), and (iii) a frequency offset of f_{c}+F_{LO3} (which is associated with frequency-detection channel 368-3). In FIGS. 46 and 50, the controller 150 receives the output signals 145c and 145d associated with the respective received pulses of light 410c and 410d. Based on the output signals, the controller 150 receives or determines digital representations of (i) pulse signals 364-1c, 364-2c, and 364-3c associated with received pulse of light 410c and (ii) pulse signals 364-1d, 364-2d, and 364-3d associated with received pulse of light 410d. For example, the controller 150 may determine that received pulse of light 410c is associated with frequency-detection channel 368-2 (which is associated with a frequency offset of f_{b}+F_{LO2}) based on the amplitude of pulse signal 364-2c exceeding a particular threshold value or based on the amplitude of pulse signal 364-2c being greater than the amplitudes of pulse signals 364-1c and 364-3c. Additionally or alternatively, the controller 150 may determine, based on the amplitudes of the pulse signals 364-1c, 364-2c, and 364-3c, that received pulse of light 410c is associated with a particular emitted pulse of light 400 that has a frequency offset of f_{b}+F_{LO2} (which is associated with frequency-detection channel 368-2). The determination may be based on the amplitude of pulse signal 364-2c exceeding a particular threshold value or based on the amplitude of pulse signal 364-2c being greater than the amplitudes of pulse signals 364-1c and 364-3c. Additionally or alternatively, the controller 150 may determine, based on the amplitudes of the pulse signals 364-1c, 364-2c, and 364-3c, that received pulse of light 410c is not associated with an emitted pulse of light 400 that has a frequency offset of fₐ+F_{LO1} (which is associated with frequency-detection channel 368-1) or an emitted pulse of light 400 that has a frequency offset of f_{c}+F_{LO3} (which is associated with frequency-detection channel 368-3). As another example, the controller 150 may determine that received pulse of light 410d is associated with frequency-detection channel 368-3 (which is associated with a frequency offset of f_{c}+F_{LO3}) based on the amplitude of pulse signal 364-3d exceeding a particular threshold value or based on the amplitude of pulse signal 364-3d being greater than the amplitudes of pulse signals 364-1d and 364-2d. Additionally or alternatively, the controller 150 may determine, based on the amplitudes of the pulse signals 364-1d, 364-2d, and 364-3d, that received pulse of light 410d is associated with a particular emitted pulse of light 400 that has a frequency offset of f_{c}+F_{LO3} (which is associated with frequency-detection channel 368-3). Additionally or alternatively, the controller 150 may determine, based on the amplitudes of the pulse signals 364-1d, 364-2d, and 364-3d, that received pulse of light 410d is not associated with an emitted pulse of light 400 that has a frequency offset of fₐ+F_{LO1} (which is associated with frequency-detection channel 368-1) or an emitted pulse of light 400 that has a frequency offset of f_{b}+F_{LO2} (which is associated with frequency-detection channel 368-2).

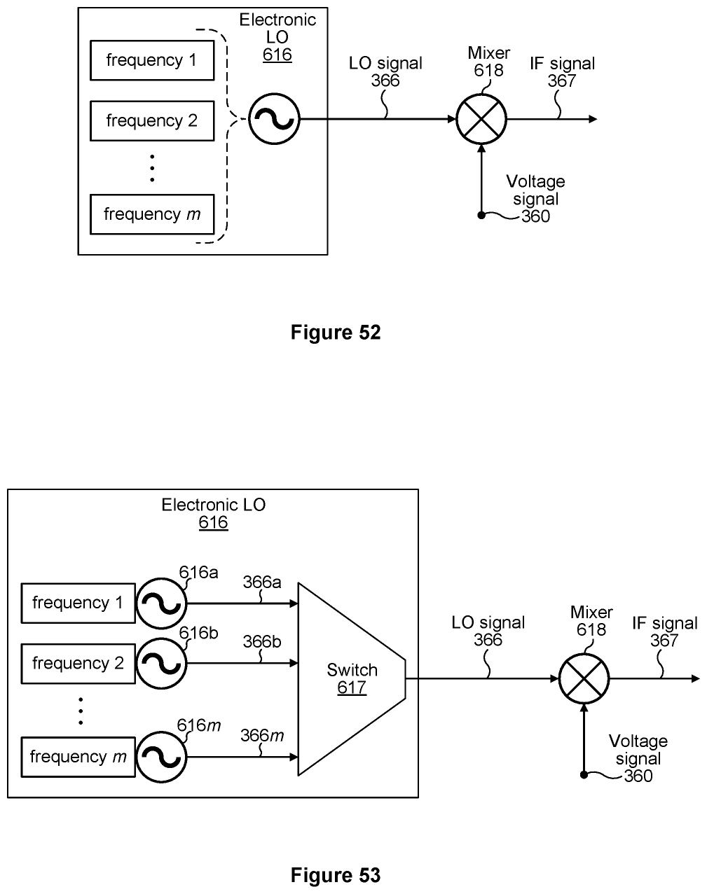

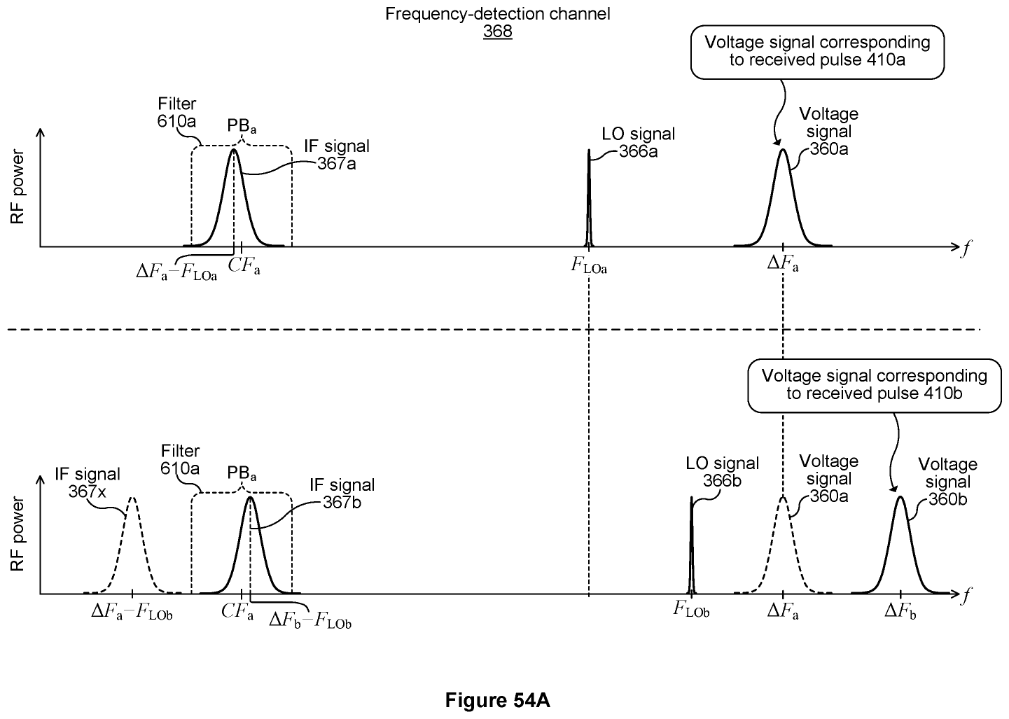

FIGS. 52-53 each illustrate an example adjustable electronic local oscillator 616 configured to produce multiple different oscillator frequencies (LO frequency 1, LO frequency 2, . . . , LO frequency m). In some embodiments, an electronic LO 616 may produce an electronic LO signal 366 having a single, non-adjustable oscillator frequency F_{LO}. For example, the electronic LO 616-1 in FIGS. 46 and 50 may be a fixed-frequency electronic LO that produces an LO signal 366-1 at one particular fixed oscillator frequency F_{LO1}. In other embodiments, an electronic LO 616 may be an adjustable-frequency local oscillator that produces an LO signal 366 that is adjustable to multiple different oscillator frequencies. The electronic LO 616 in each of FIGS. 52 and 53 is an adjustable-frequency local oscillator that produces an LO signal 366 having one oscillator frequency of m different frequencies, where m is an integer greater than or equal to 2 (e.g., m may equal 2, 3, 4, 5, 10, 20, or any other suitable number of different frequencies). Additionally, the electronic LO 616 in each of FIGS. 52 and 53 is configured to switch between operating at any of the m different frequencies. At any particular time, the adjustable-frequency electronic LO 616 may produce only one of the m different frequencies. For example, during a first interval of time, the electronic LO 616 in each of FIGS. 52 and 53 may produce one oscillator frequency of the m different frequencies, and during a subsequent second interval of time the LO 616 may switch to produce a different frequency of the m different frequencies. A controller 150 may provide instructions to an adjustable-frequency electronic LO 616 to produce an LO signal 366 having a particular frequency of the m different oscillator frequencies. Additionally, the controller 150 may instruct the electronic LO 616 to switch to producing an LO signal 366 at a different frequency.

The electronic LO 616 in FIG. 52 includes one adjustable-frequency electronic oscillator that is configured to switch between operating at each of the m different oscillator frequencies. The electronic LO 616 in FIG. 53 includes m fixed-frequency electronic oscillators, where each oscillator is configured to produce an LO signal 366 at one particular frequency of the m different oscillator frequencies. Oscillator 616a produces an LO signal 366a at frequency 1, oscillator 616b produces an LO signal 366b at frequency 2, and oscillator 616m produces an LO signal 366m at frequency m. The electronic LO 616 in FIG. 53 includes an electronic switch 617 that selects one of the oscillator frequencies to send out as the LO signal 366 to the mixer 618. For example, the electronic switch 617 may be a m×1 switch that switches between the m input frequencies to connect a particular one of the m input frequencies to the output of the switch to produce an LO signal 366 at a particular oscillator frequency that is sent to the mixer 618.

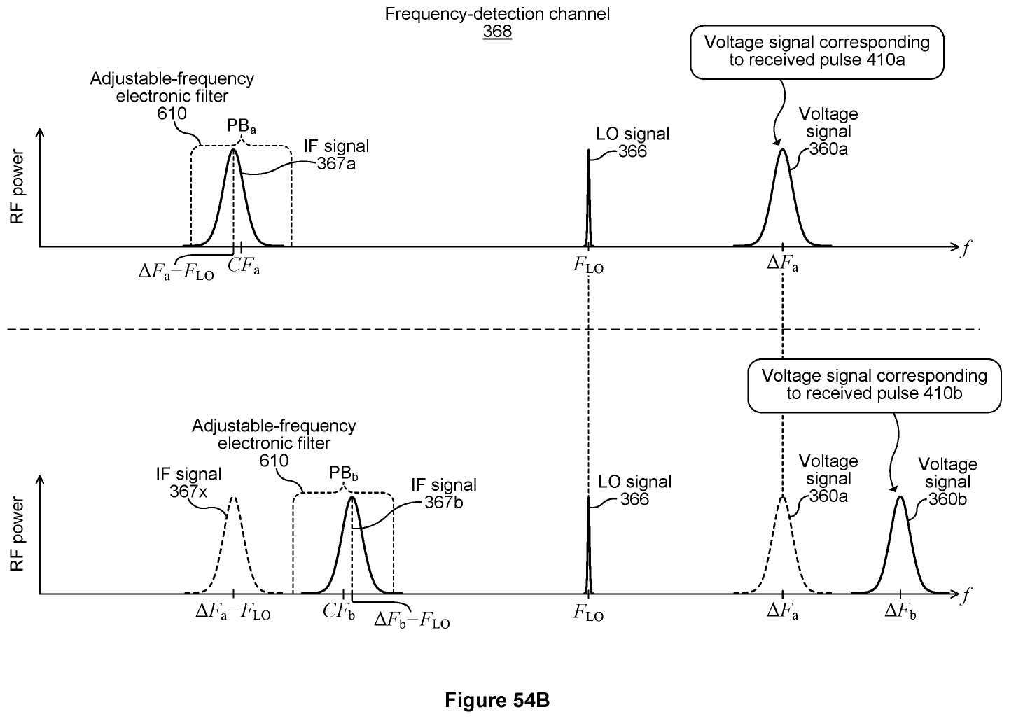

FIG. 54A illustrates example frequency-domain graphs of signals associated with an adjustable-frequency electronic local oscillator 616 and two received pulses of light 410a and 410b. The upper graph is associated with the received pulse of light 410a, and the lower graph is associated with the received pulse of light 410b. The pulses of light 410a and 410b in FIG. 54A may correspond to those illustrated in FIG. 34, where received pulse of light 410a is associated with emitted pulse of light 400a, and received pulse of light 410b is associated with emitted pulse of light 400b.

The signals in FIG. 54A may be produced by one frequency-detection channel (e.g., frequency-detection channel 368 of FIG. 43 or 44, or frequency-detection channel 368-1 of FIG. 46) that includes an adjustable-frequency electronic local oscillator 616. An adjustable-frequency electronic local oscillator 616 may allow a frequency-detection channel 368 of a receiver 140 to detect multiple received pulses of light 410 having multiple different frequency offsets ΔF. A frequency-detection channel 368 that is configured to detect received pulses of light 410 having m different frequency offsets may include an adjustable-frequency electronic LO 616 that produces m different LO frequencies, where each oscillator frequency is associated with one of the m different frequency offsets. An adjustable-frequency electronic local oscillator 616 that produces m different LO frequencies may allow a frequency-detection channel 368 to detect pulses of light 410 having m different frequency offsets. For example, the electronic LO 616 in FIG. 43 or 44 may be an adjustable-frequency electronic LO that is configured to switch between the two LO signals 366a and 366b in FIG. 54A with two different oscillator frequencies F_{LOa} and F_{LOb}. The frequency-detection channel 368 may be configured to detect pulses of light 410 having two different frequency offsets of approximately CFₐ+F_{LOa} and CFₐ+F_{LOb}, where CFₐ is the center frequency of the electronic band-pass filter 610a.

The voltage signal 360a in FIG. 54A results from coherent mixing of received pulse of light 410a with LO light 430 and has a frequency component of ΔFₐ. Voltage signal 360b results from coherent mixing of received pulse of light 410b with LO light 430 and has a different frequency component of ΔF_{b}. An adjustable-frequency electronic LO 616 of the frequency-detection channel 368 may switch between producing an LO signal 366 at two different frequencies: LO signal 366a at frequency F_{LOa} and LO signal 366b at frequency F_{LOb}. Starting around a time when pulse of light 400a is emitted, the electronic LO 616 produces LO signal 366a at frequency F_{LOa}, and subsequent to that, pulse 410a is detected by the receiver 140. The resulting voltage signal 360a is then mixed with the LO signal 366a to produce the IF signal 367a having a frequency of ΔFₐ−F_{LOa}, which is within the pass-band PBₐ of the filter 610a. Then, around a time when pulse of light 400b is emitted, the electronic LO 616 is switched to produce LO signal 366b at frequency F_{LOb}, and subsequent to that, pulse 410b is detected by the receiver 140. The resulting voltage signal 360b is then mixed with the LO signal 366b to produce the IF signal 367b having a frequency of ΔF_{b}−F_{LOb}, which is within the pass-band PBₐ of the filter 610a.

An adjustable-frequency electronic LO 616 allows the frequency-detection channel 368 in FIG. 54A to detect pulses of light 410a and 410b having two different frequency offsets. The frequency-detection channel 368 includes an electronic band-pass filter 610a having a center frequency CFₐ and a pass-band PBₐ. The frequency of the IF signal 367a is within the pass-band PBₐ of the electronic filter 610a, and the frequency of the IF signal 367b is also within the pass-band PBₐ of the electronic filter 610a. While the two received pulses of light 410a and 410b have two different frequency offsets (ΔFₐ and ΔF_{b}), the adjustable-frequency electronic LO 616 results in two IF signals 367a and 367b that are both within the pass-band PBₐ. The resulting two filtered signals 362 produced by the filter 610a may have relatively large amplitudes, and based on the output signal 145 produced by the receiver 140, a controller 150 may determine that (i) received pulse of light 410a is associated with emitted pulse of light 400a and (ii) received pulse of light 410b is associated with emitted pulse of light 400b.

The frequency-detection channel 368 in FIG. 54A may be relatively immune to crosstalk between received pulses of light associated with the two different frequency offsets. When the frequency-detection channel 368 is configured to detect pulses of light 410 having a frequency offset of ΔFₐ, the frequency-detection channel 368 may not detect pulses of light 410 having a frequency offset of ΔF_{b}, and vice versa. For example, in the upper portion of FIG. 54A, when the electronic LO 616 produces the LO signal 366a at frequency F_{LOa}, the frequency-detection channel 368 may only detect a received pulse of light 410a having a frequency offset of ΔFₐ and may not detect a received pulse of light 410b having a frequency offset of ΔF_{b}. The IF signal 367 produced by a pulse of light 410b having a frequency offset of ΔF_{b} may be removed or filtered out by the filter 610a when the frequency-detection channel is configured to detect pulses of light with a ΔFₐ frequency offset. Similarly, in the lower portion of FIG. 54A, when the electronic LO 616 produces the LO signal 366b at frequency F_{LOb}, the frequency-detection channel 368 may only detect a received pulse of light 410b having a frequency offset of ΔF_{b} and may not detect a received pulse of light 410a having a frequency offset of ΔFₐ. A received pulse of light 410a with a ΔFₐ frequency offset produces a voltage signal 360a having a ΔFₐ frequency component (as indicated by the dashed-line voltage signal 360a in the lower portion of FIG. 54A). If a pulse of light 410a with a ΔFₐ frequency offset is received when the frequency-detection channel 368 is configured to detect pulses with frequency offset of ΔF_{b}, then mixing of the dashed-line voltage signal 360a with the LO signal 366b may result in an IF signal 367x having a frequency of ΔFₐ−F_{LOb}. The frequency of the dashed-line IF signal 367x is located outside of the pass-band PBₐ, which indicates that most of the IF signal 367x will be attenuated by the filter 610a, and the received pulse of light 410a likely will not be detected by the frequency-detection channel 368.

In particular embodiments, a controller 150 may be configured to (i) select a particular frequency offset Δf for each emitted pulse of light 400 and (ii) select an oscillator frequency F_{LO} for an LO signal 366 produced by an adjustable-frequency electronic LO 616 of a particular frequency-detection channel 368 in accordance with the selected frequency offset Δf. The oscillator frequency F_{LO} may be selected so that an IF signal 367, which is produced in response to a received pulse of light 410 that is associated with the emitted pulse of light 400, is within a pass-band of an electronic filter 610a of the particular frequency-detection channel 368. The oscillator frequency F_{LO} may be selected to be approximately equal to Δf−CFₐ, where Δf is the frequency offset for the emitted pulse of light, and CFₐ is the center frequency of the electronic filter 610a. For example, the emitted pulse of light 400a that is associated with received pulse of light 410a in FIG. 54A may have a frequency offset of Δfₐ with respect to LO light 430, where the frequency offset is selected by a controller 150 of the lidar system 100. At a time around when pulse of light 400a is emitted, the controller 150 may select the oscillator frequency F_{LOa} for the LO signal 366a so that ||Δfₐ|−F_{LOa}| is within a pass-band of the electronic filter 610a. The oscillator frequency F_{LOa} in FIG. 54A may be selected to be approximately equal to Δfₐ−CFₐ so that the received pulse of light 410a with a frequency offset of ΔFₐ (which may be within a particular frequency threshold of the frequency offset Δfₐ) produces an IF signal 367a that is within the pass-band PBₐ of the electronic filter 610a. The frequency offset Δfₐ of the emitted pulse of light 400a may be 4 GHZ, and the electronic filter 610a may have a center frequency CFₐ of 1 GHZ and a pass-band PBₐ that extends from 0.9 GHZ to 1.1 GHZ. The oscillator frequency F_{LOa} may be selected to be 3 GHZ, and the received pulse of light 410a may produce a voltage signal 360a with a frequency component ΔFₐ between 3.9 GHZ and 4.1 GHZ, which results in the IF signal 367a being within the 0.9-1.1-GHz pass-band PBₐ. As another example, the emitted pulse of light 400b that is associated with received pulse of light 410b in FIG. 54A may have a frequency offset of Δf_{b} with respect to LO light 430, where the frequency offset is selected by the controller 150 of the lidar system 100. At a time around when pulse of light 400b is emitted, the controller 150 may instruct the electronic LO 616 to switch to produce the oscillator frequency F_{LOb} for the LO signal 366b so that ||Δf_{b}|−F_{LOb}| is within a pass-band of the electronic filter 610a. The oscillator frequency F_{LOb} in FIG. 54A may be selected to be approximately equal to Δf_{b}−CFₐ so that the received pulse of light 410b with a frequency offset of ΔF_{b} produces an IF signal 367b that is within the pass-band PBₐ of the electronic filter 610a. The frequency offset Δf_{b} of the emitted pulse of light 400a may be 4.5 GHZ, and the oscillator frequency F_{LOb} may be selected to be 3.5 GHZ. The received pulse of light 410b may produce a voltage signal 360b with a frequency component ΔF_{b} between 4.4 GHZ and 4.6 GHZ, which results in the IF signal 367a being within the 0.9-1.1-GHz pass-band PBₐ.

FIG. 54B illustrates example frequency-domain graphs of signals associated with an adjustable-frequency electronic filter 610 and two received pulses of light 410a and 410b. The upper graph is associated with the received pulse of light 410a, and the lower graph is associated with the received pulse of light 410b. The pulses of light 410a and 410b in FIG. 54B may correspond to those illustrated in FIG. 34, where received pulse of light 410a is associated with emitted pulse of light 400a, and received pulse of light 410b is associated with emitted pulse of light 400b.

The signals in FIG. 54B may be produced by one frequency-detection channel (e.g., frequency-detection channel 368 of FIG. 43 or 44, or frequency-detection channel 368-1 of FIG. 46) that includes an adjustable-frequency electronic filter 610. In particular embodiments, a frequency-detection channel 368 may include an adjustable-frequency electronic filter 610 that may be adjusted to operate at a particular center frequency of multiple different center frequencies. An adjustable-frequency electronic filter 610 may be configured to receive an IF signal 367 and produce a corresponding filtered signal 362. In FIG. 54B, the frequency F_{LO} of the LO signal 366 is fixed, and the electronic filter 610 is adjustable to the center frequencies CFₐ and CF_{b}. The frequency-detection channel 368 may be configured to detect pulses of light 410 having two different frequency offsets of approximately CFₐ+F_{LO} and CF_{b}+F_{LO}.

An adjustable-frequency electronic filter 610 may allow a frequency-detection channel 368 of a receiver 40 to detect multiple received pulses of light 410 having multiple different frequency offsets ΔF. A frequency-detection channel 368 that is configured to detect received pulses of light 410 having m different frequency offsets may include an adjustable-frequency electronic filter 610 that is adjustable to m different center frequencies, where each center frequency is associated with one of the m different frequency offsets. An adjustable-frequency electronic filter 610 that is adjustable to m different center frequencies may allow a frequency-detection channel 368 to detect pulses of light 410 having m different frequency offsets. For example, the parameter m may have a value of 2, and the electronic filter 610a in FIG. 43 or 44 may be an adjustable-frequency electronic filter that is configured to switch between operating at one of the two center frequencies CFₐ and CF_{b} illustrated in FIG. 54B.

The voltage signal 360a in FIG. 54B results from coherent mixing of received pulse of light 410a with LO light 430 and has a frequency component of ΔFₐ. Voltage signal 360b results from coherent mixing of received pulse of light 410b with LO light 430 and has a different frequency component of ΔF_{b}. An adjustable-frequency electronic filter 610 of the frequency-detection channel 368 may switch between operating at two different center frequencies CFₐ and CF_{b}. Starting around a time when pulse of light 400a is emitted, the electronic filter 610 is adjusted to the center frequency CFₐ, and subsequent to that, pulse 410a is detected. The resulting voltage signal 360a is then mixed with the LO signal 366 to produce the IF signal 367a having a frequency of ΔFₐ−F_{LO}, which is within the pass-band PBₐ of the filter 610. Then, around a time when pulse of light 400b is emitted, the electronic filter 610 is switched to operate at the center frequency CF_{b}, and subsequent to that, pulse 410b is detected. The resulting voltage signal 360b is then mixed with the LO signal 366 to produce the IF signal 367b having a frequency of ΔF_{b}−F_{LO}, which is within the pass-band PB_{b} of the filter 610.

An adjustable-frequency electronic filter 610 allows the frequency-detection channel 368 in FIG. 54B to detect pulses of light 410a and 410b having two different frequency offsets. The frequency-detection channel 368 includes an electronic LO 616 that produces a LO signal 366 at a fixed frequency of F_{LO}. Additionally, the frequency-detection channel 368 includes an adjustable-frequency electronic band-pass filter 610 that is switchable between (i) a center frequency CFₐ and a pass-band PBₐ and (ii) a center frequency CF_{b} and a pass-band PB_{b}. The frequency of the IF signal 367a is within the pass-band PBₐ of the electronic filter 610, and the frequency of the IF signal 367b is within the pass-band PB_{b} of the electronic filter 610. While the two received pulses of light 410a and 410b have two different frequency offsets (ΔFₐ and ΔF_{b}), the adjustable-frequency electronic filter 610 results in two IF signals 367a and 367b that are both within the respective pass-bands PBₐ and PB_{b}. The resulting two filtered signals 362 produced by the filter 610 may have relatively large amplitudes, and based on the output signal 145 produced by the receiver 140, a controller 150 may determine that (i) received pulse of light 410a is associated with emitted pulse of light 400a and (ii) received pulse of light 410b is associated with emitted pulse of light 400b.

The frequency-detection channel 368 in FIG. 54B may be relatively immune to crosstalk between received pulses of light associated with the two different frequency offsets. When the frequency-detection channel 368 is configured to detect pulses of light 410 having a frequency offset of ΔFₐ, the frequency-detection channel 368 may not detect pulses of light 410 having a frequency offset of ΔF_{b}, and vice versa. A received pulse of light 410a with a ΔFₐ frequency offset produces a voltage signal 360a having a ΔFₐ frequency component (as indicated by the dashed-line voltage signal 360a in the lower portion of FIG. 54B). If a pulse of light 410a with a ΔFₐ frequency offset is received when the frequency-detection channel 368 is configured to detect pulses with frequency offset of ΔF_{b}, then mixing of the dashed-line voltage signal 360a with the LO signal 366 may result in an IF signal 367x having a frequency of ΔFₐ−F_{LO}. The frequency of the dashed-line IF signal 367x is located outside of the pass-band PB_{b}, which indicates that most of the IF signal 367x will be attenuated by the filter 610, and the received pulse of light 410a likely will not be detected by the frequency-detection channel 368.

In particular embodiments, a controller 150 may be configured to (i) select a particular frequency offset Δf for each emitted pulse of light 400 and (ii) select a center frequency for an adjustable-frequency electronic filter 610 of a particular frequency-detection channel 368 in accordance with the selected frequency offset Δf. The center frequency of the electronic filter 610 may be selected so that an IF signal 367, which is produced in response to a received pulse of light 410 that is associated with an emitted pulse of light 400, is within a pass-band of the electronic filter 610. The electronic-filter center frequency CF may be selected to be approximately equal to Δf−F_{LO}, where Δf is the frequency offset of the emitted pulse of light 400, and F_{LO} is frequency of the LO signal 366.

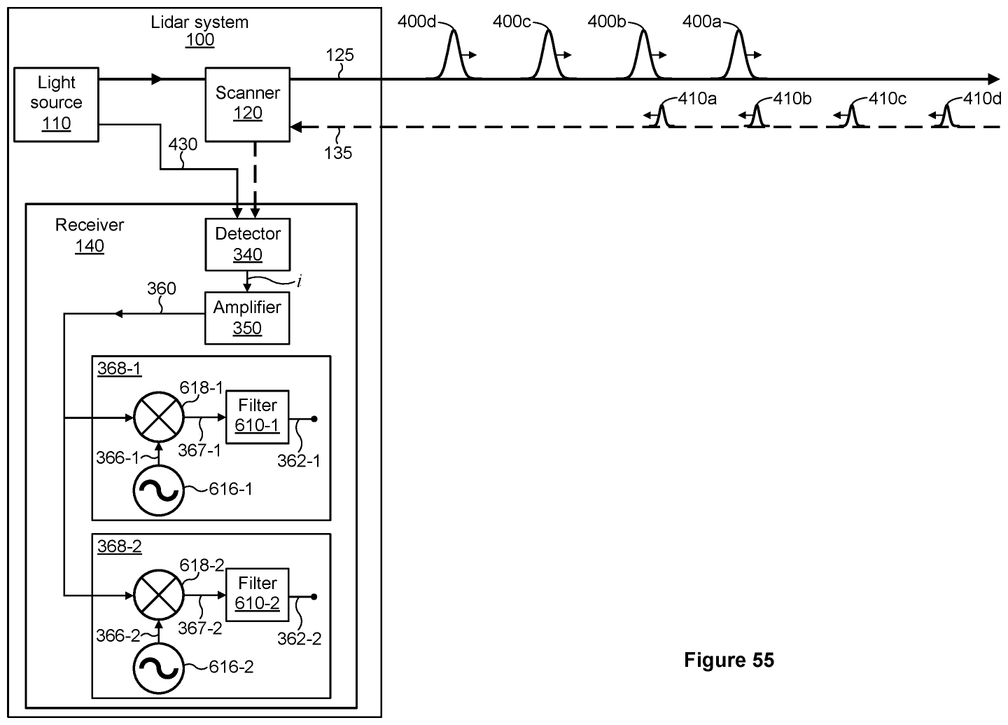

FIG. 55 illustrates an example lidar system 100 with four emitted pulses of light (400a, 400b, 400c, 400d) and four received pulses of light (410a, 410b, 410c, 410d). The lidar system 100 includes a light source 110 that emits the four pulses of light as part of an output beam 125 that is scanned across a field of regard of the lidar system. The input beam 135 includes the four received pulses of light, which are detected by the receiver 140. Each received pulses of light 410a, 410b, 410c, and 410d may be associated with a respective emitted pulse of light 400a, 400b, 400c, and 400d (e.g., received pulse of light 410a may include light from emitted pulse of light 400a that is scattered by a target 130). The lidar system 100 in FIG. 55 is a coherent pulsed lidar system in which each received pulse of light is coherently mixed with LO light 410 at a detector 340. The resulting photocurrent signal i is amplified by an electronic amplifier 350 to produce a corresponding voltage signal 360, which is sent to two frequency-detection channels 368-1 and 368-2. Frequency-detection channel 368-1 includes an electronic mixer 618-1 that mixes the voltage signal 360 with an electronic LO signal 366-1 to produce an IF signal 367-1, which is sent to a filter 610-1 that produces a filtered signal 362-1. Frequency-detection channel 368-2 includes an electronic mixer 618-2 that mixes the voltage signal 360 with an electronic LO signal 366-2 to produce an IF signal 367-2, which is sent to a filter 610-2 that produces a filtered signal 362-2. Each of the electronic LOs 616-1 and 616-2 may be an adjustable-frequency electronic LO that produces a respective electronic LO signal 366-1 and 366-2 at two or more different oscillator frequencies. Based on the frequency components of the AM photocurrent signals that result from the coherent mixing of the received pulses of light, the lidar system 100 may determine that received pulse of light 410a is associated with emitted pulse of light 400a. Additionally, the lidar system 100 may determine that the received pulses of light 410b, 410c, and 410d are associated with the respective emitted pulses of light 400b, 400c, and 400d.

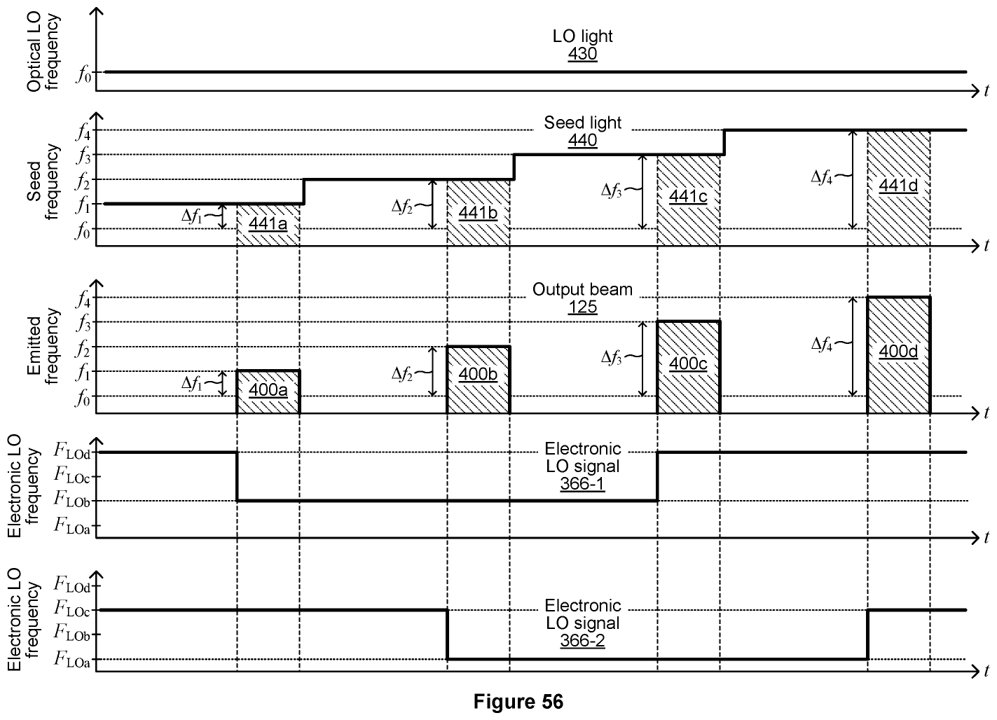

FIG. 56 illustrates example time-domain graphs of signals associated with the lidar system 100 of FIG. 55. The light source 110 emits LO light 430 having a substantially constant optical frequency of f₀ and pulses of light 400 having four different optical frequencies (f₁, f₂, f₃, f₄) and four different frequency offsets (Δf₁, Δf₂, Δf₃, Δf₄). The output beam 125 includes four emitted pulses of light 400a, 400b, 400c, and 400d, which are produced by optical amplification of the four respective seed-light temporal portions 441a, 441b, 441c, and 441d. Each of the emitted pulses of light 400a, 400b, 400c, and 400d has a respective frequency offset of Δf₁, Δf₂, Δf₃, and Δf₄ with respect to the LO light 430. Frequency-detection channel 368-1 includes an adjustable-frequency electronic LO 616-1 that produces an electronic LO signal 366-1 at two oscillator frequencies F_{LOb} and F_{LOd}. The frequency of the electronic LO signal 366-1 is switched between the two oscillator frequencies F_{LOb} and F_{LOd} at times that are synchronized with the emission of pulses of light 400a and 400b. At or around the time when a pulse of light with a frequency offset of Δf₁ is emitted (e.g., pulse 400a), the electronic LO signal 366-1 may be switched to oscillator frequency F_{LOb}, and at or around the time when a pulse of light with a frequency offset of Δf₃ is emitted (e.g., pulse 400c), the electronic LO signal 366-1 may be switched to oscillator frequency F_{LOd}. Frequency-detection channel 368-2 includes an adjustable-frequency electronic LO 616-2 that produces an electronic LO signal 366-2 at two frequencies F_{LOa} and F_{LOc}. The frequency of the electronic LO signal 366-2 is switched between the two oscillator frequencies F_{LOa} and F_{LOc} at times that are synchronized with the emission of pulses of light 400b and 400d. At or around the time when a pulse of light with a frequency offset of Δf₂ is emitted (e.g., pulse 400b), the electronic LO signal 366-2 may be switched to oscillator frequency F_{LOa}, and at or around the time when a pulse of light with a frequency offset of Δf₄ is emitted (e.g., pulse 400d), the electronic LO signal 366-2 may be switched to oscillator frequency F_{LOc}.

Frequency-detection channel 368-1 may be configured to detect or produce electronic signals associated with emitted pulses of light 400a and 400c. Additionally, the frequency-detection channel 368-1 may remove or filter out signals associated with emitted pulses of light 400b and 400d. The electronic filter 610-1 may have a pass-band that includes the frequency |Δf₁−F_{LOb}| (associated with pulse of light 400a) and the frequency |Δf₃−F_{L0d}| (associated with pulse of light 400c). For example, received pulse of light 410a may have a frequency offset of approximately Δf₁, and mixing the associated voltage signal 360 with the LO signal 366-1 at frequency F_{LOb} may produce IF signal 367-1 having a frequency of approximately |Δf₁−F_{LOb}|, which is within the pass-band of the electronic filter 610-1. Similarly, received pulse of light 410c may have a frequency offset of approximately Δf₃, and mixing the associated voltage signal 360 with the LO signal 366-1 at frequency F_{LOd} may produce IF signal 367-1 having a frequency of approximately |Δf₃−F_{L0d}|, which is within the pass-band of the electronic filter 610-1.

The frequency-detection channel 368-1 may be relatively immune to crosstalk between received pulses of light associated with other frequency offsets. For example, when the frequency-detection channel 368-1 is configured to detect signals associated with emitted pulse of light 400a (with a Δf₁ frequency offset), the frequency-detection channel 368-1 may not detect signals associated with other pulses of light having a frequency offset of Δf₂, Δf₃, or Δf₄. Additionally, when the frequency-detection channel 368-1 is configured to detect signals associated with emitted pulse of light 400c (with a Δf₃ frequency offset), the frequency-detection channel 368-1 may not detect signals associated with other pulses of light having a frequency offset of Δf₁, Δf₂, or Δf₄. The exclusion of unwanted pulses of light may be achieved in part by configuring the pass-band of the electronic filter 610-1 to not include the frequencies |Δf₁−F_{LOd}| and |Δf₃−F_{LOb}|. Additionally, to exclude signals associated with emitted pulses of light 400b (with a Δf₂ frequency offset) and 400d (with a Δf₄ frequency offset), the electronic filter 610-1 may not include the frequencies |Δf₂−F_{LOb}|, |Δf₂−F_{LOd}|, |Δf₄−F_{LOb}|, and |Δf₄−F_{LOd}|. For example, when the frequency-detection channel 368-1 is configured to detect signals associated with emitted pulse of light 400a, the electronic LO 616-1 may produce the LO signal 366-1 with an oscillator frequency of F_{LOb}. A received pulse of light 410a with a frequency offset of approximately Δf₁ may produce an IF signal 367-1 having a frequency of |Δf₁−F_{LOb}|, and the received pulse of light 410a may be detected since the frequency of the IF signal 367-1 is within the pass-band of the electronic filter 610-1. A received pulse of light 410c with a frequency offset of approximately Δf₃ may not be detected since the frequency of the associated IF signal 367-1 is |Δf₃−F_{LOb}|, which is outside the pass-band of the electronic filter 610-1. Similarly, a received pulse of light 410b with a frequency offset of approximately Δf₂ may not be detected since the frequency of the associated IF signal 367-1 is |Δf₂−F_{LOb}|, which is outside the pass-band of the electronic filter 610-1.

Frequency-detection channel 368-2 may be configured to detect or produce electronic signals associated with emitted pulses of light 400b and 400d. Additionally, the frequency-detection channel 368-2 may remove or filter out signals associated with emitted pulses of light 400a and 400c. The electronic filter 610-2 may have a pass-band that includes the frequency |Δf₂−F_{LOa}| (associated with pulse of light 400b) and the frequency |Δf₄−F_{LOc}| (associated with pulse of light 400d). For example, received pulse of light 410b may have a frequency offset of approximately Δf₂, and mixing the associated voltage signal 360 with the LO signal 366-2 at frequency F_{LOa} may produce IF signal 367-2 having a frequency of approximately |Δf₂−F_{LOa}|, which is within the pass-band of the electronic filter 610-2. Similarly, received pulse of light 410d may have a frequency offset of approximately Δf₄, and mixing the associated voltage signal 360 with the LO signal 366-2 at frequency F_{LOc} may produce IF signal 367-2 having a frequency of approximately |Δf₄−F_{LOc}|, which is within the pass-band of the electronic filter 610-2.

The frequency-detection channel 368-2 may be relatively immune to crosstalk between received pulses of light associated with other frequency offsets. For example, when the frequency-detection channel 368-2 is configured to detect signals associated with emitted pulse of light 400b (with a Δf₂ frequency offset), the frequency-detection channel 368-2 may not detect signals associated with other pulses of light having a frequency offset of Δf₁, Δf₃, or Δf₄. Additionally, when the frequency-detection channel 368-2 is configured to detect signals associated with emitted pulse of light 400d (with a Δf₄ frequency offset), the frequency-detection channel 368-2 may not detect signals associated with other pulses of light having a frequency offset of Δf₁, Δf₂, or Δf₃. The exclusion of unwanted pulses of light may be achieved in part by configuring the pass-band of the electronic filter 610-2 to not include the frequencies |Δf₂−F_{LOc}| and |Δf₄−F_{LOa}|. Additionally, to exclude signals associated with emitted pulses of light 400a (with a Δf₁ frequency offset) and 400c (with a Δf₃ frequency offset), the electronic filter 610-2 may not include the frequencies |Δf₁−F_{LOa}|, |Δf₁−F_{LOc}|, |Δf₃−F_{LOa}|, and |Δf₃−F_{LOc}|. For example, when the frequency-detection channel 368-2 is configured to detect signals associated with emitted pulse of light 400b, the electronic LO 616-2 may produce the LO signal 366-2 with an oscillator frequency of F_{LOa}. A received pulse of light 410b with a frequency offset of approximately Δf₂ may produce an IF signal 367-2 having a frequency of |Δf₂−F_{LOa}|, and the received pulse of light 410b may be detected since the frequency of the IF signal 367-2 is within the pass-band of the electronic filter 610-2. A received pulse of light 410d with a frequency offset of approximately Δf₄ may not be detected since the frequency of the associated IF signal 367-2 is |Δf₄−F_{LOa}|, which is outside the pass-band of the electronic filter 610-1. Similarly, a received pulse of light 410a with a frequency offset of approximately Δf₁ may not be detected since the frequency of the associated IF signal 367-2 is |Δf₁−F_{LOa}|, which is outside the pass-band of the electronic filter 610-1.

In particular embodiments, a detection circuit 361 of a lidar system 100 may include N frequency-detection channels 361, where N is an integer greater than or equal to 1, and the light source 110 of the lidar system 100 may emit pulses of light 400 where each emitted pulse of light is offset from the optical frequency of LO light 430 by a particular frequency offset of m×N different frequency offsets, where m is an integer greater than or equal to 2. Each frequency-detection channel 361 may be associated with m of the m×N different frequency offsets, and each frequency-detection channel 361 may include an adjustable-frequency electronic LO 616 configured to produce m different oscillator frequencies, each oscillator frequency associated with one of the m frequency offsets. For example, the detection circuit 361 in FIG. 43 includes one frequency-detection channel 368 (e.g., N=1). The receiver 140 in FIG. 43 may be part of a lidar system 100 with a light source 110 that emits pulses of light 400 where each emitted pulse of light 400 has a particular frequency offset of four different frequency offsets (e.g., m=4). In this embodiment, the electronic LO 616 in FIG. 43 may be an adjustable-frequency electronic LO 616 that produces four different oscillator frequencies, each oscillator frequency associated with one of the four frequency offsets. The oscillator frequency produced by the electronic LO 616 may be switched in accordance with and in synch with the frequency offset of the emitted pulses of light 400. As another example, the detection circuit 361 in FIG. 46 includes three frequency-detection channels 368 (e.g., N=3). The receiver 140 in FIG. 46 may be part of a lidar system 100 with a light source 110 that emits pulses of light 400 where each emitted pulse of light 400 has a particular frequency offset of 12 different frequency offsets (e.g., m=3). In this embodiment, each frequency-detection channel 368 in FIG. 46 may be associated with three of the 12 different frequency offsets. An electronic LO 616 that is part of a frequency-detection channel 368 may be an adjustable-frequency electronic LO 616 that produces three different oscillator frequencies, where each oscillator frequency is associated with one of the three frequency offsets associated with the frequency-detection channel. As another example, the receiver 140 in FIG. 55 includes two frequency-detection channels 368 (e.g., N=2), and the light source 110 emits pulses of light 400 having four different frequency offsets (e.g., m=2). Frequency-detection channel 368-1 is associated with frequency offsets Δf₁ and Δf₃, and frequency-detection channel 368-2 is associated with frequency offsets Δf₂ and Δf₄. Electronic LO 616-1 produces an electronic LO signal 366-1 with two oscillator frequencies, F_{LOb} and F_{LOd}, which are associated with frequency offsets Δf₁ and Δf₃, respectively. Electronic LO 616-2 produces an electronic LO signal 366-2 with two oscillator frequencies, F_{LOa} and F_{LOc}, which are associated with frequency offsets Δf₂ and Δf₄, respectively.

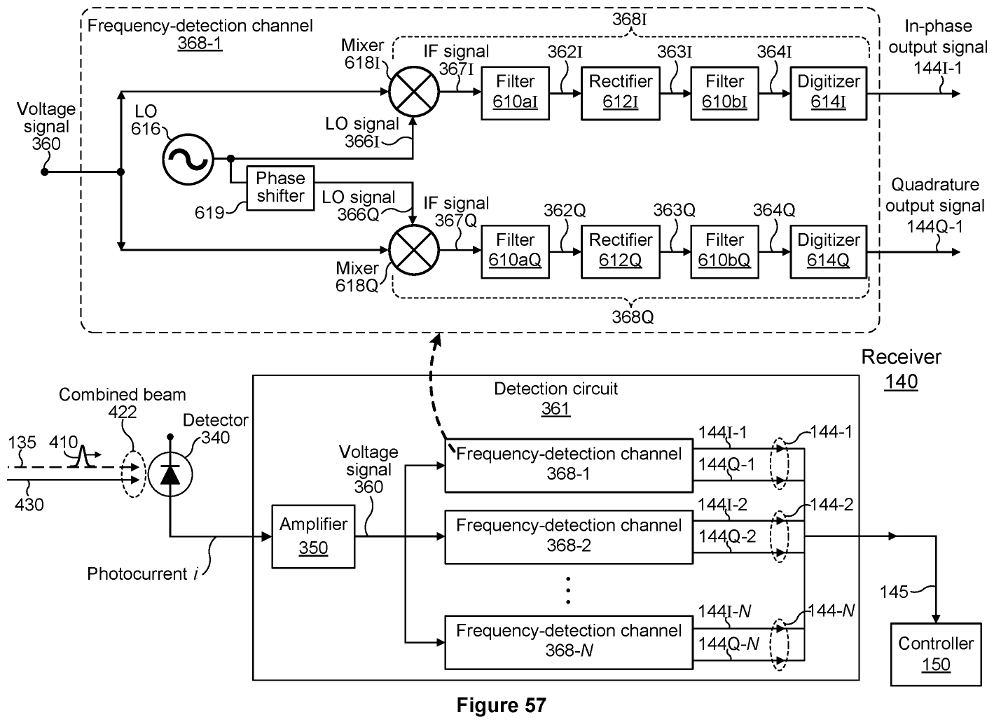

FIG. 57 illustrates an example receiver 140 in which each frequency-detection channel 368 includes an in-phase channel 368I and a quadrature channel 368Q. In particular embodiments, a detection circuit 361 of a receiver 140 may include one or more frequency-detection channels 368, where each frequency-detection channel 368 receives a voltage signal 360 and produces an output-signal portion 144 that includes an in-phase output-signal portion 144I and a quadrature output-signal portion 144Q. Each frequency-detection channel 368 may include an in-phase frequency-detection channel 368I that produces the in-phase output-signal portion 144I and a quadrature frequency-detection channel 368Q that produces the quadrature output-signal portion 144Q. The receiver 140 in FIG. 57 includes a detection circuit 361 with N frequency-detection channels 368, where N is an integer greater than or equal to 1 (e.g., N may equal 1, 2, 3, 4, 5, 10, 20, 50, 100, or any other suitable positive integer). The receiver 140 in FIG. 57 is similar to the receiver 140 in FIG. 37, except each frequency-detection channel 368 in FIG. 57 includes an in-phase frequency-detection channel 368I and a quadrature frequency-detection channel 368Q. The receiver 140 in FIG. 57 is an optical superheterodyne receiver that includes optical mixing at a detector 340 followed by electronic mixing at an electronic mixer 618.

In FIG. 57, the received pulse of light 410 and the LO light 430 are coherently mixed together at the detector 340, and the detector 340 produces a photocurrent signal i corresponding to the coherent mixing of the received pulse of light 410 and the LO light 430. The photocurrent signal i, which may include an AM photocurrent signal, is sent to the detection circuit 361. The electronic amplifier 350 receives the photocurrent signal i and produces a voltage signal 360 corresponding to the photocurrent signal. The voltage signal 360 is sent to each of the N frequency-detection channels 368 where it is electronically mixed with an in-phase LO signal 366I at an in-phase channel 368I and electronically mixed with a quadrature LO signal 366Q at a quadrature channel 368Q. Frequency-detection channel 368-1 produces an output-signal portion 144-1 that includes an in-phase output-signal portion 144I-1 and a quadrature output-signal portion 144Q-1. Similarly, frequency-detection channel 368-2 produces an output-signal portion 144-2 that includes an in-phase output-signal portion 144I-2 and a quadrature output-signal portion 144Q-2, and frequency-detection channel 368-N produces an output-signal portion 144-N that includes an in-phase output-signal portion 144I-N and a quadrature output-signal portion 144Q-N. The in-phase and quadrature output-signal portions 144 may provide phase information related to the voltage signal 360 or the photocurrent signal i. The output signal 145, which includes each of the output-signal portions 144-1 through 144-N, is sent to the controller 150, and the controller 150 may determine, based on the output signal 145, that the received pulse of light 410 is associated with a particular emitted pulse of light 400.

Each in-phase channel 368I and each quadrature channel 368Q may include a mixer 618, one or more electronic filters 610, a rectifier 612, or a digitizer 614. The in-phase channel 368I in FIG. 57 that is part of the frequency-detection channel 368-1 includes: a mixer 618I that produces an IF signal 367I, an electronic filter 610aI that produces a filtered signal 362I, a rectifier 612I that produces a rectified signal 3631, an electronic filter 610bI that produces a pulse signal 364I, and a digitizer 614I that produces an in-phase output-signal portion 144I-1. The quadrature channel 368Q includes: a mixer 618Q that produces an IF signal 367Q, an electronic filter 610aQ that produces a filtered signal 362Q, a rectifier 612Q that produces a rectified signal 363Q, an electronic filter 610bQ that produces a pulse signal 364Q, and a digitizer 614Q that produces a quadrature output-signal portion 144Q-1.

The frequency-detection channel 368-1 in FIG. 57 includes an electronic LO 616 that produces an LO signal 366I which is supplied to the electronic mixer 618I. The phase shifter 619 is an electronic device that applies a particular phase shift to the LO signal produced by the electronic LO 616 to produce the LO signal 366Q, which is a phase-shifted version of the LO signal 366I. The LO signal 366I may be referred to as an in-phase LO signal, and the LO signal 366Q may be referred to as a quadrature LO signal. The phase shift applied by the phase shifter may be approximately ±90 degrees so that the quadrature LO signal 366Q is phase-shifted by ±90 degrees with respect to the in-phase LO signal 366I. For example, the in-phase LO signal 366I may be expressed as V_{LO} sin(2πF_{LO}t), where V_{LO} is the peak voltage of the LO signal 366I and F_{LO} is the frequency of the signal. The 90-degree phase-shifted LO signal 366Q may then be expressed as V_{LO} sin(2πF_{LO}t+π/2) or V_{LO} cos(2πF_{LO}t). In other embodiments, a frequency-detection channel 368 may include two electronic LOs 616, where one LO 616 produces an in-phase LO signal 366I and the other LO 616 produces a quadrature LO signal 366Q. The two LO signals 366I and 366Q may have the same oscillator frequency F_{LO}, and the two electronic LOs 616 may be configured so that the two LO signals 366I and 366Q have a relative phase shift of 90 degrees.

In FIG. 57, the electronic mixer 618I of the in-phase channel 368I mixes the voltage signal 360 with the in-phase LO signal 366I to produce an in-phase IF signal 367I. The electronic filter 610al transmits the spectral portion of the in-phase IF signal 367I that is located within the pass-band of the filter 610al to produce the in-phase filtered signal 362I. After the rectifier 612I and electronic filter 610bI, an in-phase pulse signal 364I is produced and is digitized by the digitizer 614I. The resulting in-phase output-signal portion 144I-1 corresponds to the portion of the in-phase IF signal 367I that is transmitted by the electronic filter 610aI, which in turn corresponds to an in-phase component of the voltage signal 360. In the quadrature channel 368Q, the electronic mixer 618Q mixes the voltage signal 360 with the quadrature LO signal 366Q to produce a quadrature IF signal 367Q. The electronic filter 610aQ transmits the spectral portion of the quadrature IF signal 367Q that is located within the pass-band of the filter 610aQ to produce the quadrature filtered signal 362Q. After the rectifier 612Q and electronic filter 610bQ, a quadrature pulse signal 364Q is produced and is digitized by the digitizer 614Q. The resulting quadrature output-signal portion 144Q-1 corresponds to the portion of the quadrature IF signal 367Q that is transmitted by the electronic filter 610aQ, which in turn corresponds to a quadrature component of the voltage signal 360.

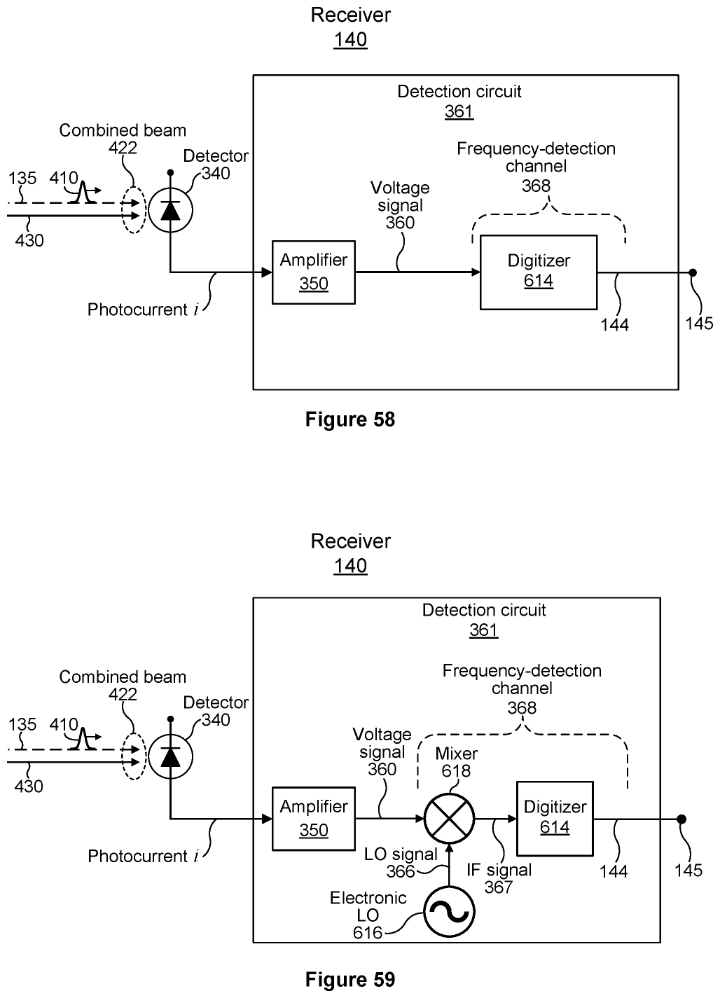

FIGS. 58-59 each illustrate an example receiver 140 with a detection circuit 361 that includes a frequency-detection channel 368. In each of FIGS. 58-59, a received pulse of light 410 and LO light 430 are coherently mixed together at a detector 340, and the detector 340 produces a corresponding photocurrent signal i, which may include an AM photocurrent signal. The electronic amplifier 350 receives the photocurrent signal i and produces a voltage signal 360 corresponding to the photocurrent signal. The voltage signal 360 is sent to the frequency-detection channel 368, which produces a corresponding output-signal portion 144. The detection circuit 361 may include just one frequency-detection channel 368 (as illustrated in FIGS. 58-59) in which case, the output-signal portion 144 and the output signal 145 may be substantially the same. Alternatively, the detection circuit 361 in FIG. 58 or FIG. 59 may include one or more additional frequency-detection channels (in addition to the one frequency-detection channel 368 illustrated in FIGS. 58-59), and each of the frequency-detection channels may produce an output-signal portion 144. The output signal 145 in each of FIGS. 58 and 59 may be referred to as corresponding to the AM photocurrent signal. For example, the output signal 145 in FIG. 58 may correspond to or may include an electronic representation of voltage signal 360, which is produced from the photocurrent signal i, which includes the AM photocurrent signal. As another example, the output signal 145 in FIG. 59 may correspond to or may include an electronic representation of the IF signal 367, which is produced from the voltage signal 360, which in turn is produced from the photocurrent signal i.

The frequency-detection channel 368 in FIG. 58 includes a digitizer 614. The digitizer 614 receives the voltage signal 360 and produces an output-signal portion 144 which may include a digital representation of the voltage signal 360. This digitized signal that corresponds to the voltage signal 360 may be sent as part of the output signal 145 to a controller 150 for further processing (e.g., digital filtering, digital rectification, or digital mixing). For example, the digital processing performed by the controller 150 may include one or more of: (i) filtering the digital representation of the voltage signal 360 to produce a filtered signal 362, (ii) rectifying the filtered signal 362 to produce a rectified signal 363, and (iii) filtering the rectified signal 363 to produce a pulse signal 364. Filtering the digital representation of the voltage signal 360 may be implemented in software using a digital filtering algorithm. The voltage signal 360 in FIG. 58 is an analog electronic signal, while the signals processed at the controller (e.g., the digital representation of the voltage signal, the filtered signal, the rectified signal, and the pulse signal) are digital electronic signals. As another example, the digital processing performed by the controller 150 may include one or more of: (i) mixing the digital representation of the voltage signal 360 with a digital LO signal 366 to produce an IF signal 367, (ii) filtering the IF signal 367 to produce a filtered signal 362, (iii) rectifying the filtered signal 362 to produce a rectified signal 363, and (iv) filtering the rectified signal 363 to produce a pulse signal 364. The signals processed at the controller (e.g., the digital representation of the voltage signal, the LO signal, the IF signal, the filtered signal, the rectified signal, and the pulse signal) are digital electronic signals. In FIG. 58, the voltage signal is directly coupled from the electronic amplifier 350 to the digitizer 614. In other embodiments, the detection circuit 361 may include an anti-aliasing electronic filter located between the electronic amplifier 350 and the digitizer 614.

The frequency-detection channel in FIG. 59 includes an electronic LO 616, an electronic mixer 618, and a digitizer 614. The voltage signal 360 is mixed with the LO signal 366 to produce the IF signal 367, where all three signals (voltage signal, LO signal, and IF signal) are analog electronic signals. The digitizer 614 receives the IF signal 367 and produces the output-signal portion 144 which may include a digitized version of the IF signal 367. The output-signal portion 144 may be sent as part of the output signal 145 to a controller 150 for further processing. For example, the digital processing performed by the controller 150 may include (i) applying a digital filtering operation to the digitized IF signal 367 to produce a digitized filtered signal 362, (ii) rectifying the filtered signal 362 to produce a rectified signal 363, and (iii) applying a digital filtering operation to the rectified signal 363 to produce a digitized pulse signal 364. In the receiver 140 of FIG. 59, the signals processed at the controller (e.g., the digitized IF signal, the filtered signal, the rectified signal, and the pulse signal) are digital electronic signals.

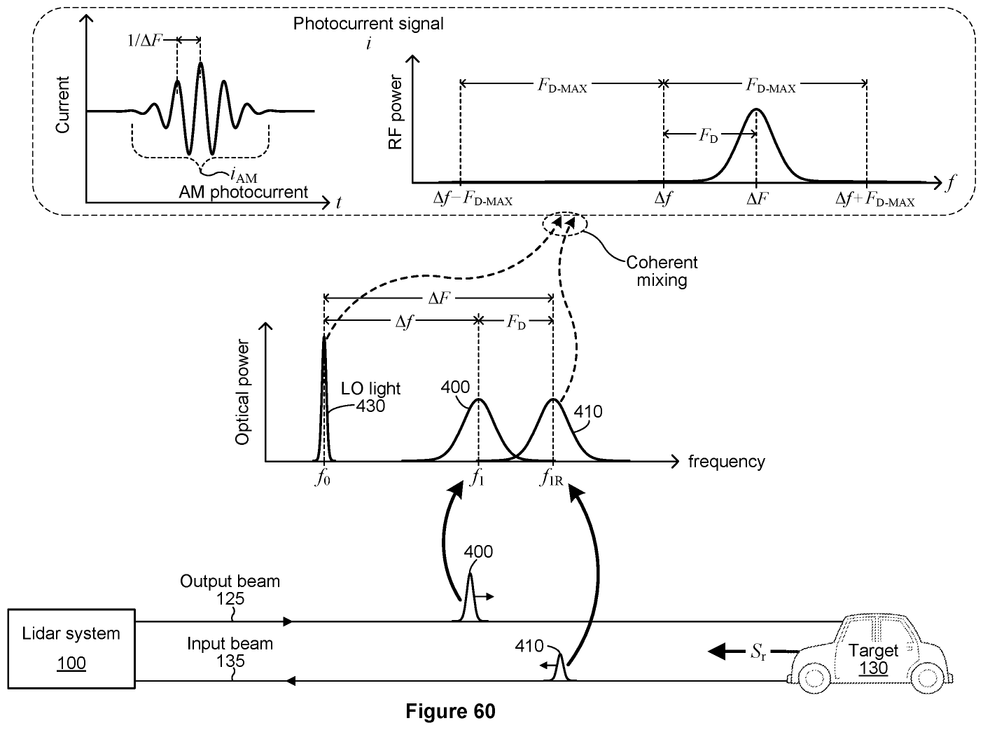

FIG. 60 illustrates example signals associated with a Doppler-shifted pulse of light 410 that is received by a lidar system 100. A light source 110 of the lidar system 100 emits pulse of light 400 as part of an output beam 125, and the input beam 135 includes a received pulse of light 410 that is detected by a receiver 140 of the lidar system 100. The LO light 430 has an optical frequency of f₀, and the emitted pulse of light 400 has an optical frequency of f₁. The emitted pulse of light has a frequency offset of Δf with respect to the LO light 430, where Δf=f₁−f₀. The received pulse of light 410 includes light from the emitted pulse of light 400 that is scattered from the target 130. The target 130 is moving with respect to the lidar system 100, which results in a Doppler frequency shift of F_{D} that is imparted to the received pulse of light 130. The received pulse of light 410 has an optical frequency of f_{1R} that is offset from the optical frequency of the emitted pulse of light 400 by the Doppler frequency shift F_{D} (e.g., f_{1R}=f₁+F_{D}). The optical frequency of the received pulse of light 410 has a frequency offset of ΔF with respect to the LO light 430, where ΔF=Δf+F_{D}. The received pulse of light 410 is coherently mixed with the LO light 430 to produce a photocurrent signal i that includes an AM photocurrent signal i_{AM} with frequency component ΔF, where the frequency ΔF is related to the frequency offset Δf. For example, the relationship between the AM-signal frequency ΔF and the frequency offset Δf may be expressed as ΔF=|Δf+F_{D}|.

When an emitted pulse of light 400 is scattered from a target 130 that is moving with respect to the lidar system 100, the resulting scattered pulse of light 410 has its frequency shifted due to the Doppler effect. An emitted pulse of light 400 with an optical frequency of f₁ that is scattered from a target 130 moving with a speed Sᵣ (where Sᵣ is the radial speed of the target 130 relative to the lidar system 100) has its frequency shifted by F_{D}=(2Sᵣ/c)f₁, where c is the speed of light. The expression for the Doppler frequency shift may also be written as F_{D}=2Sᵣ/λ, where λ is the wavelength of the pulse of light. The radial speed Sᵣ refers to the component of the relative velocity of the target 130 along a line connecting the lidar system 100 and the target 130. The radial speed does not include the transverse component of the relative velocity of the target 130 which is directed orthogonal to the line between the lidar system 100 and the target 130. A positive value for the radial speed Sᵣ corresponds to the lidar system 100 and target 130 moving toward each other and results in a positive value for the Doppler frequency shift F_{D}. In this case, the frequency of the received pulse of light 410 is upshifted by F_{D} with respect to the emitted pulse of light 400. Similarly, a negative value for the radial speed Sᵣ corresponds to the lidar system 100 and target 130 moving away from each other and results in a negative value for the Doppler frequency shift F_{D}. In this case, the frequency of the received pulse of light 410 is downshifted by |F_{D}|.

The target 130 in FIG. 58 is moving toward the lidar system 100 with a relative speed Sᵣ, and the emitted pulse of light 400 scatters from the moving target 130 to produce a scattered pulse of light 410 that is received by the lidar system 100. The emitted pulse of light 400 has an optical frequency of f₁, and the received pulse of light 410 has a higher optical frequency of f_{1R}, where f_{1R}>f₁. Because the target 130 is moving toward the lidar system 100, the frequency of the received pulse of light 410 is upshifted with respect to the frequency of the emitted pulse of light 400 due to the Doppler effect, and the amount of frequency upshift is proportional to the relative radial speed (Sᵣ) of the target 130. If the target 130 were moving away from the lidar system 100, then the frequency of the received pulse of light 410A would be downshifted so that f_{1R}<f₁. In FIG. 58, if the target 130 moves toward the lidar system 100 with a relative speed of 25 m/s (or, 56 miles/hour (mph)), this produces a Doppler frequency shift of approximately +32 MHZ for a pulse of light with a 1550-nm wavelength. In this case, the frequency of the pulse of light 410 is upshifted by 32 MHz relative to the frequency of the emitted pulse of light 400. If the target 130 were moving away from the lidar system 100 with a relative speed of 25 m/s (e.g., the speed Sᵣ is −25 m/s), then the Doppler frequency shift is approximately −32 MHz so that the frequency of the pulse of light 410 is downshifted by 32 MHZ. As another example, a target 130 moving toward the lidar system 100 with a relative speed of 100 m/s (or, approximately 224 mph) produces a Doppler frequency shift of approximately +129 MHZ for a pulse of light 410 with a 1550-nm wavelength.

If the target 130 in FIG. 58 is stationary with respect to the lidar system, then the radial speed Sᵣ is zero and the Doppler frequency shift is zero. In this case, the frequency offset ΔF of the received pulse of light 410 may be approximately equal to the frequency offset Δf of the emitted pulse of light 400. Additionally, for a stationary target 130, the frequency ΔF of the AM photocurrent signal is approximately equal to |Δf|. Herein, a frequency offset refers to a relative frequency difference and may have a positive or negative value, while a frequency component or a frequency of an electronic signal may be an inherently positive value. For example, an emitted pulse of light with a +1-GHz frequency offset may produce a received pulse of light 410 with a +1-GHz frequency offset after scattering from a target 130 that is stationary with respect to the lidar system 100. When the received pulse of light 410 is coherently mixed with the LO light 430, a photocurrent signal i may be produced having a frequency component at 1 GHZ. In this case, the frequency offsets ΔF and Δf are positive, and the frequency of the AM photocurrent signal is equal to Δf. As another example, an emitted pulse of light with a −1-GHz frequency offset may produce a received pulse of light 410 with a −1-GHz frequency offset after scattering from a target 130 that is stationary with respect to the lidar system. When the received pulse of light 410 is coherently mixed with the LO light 430, a photocurrent signal i may be produced having a frequency component at 1 GHZ. In this case, the frequency offsets ΔF and Δf are both negative, and the frequency of the AM photocurrent signal is equal to |Δf|.

The relationship between the frequency component ΔF of an AM photocurrent signal and the frequency offset Δf of an emitted pulse of light 400 may be expressed as ΔF=|Δf+F_{D}|. For example, the emitted pulse of light 400 in FIG. 58 may have a frequency offset Δf of 5 GHZ and a wavelength of 1550 nm. If the target 130 is moving toward the lidar system 100 with a relative radial speed Sᵣ of 77.5 m/s (or, approximately 173 mph), a Doppler frequency shift F_{D} of +100 MHz is imparted to the received pulse of light 410. The frequency offset ΔF of the received pulse of light is then 5.1 GHZ, and the frequency of the AM photocurrent signal is 5.1 GHz. If the target 130 is moving away from the lidar system 100 with a relative speed of 77.5 m/s (e.g., the speed Sᵣ is −77.5 m/s), a Doppler frequency shift F_{D} of −100 MHz is imparted to the received pulse of light 410. The frequency offset ΔF of the received pulse of light is then 4.9 GHZ, and the frequency of the AM photocurrent signal is 4.9 GHZ. As another example, an emitted pulse of light 400 may have a frequency offset Δf of −5 GHz (e.g., the optical frequency of the emitted pulse of light 400 is 5 GHz less than the optical frequency of the LO light 430) and a wavelength of 1550 nm. If the target 130 is moving toward the lidar system 100 with a relative radial speed Sᵣ of 77.5 m/s, a Doppler frequency shift F_{D} of +100 MHz is imparted to the received pulse of light 410. The frequency offset ΔF of the received pulse of light is then −4.9 GHZ, and the frequency of the AM photocurrent signal is 4.9 GHZ. If the target 130 is moving away from the lidar system 100 with a relative radial speed Sᵣ of 77.5 m/s (e.g., the speed Sᵣ is −77.5 m/s), a Doppler frequency shift F_{D} of −100 MHz is imparted to the received pulse of light 410. The frequency offset ΔF of the received pulse of light is then −5.1 GHZ, and the frequency of the AM photocurrent signal is 5.1 GHZ.

A controller 150 of the lidar system 100 in FIG. 58 may determine that the received pulse of light 410 is associated with the emitted pulse of light 400 based on the frequency of the AM photocurrent signal ΔF matching the frequency offset Δf of the emitted pulse of light 400. The frequency ΔF matching the frequency offset Δf may correspond to the frequency ΔF being within a particular threshold value of the frequency offset Δf. The particular threshold value may depend at least in part on a maximum expected Doppler shift (F_{D-MAX}) of the received pulse of light 410 associated with motion of the target 130 with respect to the lidar system 100 (e.g., the maximum expected Doppler shift may be based on a maximum expected radial speed of the target 130 with respect to the lidar system 100). For example, the particular threshold value may be approximately equal to F_{D-MAX} so that the frequency of the AM photocurrent signal ΔF is between approximately |Δf−F_{D-MAX}| and approximately |Δf+F_{D-MAX}|. A frequency-detection channel 368 of the lidar system 100 may include a band-pass filter 610 with a pass-band that extends from at least |Δf−F_{D-MAX}| to |Δf+F_{D-MAX}|, and an output-signal portion 144 produced by the frequency-detection channel may be used to determine that the received pulse of light 410 is associated with the emitted pulse of light 400.

In particular embodiments, a maximum expected Doppler shift (F_{D-MAX}) of a received pulse of light 410 may be assigned a particular value. The maximum expected Doppler shift may be related to a maximum expected relative radial speed (S_{r-MAX}) according to the expression F_{D-MAX}=2S_{r-MAX}/λ, where λ is the wavelength of a pulse of light. The maximum expected relative speed may refer to the maximum relative speed between a lidar system 100 and a target 130 that is expected to occur, and the maximum relative speed may depend on the particular application in which a lidar system 100 is deployed. For example, if a lidar system 100 is deployed in a commercial airplane with a maximum airspeed of 600 mph, then the maximum relative speed may be assigned a value of 1200 mph (e.g., if two aircraft are each flying at 600 mph toward one another, then their relative speed is 1200 mph). At a wavelength of 1550 nm, the maximum expected Doppler shift may be determined from the above expression for F_{D-MAX} to be 692 MHz in this implementation. The Doppler frequency shift F_{D} imparted to a received pulse of light 410 may be between −692 MHz (for objects moving away from each other at 1200 mph) and +692 MHz (for objects moving toward each other at 1200 MHZ). In FIG. 58, if the emitted pulse of light 400 has a frequency offset Δf of 5 GHZ, then the received pulse of light 410 may have a frequency offset ΔF between approximately 4.31 GHZ and 5.69 GHZ (which corresponds to the frequency offset being between Δf−F_{D-MAX} and Δf+F_{D-MAX}). As another example, if a lidar system 100 is deployed in a highway driving application (with a maximum driving speed of 125 mph), then the maximum relative speed may be set to 250 mph. At a wavelength of 1550 nm, the maximum expected Doppler shift may be determined to be 144 MHZ in this implementation, and the Doppler frequency shift F_{D} imparted to a received pulse of light 410 may be between −144 MHz and +144 MHz. As another example, if a lidar system 100 is deployed in a residential-neighborhood driving application (with a speed limit of 25 mph), then the maximum relative speed may be defined as 60 mph (which accounts for possible driving over the speed limit). At a wavelength of 1550 nm, the maximum expected Doppler shift may be determined to be 35 MHZ in this application, and the Doppler frequency shift F_{D} imparted to a received pulse of light 410 may be between −35 MHz and +35 MHz. For a lidar system 100 operating at 1550 nm and installed in a car driving on public streets and highways, the maximum expected Doppler shift may be between approximately 30 MHZ (which corresponds to a maximum relative speed of approximately 52 mph) and approximately 150 MHZ (which corresponds to a maximum relative speed of approximately 260 mph).

FIGS. 61-64 each illustrate example pass-bands (PB) of an electronic band-pass filter 610. Each electronic filter 610 is a band-pass filter having a relatively high transmission (e.g., 90-100% transmission) for frequencies within the pass-band and a relatively low transmission (e.g., 0-10% transmission) for frequencies outside of the pass-band. Each of the electronic filters 610 in FIGS. 61-64 may be part of a heterodyne optical receiver 140 that is part of a pulsed coherent lidar system 100, and each of the electronic filters may be configured to receive a voltage signal 360 from an electronic amplifier 350 and produce a corresponding filtered signal 362. The filtered signal 362 may include a portion of the voltage signal 360 having frequency components within the pass-band of the filter 610. Each of the electronic filters 610 in FIGS. 61-64 may correspond to filter 610a in FIG. 38, filter 610a in FIG. 39, or filter 610-1, 610-2, or 610-3 in FIGS. 41-42. The pass-band in each of FIGS. 61-64 includes the frequency offset Δf and has a pass-band frequency width between approximately F_{D-MAX} and approximately 2F_{D-MAX}. Each electronic filter 610 in FIGS. 61-64 may be part of a frequency-detection channel 368 that is configured to detect a received pulse of light 410 associated with an emitted pulse of light having a frequency offset of Δf.

The electronic filter 610 in FIG. 61 has a pass-band with a frequency width F_{PB} of 2F_{D-MAX} that extends from |Δf−F_{D-MAX}| to |Δf+F_{D-MAX}|. In FIG. 61, since the frequency Δf and the maximum expected Doppler shift F_{D-MAX} are both positive values, the pass-band may be referred to as extending from Δf−F_{D-MAX} to λf+F_{D-MAX}, as indicated in FIG. 61. The voltage signal 360a in FIG. 61 may correspond to the voltage signal 360a in FIG. 41, and the filter 610 in FIG. 61 may correspond to the filter 610-1 in FIG. 41. The voltage signal 360a in FIG. 61 resulting from the received pulse of light 410a in FIG. 41 has a frequency component of ΔF located within the pass-band. The electronic filter 610 in FIG. 61 may transmit most of the voltage signal 360a, and the associated frequency-detection channel 368-1 in FIG. 41 may produce the output-signal portion 144-1a having a relatively large amplitude. The voltage signal 360b in FIG. 61 may correspond to the voltage signal 360b in FIG. 42. The filter 610 in FIG. 61 may substantially block most of the voltage signal 360b, and the associated frequency-detection channel 368-1 in FIG. 42 may produce the output-signal portion 144-1b having a relatively small amplitude.

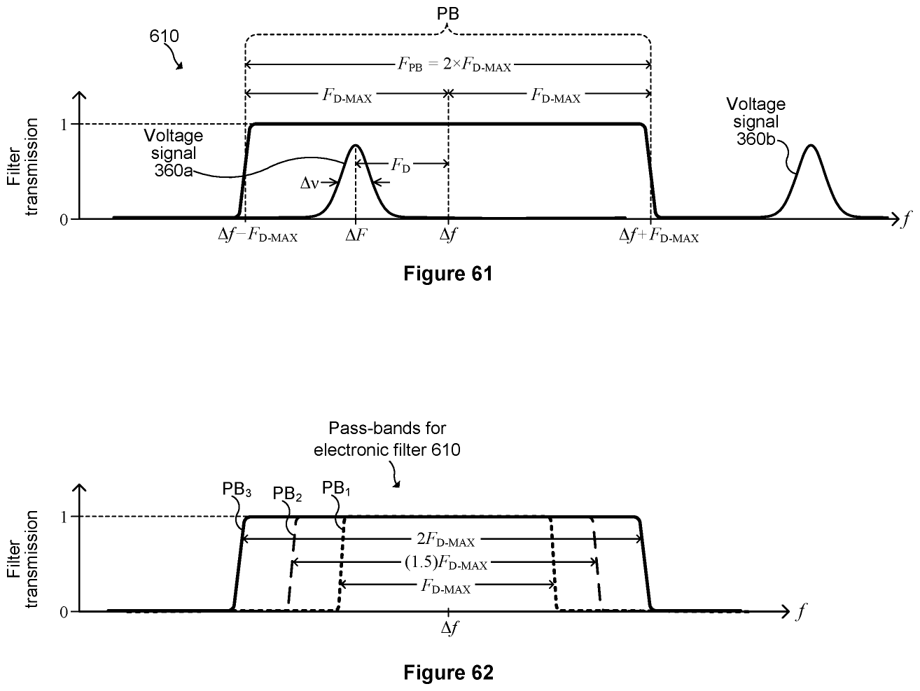

In particular embodiments, each frequency-detection channel 368 of a detection circuit 361 may include an electronic filter 610 having a particular pass-band frequency width. FIG. 62 illustrates three example pass-bands for three different electronic filters 610. Pass-band PB₁ has a pass-band frequency width of F_{D-MAX}, pass-band PB₂ has a pass-band frequency width of (1.5)F_{D-MAX}, and pass-band PB₃ has a pass-band frequency width of 2F_{D-MAX}. An electronic filter 610 may have a pass-band frequency width F_{PB} that is greater than or equal to F_{D-MAX}, (1.5)F_{D-MAX}, or 2F_{D-MAX}, or greater than or equal to any other suitable factor of F_{D-MAX}. Additionally, an electronic filter 610 may have a pass-band frequency width F_{PB} that is less than or equal to 2F_{D-MAX}, 3F_{D-MAX}, 4F_{D-MAX}, or 5F_{D-MAX}, or less than or equal to any other suitable factor of F_{D-MAX}. For example, the electronic filters 610-1, 610-2, and 610-3 in FIGS. 41-42 may each have a pass-band with a frequency width that is greater than or equal to (1.5)F_{D-MAX}. As another example, the electronic filter 610a in FIG. 38 may have a pass-band with a frequency width that is approximately equal to 2F_{D-MAX}. As another example, the electronic filter 610a in FIG. 39 may have a pass-band with a frequency width between approximately (1.5)F_{D-MAX} and approximately 3F_{D-MAX}.

A pass-band frequency width (F_{PB}) of an electronic filter 610 may have a value of approximately 50 MHZ, 100 MHZ, 200 MHZ, or 500 MHZ, or any other suitable value between approximately 50 MHz and approximately 500 MHZ. A pass-band width may be expressed in terms of a maximum expected Doppler shift (F_{D-MAX}). For example, a pass-band may have a frequency width that is approximately equal to (1.5)F_{D-MAX}, 2F_{D-MAX}, or 3F_{D-MAX}. Alternatively, a pass-band width may be expressed in terms of (i) a maximum expected Doppler shift (F_{D}-MAX) and (ii) an electrical bandwidth (Δν) of a voltage signal 360 or a spectral linewidth (Δν₁) of a corresponding received pulse of light 410. For example, a pass-band frequency width may have any suitable value between approximately F_{D-MAX} and approximately 3(F_{D-MAX}+Δν). As another example, a pass-band frequency width may have any suitable value between approximately F_{D-MAX} and approximately 3(F_{D-MAX}+Δν₁). As another example, a pass-band frequency width may be approximately equal to (1.5)F_{D-MAX}+Δν, 2(F_{D-MAX}+Δν), or 3F_{D-MAX}+Δ∇.

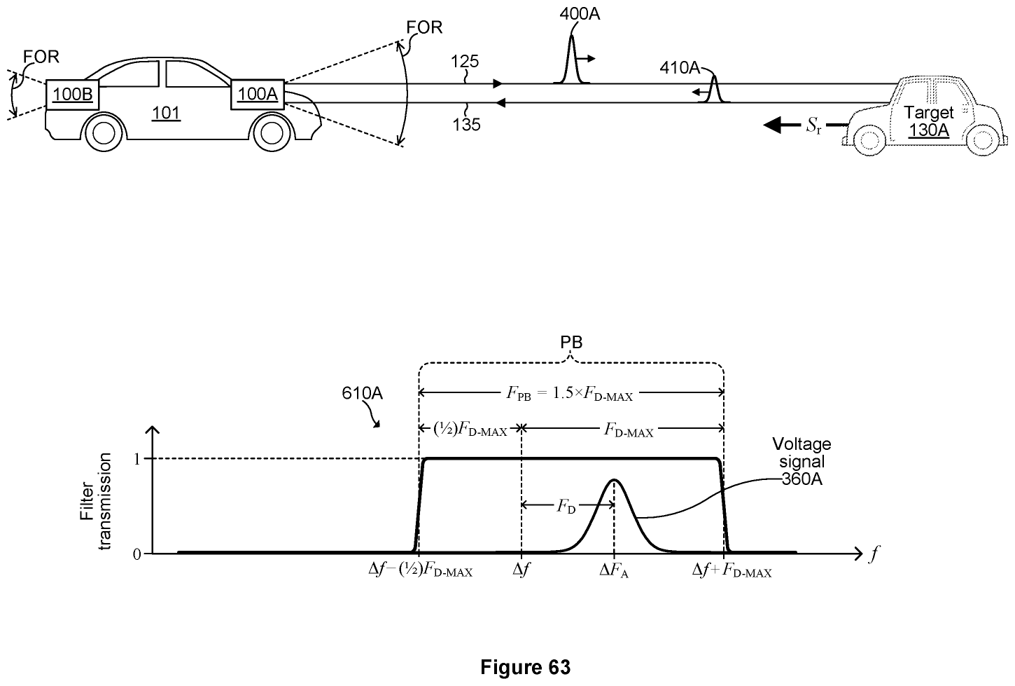

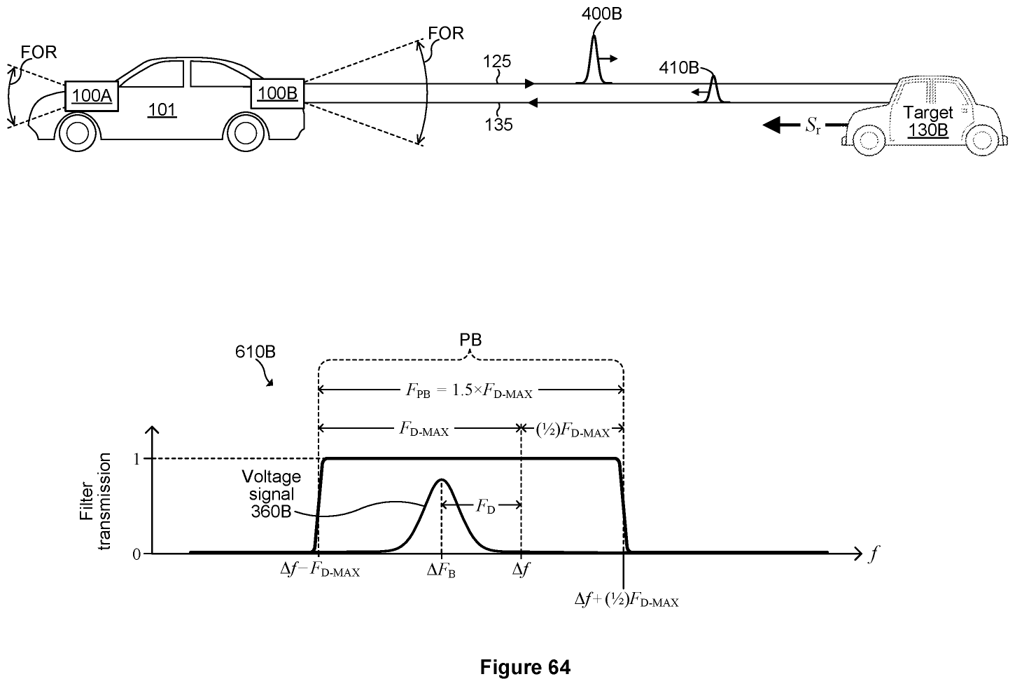

The vehicle 101 in FIGS. 63-64 includes two lidar systems: (i) lidar system 100A is a forward-facing lidar system that looks ahead of the vehicle in the direction of forward travel and (ii) lidar system 100B is a backward-facing lidar system that looks behind the vehicle. In FIG. 63, a pulse of light 400A scatters from a target 130A to produce a received pulse of light 410A that is detected by lidar system 100A. The resulting voltage signal 360A has a frequency component at the frequency ΔF_{A}, where ΔF_{A}=Δf+F_{D}, and Δf is the frequency offset of the emitted pulse of light 400A. In FIG. 64, a pulse of light 400B scatters from a target 130B to produce a received pulse of light 410B that is detected by lidar system 100B. The resulting voltage signal 360B has a frequency component at the frequency ΔF_{B}.

In particular embodiments, each frequency-detection channel 368 of a detection circuit 361 may include an electronic filter 610 having a pass-band width greater than or equal to (1.5)F_{D-MAX}. Each of the electronic filters 610A and 610B in FIGS. 63-64 has a pass-band width of (1.5)F_{D-MAX}. The electronic filter 610A in FIG. 63 is part of the forward-facing lidar system 100A, and the electronic filter 610B in FIG. 64 is part of the backward-facing lidar system 100B. Both electronic filters 610A and 610B have a pass-band frequency width of (1.5)F_{D-MAX}, but each filter includes a different range of frequencies. The pass-band of electronic filter 610A extends from Δf−(½)F_{D-MAX} to Δf+F_{D-MAX}, and the pass-band of electronic filter 610B extends from Δf−F_{D-MAX} to Δf+(½)F_{D-MAX}, where Δf is the frequency offset of the emitted pulses of light 400A and 400B. In FIG. 63, the forward-facing lidar system 100A may receive a pulse of light 410 with a maximum frequency upshift of F_{D-MAX}, but the maximum frequency downshift of a received pulse of light 410 may be approximately one-half of that, or (½)F_{D-MAX}. The vehicle 101 and the target 130A may move toward each other (e.g., Sᵣ>0) while both are driving at a maximum speed, which may result in a received pulse of light 410 having its frequency upshifted by F_{D-MAX}. However, for negative values of the relative speed Sᵣ (when vehicle 101 and target 130A are moving away from each other), a target 130 may move at a maximum speed, while the vehicle 101 may be stationary or moving slowly in reverse (since a passenger vehicle generally has a relatively slow reverse speed). This results in a maximum frequency downshift that may be imparted to a received pulse of light 410 of approximately (½)F_{D-MAX}. In FIG. 64, the backward-facing lidar system 100B may receive a pulse of light 410 with a maximum frequency downshift of F_{D-MAX}, but the maximum frequency upshift of a received pulse of light 410 may be approximately one-half of that, or (½)F_{D-MAX}. The vehicle 101 and a target 130 may move away from each other (e.g., Sᵣ<0) while both are driving at a maximum speed, which may result in a received pulse of light 410 having its frequency downshifted by F_{D-MAX}. However, for positive values of the relative speed Sᵣ (when vehicle 101 and target 130A are moving toward each other), only target 130B may move at a maximum speed, while the vehicle may be stationary or moving slowly in reverse. This results in a maximum frequency upshift that may be imparted to a received pulse of light 410 of approximately (½)F_{D-MAX}.

A pass-band frequency width of (1.5)F_{D-MAX} may correspond to a minimum pass-band width for an electronic filter 610, and an electronic filter 610 may have a pass-band frequency width that is greater than or equal to (1.5)F_{D-MAX}. For example, for a lidar system 100 that provides a 360-degree view around a vehicle, an electronic-filter pass-band may have a width of greater than or equal to 2F_{D-MAX}. As another example, an electronic-filter pass-band may have a width of greater than or equal to (1.5)F_{D-MAX}+Δν or 2F_{D-MAX}+Δν, which takes into account the electrical bandwidth of the voltage signal 360.

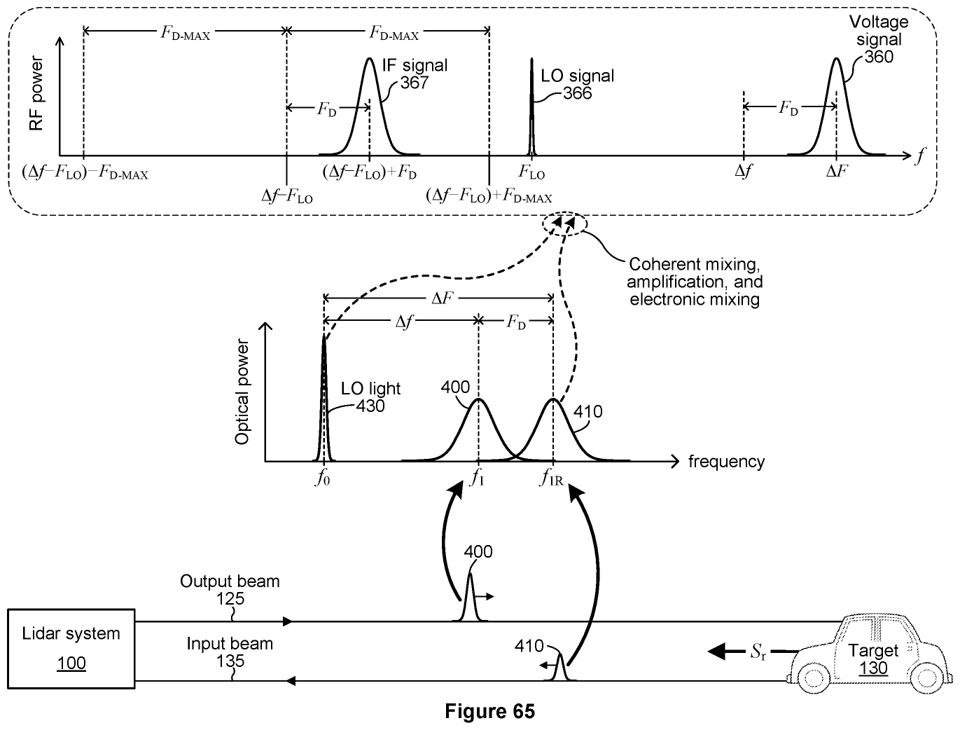

FIG. 65 illustrates example signals associated with a Doppler-shifted pulse of light 410 that is received by a lidar system 100. A light source 110 of the lidar system 100 emits pulse of light 400 as part of an output beam 125, and the input beam 135 includes a received pulse of light 410 that is detected by a receiver 140 of the lidar system 100. The LO light 430 has an optical frequency of f₀, and the emitted pulse of light 400 has an optical frequency of f₁ and a frequency offset of Δf. The received pulse of light 410 includes light from the emitted pulse of light 400 that is scattered from the target 130. The target 130 is moving with respect to the lidar system 100, which results in a Doppler frequency shift of F_{D} that is imparted to the received pulse of light 130. The received pulse of light 410 has an optical frequency of fir that is offset from the optical frequency of the emitted pulse of light 400 by the Doppler frequency shift F_{D}. The optical frequency of the received pulse of light 410 has a frequency offset of ΔF with respect to the LO light 430, where ΔF=Δf+F_{D}.

The lidar system 100 in FIG. 65 includes an optical superheterodyne receiver 140 with two stages of mixing: (i) the received pulse of light 410 is coherently mixed with LO light 430 to produce an electronic signal with a ΔF frequency component and (ii) the corresponding voltage signal 360 is mixed with an electronic LO signal 366 to produce an IF signal 367. The voltage signal 360 has a frequency component at frequency ΔF, and mixing the voltage signal with the LO signal 366 at frequency F_{LO} produces the IF signal 367 at a frequency of |ΔF−F_{LO}|. The frequency of the IF signal 367 may also be expressed as ||Δf+F_{D}|−F_{LO}|. In FIG. 65, since the frequencies Δf and ΔF are both positive values that are greater than F_{LO}, the frequency of the IF signal 367 may be expressed without absolute-value symbols as (ΔF−F_{LO}), or as (Δf+F_{D})−F_{LO}, or (as indicated in FIG. 65) as (Δf−F_{LO})+F_{D}. The frequency of the IF signal 367 may be shifted by a maximum of F_{D-MAX} with respect to the frequency |Δf−F_{LO}|, which corresponds to the frequency of the IF signal 367 being between ||Δf−F_{D-MAX}|−F_{LO}| and ||Δf+F_{D-MAX}|−F_{LO}|. In FIG. 65, since the frequency Δf is a positive value that is greater than F_{LO}, this relationship may be expressed without absolute-value symbols as the frequency of the IF signal 367 being between (Δf−F_{LO})−F_{D-MAX} and (Δf−F_{LO})+F_{D-MAX}. A frequency-detection channel 368 of the lidar system 100 in FIG. 65 may include a band-pass filter 610 with a pass-band that extends from at least ||Δf−F_{D-MAX}|−F_{LO}| to ||Δf+F_{D-MAX}|−F_{LO}|, and an output-signal portion 144 produced by the frequency-detection channel may be used to determine that the received pulse of light 410 is associated with the emitted pulse of light 400. A frequency-detection channel 368 of the lidar system 100 in FIG. 65 may include a band-pass filter 610 with a pass-band that includes the frequency ||Δf|−F_{LO}|, where Δf is the frequency offset of the emitted pulse of light 400, and Fro is the frequency of the LO signal 366 produced by an electronic LO 616 of the frequency-detection channel. In FIG. 65, since the frequency Δf is a positive value that is greater than F_{LO}, this corresponds to a band-pass filter 610 with a pass-band that includes the frequency (Δf−F_{LO}).

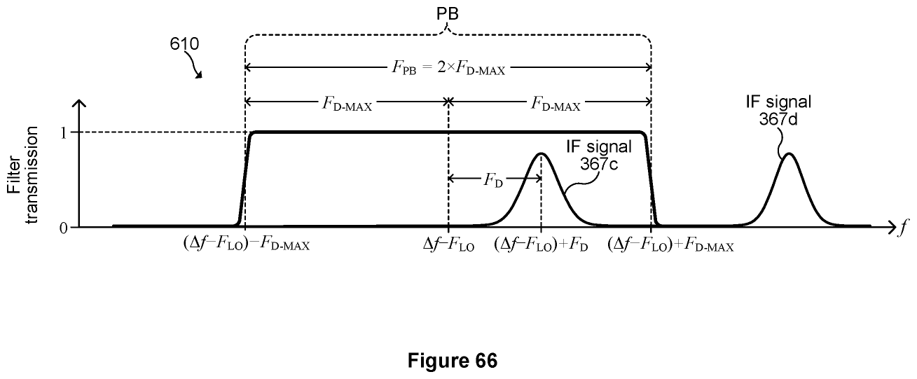

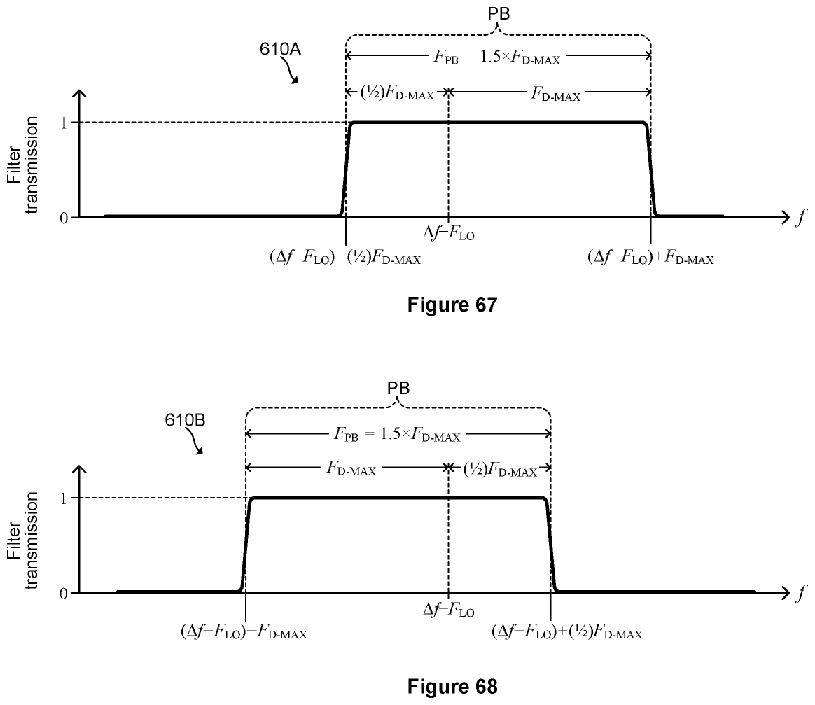

FIGS. 66-68 each illustrate example pass-bands of an electronic band-pass filter 610. Each of the electronic filters 610 in FIGS. 66-68 may be part of a superheterodyne optical receiver 140 that is part of a pulsed coherent lidar system 100, and each of the electronic filters may be configured to receive an IF signal 367 from an electronic mixer 618 and produce a corresponding filtered signal 362. The filtered signal 362 may include the transmitted portion of the IF signal 367 having frequency components within the pass-band of the electronic filter 610. Each of the electronic filters 610 in FIGS. 64-68 may correspond to filter 610a in FIG. 43, filter 610a in FIG. 44, filter 610-1, 610-2, or 610-3 in FIGS. 46 and 50, filter 610-1 or 610-2 in FIG. 55, or filter 610al or 610aQ in FIG. 57. An electronic filter 610 that is part of a superheterodyne optical receiver 140 may have a pass-band that includes the frequency ||Δf|−F_{LO}|. In FIGS. 66-68, since the frequency Δf is a positive value that is greater than F_{LO}, this corresponds to each of the pass-bands including the frequency Δf−F_{LO}. The electronic filter 610 in FIG. 66 has a pass-band frequency width of 2F_{D-MAX}, and the electronic filters 610A and 610B in FIGS. 67-68 each have a pass-band frequency width of (1.5)F_{D-MAX}. Each electronic filter 610 in FIGS. 66-68 may be part of a superheterodyne frequency-detection channel 368 that is configured to detect a received pulse of light 410 associated with an emitted pulse of light 400 having a frequency offset of Δf.

The electronic filter 610 in FIG. 66 has a pass-band frequency width F_{PB} of 2F_{D-MAX} that extends from (Δf−F_{LO})−F_{D-MAX} to (Δf−F_{LO})+F_{D-MAX}. The IF signal 367c in FIG. 66 may correspond to the IF signal 367-2c in FIGS. 46-48, and the filter 610 in FIG. 66 may correspond to the filter 610-2 in FIGS. 46-47. The IF signal 367c in FIG. 66 resulting from the received pulse of light 410c in FIG. 46 has a frequency component of (Δf−F_{LO})+F_{D} located within the pass-band. The electronic filter 610 in FIG. 66 may transmit most of the IF signal 367c, and the associated frequency-detection channel 368-2 in FIG. 46 may produce the output-signal portion 144-2c having a relatively large amplitude. The IF signal 367d in FIG. 66 may correspond to the IF signal 367-2d in FIGS. 50-51. The filter 610 in FIG. 66 may substantially block most of the IF signal 367d, and the associated frequency-detection channel 368-2 in FIG. 50 may produce the output-signal portion 144-2d having a relatively small amplitude.

In particular embodiments, each frequency-detection channel 368 in a lidar system 100 with a superheterodyne optical receiver 140 may include an electronic filter 610 with a pass-band width of greater than or equal to 1.5×F_{D-MAX}. Each of the electronic filters 610A and 610B in FIGS. 67-68 has a pass-band width of (1.5)F_{D-MAX}. The electronic filter 610A in FIG. 67 may be part of the forward-facing lidar system 100A in FIGS. 63-64, and the electronic filter 610B in FIG. 68 may be part of the backward-facing lidar system 100B in FIGS. 63-64. Both electronic filters 610A and 610B have a pass-band frequency width of (1.5)F_{D-MAX}, but each filter includes a different range of frequencies. The pass-band of electronic filter 610A extends from (Δf−F_{LO})−(½)F_{D-MAX} to (Δf−F_{LO})+F_{D-MAX}, and the pass-band of electronic filter 610B extends from (Δf−F_{LO})−F_{D-MAX} to (Δf−F_{LO})+(½)F_{D-MAX}, where Δf is the frequency offset of the emitted pulses of light 400A and 400B in FIGS. 63-64. In FIG. 63, the forward-facing lidar system 100A may receive a pulse of light 410 with a maximum frequency upshift of F_{D-MAX}, but the maximum frequency downshift of a received pulse of light 410 may be approximately one-half of that, or (½)F_{D-MAX} (which corresponds to the pass-band of electronic filter 610A in FIG. 67). In FIG. 64, the backward-facing lidar system 100B may receive a pulse of light 410 with a maximum frequency downshift of F_{D}-MAX, but the maximum frequency upshift of a received pulse of light 410 may be approximately one-half of that, or (½)F_{D-MAX} (which corresponds to the pass-band of electronic filter 610B in FIG. 68).

In particular embodiments, each frequency-detection channel 368 of a detection circuit 361 may include an electronic filter 610 having a particular pass-band. The pass-band center frequency and width may depend on one or more of the following: Δf (the frequency offset associated with an emitted pulse of light 400); F_{D-MAX}; F_{LO} (the oscillator frequency of the frequency-detection channel 368); and an electrical bandwidth (Av) of a voltage signal 360 or a spectral linewidth (Δν₁) of a corresponding received pulse of light 410. For example, the pass-band of an electronic filter 610 may include at least the frequencies between approximately ||Δf−(½)F_{D-MAX}|−F_{LO}| and approximately |Δf+(½)F_{D-MAX}|−F_{LO}| and may have a pass-band width greater than or equal to F_{D-MAX}. As another example, the pass-band of an electronic filter 610 may include at least the frequencies between approximately ||Δf−F_{D-MAX}|−F_{LO}| and approximately ||Δf+F_{D-MAX}|−F_{LO}| and may have a pass-band width greater than or equal to 2F_{D-MAX}, which corresponds to the filter 610 in FIG. 66. As another example, the pass-band of an electronic filter 610 may include at least the frequencies between approximately ||Δf−(½)F_{D-MAX}|−F_{LO}| and approximately ||Δf+F_{D-MAX}|−F_{LO}| and may have a pass-band width greater than or equal to (1.5)F_{D-MAX}, which corresponds to the filter 610A in FIG. 67. As another example, the pass-band of an electronic filter 610 may include at least the frequencies between approximately ||Δf−F_{D-MAX}|−F_{LO} and approximately ||Δf+(½)F_{D-MAX}|−F_{LO}| and may have a pass-band width greater than or equal to (1.5)F_{D-MAX}, which corresponds to the filter 610B in FIG. 68.

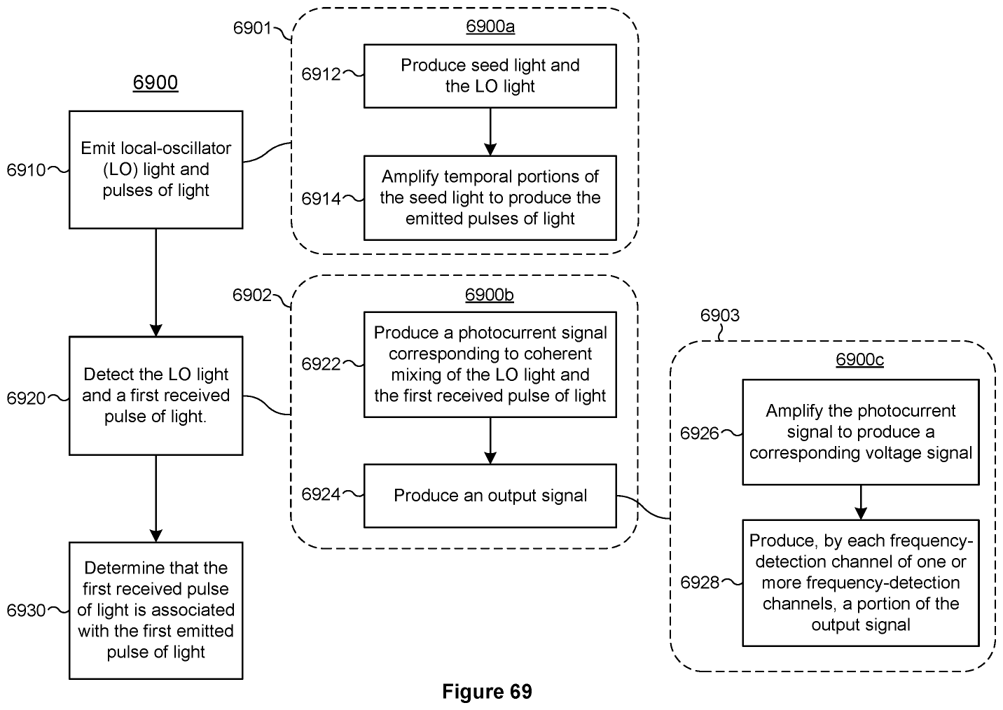

FIG. 69 illustrates an example method 6900 for determining that a received pulse of light 400 is associated with an emitted pulse of light 410. The method 6900 may begin at step 6910, where a light source 110 of a lidar system 100 emits local-oscillator (LO) light 430 and pulses of light 400. The emitted pulses of light may include a first emitted pulse of light 400, where an optical frequency of the first emitted pulse of light is offset from an optical frequency of the LO light 430 by a first frequency offset Δf. Inset 6901 illustrates an example method 6900a for emitting the LO light 430 and the pulses of light 400. At step 6912, a seed laser 450 produces seed light 440 and the LO light 430. At step 6914, an optical amplifier amplifies temporal portions 441 of the seed light 400 to produce the emitted pulses of light 400. Each amplified temporal portion of the seed light may correspond to one of the emitted pulses of light. The seed laser 450 may include one or more laser diodes, and the optical amplifier may include a semiconductor optical amplifier (SOA) 460, a fiber-optic amplifier 500, or a SOA 460 followed by a fiber-optic amplifier 500.

At step 6920 of the method 6900, a receiver 140 of the lidar system 100 detects the LO light 430 and a first received pulse of light 410. The first received pulse of light 410 may include light from the first emitted pulse of light 400 that is scattered by a target 130 located a distance D from the lidar system 100. Inset 6902 illustrates an example method 6900b for detecting the LO light 430 and the first received pulse of light 410. At step 6922, a detector 340 produces a photocurrent signal i that corresponds to coherent mixing of the LO light and the first received pulse of light. At step 6924, a detection circuit 361 produces an output signal 145. The photocurrent signal may include an amplitude-modulation (AM) signal, and the output signal 145 may include one or more output-signal portions 144 that correspond to the AM photocurrent signal. The AM photocurrent signal may include a frequency component having a frequency of ΔF, where the frequency ΔF is related to the first frequency offset Δf between the first emitted pulse of light 400 and the LO light 430. For example, the relationship between the frequency component ΔF and the first frequency offset Δf may be expressed as ΔF=|Δf+F_{D}|, where F_{D} is a Doppler frequency shift imparted to the received pulse of light 410. Inset 6903 illustrates an example method 6900c for producing the output signal 145. At step 6926, an electronic amplifier 350 amplifies the photocurrent signal i to produce a voltage signal 360 that corresponds to the photocurrent signal. The detection circuit 361 may include one or more frequency-detection channels 368, and at step 6928, each frequency-detection channel produces a portion 144 of the output signal 145. The output signal 145 may include the output-signal portion 144 produced by each of the frequency-detection channels 368. Each frequency-detection channel 368 may include an electronic band-pass filter 610 that transmits a portion of the voltage signal 360 located within a pass-band of the filter. Alternatively, each frequency-detection channel 368 may include (i) an electronic local oscillator (LO) 616 that produces an electronic local-oscillator (LO) signal 366 having a particular oscillator frequency, (ii) an electronic mixer 618 that that mixes the voltage signal 360 with the electronic LO signal 366 to produce an intermediate-frequency (IF) signal 367, and (iii) an electronic filter 610 that transmits a portion of the IF signal 367 located within a pass-band of the filter.

At step 6930 of the method 6900, a processor 150 of the lidar system 100 determines, based on the output signal 145, that the first received pulse of light 410 is associated with the first emitted pulse of light 400, at which point the method 6900 may end. The processor 150 may additionally determine a time-of-arrival of the first received pulse of light 410, and based on the time-of-arrival, the processor 150 may also determine the distance D to the target 130. The processor 150 may determine that the first received pulse of light 410 is associated with the first emitted pulse of light 400 based on a frequency ΔF of the AM photocurrent signal matching the first frequency offset Δf between the first emitted pulse of light 400 and the LO light 430. Additionally or alternatively, the processor 150 may determine that the first received pulse of light 410 is associated with the first emitted pulse of light 400 based on the amplitudes of the one or more output-signal portions 144 produced by the one or more frequency-detection channels 368.

Various example aspects directed to a lidar system are described below.
1. A lidar system comprising: a light source configured to emit local-oscillator (LO) light and pulses of light, the emitted pulses of light comprising a first emitted pulse of light, wherein an optical frequency of the first emitted pulse of light is offset from an optical frequency of the LO light by a first frequency offset, and the light source comprises: a seed laser configured to produce seed light and the LO light; and an optical amplifier configured to amplify temporal portions of the seed light to produce the emitted pulses of light; a receiver configured to detect the LO light and a first received pulse of light, the first received pulse of light comprising light from the first emitted pulse of light scattered by a target located a distance from the lidar system, wherein the LO light and the first received pulse of light are coherently mixed together at the receiver to produce a corresponding photocurrent signal comprising an amplitude-modulation (AM) signal, and the receiver is configured to produce an output signal corresponding to the AM photocurrent signal; and a processor configured to determine, based on the output signal, that the first received pulse of light is associated with the first emitted pulse of light.
2. The lidar system of Aspect 1, wherein the seed laser comprises a laser diode comprising a front face and a back face, wherein the seed light is emitted from the front face and the LO light is emitted from the back face.
3. The lidar system of Aspect 1, wherein: the seed laser comprises a laser diode comprising a front face from which output light is emitted; and the light source further comprises an optical splitter configured to split the output light to produce the seed light and the LO light.
4. The lidar system of Aspect 1, wherein the seed laser comprises: a seed laser diode configured to produce the seed light; and a local-oscillator laser diode configured to produce the LO light.
5. The lidar system of Aspect 1, wherein the optical amplifier comprises a semiconductor optical amplifier (SOA), a fiber-optic amplifier, or a SOA followed by a fiber-optic amplifier.
6. The lidar system of Aspect 1, wherein the seed laser is configured to produce the LO light so that the LO light has a substantially constant optical power and a substantially constant optical frequency.
7. The light source of Aspect 1, wherein each amplified temporal portion of the seed light corresponds to one of the emitted pulses of light.
8. The lidar system of Aspect 1, wherein the temporal portions of the seed light comprise a first temporal portion that is amplified by the optical amplifier to produce the first emitted pulse of light, wherein an optical frequency of the first temporal portion is offset from the optical frequency of the LO light by the first frequency offset.
9. The lidar system of Aspect 1, wherein: the seed laser is configured to produce the seed light and the LO light so that each temporal portion of the seed light that is amplified to produce a corresponding emitted pulse of light is offset from the optical frequency of the LO light by a frequency offset of Δf, wherein Δf is a particular frequency offset of one or more different frequency offsets, the one or more different frequency offsets including the first frequency offset; and the optical amplifier is configured to amplify each temporal portion of the seed light to produce a corresponding emitted pulse of light that is offset by approximately Δf from the optical frequency of the LO light.
10. The lidar system of Aspect 1, wherein: the seed laser comprises a laser diode configured to produce the seed light; and the light source further comprises an electronic driver configured to supply a first set of one or more electrical currents to the laser diode, wherein the first set is a set of one or more sets of electrical currents which the electronic driver is configured to supply to the laser diode, wherein each set of electrical currents is configured to cause the laser diode to produce seed light having a particular optical frequency.
11. The lidar system of Aspect 10, wherein the first set of electrical currents is configured to cause the laser diode to produce a first temporal portion of seed light having a first optical frequency, the first optical frequency being approximately equal to the optical frequency of the first emitted pulse of light, wherein the optical amplifier is configured to amplify the first temporal portion to produce the first emitted pulse of light.
12. The lidar system of Aspect 11, wherein the electronic driver is further configured to supply a second set of electrical currents to the laser diode to cause the laser diode to produce a second temporal portion of seed light having a second optical frequency different from the first optical frequency, wherein the optical amplifier is configured to amplify the second temporal portion to produce a second emitted pulse of light having an optical frequency approximately equal to the second optical frequency.
13. The lidar system of Aspect 11, wherein: the laser diode is further configured to produce the LO light; and subsequent to the first pulse of light being emitted by the light source, the electronic driver is further configured to supply a second set of electrical currents to the laser diode to cause the laser diode to produce the LO light so that the optical frequency of the first emitted pulse of light is offset from the optical frequency of the LO light by the first frequency offset.
14. The lidar system of Aspect 1, wherein the light source further comprises an optical modulator configured to shift a frequency of the seed light or the LO light so that the seed light and the LO light are offset by a particular frequency offset of one or more different frequency offsets, the one or more different frequency offsets including the first frequency offset.
15. The lidar system of Aspect 1, wherein an optical frequency of each emitted pulse of light is offset from the optical frequency of the LO light by a particular frequency offset of one or more different frequency offsets, the one or more different frequency offsets including the first frequency offset.
16. The lidar system of Aspect 15, wherein each of the different frequency offsets is a fixed frequency offset.
17. The lidar system of Aspect 15, wherein the seed laser comprises a frequency-tunable laser diode configured to produce the seed light, wherein the frequency-tunable laser diode is configured to produce the seed light at one or more different optical frequencies corresponding to the one or more respective different frequency offsets.
18. The lidar system of Aspect 15, wherein the seed laser comprises one or more laser diodes, each laser diode configured to produce seed light at one of one or more different optical frequencies corresponding to the one or more respective different frequency offsets.
19. The lidar system of Aspect 15, wherein: the optical frequency of the LO light is between 175 THz and 335 THz; and each of the different frequency offsets is between 10 MHZ and 50 GHZ.
20. The lidar system of Aspect 1, wherein: the optical frequency of the first emitted pulse of light is f₁; the optical frequency of the LO light is f₀; and the first frequency offset is Δf₁, wherein Δf₁=f₁−f₀.
21. The lidar system of Aspect 1, wherein the processor is configured to determine that the first received pulse of light is associated with the first emitted pulse of light based on a frequency of the AM photocurrent signal matching the first frequency offset between the first emitted pulse of light and the optical frequency of the LO light, wherein: the frequency of the AM photocurrent signal matching the first frequency offset corresponds to the frequency of the AM photocurrent signal being within a particular threshold value of the first frequency offset; and the particular threshold value depends at least in part on a maximum expected Doppler shift of the first received pulse of light associated with motion of the target with respect to the lidar system.
22. The lidar system of Aspect 1, wherein the first received pulse of light being associated with the first emitted pulse of light corresponds to the first received pulse of light comprising a portion of light from the first emitted pulse of light.
23. The lidar system of Aspect 1, wherein the emitted pulses of light further comprise (i) a previous pulse of light that is emitted prior to the first emitted pulse of light and (ii) a subsequent pulse of light that is emitted after the first emitted pulse of light, wherein each of the previous and subsequent pulses of light has an optical frequency that is offset from the optical frequency of the LO light by a frequency offset that is different from the first frequency offset.
24. The lidar system of Aspect 1, wherein: the emitted pulses of light further comprise a second emitted pulse of light, wherein an optical frequency of the second emitted pulse of light is offset from the optical frequency of the LO light by a second frequency offset different from the first frequency offset; the receiver is further configured to detect the LO light and a second received pulse of light, the second received pulse of light comprising scattered light from the second emitted pulse of light, wherein: the LO light and the second received pulse of light are coherently mixed together at the receiver to produce a second photocurrent signal comprising a second AM photocurrent signal; and the receiver is further configured to produce a second output signal corresponding to the second AM photocurrent signal; and the processor is further configured to determine, based on the second output signal, that the second received pulse of light is not associated with the first emitted pulse of light.
25. The lidar system of Aspect 1, wherein the AM photocurrent signal includes a coherent-mixing term that is proportional to a product of (i) an amplitude of an electric field of the first received pulse of light and (ii) an amplitude of an electric field of the LO light.
26. The lidar system of Aspect 1, wherein the receiver comprises: a detector, wherein the LO light and the first received pulse of light are coherently mixed together at the detector, and the detector produces the photocurrent signal; and a detection circuit configured to receive the photocurrent signal and produce the output signal corresponding to the AM photocurrent signal.
27. The lidar system of Aspect 1, wherein the receiver comprises an optical polarization element configured to: (i) convert a polarization of the LO light into circularly polarized light or (ii) depolarize the polarization of the local-oscillator light.
28. The lidar system of Aspect 1, wherein the processor is further configured to determine, based on the output signal, a time-of-arrival of the first received pulse of light.
29. The lidar system of Aspect 28, wherein the output signal includes or corresponds to an electronic representation of the first received pulse of light, and the time-of-arrival is determined from a zero crossing of a first derivative with respect to time of the electronic representation of the first received pulse of light.
30. The lidar system of Aspect 28, wherein the processor is further configured to determine the distance to the target based at least in part on the time-of-arrival of the first received pulse of light, wherein: the time-of-arrival of the first received pulse of light corresponds to a round-trip time (ΔT) for light from the first emitted pulse of light to travel to the target and back to the lidar system; and the distance (D) to the target is determined from an expression D=c·ΔT/2, wherein c is a speed of light.
31. A method comprising: emitting, by a light source of a lidar system, local-oscillator (LO) light and pulses of light, the emitted pulses of light comprising a first emitted pulse of light, wherein an optical frequency of the first emitted pulse of light is offset from an optical frequency of the LO light by a first frequency offset, and emitting the LO light and the pulses of light comprises: producing, by a seed laser of the light source, seed light and the LO light; and amplifying, by an optical amplifier of the light source, temporal portions of the seed light to produce the emitted pulses of light; detecting, by a receiver of the lidar system, the LO light and a first received pulse of light, the first received pulse of light comprising light from the first emitted pulse of light scattered by a target located a distance from the lidar system, wherein the LO light and the first received pulse of light are coherently mixed together at the receiver to produce a corresponding photocurrent signal comprising an amplitude-modulation (AM) signal, and the receiver is configured to produce an output signal corresponding to the AM photocurrent signal; and determining, by a processor of the lidar system and based on the output signal, that the first received pulse of light is associated with the first emitted pulse of light.
32. A lidar system comprising: a light source configured to emit local-oscillator (LO) light and pulses of light, the emitted pulses of light comprising a first emitted pulse of light, wherein an optical frequency of the first emitted pulse of light is offset from an optical frequency of the LO light by a first frequency offset, and the light source comprises: a direct-emitter laser diode configured to produce the emitted pulses of light; and a local-oscillator laser diode configured to produce the LO light; a receiver configured to detect the LO light and a first received pulse of light, the first received pulse of light comprising light from the first emitted pulse of light scattered by a target located a distance from the lidar system, wherein the LO light and the first received pulse of light are coherently mixed together at the receiver to produce a corresponding photocurrent signal comprising an amplitude-modulation (AM) signal, and the receiver is configured to produce an output signal corresponding to the AM photocurrent signal; and a processor configured to determine, based on the output signal, that the first received pulse of light is associated with the first emitted pulse of light.

Various example aspects directed to another lidar system are described below.
1. A lidar system comprising: a light source configured to emit local-oscillator (LO) light and pulses of light, the emitted pulses of light comprising a first emitted pulse of light, wherein an optical frequency of the first emitted pulse of light is offset from an optical frequency of the LO light by a first frequency offset; a receiver configured to detect the LO light and a first received pulse of light, the first received pulse of light comprising light from the first emitted pulse of light scattered by a target located a distance from the lidar system, wherein the receiver comprises: a detector, wherein: the LO light and the first received pulse of light are coherently mixed together at the detector; and the detector is configured to produce a photocurrent signal corresponding to the coherent mixing of the LO light and the first received pulse of light, the photocurrent signal comprising an amplitude-modulation (AM) signal; and a detection circuit configured to receive the photocurrent signal and produce an output signal corresponding to the AM photocurrent signal; and a processor configured to determine, based on the output signal, that the first received pulse of light is associated with the first emitted pulse of light.
2. The lidar system of Aspect 1, wherein the AM photocurrent signal comprises a frequency component having a frequency of ΔF, wherein the frequency ΔF is related to the first frequency offset.
3. The lidar system of Aspect 2, wherein the frequency ΔF is related to the first frequency offset (Δf) by a Doppler frequency shift (F_{D}) that is proportional to a radial speed of the target with respect to the lidar system, wherein ΔF=|Δf+F_{D}|.
4. The lidar system of Aspect 2, wherein the AM photocurrent signal includes periodic pulsations separated by a time interval of 1/ΔF.
5. The lidar system of Aspect 2, wherein ΔF is greater than 1/Δt, wherein Δτ is a duration of the first emitted pulse of light.
6. The lidar system of Aspect 1, wherein the receiver further comprises an input optical filter configured to (i) transmit, to the detector, light over a particular optical pass-band that includes a wavelength of the first received pulse of light and (ii) substantially block light over one or more wavelength ranges outside of the optical pass-band.
7. The lidar system of Aspect 1, wherein the detection circuit comprises an electronic amplifier configured to amplify the photocurrent signal to produce a voltage signal corresponding to the photocurrent signal.
8. The lidar system of Aspect 1, wherein: the detection circuit comprises one or more frequency-detection channels, each frequency-detection channel configured to produce a portion of the output signal, wherein each output-signal portion corresponds to a particular frequency component of the photocurrent signal; and the processor is configured to determine that the first received pulse of light is associated with the first emitted pulse of light based on one or more amplitudes of the one or more output-signal portions.
9. The lidar system of Aspect 1, wherein: the detection circuit comprises N frequency-detection channels, wherein Nis an integer greater than or equal to 1; and each emitted pulse of light is offset from the optical frequency of the LO light by a particular frequency offset of N different frequency offsets, wherein each frequency offset is associated with one of the frequency-detection channels.
10. The lidar system of Aspect 1, wherein the detection circuit comprises one or more electronic filters, each filter having a pass-band width greater than or equal to 1.5×F_{D-MAX}, wherein F_{D-MAX} is a maximum expected Doppler shift of a received pulse of light associated with motion of the target with respect to the lidar system.
11. The lidar system of Aspect 1, wherein the detection circuit comprises one or more electronic rectification circuits, each rectification circuit configured to receive a voltage signal corresponding to the photocurrent signal and produce a rectified signal comprising a unipolar version of the received voltage signal.
12. The lidar system of Aspect 1, wherein the detection circuit comprises a low-pass or band-pass electronic filter configured to produce a signal representing the first received pulse of light, wherein the filter has an upper cutoff frequency greater than or equal to 1/Δτ, wherein Δτ is a duration of the first emitted pulse of light.
13. The lidar system of Aspect 1, wherein the detection circuit comprises one or more digitizers configured to produce the output signal.
14. The lidar system of Aspect 1, wherein the output signal comprises a digital representation of the AM photocurrent signal.
15. The lidar system of Aspect 14, wherein the processor is configured to produce a digital representation of the first received pulse of light based on the digital representation of the AM photocurrent signal, wherein producing the digital representation of the first received pulse of light comprises (i) rectifying the digital representation of the AM photocurrent signal to produce a rectified digital signal and (ii) low-pass filtering the rectified digital signal.
16. The lidar system of Aspect 1, wherein the output signal comprises a digital representation of the first received pulse of light.
17. The lidar system of Aspect 1, wherein the detector is one of a plurality of detectors, wherein the LO light and the first received pulse of light are coherently mixed together at one or more of the plurality of detectors, and each of the one or more detectors is configured to produce a photocurrent signal corresponding to coherent mixing of the LO light and the first received pulse of light.
18. The lidar system of Aspect 1, wherein an optical frequency of each emitted pulse of light is offset from the optical frequency of the LO light by a particular frequency offset of one or more different frequency offsets, the one or more different frequency offsets including the first frequency offset.
19. The lidar system of Aspect 18, wherein the detection circuit comprises one or more frequency-detection channels, wherein each frequency-detection channel (i) is associated with a particular one of the one or more different frequency offsets and (ii) comprises an electronic band-pass filter having a pass-band that includes the particular one of the frequency offsets.
20. The lidar system of Aspect 18, wherein the detection circuit comprises one or more frequency-detection channels, each frequency-detection channel configured to produce a portion of the output signal, wherein the output-signal portion produced by a particular frequency-detection channel is associated with a particular one of the one or more different frequency offsets.
21. The lidar system of Aspect 20, wherein: the detection circuit comprises a first frequency-detection channel and one or more other frequency-detection channels, wherein the first frequency-detection channel is configured to produce an output-signal portion associated with the first frequency offset; and the processor is configured to determine that the first received pulse of light is associated with the first emitted pulse of light based on an amplitude of the output-signal portion produced by the first frequency-detection channel being greater than an amplitude of each output-signal portion produced by the one or more other frequency-detection channels.
22. The lidar system of Aspect 1, wherein the detection circuit comprises: an electronic amplifier configured to amplify the photocurrent signal to produce a voltage signal corresponding to the photocurrent signal; and one or more frequency-detection channels, each frequency-detection channel configured to receive the voltage signal and produce a portion of the output signal, wherein each frequency-detection channel comprises an electronic band-pass filter configured to transmit a portion of the voltage signal located within a pass-band of the filter.
23. The lidar system of Aspect 22, wherein the output-signal portion produced by each frequency-detection channel corresponds to the transmitted portion of the voltage signal.
24. The lidar system of Aspect 22, wherein a first frequency-detection channel of the one or more frequency-detection channels comprises a first band-pass filter having a pass-band that includes the first frequency offset, wherein the first band-pass filter is configured to transmit at least a portion of the voltage signal corresponding to the AM photocurrent signal.
25. The lidar system of Aspect 24, wherein the first frequency-detection channel further comprises a first digitizer configured to produce a digitized signal corresponding to the transmitted portion of the voltage signal.
26. The lidar system of Aspect 25, wherein: the digitized signal produced by the first digitizer is part of the output signal produced by the detection circuit; and the processor is configured to produce a digital representation of the first received pulse of light based on the digitized signal, wherein producing the digital representation comprises (i) rectifying the digitized signal to produce a rectified digital signal and (ii) low-pass filtering the rectified digital signal.
27. The lidar system of Aspect 24, wherein the first frequency-detection channel further comprises: a rectification circuit configured to produce a rectified version of the transmitted portion of the voltage signal; a low-pass filter configured to receive the rectified signal and produce an analog voltage signal representing the first received pulse of light; and a digitizer configured to receive the analog voltage signal and produce a digital representation of the first received pulse of light.
28. The lidar system of Aspect 1, wherein the detection circuit comprises: an electronic amplifier configured to amplify the photocurrent signal to produce a voltage signal corresponding to the photocurrent signal; and a frequency-detection channel comprising a digitizer configured to produce a digitized signal corresponding to the voltage signal.
29. The lidar system of Aspect 1, wherein the detection circuit comprises one or more frequency-detection channels, each frequency-detection channel comprising: an electronic local-oscillator configured to produce an electronic local-oscillator signal having a particular oscillator frequency; an electronic mixer configured to mix a voltage signal corresponding to the photocurrent signal with the electronic local-oscillator signal to produce an intermediate-frequency signal; and an electronic filter configured to receive the intermediate-frequency signal and transmit a portion of the received intermediate-frequency signal located within a pass-band of the electronic filter.
30. The lidar system of Aspect 1, wherein the detection circuit comprises a frequency-detection channel comprising: an electronic local-oscillator configured to produce an electronic local-oscillator signal having a particular oscillator frequency; an electronic mixer configured to mix a voltage signal corresponding to the photocurrent signal with the electronic local-oscillator signal to produce an intermediate-frequency signal; and a digitizer configured to produce a digitized signal corresponding to the intermediate-frequency signal.
31. The lidar system of Aspect 1, wherein the detection circuit comprises: an electronic amplifier configured to amplify the photocurrent signal to produce a voltage signal corresponding to the photocurrent signal; and one or more frequency-detection channels, each frequency-detection channel configured to receive the voltage signal and produce a portion of the output signal, the output-signal portion comprising an in-phase portion and a quadrature portion, wherein each frequency-detection channel comprises: an in-phase channel configured to produce the in-phase portion of the output signal, the in-phase channel comprising: a first electronic mixer configured to mix the voltage signal with an electronic local-oscillator signal having a particular oscillator frequency to produce an in-phase intermediate-frequency signal; and a first electronic filter configured to transmit a portion of the in-phase intermediate-frequency signal located with a pass-band of the first electronic band-pass filter; and a quadrature channel configured to produce a quadrature portion of the output signal, the quadrature channel comprising: a second electronic mixer configured to mix the voltage signal with a phase-shifted version of the electronic local-oscillator signal to produce a quadrature intermediate-frequency signal; and a second electronic filter configured to transmit a portion of the quadrature intermediate-frequency signal located within a pass-band of the second electronic band-pass filter.
32. The lidar system of Aspect 1, wherein the receiver comprises an optical polarization element configured to: (i) convert a polarization of the LO light into circularly polarized light or (ii) depolarize the polarization of the local-oscillator light.
33. The lidar system of Aspect 1, wherein the AM photocurrent signal includes a coherent-mixing term that is proportional to a product of (i) an amplitude of an electric field of the first received pulse of light and (ii) an amplitude of an electric field of the LO light.
34. The lidar system of Aspect 1, wherein the light source comprises: a seed laser configured to produce seed light and the LO light; and an optical amplifier configured to amplify temporal portions of the seed light to produce the emitted pulses of light, wherein each amplified temporal portion of the seed light corresponds to one of the emitted pulses of light, and the optical amplifier comprises a semiconductor optical amplifier (SOA), a fiber-optic amplifier, or a SOA followed by a fiber-optic amplifier.
35. The lidar system of Aspect 1, wherein the light source comprises: a direct-emitter laser diode configured to produce the emitted pulses of light; and a local-oscillator laser diode configured to produce the LO light.
36. A method comprising: emitting, by a light source of a lidar system, local-oscillator (LO) light and pulses of light, the emitted pulses of light comprising a first emitted pulse of light, wherein an optical frequency of the first emitted pulse of light is offset from an optical frequency of the LO light by a first frequency offset; detecting, by a receiver of the lidar system, the LO light and a first received pulse of light, the first received pulse of light comprising light from the first emitted pulse of light scattered by a target located a distance from the lidar system, wherein detecting the LO light and the first received pulse of light comprises: producing, by a detector of the receiver, a photocurrent signal corresponding to coherent mixing of the LO light and the first received pulse of light, the photocurrent signal comprising an amplitude-modulation (AM) signal; and producing, by a detection circuit of the receiver, an output signal corresponding to the AM photocurrent signal; and determining, by a processor of the lidar system and based on the output signal, that the first received pulse of light is associated with the first emitted pulse of light.

Various example aspects directed to another lidar system are described below.
1. A lidar system comprising: a light source configured to emit local-oscillator (LO) light and pulses of light, the emitted pulses of light comprising a first emitted pulse of light, wherein an optical frequency of the first emitted pulse of light is offset from an optical frequency of the LO light by a first frequency offset; a receiver configured to detect the LO light and a first received pulse of light, the first received pulse of light comprising light from the first emitted pulse of light scattered by a target located a distance from the lidar system, wherein the receiver comprises: a detector, wherein: the LO light and the first received pulse of light are coherently mixed together at the detector; and the detector is configured to produce a photocurrent signal corresponding to the coherent mixing of the LO light and the first received pulse of light, the photocurrent signal comprising an amplitude-modulation (AM) signal; and a detection circuit configured to receive the photocurrent signal and produce an output signal corresponding to the AM photocurrent signal, wherein the detection circuit comprises: an electronic amplifier configured to amplify the photocurrent signal to produce a voltage signal corresponding to the photocurrent signal; and one or more frequency-detection channels, each frequency-detection channel configured to receive the voltage signal and produce a portion of the output signal, wherein each frequency-detection channel comprises: an electronic local oscillator configured to produce an electronic local-oscillator signal having a particular oscillator frequency; an electronic mixer configured to mix the voltage signal with the electronic local-oscillator signal to produce an intermediate-frequency signal; and an electronic filter configured to transmit a portion of the intermediate-frequency signal located within a pass-band of the electronic filter; and a processor configured to determine, based on the output signal, that the first received pulse of light is associated with the first emitted pulse of light.
2. The lidar system of Aspect 1, wherein the processor is configured to determine that the first received pulse of light is associated with the first emitted pulse of light based on one or more amplitudes of the one or more output-signal portions produced by the one or more frequency-detection channels.
3. The lidar system of Aspect 1, wherein: the one or more frequency-detection channels comprise a first frequency-detection channel and one or more other frequency-detection channels, wherein the first frequency-detection channel is configured to produce an output-signal portion associated with the first frequency offset; and the processor is configured to determine that the first received pulse of light is associated with the first emitted pulse of light based on an amplitude of the output-signal portion produced by the first frequency-detection channel being greater than an amplitude of each output-signal portion produced by the one or more other frequency-detection channels.
4. The lidar system of Aspect 1, wherein each frequency-detection channel further comprises a digitizer configured to produce a digitized signal corresponding to the transmitted portion of the intermediate-frequency signal, wherein the output signal produced by the detection circuit comprises one or more digitized signals produced by the one or more respective frequency-detection channels.
5. The lidar system of Aspect 4, wherein: a first frequency-detection channel produces a first digitized signal; and the processor is configured to produce a digital representation of the first received pulse of light based on the first digitized signal, wherein producing the digital representation comprises (i) rectifying the first digitized signal to produce a rectified digital signal and (ii) low-pass filtering the rectified digital signal.
6. The lidar system of Aspect 1, wherein each frequency-detection channel further comprises: a rectification circuit configured to produce a rectified version of the transmitted portion of the intermediate-frequency signal; a low-pass filter configured to receive the rectified signal and produce a corresponding analog voltage signal; and a digitizer configured to receive the analog voltage signal and produce a corresponding digitized signal.
7. The lidar system of Aspect 6, wherein: an analog voltage signal produced by a first frequency-detection channel comprises an analog representation of the first received pulse of light; and the corresponding digitized signal produced by the first frequency-detection channel comprises a digital representation of the first received pulse of light.
8. The lidar system of Aspect 1, wherein: the optical frequency of the first emitted pulse of light is f₁; the optical frequency of the LO light is f₀; the first frequency offset is Δf, wherein Δf=f₁−f₀; and a first frequency-detection channel associated with the first emitted pulse of light comprises: an electronic local oscillator configured to produce an electronic local-oscillator signal with an oscillator frequency of F_{LO}; and an electronic filter having a pass-band that includes a frequency ||Δf|−F_{LO}|.
9. The lidar system of Aspect 8, wherein: the AM photocurrent signal comprises a frequency component having a frequency of ΔF; and the intermediate-frequency signal produced by the electronic mixer of the first frequency-detection channel comprises a frequency component having a frequency of |ΔF−F_{LO}|.
10. The lidar system of Aspect 9, wherein the frequency component corresponds to periodic pulsations in the AM photocurrent signal, the pulsations separated by a time interval of 1/ΔF, wherein ΔF is greater than 1/Δτ, and Δτ is a duration of the first emitted pulse of light.
11. The lidar system of Aspect 9, wherein the frequency ΔF is related to the first frequency offset Δf by a Doppler frequency shift (F_{D}) that is proportional to a radial speed of the target with respect to the lidar system, wherein ΔF=|Δf+F_{D}|.
12. The lidar system of Aspect 8, wherein: F_{D-MAX} is a maximum expected Doppler shift of the first received pulse of light associated with motion of the target with respect to the lidar system; and the electronic filter pass-band further includes frequencies between approximately

$$\vert \vert Δ f - \frac{1}{2} {F}_{D - MAX} \vert - {F}_{LO} \vert$$

and approximately

$$\vert \vert Δ f - \frac{1}{2} {F}_{D - MAX} \vert - {F}_{LO} \vert .$$

13. The lidar system of Aspect 1, wherein: the oscillator frequency of the electronic local oscillator is adjustable to a plurality of different oscillator frequencies; and the processor is further configured to instruct the electronic local oscillator to produce an electronic local-oscillator signal having one frequency of the plurality of different oscillator frequencies.
14. The lidar system of Aspect 13, wherein the electronic local-oscillator comprises one electronic oscillator configured to switch between the plurality of different oscillator frequencies.
15. The lidar system of Aspect 13, wherein the electronic local-oscillator comprises a plurality of electronic oscillators, each electronic oscillator configured to produce one of the plurality of different oscillator frequencies.
16. The lidar system of Aspect 13, wherein: an optical frequency of each emitted pulse of light is offset from the optical frequency of the LO light by a frequency offset of Δf, wherein Δf is a particular frequency offset of one or more different frequency offsets, the one or more different frequency offsets including the first frequency offset; and the processor is further configured to: select the particular frequency offset of each emitted pulse of light; and select the particular oscillator frequency of a particular frequency-detection channel in accordance with the selected particular frequency offset.
17. The lidar system of Aspect 16, wherein: the optical frequency of the first emitted pulse of light is f₁; the optical frequency of the LO light is f₀; the first frequency offset is Δf₁, wherein Δf₁=f₁−f₀; and a first frequency-detection channel comprises a first electronic filter and an electronic local oscillator configured to produce an electronic local-oscillator signal with an oscillator frequency of F_{LO}, wherein the processor is configured to select the oscillator frequency so that ||Δf₁|−F_{LO}| is within a pass-band of the first electronic filter.
18. The lidar system of Aspect 17, wherein the processor is further configured to: select a second frequency offset of Δf₂ for a second emitted pulse of light, wherein an optical frequency of the second emitted pulse of light is f₂=f₀+Δf₂; and select the oscillator frequency F_{LO} of the first frequency-detection channel so that ||Δf₂|−F_{LO}| is within the pass-band of the first electronic filter.
19. The lidar system of Aspect 1, wherein: the detection circuit comprises a first frequency-detection channel that is associated with m of the different frequency offsets, wherein m is an integer greater than or equal to 2; and an electronic local oscillator of the first frequency-detection channel is configured to produce m different oscillator frequencies, each oscillator frequency associated with one of the m frequency offsets.
20. The lidar system of Aspect 1, wherein: the detection circuit comprises N frequency-detection channels, wherein Nis an integer greater than or equal to 1; each emitted pulse of light is offset from the optical frequency of the LO light by a particular frequency offset of m×N different frequency offsets, wherein m is an integer greater than or equal to 2.
21. The lidar system of Aspect 20, wherein: each frequency-detection channel is associated with m of the m×N different frequency offsets; and the electronic local oscillator of each frequency-detection channel is configured to produce m different oscillator frequencies, each oscillator frequency associated with one of the m frequency offsets.
22. The lidar system of Aspect 1, wherein the electronic filter is an adjustable-frequency electronic filter that is adjustable to a plurality of different center frequencies.
23. The lidar system of Aspect 1, wherein: the portion of the output signal produced by each frequency-detection channel comprises an in-phase portion and a quadrature portion; and each frequency-detection channel comprises: an in-phase channel configured to produce the in-phase portion of the output signal, wherein: the electronic mixer is a first electronic mixer and is part of the in-phase channel, wherein the intermediate-frequency signal produced by the first electronic mixer is an in-phase intermediate-frequency signal; and the electronic filter is a first electronic filter and is part of the in-phase channel, wherein the first electronic filter is configured to transmit a portion of the in-phase intermediate-frequency signal; and a quadrature channel configured to produce the quadrature portion of the output signal, the quadrature channel comprising: a second electronic mixer configured to mix the voltage signal with a phase-shifted version of the electronic local-oscillator signal to produce a quadrature intermediate-frequency signal; and a second electronic filter configured to transmit a portion of the quadrature intermediate-frequency signal located within a pass-band of the second electronic band-pass filter.
24. The lidar system of Aspect 1, wherein the output-signal portion produced by each frequency-detection channel corresponds to the portion of the intermediate-frequency signal transmitted by the electronic filter.
25. The lidar system of Aspect 1, wherein the AM photocurrent signal includes a coherent-mixing term that is proportional to a product of (i) an amplitude of an electric field of the first received pulse of light and (ii) an amplitude of an electric field of the LO light.
26. The lidar system of Aspect 1, wherein an optical frequency of each emitted pulse of light is offset from the optical frequency of the LO light by a particular frequency offset of one or more different frequency offsets, the one or more different frequency offsets including the first frequency offset.
27. The lidar system of Aspect 1, wherein the light source comprises: a seed laser configured to produce seed light and the LO light; and an optical amplifier configured to amplify temporal portions of the seed light to produce the emitted pulses of light, wherein each amplified temporal portion of the seed light corresponds to one of the emitted pulses of light, and the optical amplifier comprises a semiconductor optical amplifier (SOA), a fiber-optic amplifier, or a SOA followed by a fiber-optic amplifier.
28. A method comprising: emitting, by a light source of a lidar system, local-oscillator (LO) light and pulses of light, the emitted pulses of light comprising a first emitted pulse of light, wherein an optical frequency of the first emitted pulse of light is offset from an optical frequency of the LO light by a first frequency offset; detecting, by a receiver of the lidar system, the LO light and a first received pulse of light, the first received pulse of light comprising light from the first emitted pulse of light scattered by a target located a distance from the lidar system, wherein detecting the LO light and the first received pulse of light comprises: producing, by a detector of the receiver, a photocurrent signal corresponding to coherent mixing of the LO light and the first received pulse of light, the photocurrent signal comprising an amplitude-modulation (AM) signal; and producing, by a detection circuit of the receiver, an output signal corresponding to the AM photocurrent signal, wherein producing the output signal comprises: amplifying, by an electronic amplifier of the detection circuit, the photocurrent signal to produce a voltage signal corresponding to the photocurrent signal; and producing, by each frequency-detection channel of one or more frequency-detection channels of the detection circuit, a portion of the output signal, wherein each frequency-detection channel comprises: an electronic local oscillator configured to produce an electronic local-oscillator signal having a particular oscillator frequency; an electronic mixer configured to mix the voltage signal with the electronic local-oscillator signal to produce an intermediate-frequency signal; and an electronic filter configured to transmit a portion of the intermediate-frequency signal located within a pass-band of the electronic filter; and determining, by a processor of the lidar system and based on the output signal, that the first received pulse of light is associated with the first emitted pulse of light.
29. A lidar system comprising: a light source configured to emit local-oscillator (LO) light and pulses of light, the emitted pulses of light comprising a first emitted pulse of light, wherein an optical frequency of the first emitted pulse of light is offset from an optical frequency of the LO light by a first frequency offset; a receiver configured to detect the LO light and a first received pulse of light, the first received pulse of light comprising light from the first emitted pulse of light scattered by a target located a distance from the lidar system, wherein the receiver comprises: a detector, wherein: the LO light and the first received pulse of light are coherently mixed together at the detector; and the detector is configured to produce a photocurrent signal corresponding to the coherent mixing of the LO light and the first received pulse of light, the photocurrent signal comprising an amplitude-modulation (AM) signal; and a detection circuit configured to receive the photocurrent signal and produce an output signal corresponding to the AM photocurrent signal, wherein the detection circuit comprises: an electronic amplifier configured to amplify the photocurrent signal to produce a voltage signal corresponding to the photocurrent signal; and one or more frequency-detection channels, each frequency-detection channel configured to receive the voltage signal and produce a portion of the output signal, wherein each frequency-detection channel comprises: an electronic local oscillator configured to produce an electronic local-oscillator signal having a particular oscillator frequency; an electronic mixer configured to mix the voltage signal with the electronic local-oscillator signal to produce an intermediate-frequency signal; and a digitizer configured to produce a digitized signal corresponding to the intermediate-frequency signal; and a processor configured to determine, based on the output signal, that the first received pulse of light is associated with the first emitted pulse of light.

Various example aspects directed to another lidar system are described below.
1. A lidar system comprising: a light source configured to emit local-oscillator (LO) light and pulses of light, the emitted pulses of light comprising a first emitted pulse of light, wherein an optical frequency of the first emitted pulse of light is offset from an optical frequency of the LO light by a first frequency offset; a receiver configured to detect the LO light and a first received pulse of light, the first received pulse of light comprising light from the first emitted pulse of light scattered by a target located a distance from the lidar system, wherein the receiver comprises: a detector, wherein: the LO light and the first received pulse of light are coherently mixed together at the detector; and the detector is configured to produce a photocurrent signal corresponding to the coherent mixing of the LO light and the first received pulse of light, the photocurrent signal comprising an amplitude-modulation (AM) signal, wherein the AM photocurrent signal comprises a frequency component having a frequency of ΔF, wherein the frequency ΔF is related to the first frequency offset; and a detection circuit configured to receive the photocurrent signal and produce an output signal corresponding to the AM photocurrent signal; and a processor configured to determine, based on the output signal, that the first received pulse of light is associated with the first emitted pulse of light.
2. The lidar system of Aspect 1, wherein when the target is approximately stationary with respect to the lidar system, the frequency ΔF is approximately equal to |Δf|, wherein Δf is the first frequency offset.
3. The lidar system of Aspect 1, wherein the frequency ΔF is related to the first frequency offset (Δf) by a Doppler frequency shift (F_{D}) that is proportional to a radial speed of the target with respect to the lidar system, wherein ΔF=|Δf+F_{D}|.
4. The lidar system of Aspect 3, wherein the Doppler frequency shift F_{D} equals 2Sᵣ/λ, wherein Sᵣ is the radial speed of the target with respect to the lidar system, and λ is a wavelength of the first emitted pulse of light.
5. The lidar system of Aspect 1, wherein the frequency ΔF of the AM photocurrent signal is between approximately |Δf−F_{D-MAX}| and approximately |Δf+F_{D-MAX}|, wherein Δf is the first frequency offset, and F_{D-MAX} is a maximum expected Doppler shift of the received pulse of light associated with motion of the target with respect to the lidar system.
6. The lidar system of Aspect 1, wherein the detection circuit comprises one or more electronic filters, each filter having a pass-band width greater than or equal to 1.5×F_{D-MAX}, wherein F_{D-MAX} is a maximum expected Doppler shift of a received pulse of light associated with motion of the target with respect to the lidar system.
7. The lidar system of Aspect 6, wherein the maximum expected Doppler shift of a received pulse of light is between approximately 30 MHz and approximately 150 MHZ.
8. The lidar system of Aspect 6, wherein the pass-band width is between approximately 50 MHz and approximately 500 MHZ.
9. The lidar system of Aspect 1, wherein the processor is configured to determine that the first received pulse of light is associated with the first emitted pulse of light based on a frequency of the AM photocurrent signal matching the first frequency offset between the first emitted pulse of light and the optical frequency of the LO light, wherein: the frequency of the AM photocurrent signal matching the first frequency offset corresponds to the frequency of the AM photocurrent signal being within a particular threshold value of the first frequency offset; and the particular threshold value depends at least in part on a maximum expected Doppler shift of the received pulse of light associated with motion of the target with respect to the lidar system.
10. The lidar system of Aspect 1, wherein the AM photocurrent signal includes periodic pulsations separated by a time interval of 1/ΔF, wherein ΔF is greater than 1/Δτ, and Δτ is a duration of the first emitted pulse of light.
11. The lidar system of Aspect 1, wherein the detection circuit comprises: an electronic amplifier configured to amplify the photocurrent signal to produce a voltage signal corresponding to the photocurrent signal; and one or more frequency-detection channels, each frequency-detection channel configured to receive the voltage signal and produce a portion of the output signal, wherein each output-signal portion corresponds to a particular frequency component of the photocurrent signal.
12. The lidar system of Aspect 11, wherein the processor is configured to determine that the first received pulse of light is associated with the first emitted pulse of light based on one or more amplitudes of the one or more output-signal portions.
13. The lidar system of Aspect 11, wherein each frequency-detection channel comprises an electronic filter having a pass-band width greater than or equal to 1.5×F_{D-MAX}, wherein F_{D-MAX} is a maximum expected Doppler shift of a received pulse of light associated with motion of the target with respect to the lidar system.
14. The lidar system of Aspect 1, wherein the AM photocurrent signal includes a coherent-mixing term that is proportional to a product of (i) an amplitude of an electric field of the first received pulse of light and (ii) an amplitude of an electric field of the LO light.
15. The lidar system of Aspect 1, wherein an optical frequency of each emitted pulse of light is offset from the optical frequency of the LO light by a particular frequency offset of one or more different frequency offsets, the one or more different frequency offsets including the first frequency offset.
16. The lidar system of Aspect 15, wherein each of the different frequency offsets is a fixed frequency offset.
17. The lidar system of Aspect 1, wherein the light source comprises: a seed laser configured to produce seed light and the LO light; and an optical amplifier configured to amplify temporal portions of the seed light to produce the emitted pulses of light, wherein each amplified temporal portion of the seed light corresponds to one of the emitted pulses of light, and the optical amplifier comprises a semiconductor optical amplifier (SOA), a fiber-optic amplifier, or a SOA followed by a fiber-optic amplifier.
18. The lidar system of Aspect 1, wherein the emitted pulses of light have optical characteristics comprising: one or more wavelengths between 900 nanometers (nm) and 1700 nm; a pulse energy between 0.01 μJ and 100 μJ; a pulse repetition frequency between 80 kHz and 10 MHz; and a pulse duration between 1 ns and 100 ns.
19. The lidar system of Aspect 1, further comprising a scanner configured to scan the emitted pulses of light across a field of regard of the lidar system.
20. A method comprising: emitting, by a light source of a lidar system, local-oscillator (LO) light and pulses of light, the emitted pulses of light comprising a first emitted pulse of light, wherein an optical frequency of the first emitted pulse of light is offset from an optical frequency of the LO light by a first frequency offset; detecting, by a receiver of the lidar system, the LO light and a first received pulse of light, the first received pulse of light comprising light from the first emitted pulse of light scattered by a target located a distance from the lidar system, wherein detecting the LO light and the first received pulse of light comprises: producing, by a detector of the receiver, a photocurrent signal corresponding to coherent mixing of the LO light and the first received pulse of light, the photocurrent signal comprising an amplitude-modulation (AM) signal, wherein the AM photocurrent signal comprises a frequency component having a frequency of ΔF, wherein the frequency ΔF is related to the first frequency offset; and producing, by a detection circuit of the receiver, an output signal corresponding to the AM photocurrent signal; and determining, by a processor of the lidar system and based on the output signal, that the first received pulse of light is associated with the first emitted pulse of light.

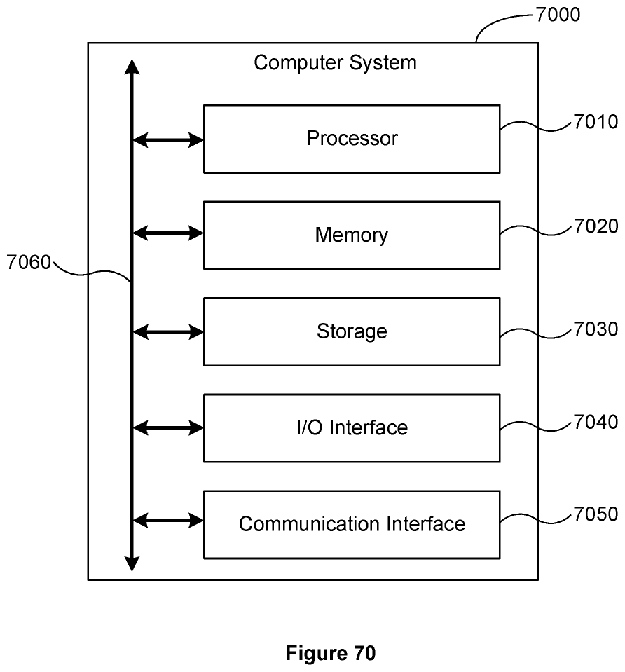

FIG. 70 illustrates an example computer system 7000. One or more computer systems 7000 may perform one or more steps of one or more methods described or illustrated herein. One or more computer systems 7000 may provide functionality described or illustrated herein. Software running on one or more computer systems 7000 may perform one or more steps of one or more methods described or illustrated herein or may provide functionality described or illustrated herein. A computer system may be referred to as a processor, a controller, a computing device, a computing system, a computer, a general-purpose computer, or a data-processing apparatus. For example, controller 150 in FIG. 1 may be referred to or may include a computer system. Herein, reference to a computer system may encompass one or more computer systems, where appropriate.

Computer system 7000 may take any suitable physical form. As an example, computer system 7000 may be an embedded computer system, a system-on-chip (SOC), an application-specific integrated circuit (ASIC), a field-programmable gate array (FPGA), a single-board computer system (SBC), a desktop computer system, a laptop or notebook computer system, a mainframe, a mesh of computer systems, a server, a tablet computer system, or any suitable combination of two or more of these. As another example, all or part of computer system 7000 may be combined with, coupled to, or integrated into a variety of devices, including, but not limited to, a camera, camcorder, personal digital assistant (PDA), mobile telephone, smartphone, electronic reading device (e.g., an e-reader), game console, smart watch, clock, calculator, television monitor, flat-panel display, computer monitor, vehicle display (e.g., odometer display or dashboard display), vehicle navigation system, lidar system, ADAS, autonomous vehicle, autonomous-vehicle driving system, cockpit control, camera view display (e.g., display of a rear-view camera in a vehicle), eyewear, or head-mounted display. Where appropriate, computer system 7000 may include one or more computer systems 7000; be unitary or distributed; span multiple locations; span multiple machines; span multiple data centers; or reside in a cloud, which may include one or more cloud components in one or more networks. Where appropriate, one or more computer systems 7000 may perform without substantial spatial or temporal limitation one or more steps of one or more methods described or illustrated herein. As an example, one or more computer systems 7000 may perform in real time or in batch mode one or more steps of one or more methods described or illustrated herein. One or more computer systems 7000 may perform at different times or at different locations one or more steps of one or more methods described or illustrated herein, where appropriate.

As illustrated in the example of FIG. 70, computer system 7000 may include a processor 7010, memory 7020, storage 7030, an input/output (I/O) interface 7040, a communication interface 7050, or a bus 7060. Computer system 7000 may include any suitable number of any suitable components in any suitable arrangement.

Processor 7010 may include hardware for executing instructions, such as those making up a computer program. As an example, to execute instructions, processor 7010 may retrieve (or fetch) the instructions from an internal register, an internal cache, memory 7020, or storage 7030; decode and execute them; and then write one or more results to an internal register, an internal cache, memory 7020, or storage 7030. A processor 7010 may include one or more internal caches for data, instructions, or addresses. Processor 7010 may include any suitable number of any suitable internal caches, where appropriate. As an example, processor 7010 may include one or more instruction caches, one or more data caches, or one or more translation lookaside buffers (TLBs). Instructions in the instruction caches may be copies of instructions in memory 7020 or storage 7030, and the instruction caches may speed up retrieval of those instructions by processor 7010. Data in the data caches may be copies of data in memory 7020 or storage 7030 for instructions executing at processor 7010 to operate on; the results of previous instructions executed at processor 7010 for access by subsequent instructions executing at processor 7010 or for writing to memory 7020 or storage 7030; or other suitable data. The data caches may speed up read or write operations by processor 7010. The TLBs may speed up virtual-address translation for processor 7010. Processor 7010 may include one or more internal registers for data, instructions, or addresses. Processor 7010 may include any suitable number of any suitable internal registers, where appropriate. Where appropriate, processor 7010 may include one or more arithmetic logic units (ALUs); may be a multi-core processor; or may include one or more processors 7010.

Memory 7020 may include main memory for storing instructions for processor 7010 to execute or data for processor 7010 to operate on. As an example, computer system 7000 may load instructions from storage 7030 or another source (such as, for example, another computer system 7000) to memory 7020. Processor 7010 may then load the instructions from memory 7020 to an internal register or internal cache. To execute the instructions, processor 7010 may retrieve the instructions from the internal register or internal cache and decode them. During or after execution of the instructions, processor 7010 may write one or more results (which may be intermediate or final results) to the internal register or internal cache. Processor 7010 may then write one or more of those results to memory 7020. One or more memory buses (which may each include an address bus and a data bus) may couple processor 7010 to memory 7020. Bus 7060 may include one or more memory buses. One or more memory management units (MMUs) may reside between processor 7010 and memory 7020 and facilitate accesses to memory 7020 requested by processor 7010. Memory 7020 may include random access memory (RAM). This RAM may be volatile memory, where appropriate. Where appropriate, this RAM may be dynamic RAM (DRAM) or static RAM (SRAM). Memory 7020 may include one or more memories 7020, where appropriate.

Storage 7030 may include mass storage for data or instructions. As an example, storage 7030 may include a hard disk drive (HDD), a floppy disk drive, flash memory, an optical disc, a magneto-optical disc, magnetic tape, or a Universal Serial Bus (USB) drive or a combination of two or more of these. Storage 7030 may include removable or non-removable (or fixed) media, where appropriate. Storage 7030 may be internal or external to computer system 7000, where appropriate. Storage 7030 may be non-volatile, solid-state memory. Storage 7030 may include read-only memory (ROM). Where appropriate, this ROM may be mask ROM (MROM), programmable ROM (PROM), erasable PROM (EPROM), electrically erasable PROM (EEPROM), flash memory, or a combination of two or more of these. Storage 7030 may include one or more storage control units facilitating communication between processor 7010 and storage 7030, where appropriate. Where appropriate, storage 7030 may include one or more storages 7030.

I/O interface 7040 may include hardware, software, or both, providing one or more interfaces for communication between computer system 7000 and one or more I/O devices. Computer system 7000 may include one or more of these I/O devices, where appropriate. One or more of these I/O devices may enable communication between a person and computer system 7000. As an example, an I/O device may include a keyboard, keypad, microphone, monitor, mouse, printer, scanner, speaker, camera, stylus, tablet, touch screen, trackball, another suitable I/O device, or any suitable combination of two or more of these. An I/O device may include one or more sensors. Where appropriate, I/O interface 7040 may include one or more device or software drivers enabling processor 7010 to drive one or more of these I/O devices. I/O interface 7040 may include one or more I/O interfaces 7040, where appropriate.

Communication interface 7050 may include hardware, software, or both providing one or more interfaces for communication (such as, for example, packet-based communication) between computer system 7000 and one or more other computer systems 7000 or one or more networks. As an example, communication interface 7050 may include a network interface controller (NIC) or network adapter for communicating with an Ethernet or other wire-based network or a wireless NIC (WNIC); a wireless adapter for communicating with a wireless network, such as a WI-FI network; or an optical transmitter (e.g., a laser or a light-emitting diode) or an optical receiver (e.g., a photodetector) for communicating using fiber-optic communication or free-space optical communication. Computer system 7000 may communicate with an ad hoc network, a personal area network (PAN), an in-vehicle network (IVN), a local area network (LAN), a wide area network (WAN), a metropolitan area network (MAN), or one or more portions of the Internet or a combination of two or more of these. One or more portions of one or more of these networks may be wired or wireless. As an example, computer system 7000 may communicate with a wireless PAN (WPAN) (such as, for example, a BLUETOOTH WPAN), a WI-FI network, a Worldwide Interoperability for Microwave Access (WiMAX) network, a cellular telephone network (such as, for example, a Global System for Mobile Communications (GSM) network), or other suitable wireless network or a combination of two or more of these. As another example, computer system 7000 may communicate using fiber-optic communication based on 100 Gigabit Ethernet (100 GbE), 10 Gigabit Ethernet (10 GbE), or Synchronous Optical Networking (SONET). Computer system 7000 may include any suitable communication interface 7050 for any of these networks, where appropriate. Communication interface 7050 may include one or more communication interfaces 7050, where appropriate.

Bus 7060 may include hardware, software, or both coupling components of computer system 7000 to each other. As an example, bus 7060 may include an Accelerated Graphics Port (AGP) or other graphics bus, a controller area network (CAN) bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local bus (VLB), or another suitable bus or a combination of two or more of these. Bus 7060 may include one or more buses 7060, where appropriate.

Various modules, circuits, systems, methods, or algorithm steps described in connection with the implementations disclosed herein may be implemented as electronic hardware, computer software, or any suitable combination of hardware and software. Computer software (which may be referred to as software, computer-executable code, computer code, a computer program, computer instructions, or instructions) may be used to perform various functions described or illustrated herein, and computer software may be configured to be executed by or to control the operation of computer system 7000. As an example, computer software may include instructions configured to be executed by processor 7010. Owing to the interchangeability of hardware and software, the various illustrative logical blocks, modules, circuits, or algorithm steps have been described generally in terms of functionality. Whether such functionality is implemented in hardware, software, or a combination of hardware and software may depend upon the particular application or design constraints imposed on the overall system.

A computing device may be used to implement various modules, circuits, systems, methods, or algorithm steps disclosed herein. As an example, all or part of a module, circuit, system, method, or algorithm disclosed herein may be implemented or performed by a general-purpose single- or multi-chip processor, a digital signal processor (DSP), an ASIC, a FPGA, any other suitable programmable-logic device, discrete gate or transistor logic, discrete hardware components, or any suitable combination thereof. A general-purpose processor may be a microprocessor, or, any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

One or more implementations of the subject matter described herein may be implemented as one or more computer programs (e.g., one or more modules of computer-program instructions encoded or stored on a computer-readable non-transitory storage medium). As an example, the steps of a method or algorithm disclosed herein may be implemented in a processor-executable software module which may reside on a computer-readable non-transitory storage medium. A computer-readable non-transitory storage medium may include any suitable storage medium that may be used to store or transfer computer software and that may be accessed by a computer system. Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs (e.g., compact discs (CDs), CD-ROM, digital versatile discs (DVDs), Blu-ray discs, or laser discs), optical disc drives (ODDs), magneto-optical discs, magneto-optical drives, floppy diskettes, floppy disk drives (FDDs), magnetic tapes, flash memories, solid-state drives (SSDs), RAM, RAM-drives, ROM, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Certain features described herein in the context of separate implementations may also be combined and implemented in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

While operations may be depicted in the drawings as occurring in a particular order, this should not be understood as requiring that such operations be performed in the particular order shown or in sequential order, or that all operations be performed. Further, the drawings may schematically depict one more example processes or methods in the form of a flow diagram or a sequence diagram. However, other operations that are not depicted may be incorporated in the example processes or methods that are schematically illustrated. For example, one or more additional operations may be performed before, after, simultaneously with, or between any of the illustrated operations. Moreover, one or more operations depicted in a diagram may be repeated, where appropriate. Additionally, operations depicted in a diagram may be performed in any suitable order. Furthermore, although particular components, devices, or systems are described herein as carrying out particular operations, any suitable combination of any suitable components, devices, or systems may be used to carry out any suitable operation or combination of operations. In certain circumstances, multitasking or parallel processing operations may be performed. Moreover, the separation of various system components in the implementations described herein should not be understood as requiring such separation in all implementations, and it should be understood that the described program components and systems may be integrated together in a single software product or packaged into multiple software products.

Various embodiments have been described in connection with the accompanying drawings. However, it should be understood that the figures may not necessarily be drawn to scale. As an example, distances or angles depicted in the figures are illustrative and may not necessarily bear an exact relationship to actual dimensions or layout of the devices illustrated.

One or more of the figures described herein may include example data that is prophetic. For example, the example graphs illustrated one or more of FIGS. 22-27, 35, 36, 40-42, 45-51, 54A, 54B, 56, 60-68 may include or may be referred to as prophetic examples.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes or illustrates respective embodiments herein as including particular components, elements, functions, operations, or steps, any of these embodiments may include any combination or permutation of any of the components, elements, functions, operations, or steps described or illustrated anywhere herein that a person having ordinary skill in the art would comprehend.

The term “or” as used herein is to be interpreted as an inclusive or meaning any one or any combination, unless expressly indicated otherwise or indicated otherwise by context. Therefore, herein, the expression “A or B” means “A, B, or both A and B.” As another example, herein, “A, B or C” means at least one of the following: A; B; C; A and B; A and C; B and C; A, B and C. An exception to this definition will occur if a combination of elements, devices, steps, or operations is in some way inherently mutually exclusive.

As used herein, words of approximation such as, without limitation, “approximately, “substantially,” or “about” refer to a condition that when so modified is understood to not necessarily be absolute or perfect but would be considered close enough to those of ordinary skill in the art to warrant designating the condition as being present. The extent to which the description may vary will depend on how great a change can be instituted and still have one of ordinary skill in the art recognize the modified feature as having the required characteristics or capabilities of the unmodified feature. In general, but subject to the preceding discussion, a numerical value herein that is modified by a word of approximation such as “approximately” may vary from the stated value by ±0.5%, ±1%, ±2%, ±3%, ±4%, ±5%, ±10%, ±12%, or ±15%. The term “substantially constant” refers to a value that varies by less than a particular amount over any suitable time interval. For example, a value that is substantially constant may vary by less than or equal to 20%, 10%, 1%, 0.5%, or 0.1% over a time interval of approximately 10⁴ s, 10³ s, 10² s, 10 s, 1 s, 100 ms, 10 ms, 1 ms, 100 μs, 10 μs, or 1 μs. The term “substantially constant” may be applied to any suitable value, such as for example, an optical power, a pulse repetition frequency, an electrical current, a wavelength, an optical or electrical frequency, or an optical or electrical phase.

As used herein, the terms “first,” “second,” “third,” etc. may be used as labels for nouns that they precede, and these terms may not necessarily imply a particular ordering (e.g., a particular spatial, temporal, or logical ordering). As an example, a system may be described as determining a “first result” and a “second result,” and the terms “first” and “second” may not necessarily imply that the first result is determined before the second result.

As used herein, the terms “based on” and “based at least in part on” may be used to describe or present one or more factors that affect a determination, and these terms may not exclude additional factors that may affect a determination. A determination may be based solely on those factors which are presented or may be based at least in part on those factors. The phrase “determine A based on B” indicates that B is a factor that affects the determination of A. In some instances, other factors may also contribute to the determination of A. In other instances, A may be determined based solely on B.

What is claimed is:

1. A lidar system comprising:
a light source configured to emit local-oscillator (LO) light and pulses of light, the emitted pulses of light comprising a first emitted pulse of light, wherein an optical frequency of the first emitted pulse of light is offset from an optical frequency of the LO light by a first frequency offset;
a receiver configured to detect the LO light and a first received pulse of light, the first received pulse of light comprising light from the first emitted pulse of light scattered by a target located a distance from the lidar system, wherein the receiver comprises:
a detector, wherein:
the LO light and the first received pulse of light are coherently mixed together at the detector; and
the detector is configured to produce a photocurrent signal corresponding to the coherent mixing of the LO light and the first received pulse of light, the photocurrent signal comprising an amplitude-modulation (AM) signal; and
a detection circuit configured to receive the photocurrent signal and produce an output signal corresponding to the AM photocurrent signal, wherein the detection circuit comprises:
an electronic amplifier configured to amplify the photocurrent signal to produce a voltage signal corresponding to the photocurrent signal; and
one or more frequency-detection channels, each frequency-detection channel configured to receive the voltage signal and produce a portion of the output signal, wherein each frequency-detection channel comprises:
an electronic local oscillator configured to produce an electronic local-oscillator signal having a particular oscillator frequency;
an electronic mixer configured to mix the voltage signal with the electronic local-oscillator signal to produce an intermediate-frequency signal; and
an electronic filter configured to transmit a portion of the intermediate-frequency signal located within a pass-band of the electronic filter; and
a processor configured to determine, based on the output signal, that the first received pulse of light is associated with the first emitted pulse of light.

2. The lidar system of claim 1, wherein the processor is configured to determine that the first received pulse of light is associated with the first emitted pulse of light based on one or more amplitudes of the one or more output-signal portions produced by the one or more frequency-detection channels.

3. The lidar system of claim 1, wherein:
the one or more frequency-detection channels comprise a first frequency-detection channel and one or more other frequency-detection channels, wherein the first frequency-detection channel is configured to produce an output-signal portion associated with the first frequency offset; and
the processor is configured to determine that the first received pulse of light is associated with the first emitted pulse of light based on an amplitude of the output-signal portion produced by the first frequency-detection channel being greater than an amplitude of each output-signal portion produced by the one or more other frequency-detection channels.

4. The lidar system of claim 1, wherein each frequency-detection channel further comprises a digitizer configured to produce a digitized signal corresponding to the transmitted portion of the intermediate-frequency signal, wherein the output signal produced by the detection circuit comprises one or more digitized signals produced by the one or more respective frequency-detection channels.

5. The lidar system of claim 4, wherein:
a first frequency-detection channel produces a first digitized signal; and
the processor is configured to produce a digital representation of the first received pulse of light based on the first digitized signal, wherein producing the digital representation comprises (i) rectifying the first digitized signal to produce a rectified digital signal and (ii) low-pass filtering the rectified digital signal.

6. The lidar system of claim 1, wherein each frequency-detection channel further comprises:
a rectification circuit configured to produce a rectified version of the transmitted portion of the intermediate-frequency signal;
a low-pass filter configured to receive the rectified signal and produce a corresponding analog voltage signal; and
a digitizer configured to receive the analog voltage signal and produce a corresponding digitized signal.

7. The lidar system of claim 6, wherein:
an analog voltage signal produced by a first frequency-detection channel comprises an analog representation of the first received pulse of light; and
the corresponding digitized signal produced by the first frequency-detection channel comprises a digital representation of the first received pulse of light.

8. The lidar system of claim 1, wherein:
the optical frequency of the first emitted pulse of light is f₁;
the optical frequency of the LO light is f₀;
the first frequency offset is Δf, wherein Δf=f₁−f₀; and
a first frequency-detection channel associated with the first emitted pulse of light comprises:
an electronic local oscillator configured to produce an electronic local-oscillator signal with an oscillator frequency of F_{LO}; and
an electronic filter having a pass-band that includes a frequency ||Δf|−F_{LO}|.

9. The lidar system of claim 8, wherein:
the AM photocurrent signal comprises a frequency component having a frequency of ΔF; and
the intermediate-frequency signal produced by the electronic mixer of the first frequency-detection channel comprises a frequency component having a frequency of |ΔF−F_{LO}|.

10. The lidar system of claim 9, wherein the frequency component corresponds to periodic pulsations in the AM photocurrent signal, the pulsations separated by a time interval of 1/ΔF, wherein ΔF is greater than 1/Δτ, and Δτ is a duration of the first emitted pulse of light.

11. The lidar system of claim 9, wherein the frequency ΔF is related to the first frequency offset Δf by a Doppler frequency shift (F_{D}) that is proportional to a radial speed of the target with respect to the lidar system, wherein ΔF=|Δf+F_{D}|.

12. The lidar system of claim 8, wherein:
F_{D-MAX} is a maximum expected Doppler shift of the first received pulse of light associated with motion of the target with respect to the lidar system; and
the electronic filter pass-band further includes frequencies between approximately
$$\vert \vert Δ f - \frac{1}{2} {F}_{D - MAX} \vert - {F}_{LO} \vert$$
and approximately
$$\vert \vert Δ f - \frac{1}{2} {F}_{D - MAX} \vert - {F}_{LO} \vert .$$

13. The lidar system of claim 1, wherein:
the oscillator frequency of the electronic local oscillator is adjustable to a plurality of different oscillator frequencies; and
the processor is further configured to instruct the electronic local oscillator to produce an electronic local-oscillator signal having one frequency of the plurality of different oscillator frequencies.

14. The lidar system of claim 13, wherein the electronic local-oscillator comprises one electronic oscillator configured to switch between the plurality of different oscillator frequencies.

15. The lidar system of claim 13, wherein the electronic local-oscillator comprises a plurality of electronic oscillators, each electronic oscillator configured to produce one of the plurality of different oscillator frequencies.

16. The lidar system of claim 13, wherein:
an optical frequency of each emitted pulse of light is offset from the optical frequency of the LO light by a frequency offset of Δf, wherein Δf is a particular frequency offset of one or more different frequency offsets, the one or more different frequency offsets including the first frequency offset; and
the processor is further configured to:
select the particular frequency offset of each emitted pulse of light; and
select the particular oscillator frequency of a particular frequency-detection channel in accordance with the selected particular frequency offset.

17. The lidar system of claim 16, wherein:
the optical frequency of the first emitted pulse of light is f₁;
the optical frequency of the LO light is f₀;
the first frequency offset is Δf₁, wherein Δf₁=f₁−f₀; and
a first frequency-detection channel comprises a first electronic filter and an electronic local oscillator configured to produce an electronic local-oscillator signal with an oscillator frequency of F_{LO}, wherein the processor is configured to select the oscillator frequency so that ||Δf₁|−F_{LO}| is within a pass-band of the first electronic filter.

18. The lidar system of claim 17, wherein the processor is further configured to:
select a second frequency offset of Δf₂ for a second emitted pulse of light, wherein an optical frequency of the second emitted pulse of light is f₂=f₀+Δf₂; and
select the oscillator frequency F_{LO} of the first frequency-detection channel so that ||Δf₂|−F_{LO}| is within the pass-band of the first electronic filter.

19. The lidar system of claim 1, wherein:
the detection circuit comprises a first frequency-detection channel that is associated with m of the different frequency offsets, wherein m is an integer greater than or equal to 2; and
an electronic local oscillator of the first frequency-detection channel is configured to produce m different oscillator frequencies, each oscillator frequency associated with one of the m frequency offsets.

20. The lidar system of claim 1, wherein:
the detection circuit comprises N frequency-detection channels, wherein N is an integer greater than or equal to 1;
each emitted pulse of light is offset from the optical frequency of the LO light by a particular frequency offset of m×N different frequency offsets, wherein m is an integer greater than or equal to 2.

21. The lidar system of claim 20, wherein:
each frequency-detection channel is associated with m of the m×N different frequency offsets; and
the electronic local oscillator of each frequency-detection channel is configured to produce m different oscillator frequencies, each oscillator frequency associated with one of the m frequency offsets.

22. The lidar system of claim 1, wherein the electronic filter is an adjustable-frequency electronic filter that is adjustable to a plurality of different center frequencies.

23. The lidar system of claim 1, wherein:
the portion of the output signal produced by each frequency-detection channel comprises an in-phase portion and a quadrature portion; and
each frequency-detection channel comprises:
an in-phase channel configured to produce the in-phase portion of the output signal, wherein:
the electronic mixer is a first electronic mixer and is part of the in-phase channel, wherein the intermediate-frequency signal produced by the first electronic mixer is an in-phase intermediate-frequency signal; and
the electronic filter is a first electronic filter and is part of the in-phase channel, wherein the first electronic filter is configured to transmit a portion of the in-phase intermediate-frequency signal; and
a quadrature channel configured to produce the quadrature portion of the output signal, the quadrature channel comprising:
a second electronic mixer configured to mix the voltage signal with a phase-shifted version of the electronic local-oscillator signal to produce a quadrature intermediate-frequency signal; and
a second electronic filter configured to transmit a portion of the quadrature intermediate-frequency signal located within a pass-band of the second electronic band-pass filter.

24. The lidar system of claim 1, wherein the output-signal portion produced by each frequency-detection channel corresponds to the portion of the intermediate-frequency signal transmitted by the electronic filter.

25. The lidar system of claim 1, wherein the AM photocurrent signal includes a coherent-mixing term that is proportional to a product of (i) an amplitude of an electric field of the first received pulse of light and (ii) an amplitude of an electric field of the LO light.

26. The lidar system of claim 1, wherein an optical frequency of each emitted pulse of light is offset from the optical frequency of the LO light by a particular frequency offset of one or more different frequency offsets, the one or more different frequency offsets including the first frequency offset.

27. The lidar system of claim 1, wherein the light source comprises:
a seed laser configured to produce seed light and the LO light; and
an optical amplifier configured to amplify temporal portions of the seed light to produce the emitted pulses of light, wherein each amplified temporal portion of the seed light corresponds to one of the emitted pulses of light, and the optical amplifier comprises a semiconductor optical amplifier (SOA), a fiber-optic amplifier, or a SOA followed by a fiber-optic amplifier.

28. A method comprising:
emitting, by a light source of a lidar system, local-oscillator (LO) light and pulses of light, the emitted pulses of light comprising a first emitted pulse of light, wherein an optical frequency of the first emitted pulse of light is offset from an optical frequency of the LO light by a first frequency offset;
detecting, by a receiver of the lidar system, the LO light and a first received pulse of light, the first received pulse of light comprising light from the first emitted pulse of light scattered by a target located a distance from the lidar system, wherein detecting the LO light and the first received pulse of light comprises:
producing, by a detector of the receiver, a photocurrent signal corresponding to coherent mixing of the LO light and the first received pulse of light, the photocurrent signal comprising an amplitude-modulation (AM) signal; and
producing, by a detection circuit of the receiver, an output signal corresponding to the AM photocurrent signal, wherein producing the output signal comprises:
amplifying, by an electronic amplifier of the detection circuit, the photocurrent signal to produce a voltage signal corresponding to the photocurrent signal; and
producing, by each frequency-detection channel of one or more frequency-detection channels of the detection circuit, a portion of the output signal, wherein each frequency-detection channel comprises:
an electronic local oscillator configured to produce an electronic local-oscillator signal having a particular oscillator frequency;
an electronic mixer configured to mix the voltage signal with the electronic local-oscillator signal to produce an intermediate-frequency signal; and
an electronic filter configured to transmit a portion of the intermediate-frequency signal located within a pass-band of the electronic filter; and
determining, by a processor of the lidar system and based on the output signal, that the first received pulse of light is associated with the first emitted pulse of light.

29. A lidar system comprising:
a light source configured to emit local-oscillator (LO) light and pulses of light, the emitted pulses of light comprising a first emitted pulse of light, wherein an optical frequency of the first emitted pulse of light is offset from an optical frequency of the LO light by a first frequency offset;
a receiver configured to detect the LO light and a first received pulse of light, the first received pulse of light comprising light from the first emitted pulse of light scattered by a target located a distance from the lidar system, wherein the receiver comprises:
a detector, wherein:
the LO light and the first received pulse of light are coherently mixed together at the detector; and
the detector is configured to produce a photocurrent signal corresponding to the coherent mixing of the LO light and the first received pulse of light, the photocurrent signal comprising an amplitude-modulation (AM) signal; and
a detection circuit configured to receive the photocurrent signal and produce an output signal corresponding to the AM photocurrent signal, wherein the detection circuit comprises:
an electronic amplifier configured to amplify the photocurrent signal to produce a voltage signal corresponding to the photocurrent signal; and
one or more frequency-detection channels, each frequency-detection channel configured to receive the voltage signal and produce a portion of the output signal, wherein each frequency-detection channel comprises:
an electronic local oscillator configured to produce an electronic local-oscillator signal having a particular oscillator frequency;
an electronic mixer configured to mix the voltage signal with the electronic local-oscillator signal to produce an intermediate-frequency signal; and
a digitizer configured to produce a digitized signal corresponding to the intermediate-frequency signal; and
a processor configured to determine, based on the output signal, that the first received pulse of light is associated with the first emitted pulse of light.
